(19) United States
(12) Patent Application Publication
(10) Pub. No.: US 2003/0059750 A1
(43) Pub. Date: Mar. 27, 2003

(54) Automated and intelligent networked-based psychological services

(76) Inventors: Paul R. Bindler, Far Rockaway, NY (US); Deborah Bindler, Far Rockaway, NY (US)

Correspondence Address: KATTEN MUCHIN ZAVIS ROSENMAN, 575 MADISON AVENUE, NEW YORK, NY, 10022-2585, US

(21) Appl. No.: 10/267,102

(22) Filed: Oct. 4, 2002

Related U.S. Application Data
(63) Continuation of application No. PCT/US01/11087, filed on Apr. 5, 2001.
(60) Provisional application No. 60/195,009, filed on Apr. 6, 2000.

(51) Int. Cl. G09B 19/00

(52) U.S. Cl. 434/236

(57) ABSTRACT

A modularized approach is provided for implementing an online psychological service. The service is made up of modules consisting of specific techniques, procedures, tests, or skills. The parameters associated with the modules are customizable to accommodate appropriate needs of a client. Furthermore, clients are able to assimilate more than one module into protocols to fit their needs. For example, clients are able to put together a set of modules to come up with a protocol for treating a specific disorder.

### BACKGROUND OF THE INVENTION

1. Field of Invention

The present invention relates generally to the field of online services. More specifically, the present invention is related to a method and a system for providing network-based psychological services.

2. Discussion of Prior Art

The healthcare marketplace in America is in a period of great upheaval. Providers are dissatisfied because of reduction in fees and ever increasing restriction of the services they can provide. Patients are unhappy because they feel they are not receiving the quality of service and attention they deserve. And the insurance companies and FMOs are in turmoil because of their difficulty in maintaining costs and remaining profitable. Everyday the newspapers and professional journals reflect this unsteady state of affairs. HMOs have closed, merged, downsized, and further restricted services in an effort to bring costs into line. Changes in federal and state policy have also had a negative impact from the perspective of the insurance companies. In addition, the growing requirement for HMOs to meet the criteria of certifying agencies (e.g., JCQA) and to upgrade their emphasis on quality assurance has also increased the cost burden on insurance companies. It turns out that the cost of management for managed care is greater than ever anticipated.

In the mental health arena, the aforementioned issues are of even greater significance. Many of the behavioral HMOs and their related insurance companies are having a difficult time maintaining cost and staying in the black. Many feel that they have already cut fees to providers as much as possible, and they have reduced the average number of sessions to clients to the minimal level. Thus, reducing payment on the provider end is basically no longer an option for cost containment. The cost of “management” of mental health providers is much greater than anyone had anticipated. The cost of maintaining a provider network is quite expensive, and has undermined the efforts of insurance companies. In addition, the growing emphasis on the quality of services, an issue previously not high on the priority list, is, will continue to add expenses. For example, The HMOs have reduced the number of sessions allocated to a patient to the minimal level. While the patient may have according to their insurance plan a 30 session maximum, the HMOs usually authorize much fewer. While they base their decisions on the clinician's reports, the HMO, and not the doctor, determines medical necessity, i.e., if the patient needs more treatment.

As a result of these issues, there is increasing concern that patient's are not being allocated the mental health services they need. There is growing pressure on HMOs to provide the appropriate level of care, particularly from certifying agencies that will require HMOs to meet and maintain the level of care required by certifying agencies. This will introduce an array of costs previously not anticipated, as for example, reviewing a percentage of the provider's charts, more careful scrutiny of the provider credentials, etc. Also, as federal and state law change, the imperviousness that HMOs have had from lawsuits will dissolve. Many are anticipating that these legal costs will be astronomical when patients can directly sue the HMOs for malpractice related issues.

The state of affairs in the American mental health marketplace makes this a particularly good time to introduce products that are cost effective but still maintain the quality of care. Thus, the state of current computer and Internet-based technologies makes it feasible to implement mental health services through this technology in an efficient and cost-effective way while also providing quality services.

What is needed is a combined technological and psychological product line and infrastructure to provide services that will give the behavioral HMOs the vehicle to dramatically reduce cost and maintain a quality level of service. For example, the elderly, homebound, and individuals living in rural communities, have notably been on the low end of the spectrum of receiving psychological services. With the ability to provide relatively low cost psychological services in the home, these segments of society may finally receive a level of care they need and deserve.

In America, for example, senior citizens often lack the opportunity or have limited access to mental health services. In many instances they are homebound, and therefore they literally could not access the clinician's office. In-home psychological services, when available, are often very minimal and cannot provide the therapy these individuals require. In addition, senior citizens are notorious for medical non-compliance. They do not follow the doctor's instructions, and their conditions worsen rapidly over time. They are also likely to avoid or ignore the need for mental health services; frequently feeling others will find them “crazy” and institutionalize them. Thus, the present invention's in-home Internet and PC-based psychological services could significantly improve the quality of the life of clients.

### SUMMARY OF THE INVENTION

The present invention provides for a modularized automated and intelligent online psychological system (AI_OPS). The system, when implemented in a network, provides for a website wherein a client can log in to access the AI_OPS services. The clients enters the web site through a central service area and is able to access various other service areas depending on the service required by the client.

The service areas further comprise one or more modules comprising specific techniques, procedures, tests, and skills. Furthermore, the variables associated with the modules are stored in a parameter matrix. Additionally, the system and method of the present invention provides for a way for manipulating the parameter matrix, thereby making the modules customizable for individual needs.

The present invention further allows clients to organize the modules into protocols to help provide a systematic approach to a problem.

In one embodiment of the present invention, sets of one or more standardized modules are stored on a server that is accessible over a network. In yet another embodiment the standardized modules are stored on a computer usable medium, such as a floppy disc, CD-ROM, or similar equivalents.

### BRIEF DESCRIPTION OF THE DRAWINGS

FIG. 1 illustrates the modularized automated and intelligent online psychological systems (AI_OPS) of the present invention.

FIG. 2 illustrates the various service areas in the AI_OPS web page.

FIG. 3 illustrates the various response options used in conjunction with the present invention.

FIG. 4 illustrates the graph of the breath duration.

FIG. 5 illustrates how temperature affects color in the liquid crystal temperature monitor.

FIG. 6 illustrates the graphical display of a respiration monitor screen.

FIG. 7 illustrates an example of a sample personal record keeping form.

FIG. 8 illustrates the method of the systematic desensitization module.

FIG. 9 illustrates an example of behavioral hierarchy with subjective anxiety ratings.

FIGS. 10a-d illustrate various forms associated with the cognitive restructuring module.

FIGS. 11a-e illustrate various forms related to the cognitive self-monitoring and self-reporting module.

FIGS. 12a-b illustrate tables associated with the behavior modification and habit control module.

FIG. 13 illustrates a sample PRKF used in self-affirmations training.

FIG. 14 illustrates a sample PRKF used in thought stopping training.

FIGS. 15a-b illustrate forms associated with reinforcement hierarchy and reinforcement schedule.

FIG. 16 illustrates an interface wherein the volume and balance are modified.

FIG. 17 illustrates a typical personal record keeping form.

FIG. 18 illustrates an example of the present invention's method for PC or Internet based behavioral assessment.

FIG. 19 illustrates the method associated with a generalized protocol generator of the present invention.

FIG. 20 illustrates a specific example of a sample protocol for the treatment of a simple phobia

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

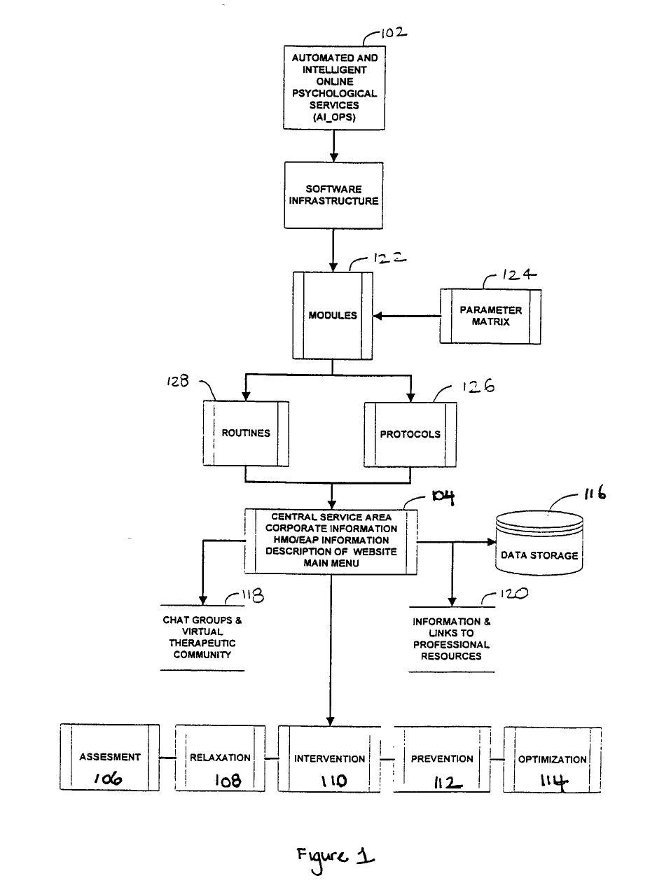

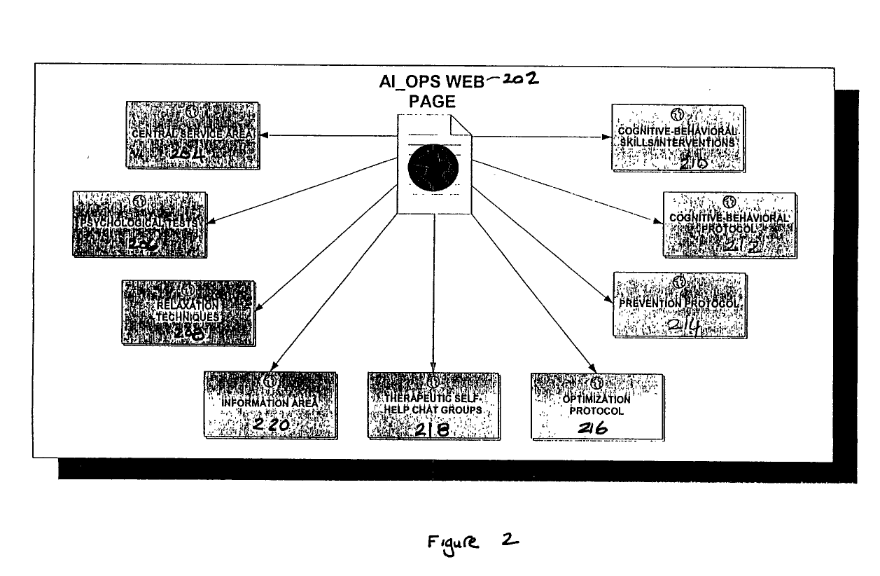

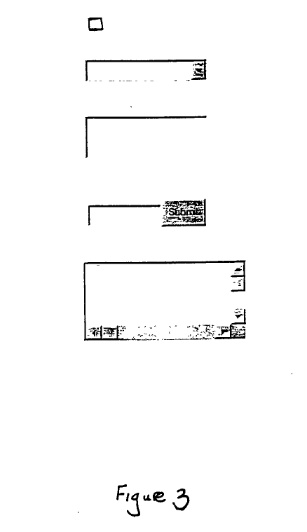

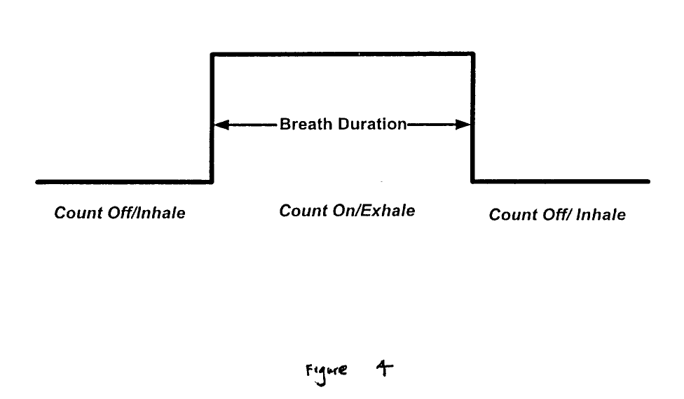

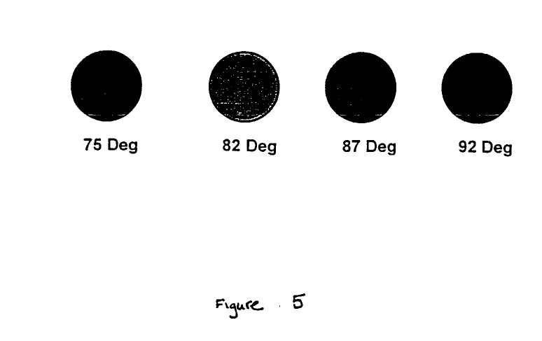

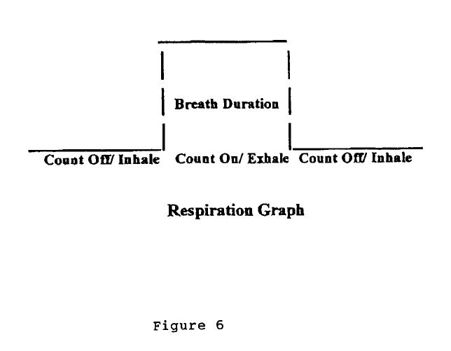

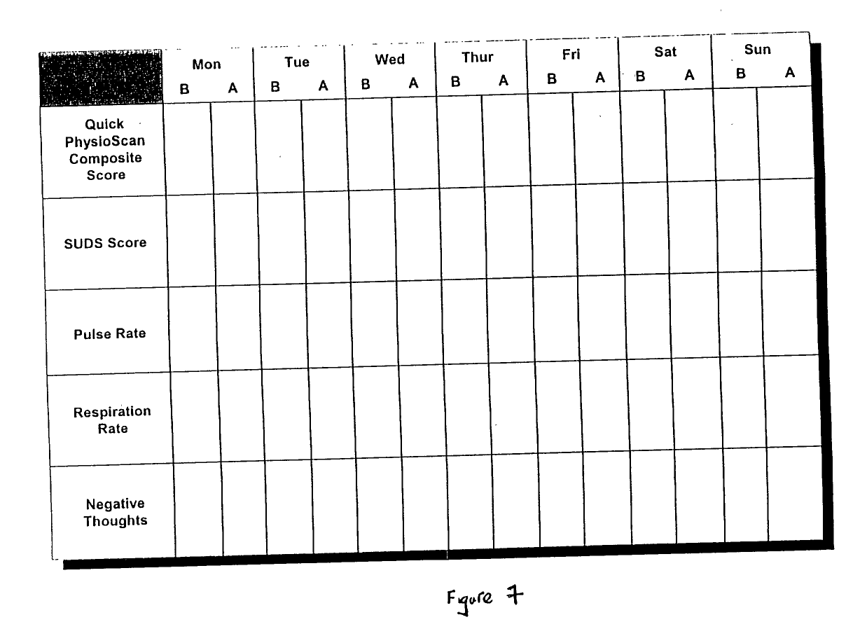

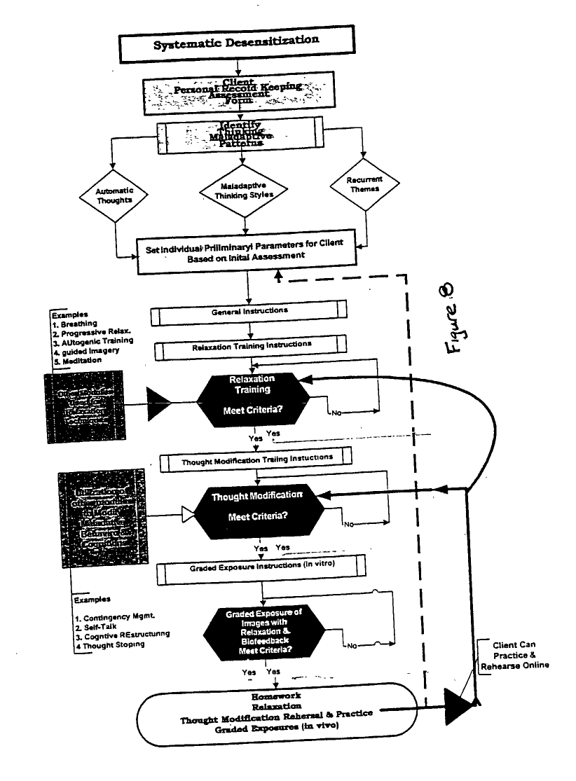

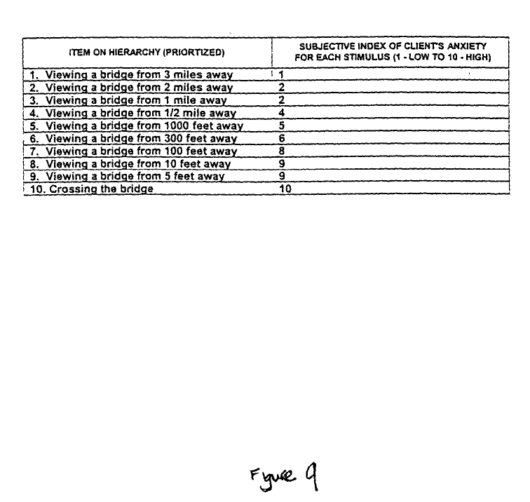

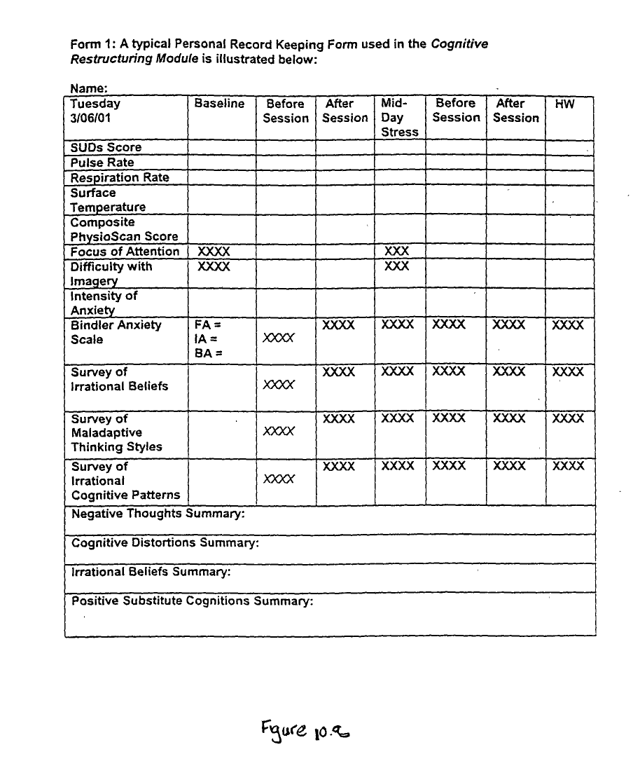

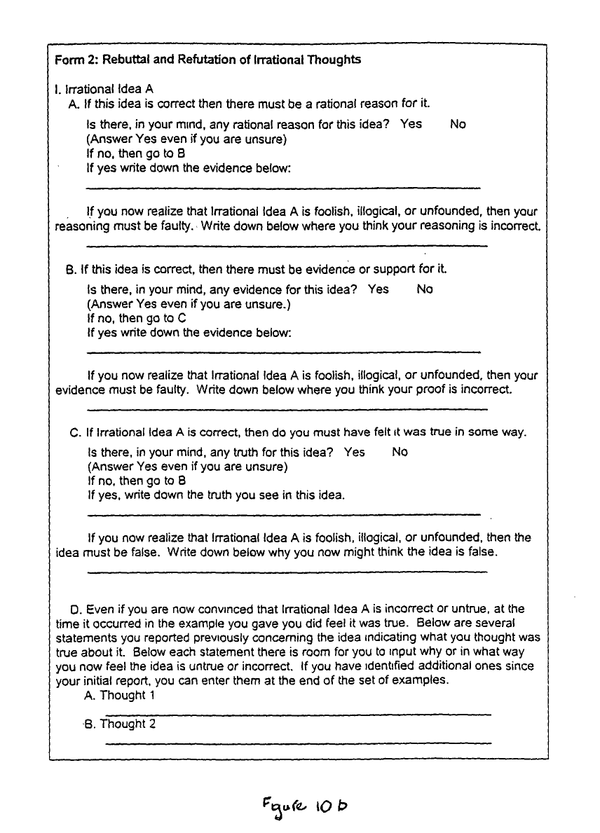

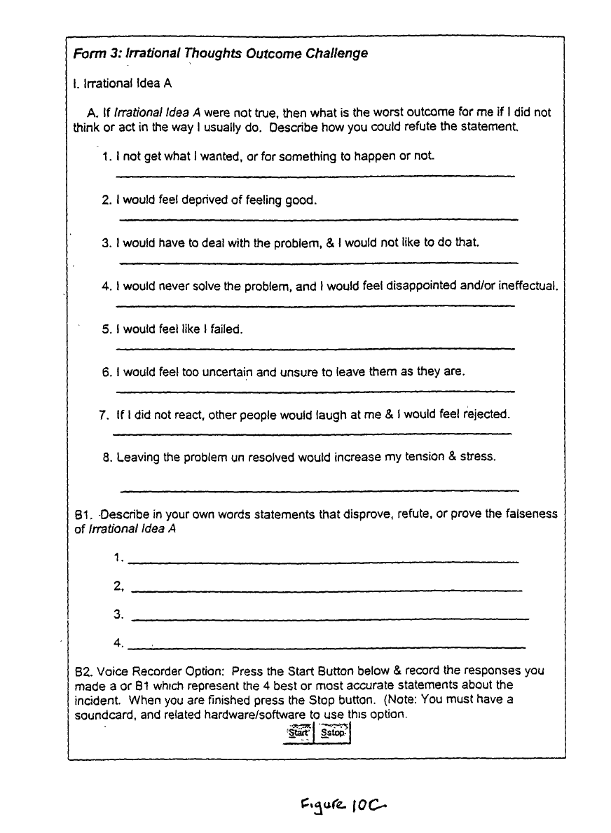

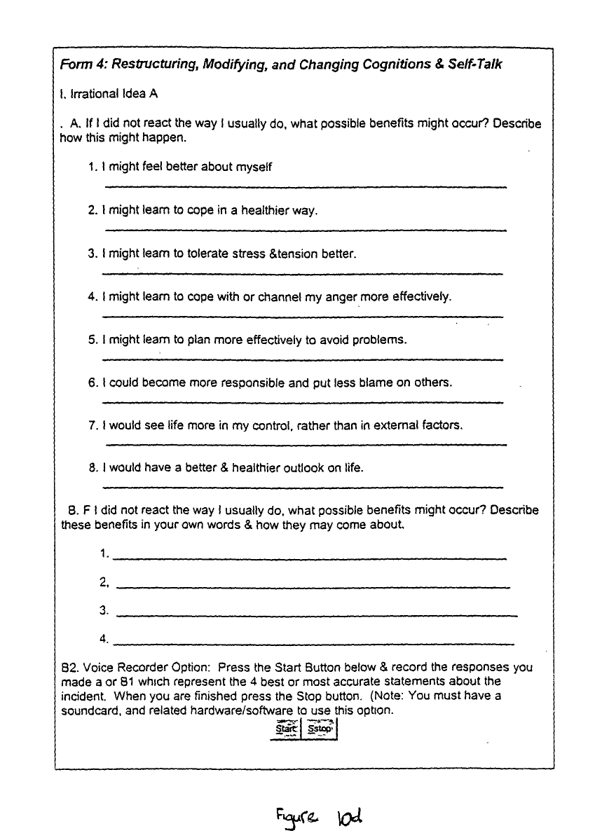

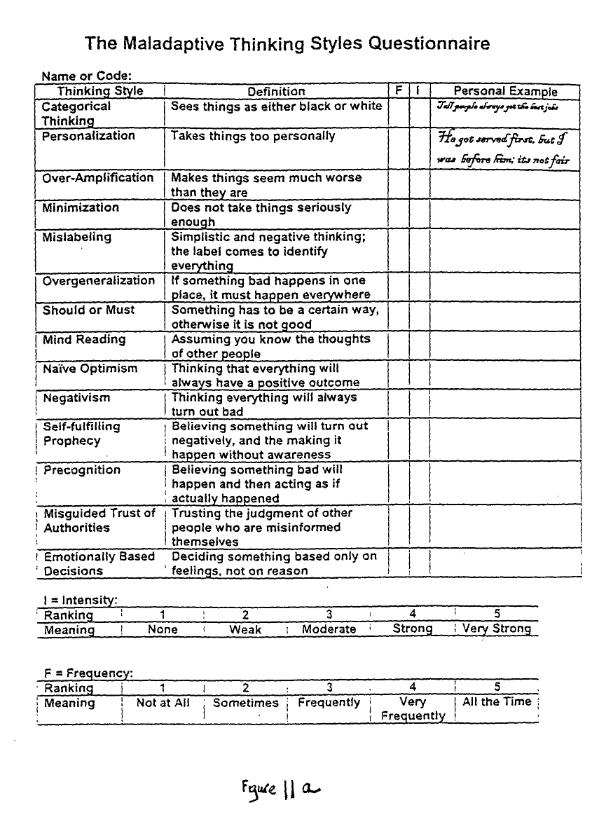

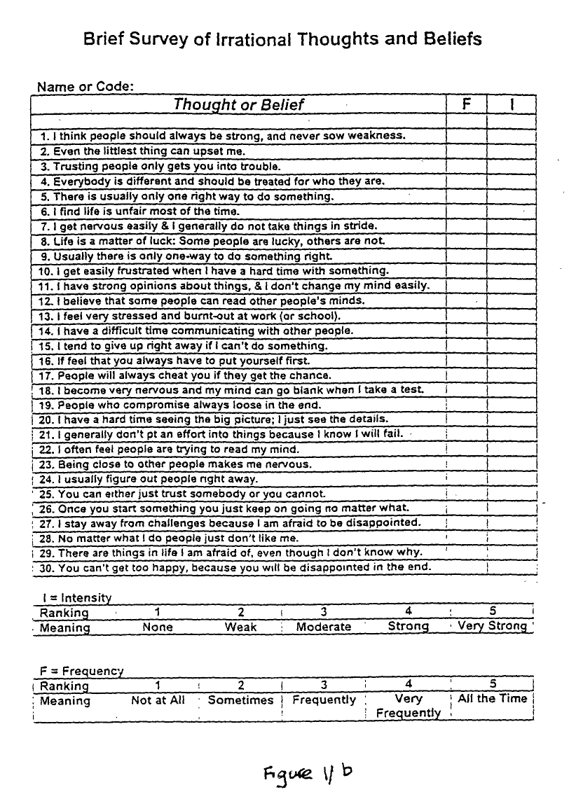

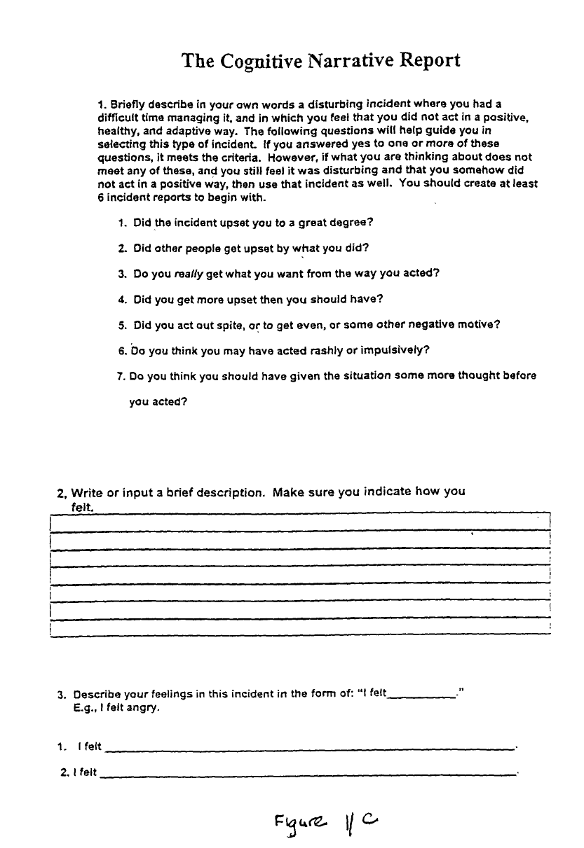

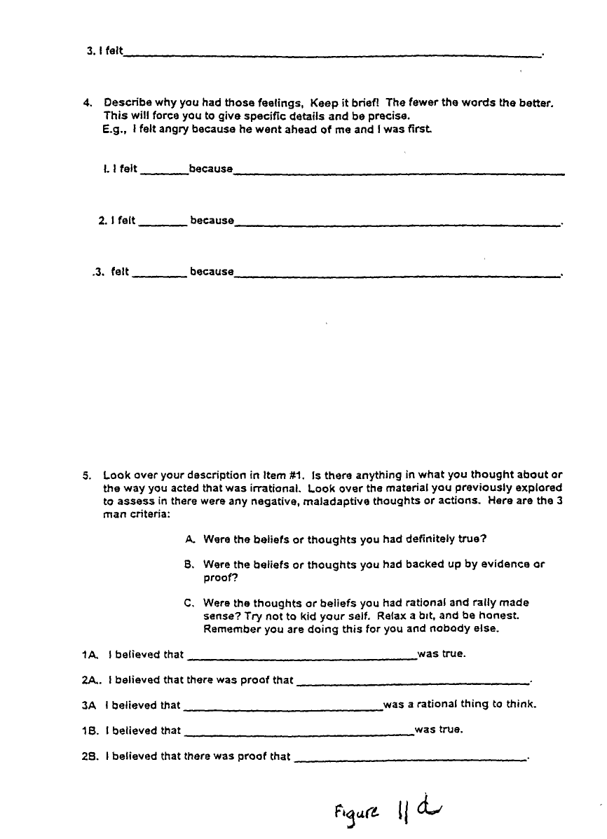

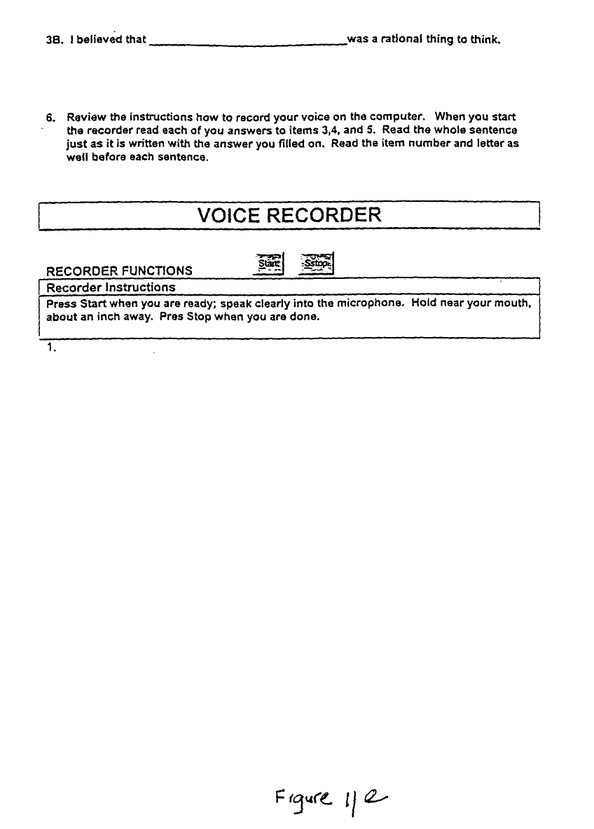

FIG. 1 illustrates automated and intelligent online psychological systems (AI_OPS) 102 of the present invention centered on a modularized design approach to provide the greatest flexibility in being able to rapidly design systems for individual clients while maintaining a high level of quality and ingenuity. The present system comprises, in the preferred embodiment, eight main service areas. Each service area represents a website region in which the client can select various services suitable to their needs. The client enters the web site through central service area 104. In one embodiment, one domain of central area 104 is devoted to explaining to clients their various options and guiding them through a selection process. In another extended embodiment, another domain provides users with client information regarding their company and various details of their employment. Furthermore, in yet another extended embodiment, HMP/EAP information (e.g., details of insurance plan, available services, etc.) is found in a third domain of the central service area The service areas are essentially the users “front-end”, wherein clients are able to choose which particular service they require.

The eight main service areas of AI_OPS 102 are:

1. Psychological Assessment 106

2. Relaxation, Stress Management, and Emotional Self-Regulation 108

3. Therapeutic Interventions, Techniques, and Skills 110

4. Preventative Mental Health Care 112

5. Performance Optimization 114

6. Information/Psychological Resources stored in data storage 116

7. Group Chat/Therapeutic Virtual Community 118

8. Links to Online Professional Clinical Services 120

The abovementioned areas 1 through 5 are referred to as exposition areas, since they form the basic building blocks of various programs called modules 122. Module 122 consists of a specific technique, procedure, test, or skill. In order to provide flexibility and adapt any given module to the needs of a specific client, each module is associated with parameter matrix 124. Parameter matrix 124 allows both the system of the present invention and/or the client to set certain variables so that the module will be appropriate for the needs of the client. It should however be noted that the system of the present invention has exclusive access to certain variables which cannot be modified/set by clients. Various factors associated with the parameter matrix 124 are determined by the present system when designing a website for a specific client. For example, the client will input other variables, such as age and gender and these parameters will then determine the various stimuli that will be incorporated into the training module. For example, video sequences demonstrating a technique will incorporate age and gender appropriate models that demonstrate the technique.

Modules 122 can also be organized into protocols 126. Protocol 126 is a sequence of modules designed either:

a) to treat a specific disorder or problem, or

b) to provide a more systematic approach to teaching a set of interrelated techniques or skills (e.g., for performance optimization)

The system of the present invention helps design a number of standardized protocols for treating a number of the more common mental health problems and for teaching a variety of skill sets that are frequently used in clinical interventions, optimizing performance, and in preventing mental illness. In addition, due to the modularized design, it is relatively easy to construct individualized protocols for specific clients.

The present invention includes a number of standardized training and treatment protocols including:

1. Stress & Anxiety Management Program

2. Generalized Anxiety Disorder Protocol

3. Phobia Treatment Protocol

4. Habit Control Protocol

5. Pain Management Protocol

6. Depression Treatment Protocol

For example, the stress management program includes a 12-session stress and anxiety management program that is a multi-tiered protocol that trains the individual in various techniques, strategies, and skills to cope with stressors and anxiety eliciting stimuli. The program is suitable for corporate and workplace utilization, as well as for individuals using a computer at home. The program can be run directly from the Internet or a computer (with the option of Internet connectivity as well). The program is fairly adaptable, because it is built from modularized components that are readily adapted to different environments. For example, the structure of the program is such that video or animation demonstrations can be designed for the client's needs. Thus, a child could demonstrate a technique when the program is used with children.

Initially the client goes through a comprehensive assessment program to determine their level and type of anxiety, their cognitive styles and skills, and the manner in which they currently cope with stress, and how stress impacts on their life. This material is used to inform the program as to which activities would be suitable for this client. At this stage the program may instruct severe cases to contact a qualified professional.

The program then attempts to match the client's needs with the type of activities they will learn. Each program is composed of specific skills, strategies, and techniques that the client learns in order to cope with stressful events. The client interacts with the program, and their training is paced to the client's level of learning the skill. The client has the ability to rehearse each activity as often as they wish. The program constantly monitors their level of skill acquisition. The clients also receive specific homework assignments that they can print out on their computer.

The client also has the ability to download auditory exercises and relaxation techniques for home practice. Specifically, in this program the client will learn relaxation skills, skills to cope with maladaptive thought processes, and other coping skills. In addition, the program will instruct the client how to apply their skills in everyday life. The program will monitor this process and instruct the client when it is necessary to modify some form of their behavior to optimize success. The program also incorporates some innovative forms of behavior technology to enhance the learning curve, and to more effectively cope with the stress of contemporary society. The test anxiety management program similar to the first program, but specifically geared to students in distress over examinations.

Additionally, in each of the programs and protocols there are assessment tools that determine if the person is suitable for the program. If they do not meet certain criteria, they are referred to other clinical resources. In addition, each program has the option for the client to occasionally access a clinician, through email or chat-based services, when the program itself cannot resolve a significant user question.

In addition to deciding client suitability, AI_OPS includes an innovative and unique front-end assessment that will determine the appropriate treatment regimen for each individual client. This determination is based upon their responses to a user-friendly clinical evaluation, which is focused and usually brief. In this fashion, the program delivers the most potentially efficacious, and cost-effective, treatment strategy for that individual. The assessment modules are also geared to provide assessments over the various phases of treatment. These evaluations, which are usually brief and easy to complete, are used to monitor treatment and assess outcome. Evaluations over the course of treatment help the programs to insure that each clinical goal is accomplished, and if they are not, what modifications need to be made to accomplish the goals. These evaluations also provide data for evaluating treatment outcomes and client satisfaction. In addition, our testing procedures also provide information that help to improve the current protocols and to serve as a source of ideas for future programs.

The programs described are used as clinical programs or as training programs. In certain instances, the latter form of deployment may be desirable when there is a need to minimize claims of clinical or therapeutic efficacy, thus avoiding some of the pitfalls that such claims might entail. Besides the technical development and clinical testing of these treatment models, AI_OPS will have to develop the legal, supervisory and qualitative regimens for ensuring the safe delivery of the therapies.

Biofeedback and applied psycho-physiological treatments use electronic instruments to monitor physiological systems in the client to determine pathological responses that impede optimal psychological and physiological functioning. The information from these instruments can then be displayed or “fed-back” to the client so they can see precisely what is occurring in their body. The client is then trained to utilize this information to learn to control these physiological responses in order to produce healthier response patterns. They then learn to use these self-regulation, strategies without the biofeedback instruments, in everyday life. Thus, these techniques become practical tools to minimize stress and to modify other maladaptive response patterns.

AI_OPS has access to advanced miniaturized biofeedback technology suitable to be integrated into the PC-based products as well as the AI_OPS portal. With the implementation of our innovative behavioral technologies the option of such hardware will enable AI_OPS to deliver medical and stress monitoring, biofeedback training for stress and anxiety management, and forms of physical therapy via the Internet.

A critical factor in securing successful therapy outside the clinic is to ensure that the patient is motivated to complete the therapy, which is enhanced by using behavioral therapy approaches and multimedia computer and Internet technologies. These procedures are targeted at involving and motivating the user with the program to insure their compliance and a successful outcome.

There are some low-end home use biofeedback devices, usually simple skin conductance or temperature devices, which provide a bar graph and some basic sound feedback to patients who exercise on their own. These devices are not usually connectable to a computer and do not record the activities of the patients and they cannot deliver treatment according prescribed protocols. On the other hand, there are professional systems that provide these functions, but these systems are generally costly and not suitable for end users.

The devices incorporated into the AI_OPS are suited to be used with both the Internet and PC-based systems. These devices are easy to use and install. When necessary, the ability to expand the treatment protocols will allow these devices to be integrated into professional protocols implemented with clinical supervision.

In another embodiment AI_OPS of the present invention is used with wireless biofeedback solutions. This will enable the design of a biofeedback device that does not need to be physically connected to the computer during treatment. This will be particularly useful for bedridden patients in whose room it may not be possible to attach the sensors to a computer. In an extended embodiment, the wireless device used in conjunction with the present invention accommodates up to 16 EMG channels although most home use devices would have two to four channels. Professional devices normally need up to eight channels while the 16 channel version would be used for specific rehabilitation requirements.

In an extended embodiment, present invention's system is implemented in a wireless device, such as palmtop computers or WAP-enabled cellular phones, using the Palms OS or Microsoft's® Windows CE® operating systems to provide full mobility during treatment, e.g. in bathrooms away from a computer or for use while traveling. The performance records would then be downloaded to a larger computer or straight to the Internet.

Advantages of AI_OPS of the Present Invention

Innovative Clinical and Training Programs

AI_OPS's clinical protocols and training programs are based on innovative behavioral techniques develop from constructivist systems approach. A number of the techniques developed facilitate the learning process in treatment or training, while maintaining the learning curve. In addition, the methods of the present invention confront specific problems in a novel ways, as for example, the test anxiety management program. Many of the computer/Internet-based cognitive-behavioral protocols are based on a complex integration and interaction with hardware, software, and Web innovations. Thus, AI_OPS does not seek to just use the Internet and computer as a high-level telephone interface. New treatment strategies have emerged from this relationship that facilitate treatment, enhance training, and optimize performance. Many of these methodologies have not been previously available due to technological limitations. For example, multimedia applications and advances in A/V streaming software allow protocols to substitute computer generated images in situations where a therapist would normally only have available the client's own imagery. Most people have very weak, ephemeral images, thus making it difficult to use them in a treatment protocol. Now, technology allows for the possibility of computer-generated images, where the protocol can control the content, intensity, audio, etc. Through these innovative methodologies AI_OPS uses can provide a wide range of services previously unavailable to client and clinician alike.

Cost-Effectiveness

Cost-effectiveness and relative ease of deployment also makes the AI_OPS's programs desirable to HMOs. There is an ever-increasing pressure to provide services while minimizing expenditures. Behavioral management organizations have great difficulty in further cutting services or clinicians' fees. These programs provide a way to offer a range of clinical services far below what they would have to pay a therapist.

These programs would also be desirable to the general public because they provide many individuals the opportunity to learn how to manage complex behavioral problems. They can learn these strategies and techniques while minimizing the costs and inconveniences imposed by traditional psychotherapy. A significant number of individuals could not afford treatment even when the HMO pays the bill. There may be additional costs that make treatment prohibitive (e.g., traveling costs, childcare, etc).

Accessibility

Many individuals may feel that this type of service is more private and they feel more comfortable opening up than if they had to express themselves to another human being. Furthermore, many people find the PC/Internet more accessible than actually having to take the time out to travel to and attend regular therapy sessions.

The fact that these programs are on the computer also means that clients cannot only access them when they want, but as often as they want. If they need further practice with a particular Internet session, they can log on to it as frequently as they desire.

Effectiveness

In addition, the multimedia computer, through audio, video, and animation can display and train behavioral techniques and procedures more precisely than humans can. Thus behavioral modeling, practice, and reinforcement are enhanced through computer/Internet delivery of treatment strategies.

Furthermore, these programs are interactive and entertaining, thus enhancing utilization of the program and practicing the techniques. Through interactivity and multimedia presentation these programs provide a deeper and richer learning environment than any self-help book could. These programs shall become eminently useful tools for people with sub-clinical forms of tension and distress that still may impair their everyday functioning.

EAP and Worksite Based Services

It also affords the client greater flexibility in terms of when they can receive their treatment. This can even be the case when the treatment is presented in an employee assistance program (EAP) based environment where the client accesses the programs through computers in the workplace. EAPs are particularly suited for the task of deploying of computer and Internet-based treatment strategies because they often constitute the first line of defense when an employee is in distress.

In the current situation in America, EAPs have little other recourse than to refer workers to more costly forms of treatment because they have few alternatives. The Internet strategies AI_OPS is developing are particularly suited to this task as they provide an effective and affordable alternative to the current state of clinical referrals.

Protocol Implementation of Current AI_OPS Modules

The current modules in the AI_OPS can readily be developed into protocol for a wide ranges of problems and disorders, as well as for protocols for enhancing learning, optimizing performance, stress-inoculation, increasing a sense of well-being. Anxiety and depression are the two main categories of mental disorders for which automated and intelligent computer/Internet-based cognitive-behavioral therapies are suitable. Anxiety and depression are classified by specific behaviors and symptoms that describe specific clinical entities. AI_OPS is also suitable for a variety of other forms of psychopathology. These programs, because of their modularized design, can readily be implemented in programs not only for behavioral disorders, but also for optimizing performance, to develop training programs, to enhance interpersonal behavior, and so forth. The table below summarizes the disorders characterizing the treatment & training market amenable to AI_OPS.

Disorders Treated by AI_OPS
Anxiety Disorders
Adjustment Disorders
Depression Disorders
Psychological Disorder
Poor Habit Control
Neuromuscular Disorders
Disorders Requiring Increase in Exercise

Anxiety

The national institutes for mental health (NIMH) estimates that 19 million Americans suffer from various anxiety disorders, of which only a small number of individuals seek treatment. Anxiety is a broad term, generally referring to a strong feeling of anxious anticipation where there is irrational worry that a perceived threat is about to occur which the individual will not be able to contain or control. For example, in a phobia of flying the person irrationally fears that the plane will fall and they will die. The specific anxiety disorders are categorized along the lines of the types of anxious anticipations people experience. Anxiety disorders include the following clinical entities:

Generalized Anxiety Disorder—a general sense of anxiousness is experienced without focusing on any particular event, place or person

Specific Phobias—a general sense of anxiousness is experienced which is focused on specific event, place or person (e.g. agoraphobia, claustrophobia, arachnophobia, school anxiety, interview anxiety and examination anxiety, social phobia)

Panic Disorder—fear of suddenly fainting or becoming very anxious in front of others, i.e. the fear of having a panic attack

Obsessive-compulsive disorder—irrational worry or fears concerning one's thoughts and/or objects in the environment

Post-Traumatic Stress Disorder & Traumatic Stress Disorder—persistent anxiety aroused after a traumatic incident, where fear of the recurrence of the traumatic incident is a significant feature of the disorder

In addition to the anxiety described in the above diagnostic categories, most people exhibit anxiety at some time point during their lives about situations in the worksite, exams, stress, financial affairs and family issues. These forms of stress, anxiety, and depression can significantly influence the individual's functioning at work and in interpersonal relationships, and as well as their level of motivation and physical health. In many cases, while the level of anxiety these individuals experience might not warrant a visit to the psychotherapist, these individuals could still greatly profit from learning to manage their anxiety and stress. For example, many students' experience test anxiety, and its debilitating influence on grades are well documented. However, most students do not avail themselves of any form of stress management to modulate the effects anxiety can have on their test outcomes.

Depression

Depression is also a common disorder afflicting close to 11% of the population, which is broadly categorized as follows:

Dysthymic Disorder—a more mild form of depression, usually experienced in reaction to some traumatic experience in the person's life (e.g., death of a loved one, loss of work, divorce)

Major Depression—a severe form of depression that significantly impacts on one's life and is usually rooted in a chemical imbalance

Bipolar Disorder—another severe mood disorder where one or more bouts of mania are present in addition to significant episodes of depression. This disorder is also usually an expression of a chemical imbalance.

Adjustment Disorders

Anxiety and depression are also the focus of concern in an area of mental illness known as the adjustment disorders, which are generally less symptomatically pronounced clinically then the above categories. In an adjustment disorder there are marked behavioral or affective symptoms to a specific stressor within three months after the occurrence of the stressor. Evidence for this disorder is indexed by a level of distress in excess of what would be expected for this stressor and/or there is significant impairment in social, occupational, or academic performance. Usually the level of disturbance does not reach the levels indicated by the disorders listed previously. This disorder may be either acute or chronic in its manifestation. The major forms of adjustment disorder include:

Depressed Mood

Anxiety

Anxiety and Depressed Mood

With Disturbance of Conduct

With Mixed Disturbance of Emotions and Conduct.

Psycho-physiological Disorders and Medical Illnesses Exacerbated by Psychological Factors

Many medical conditions that seriously impact on a person's functioning can either be triggered and/or exacerbated by psychological stress and depression. There is significant evidence that stress factors play a major role in low back pain, asthma, irritable bowel syndrome and other disturbances of the gastro-intestinal system, tension and migraine headaches, and hypertension and other cardiovascular problems. There is accumulating evidence that psychological factors may have an impact on a variety of other diseases as well. Under stress, the body shows significant physiological changes, which can have an extremely deleterious influence on the person, if the stress is significant and protracted. Physiological hyper-arousal is a hallmark of the stress reaction. During this period of hyper-arousal the person's capacity to function well, to concentrate and pay attention, to think clearly, and to act responsively and accurately is significantly compromised. Thus, in addition to the long term consequences of stress, a stressor can have an immediate impact on the individual's daily functioning.

Disorders of Childhood and Adolescence

Children often experience the same type of mental illness as adults. We know that even young children experience depression and various forms of anxiety. In addition, there are other forms of behavior that are characteristic of childhood. For example, attention-deficit/hyperactivity disorder (AD/HD) is an extremely common form of childhood disturbance that may affect over 5% of the population of children in the United States. Here, the main hallmarks are significant disturbances in the child's ability to concentrate and pay attention, and on impulsivity, and hyperactivity. This illness, if untreated, can have pervasive and long lasting deleterious effects on the individual. It is also highly correlated with other forms of mental illness. We have also learned that a residual form of this illness may persist into adulthood, and it is known at Adult AD/HD. One of the most common forms of treatment for this disorder is Ritalin, a relatively strong psycho-stimulant. There are those who are now cautioning against possible side effects of this medicine. And, even among those who agree with its use, there is still the acknowledgement that AD/HD needs to be coupled to a form of behavioral treatment. The forms of CBT over the Internet and computers are particularly significant for this population since they are entertaining and convenient. They will often engage these children more so than other forms of treatment because they are motivating and engaging, and fit into the computer/Internet/gaming world of today's children. It utilizes an environment they are already familiar with and have access to.

Worksite Related Issues

Many of the protocols that are being developed are suitable for expansion as programs focusing on worksite related problems. These include such issues as violence in the workplace, worksite safety, problems with worker communications, job satisfaction and burnout, work-related stress, and so forth. Many of the problems identified as worksite related are generally similar in nature to the issues covered by current protocols. For example, worksite stress is a variant form of stress, and is covered by AI_OPS's stress management program. AI_OPS's programs are developed in a modularized format. Each module is designed to be easily modified so as to fit the needs of a particular client. Thus, the stress management program can be readily adapted to worksite issues. Furthermore, if the client is a large-scale organization, the program can be easily modified to the needs of that particular organization. This approach allows us to rapidly deploy new modules within a short time frame. These building blocks then allow for rapid deployment of new programs or programs specified for a particular client.

Neuromuscular Disorders

There are many disorders typically treated by physiatrists and -physical therapists that require extensive practice by the patient at home. These exercises are often complicated. By the time they get home the patient often forgets how to accomplish them. They are often given a sheet of paper and brief instruction. Usually the doctor or the PT is too busy to review the exercises with the client. By and large, there is no programmatic and systematic approach to these exercises, which compromise the bulk of the treatment for many disorders. CI_CBT products are particularly suited to training the patients in these techniques, thus increasing their efficacy and efficiency in the management of the program. The protocols also dramatically increase compliance and motivation. By insuring a successful recovery in the “exercise” portion of the treatment costs are maintained because the patient recovers in a timely fashion and more drastic medical approaches are avoided. Minimizing the time needed by staff to train and monitor the adherence to the exercise program also contains costs.

Disorders Requiring Exercise

Many disorders and behavioral problems are more successfully treated when accompanied by stress when accompanied by an exercise program. For example, there is medical evidence that hypertension, overeating, insomnia, heart disease, diabetes, and so forth are more successfully treated if exercise is a component of the treatment. For example, although it is not commonly known, exercise is crucial in treating type II diabetes. Maintaining an appropriate weight level and exercise help to insure an appropriate level of insulin sensitivity. Many doctors feel that this is crucial in treating this form of diabetes. As indicated above, CI_CBT is the perfect instrument to implement exercise training programs in a way that if effective, motivating, and cost effective.

Poor Habit Control and Other Behavioral Problems

In addition to the disorders mentioned above there are many other low to moderate level forms of behavioral dysfunction which often go untreated because of the expense involved, difficulties in accessing services, or lack of availability of services. One such area is that of poor habit control, including smoking, poor hygiene, overeating, poor diet, nail biting, and so forth. Some habits, like smoking, overeating and coffee drinking, can have significant negative long-term consequences. Indeed, these habits may even represent a form of mild addiction. Many other habits may have significant consequences at a social level, like nail biting, picking one's nose, etc. Overall, poor habits are categorized as a group of behaviors that disrupt some aspect of the client's life to a lesser degree than the symptoms of a formal mental disorder. Even when there are long-term negative consequences, the level of disruption on a daily basis is not immediately evident. In a similar vein, there are other minor behavioral problems, such as muscle tics, mild to moderate stuttering, and so forth, that also can have a negative and disruptive impact on the client's daily functioning.

These behavioral problems are often related to a mild degree of anxiety, and are unconsciously learned, at some point in the client's life, as a means of discharging some the anxiety through the disruptive behavioral sequelae. Individuals with this sort of problem are often reluctant to seek treatment because they view their difficulty as not serious enough to warrant professional care. Yet, these individuals often feel some form of discomfort or concern as a consequence of their behavior. Furthermore, other people in the client's life also experience some level of distress as a consequence of the problem. For example, smokers are often surrounded by loved ones who vocalize concerns that the smoker may not.

Weight Loss Example

Problems of the type reviewed above are particularly amenable to computer/Internet-based CBT services. Discrete behavioral protocols are being developed to help individuals overcome these difficulties. As noted, these individuals usually do not seek out professional help. However, they would try these programs because they either feel discomfort from their symptoms or because of the negative feedback they receive from others. With computer/Internet-based CBT protocols they can receive a significant level of help, in the comfort of their own home or office, and not incur the expense or time commitment that prevented them from seeking help previously.

AI_OPS's weight control program is exemplifies this implementation of AI_OPS. Many overweight individuals eat in response to vague feelings in heir body. They identify the feelings as hunger, while they may actually be something else like anxiety. Overweight people are often dysphonic, meaning that they have difficulty differentiating their bodily feelings. Al OPS teaches overeaters how to make the correct internal differentiations. In addition, it can be used to help them relax, thus reducing the anxiety component of over eating. Thirdly, AI-OPS can be used to develop a behaviorally driven weight management program to help control eating. Finally, AI-OPS is used to develop an exercise program appropriate for the client and then it is used to monitor the program and help insure compliance to the program. To summarize, AI-OPS can be used in weight management in the following ways:

Reduce dysphoria and train internal response differentiation

Reduce anxiety through relaxation training

Develop a behaviorally driven food management program.

Develop & facilitate individualized exercise program

Internet-Based Implementation of AI_OPS

The AI_OPS website will also have area 120 devoted to providing a wide range of psychological information and links to other psychological resources. This would include information on the client's HMO/EAP benefits, information on psychological conditions and disorders, prevention of psychological disorders, optimizing performance, and so on. In another embodiment, the website provides the clients with an opportunity for online, real-time chat. The chat sessions are either a text-based or an audio/video Internet-based online interaction. These chat groups provide a variety of mental health services, including support, self-help, and virtual therapeutic groups.

In one embodiment, the AI_OPS system of the present invention helps service the HMO/EAP segment in the mental healthcare market place. It should be noted that this Internet service could also be interfaced with other sites for purposes of data collection, client feedback and monitoring, homework assessment, and clinical and technical support. Thus, the Internet-based AI_OPS system is a self-contained system of psychological assessment, treatment, information, and resources. The system provides for universal access for clients who have access to a computer, including the workplace and the client's home. It should be noted that all or portions of the present system could be implemented and ported to a computer (such as a PC) via a storage medium (such as CD-ROM). It should also be noted that the system of the present invention can be implemented with or without Internet connectivity.

As indicated above, the system is modularized to provide for a system that is tailored to meet the individual needs of a client without having to redevelop the product for each new client. This approach is efficient in terms of designing and implementing products geared to specific problems and disorders (e.g., panic disorder, impulse disorders) and specific populations (e.g., the elderly, executives). The abovementioned system flexibility is accomplished through the parameter matrix associated with each module where critical variables have been assessed and set in a way that is suited to the client population.

The AI_OPS also takes full advantage of the Internet not only as a vehicle for providing services but also in terms of providing treatment strategies that are seamlessly integrated with the way the Web provides information. The relative anonymity of clients using a system integrated with the Internet appears to make such client's feel more relaxed and less inhibited about their emotional expression than they would be facing an actual person in traditional therapy. Thus, the Internet-based strategy could be used to access repressed material more quickly and provide a variety of modes of expression not utilized in traditional psychotherapy. The client could respond in a variety of modalities offered through multimedia—sound, music, and pictures. Also, the ability to present, for psychotherapy, sound and images over the Internet and/or through a computer results in a novel way of implementing certain cognitive-behavioral treatment strategies that usually rely on the client's capacity to evoke a visual image. Thus, the AI_OPS system is a unique synthesis and integration of psychology and technology.

The website hosting the system of the present invention is organized into eight basic exposition areas:

1. Psychological Assessment: This section will contain modules for various levels of psychological assessment depending on the needs of the organization. Initial release modules will be:

A) Psychological Diagnosis based on the diagnostic and statistical manual of mental disorders (DSM-IV). The present invention provides for a unique form of presenting a DSM-IV online or telephonically. It is designed to rapidly assess the main diagnostic categories in the DSM-IV. This will provide the relevant data to organizations requiring a standardized diagnosis for their clients.

B) Stress Profile. For sites having psycho-physiological capability this further includes psycho-physiological data.

C) Cognitive Styles Questionnaire

D) Emotional Intelligence Inventory

E) Functional Impairment Inventory: This is a scale to assess the degree to which the person's psychological impairment affects their functioning in 11 different major life areas, such as work, interpersonal relationships, and. education. HMOs and EAPs often require this assessment to determine medical necessity.

F) Multi-Axial Cognitive Functions Questionnaire

G) Anxiety Questionnaire

H) Depression Questionnaire

I) Personality Profiler

J) Specific Psychological Assessments: This contains a variety of specific psychological tests as per the client's request. For example, a test can be used to assess a person's creativity, flexibility, and capacity for absorption. In other embodiments, this could include various other specific assessments the client may require, as for test anxiety, attention-deficit hyperactivity disorder, anger, violence potential, etc.

K) Interactive Response-Based Cognitive & Perceptual Tests: These tests measure a variety of psychological attributes through the client's reactions to stimuli presented on the display. These tests measure a variety of cognitive, attentional, and perceptual attributes. The responses measured include, but are not limited to, reaction time, error rate, number of steps to complete path, and strategy used to solve the problem. Examples of some of these tests include:

1) Concentration

2) Distractibility

3) Vigilance

4) Cognitive Search Strategies

5) Divided Attention

6) Modes of Attention and Attentional Flexibility

7) Logical Skills

8) Pattern Recognition

9) Learning Styles

It should be noted that as with the modules, the tests can be organized into specific protocols tailored to meet the requirements of the client. For example, the client may require a protocol to assess anxiety and stress at both home and work, with an assessment of the impact of stress on the client's performance in the workplace. A protocol would be developed to provide a general index of the client's stress with a profile of the specific characteristics of the client.

The assessment protocols also provide specific recommendations for the client in terms of a therapeutic plan to ameliorate specific difficulties. Additionally, the program recommends other areas of the website where the client is able to utilize online resources provided by the AI_OPS. Furthermore, during the assessment, the client is also monitored for extreme forms of mental disorder, such as suicide potential, substance abuse, and violence proneness. In the instance the system detects that the client meets these criteria, they are immediately referred back to a live HMO/EAP case manager for referral to a mental health practitioner.

Modules in the assessment section are also be integrated into and inform the treatment protocols to provide data for the parameter matrices. Assessment modules are used to monitor ongoing treatment, to recommend changes in the treatment when necessary, and to determine treatment termination. Assessment routines are also used to obtain follow-up data after termination of treatment, and to assess patient satisfaction. This will be particularly important for HMOs/EAPs in terms of data they need for the certifying agencies assessing their program. This perspective also demonstrates the high degree to which quality assurance is built into the website services. In an extended embodiment, services could also be provided to practitioners for the paperwork they must file for the HMO/EAP. This data could be collated with patient data, to provide the HMO with a more detailed picture of the mental health treatment process, including utilization data, therapy outcomes data, and client satisfaction data.

The data collected through these efforts also will provide an extensive database on mental health services provided via the Internet, a resource that has its own value. There is a potential marketplace for this data as well. Indeed, the assessment package we are developing may serve as a stand-alone product that may be sold to organizations requiring these services.

2. Relaxation, Stress Management, and Emotional Self-Regulation

A second exposition area of the website focuses on relaxation techniques, stress management procedures, coping skills, and tools for emotional self-regulation. The computer/Internet-based stress & anxiety management protocol integrates the assessment devices to help determine the most efficacious route the client will take in the going through the process of the stress and anxiety management protocol. This technique is of particular importance to EAPs who have traditionally centered their efforts on anxiety and stress, and who usually offer these types of services to their clients. In addition, anxiety reduction procedures play a central role in cognitive-behavioral protocols for anxiety and depression. Furthermore, in many instances of psychological distress the client may only need to learn how to relax and discharge some of their daily tension and to learn simple techniques to minimize the impact of stressors in their lives. Moreover, many clients need to learn techniques to minimize the impact of other negative feelings, such as anger. Some modules are so constructed as to provide a modest level of service as a self-contained unit, herein called treatment routines 128. In many instances experience with one or two routines may be sufficient for a given problem. Problems requiring a more intensive level of care are serviced though an integrated series of modules called a treatment protocol.

In the second exposition area, the client will have access to a wide variety of relaxation routines. Each routine consists of a module and its associated parameter matrix where specific variables can be set to tailor the module to the needs of the client. For example, in the Breathing Routine there will be a streaming video-clip illustrating the technique. The standard routine will have an adult demonstrating the technique. However, for a client that services families with children there would be a video-clip of a child available when the demonstrating the technique to a child patient. This structure provides for the ability to have a variety of relaxation and stress management techniques with the flexibility to provide a client-specific product. Basic modules will initially be developed with parameter matrices designed to reflect differences in age, gender, some aspects of cultural background, and socio-economic level. This will provide an initial database that will be available for the majority of potential client backgrounds. For those clients that opt for sensor technology as part of the website services, there will be relaxation techniques available centering on biofeedback procedures.

Basic modules in the initial PC & website based release will include:

A. Diaphragmatic Breathing

B. Progressive Muscle Relaxation

C. Guided Imagery: Client-based visualizations

D. Guided Imagery: Multimedia-based images

E. Autogenic Training

F. Meditation Techniques

G. Cognitive Modification & Coping Skills

H. Anger Management Training

I. Emotional Self-Regulation Training

J. Behavior Modification

K. Habit Control

L. Coping Skills Training

M. Cognitive Restructuring

N. Thought Stopping

O. Self-Monitoring & Self-Reporting techniques for thoughts and behaviors

P. PhysioScan Training (physiological discrimination training) & Basic Simple Methodologies for Monitoring Physiological Responses

Q. Interoception Training

R. Response Control Training—a new technique that has been developed that incorporates advanced behavioral technology to facilitate biofeedback training as well as learning adaptive behavioral sequences in cognitive-behavioral strategies.

S. Game oriented relaxation training, some suitable for children and others suitable for adults. These are particularly suited to enhance motivation and stimulate interest. They may be used in tandem with other procedures, or may be incorporated in treatment protocols also as motivational and interest agents. Some of these games will be based on biofeedback and sensor technology

Some of the relaxation modules, of necessity, require biofeedback. Some of he other modules do not require biofeedback, but could be enhanced by the incorporation of biofeedback procedures. Thus, in one embodiment, biofeedback is used to enhance the relaxation learning curve associated with clients. Psycho-physiological techniques are also be used to monitor relaxation and to corroborate the client's subjective reports of their own perception of their state of relaxation. In addition, biofeedback enhances many of the components of CBT, as will be indicated later. This integration of biofeedback with CBT is particularly successful when it is integrated into the portions of the treatment focused on training relaxation or in maintaining relaxation when exposed to anxiety eliciting stimuli during in-session treatments.

3. Therapeutic Interventions, Techniques, and Skills

A number of modules are used to demonstrate and train clients regarding various therapeutic techniques to modify the maladaptive behavioral patterns and negative cognitions that are at the basis of their psychological condition. Most of the modules are designed to be client specific and interactive. That is to say, the client will input data that will inform the module so that it will respond in terms of the client-specific problem. In addition to utilizing web-based technologies, these modules, in other embodiments, include other advances in logic (e.g., fuzzy logic), artificial intelligence, and behavior technology resulting in an efficient, client-specific, interactive procedure. In addition to incorporating many of the procedures of cognitive-behavioral therapy and other forms of brief therapy, specific behavioral techniques are also integrated to analyze verbal behavior, in specifying behavioral response sequences, and in augmenting and modifying the contingencies between behavior and its consequent events. These techniques include what is henceforth referred to as neurocognitive therapy, response control training, contingency management training, applied semantic analysis, and interoceptive response discrimination training. These techniques help specify the cognitive and behavior sequences characterizing maladaptive behavior and help create specific contingencies the client utilizes in modifying their behavior. These techniques also have application in prevention and performance optimization. In particular, these methods are useful in deriving specific behavioral components and procedures that are used programmatically in treatment programs where the behavioral procedures are translated into treatment algorithms that can be provided via the Internet and/or a computer.

As mentioned earlier, one or more of the modules such as the intervention module can be enhanced through the integration with biofeedback and psycho-physiological procedures. In addition to facilitating relaxation training, psycho-physiological techniques are used to monitor emotional arousal during a module or protocol. This is used in a variety of ways. For example, in desensitization training, physiological monitoring can be used to help determine if the client is sufficiently relaxed at a particular stage of training. It is also used as an in-session technique to facilitate the client's ability to relax during the presentation of anxiety eliciting stimuli. It is also be used to validate the client's subjective report of their internal state of relaxation. In addition, modules are designed to be interesting and motivating to help sustain the client's involvement and participation. In many of the modules there are embedded techniques to sustain and to reinforce the client's compliance. These abovementioned techniques are geared to insure that the clients actually use the programs, and to assure the quality of the outcomes. Indeed, one of the strong advantages of this treatment approach is the ability of the client to have access to the system whenever and wherever they desire. This extends to clients the opportunity to rehearse and practice their skills and technique as much as they like. For those clients taking advantage of this feature, they would get significantly more reinforcement and structured training time than they could otherwise in traditional therapy.

Modules in this service area generally represent a technique (or procedure) that is well documented in the literature in terms of demonstrating success at modifying negative or maladaptive behaviors or cognitions. Furthermore, each intervention module, routine, or protocol generates a homework assignment at the end of each session, wherein such homework assignments provide the client the opportunity to extend the effects of a session, to practice and to rehearse requisite skills, and to internalize the techniques learned. The assignment is individualized for the particular client based on data acquired during the session. Assignments generally require the client to record data that is entered back into the program. This data is taken into account in subsequent training sessions in terms of the type of additional training, resolving conflicts and misunderstandings about the assignment, assessing the need for additional practice or moving to the next program step, and in assuring compliance to the program.

Modules in this section are oriented toward reinforcing positive thoughts and behaviors. Thus, they play a role in protocols for optimizing performance and/or for behavioral prevention techniques. A number of modules are designated to modify a particular maladaptive thinking style or behavior pattern. Others are geared to training particular techniques that can be used to modify a particular set of maladaptive thinking styles or patterns of behavior. Other modules are oriented toward developing and enhancing particular skills to not only modify behavior, but to reinforce and to facilitate already existing positive patterns.

The modules can also be grouped together to treat a particular mental disorder. For example, most panic disorder patients tend to catastrophize events in their lives, and in particular, they tend to over-amplify the significance of changes in their perception of physiological events. This recurrence of behavior patterns allows for the development of standardized protocols that when used with the system of the present invention leads the client throughs a specific sequence of events that are geared to ameliorate designated components of the disorder. Due to the flexibility of the modules, individualized protocols are made in accordance with the specifications of a client. The protocols are also informed by the tests the client takes. This data is used in selecting relaxation and intervention modules, in setting the client's parameter matrix, and in setting treatment goals.

Some of the modules, routines, and protocols in the intervention exposition area include:

Modules and Routines

1. Skills

a. Problem Solving

b. Decision Making

c. Coping Skills

d. Interpersonal Skills

2. Techniques

a. Eliciting and Evaluating Automatic Thought

b. Targeting Techniques and Goal Setting

c. Prioritizing

d. Cognitive Modification

i. Sub-modules with specific techniques, as Metaphor Technique, Thought Stopping, Dialectical Analysis, Reductio ad absurdum, Socratic Reasoning, Self-Directed Questioning

e. Modification of Cognitive Styles

i. Sub-modules related to specific destructive thinking patterns, as Personalization, Over-Amplifying the Significance of Events, Mis-Labeling, Categorical Thinking

f. Self-Validation Methods

3. Cognitive Training

a Attention Control Training

b. Imaginative Involvement

c. Imagery Enhancement Training

4. Behavioral Training

a. Self-Monitoring and Observation (Personal Data Collection)

b. Contingency Management Training

c. Response Control Training

d. Verbal Analysis and Control

5. Emotional Self-Regulation Skills

6. Therapeutic Techniques

a. Systematic Desensitization

b. Exposure Therapy: Imagination Based

c. Exposure Therapy: Multimedia Based

d. Cognitive and Behavioral Rehearsal

e. Imaginative Role Playing

f. Modification of Cognition

II. Protocols

1. Anxiety Disorders

a. Includes a general protocol for moderate depression coupled with anxiety

2. Mood Disorders

a. Dysthymic disorder (with & without secondary anxiety)

3. Habit Disorders

4. Interpersonal Dysfunction

5. Communication Dysfunction

6. Pediatric Disorders

7. Miscellaneous

a. Attention-Deficit Disorder, residual type

b. Coping with Bereavement

Specific client populations. In the preferred embodiment, protocols are developed for specific populations, such as educational systems, the elderly, children at risk for dysfunctional behavior, and families in distress. There are many segments of society that cannot, or traditionally have not, utilized mental health resources to a significant degree. Internet and PC-based resources now extend the possibility of such resources to these populations. In America, for example, senior citizens often lack the opportunity or have limited access to mental health services. In many instances they are homebound, and therefore they literally could not access the clinician's office. In-home psychological services, when available, are often very minimal and cannot provide the therapy these individuals require. In addition, senior citizens are notorious for medical noncompliance. They do not follow the doctor's instructions, and their conditions worsen rapidly over time. They are also likely to avoid or ignore the need for mental health services; frequently feeling others will find them “crazy” and institutionalize them. In-home Internet and PC-based psychological services could significantly improve the quality of the senior citizens quality of life. In addition, we could offer a behavioral program over the Internet to enhance medical compliance, which, in the long run, is also cost-effective because the medical illness will not proceed as rapidly and require more intensive and costly care. It is envisioned that such compliance programs could also be offered in conjunction with the system of the present invention. Additionally, individuals who have suffered the loss of a family member define another substantial client population. Most companies provide only meager bereavement services, if any, to individuals who have suffered a loss. Furthermore, the loss and bereavement greatly impacts on the person's functioning at work and at home. Thus, after a loss, there can be a prolonged period where the individual is no longer working efficiently when they return to work. Hence, loss is a very common problem that has serious consequences, yet it has received minimal attention.

PC-Based Services. It should be noted that all or significant portions of the present invention can be implemented and placed as computer-readable code on a CD-ROM or hard drive. Therefore, clients are able to use many of the programs without having to log-on to the Internet. Alternatively, there could be integration between a home-based PC program and Internet-based services.

4. Mental Health Maintenance & Prevention of Illness

This exposition area provides for a variety of modules and protocols that the client utilizes to identify risk factors that predict the occurrence of some form of mental disorder. In addition, techniques are also provided in this exposition area to optimize their personal and interpersonal lives in a way that will reduce susceptibility to stress related illness (e.g. hypertension, migraines) and to minimize the impact of stress on home and work functioning. This component in particular will have a variety of resources that clients can use to cope with work related stress. In addition, the major factors of non-work related stress factors that ultimately impinge on the client's work efficiency are identified. These factors include (but are not limited to) marital and family distress, alcohol and drug abuse, depression, and social isolation. Furthermore, the system of the present invention also identifies risk factors (such as suicide potential, violence and dangerousness proneness, and substance abuse) that are best treated by a professional. In such instances, the system refers the clients to a live case manager who will, in turn, make an appropriate referral.

The client will also have access to a “library” of stress inoculation techniques that provide individuals, who are not immediately at risk, a way to discharge the excessive tensions of everyday life. Such individuals are able to learn techniques to help buffer them from the impact of stressors over which they lack immediate and direct control. Some of the techniques are relatively simple, like having the computer signal a predetermined “relaxation break,” and signal the client when it is due. In some extended embodiments, some techniques require technology, like sensors to detect physiological levels during work, or programs that assess keyboard error rates. When certain thresholds are exceeded, a cue would appear to signal a relaxation period, an exercise break, and/or postural adjustments. These techniques reduce the impact of stress and enhance the quality of the patient's life. These techniques enhance client's ability to concentrate and pay attention, to think clearly and more effectively, and to enhance their emotional outlook. Even individuals who do not suffer form disorders of emotional dysregulation, anger and frustration of everyday life can, over time, have a deleterious effect. The frustrations of today's work environment can wear on almost everyone overtime, and produce an adverse effect on a wide segment of the population. A large percentage of Americans' actually suffer from a mental disorder. Other studies show that an even larger segment of the population suffers some from work related events. Thus, these techniques either help to reduce the impact of stress or to ameliorate early signs of stress related illness before it becomes a serious problem.

5. Performance Optimization

This component is devoted to modules and protocols that go beyond those techniques provided in exposition area 4 described above. These techniques are intended to refine and perfect cognition, perception, and behavior in such a way as to achieve peak performance. These procedures often require more commitment and effort than the others do. The client has to be appropriately motivated and understand the level of dedication required to achieve these results. An example of these protocols would be the concentration and attention enhancement protocol that is designed to maximize the client's capacitate to focus, to concentrate, and to deploy attention. They are first assessed in terms of their attentional styles and capacities. They then go through a protocol designed to further reinforce their positive attributes, and to train in new forms of attentional deployment to modify weak or negative forms of attentional processing. The client is also taught to generalize their attentional skills to all aspects of their life, and they are taught how to maximize their attentional capacity in areas that it is currently weak.

6. Professional Clinical Resources

There are often times that a client needs to contact a professional, but would not require a full session contact. The present invention provides for a network of clinicians that would work for an hourly fee to provide this contact. In some embodiments, this is accomplished through email, and, if necessary, through an 800 support line. In the preferred embodiment, email is the first line of contact. In this embodiment, if the client and clinician feel its is warranted, the client would be referred to a 800 number.

7. Chat Rooms and Virtual Therapeutic Communities

Internet technology today is sufficiently advanced to provide secure private chat rooms, public chat rooms that could accommodate a number of individuals, and virtual communities that support large bodies of individuals in a collaborative effort. We can utilize this technology to provide self-help groups oriented around specific problems or disorders. Online therapeutic groups could be formed organized around a variety of themes. Some of these groups could include professional mental health clinicians to run the group. And, on a more ambitious scale, we could organize what essentially is a virtual therapeutic community, where the client becomes part of a community and plays certain roles in that community. This effort could be organized in a similar way that therapeutic comminutes are currently organized. This type of virtual community may be the first of its kind.

8. Psychological Information, Company Information, and Links to Other Resources

The website hosted in the system of the present invention provides a diversified range of resources on mental health and related topics, such as stress prevention and performance optimization. A database is maintained of articles, newspaper clippings, and material derived from other websites. In addition, there will be a diversity of links to academic, governmental, and private sector websites. Furthermore, information will be provided on the particular client concerning the organization, benefits, and other organizational information.

It should be noted that due to the modular design of the system of the present invention, one skilled in the art can conceptually and pragmatically “port over” the system to other types of corporate and non-corporate organizations. It can also serve as the basis for PC-based products, and products for the “home” marketplace. For example, if a particular organization wanted an emphasis on the treatment of certain mental disorders or psycho-physiological conditions, the AI_OPS is used to generate specific protocols for these disorders. Alternatively, protocols focusing on the acquisition of certain skills could be developed for organizations emphasizing disease or accident prevention, or performance optimization. Smaller websites can also be organized for organizations requiring a more limited treatment scope. For example, a website dealing only with bereavement issues can be developed. This type of website could then be marketed to many different types of corporate entities.

FIG. 2 illustrates one embodiment of the present invention wherein a website implementing the system of the present invention contains the following elements:

1. Basic central service area 204 with examples of corporate and HMO/EAP information

2. Four basic psychological tests 206 that are brief: diagnosis, cognitive styles, anxiety, depression

3. Three basic relaxation techniques 208—breathing, progressive relaxation, imagery

4. Four basic cognitive-behavioral skills/interventions 210 with rehearsal and homework assignments—self-observation, modifying cognitions, problem-solving, systematic desensitization

5. A cognitive-behavioral protocol 212 for phobias and/or panic disorder

6. A prevention protocol 214 for anxiety disorders with an emphasis on relaxation training and stress management

7. A performance optimization protocol 216 for enhancing awareness, attention, and concentration

8. An example of a therapeutic/self-help chat group 218 for overeating

9. A basic information service area 220, with links to other websites and email access to other professionals.

Provided below are examples of a stress management program, a program for anxiety and depression, a program for habit control, and a pain management program based on the system and method of the present invention. This program employs the principles previously delineated to form a general stress and anxiety management protocol with a number of applications to everyday life problems.

Stress Management Protocol

I. Session 1: Introduction to Stress

1. Introduction to Stress Module

2. Generalized Assessment Module

a. Introduction to the Evaluation Process

a. Assessment Instruments—Self-Report Questionnaires

i. General Introduction

ii. Introduction to specific tests

iii. Administration of specific tests

3. PhysioScan Module

A. Introduction

B. Specific Assessments

1. Pulse Rate

2. Respiration Rate

3. Surface Temperature

4. Blood Pressure

4. PhysioScan Self-Report

4. Personal Record Keeping Form (PRKF)

A. Introduction

B. Design Form SubModule of the Report & Form Generator Module

C. First Baseline Data Completion

5. Initial Assessment

A. Client Summary

B. Client Interpretation

C. Online and Printed Results

6. Reinforcement Module

A. Define concept of reinforcement

B. Initialization of Reinforcement Hierarchy

C. Establish Reinforcement Schedule

D. Assigning reinforcement points

2. Final Relaxation Period

A. Audio/Visual Relaxation Module

B. Record PRKF

3. Homework

A. Introduction

B. Online practice & PRKF completion

C. Printed Homework at completion of the PRKF

II. Session 2: Diaphragmatic Breathing

1. Diaphragmatic Breathing Module

a. Introduction

b. Demonstration

c. Breathing Technique Training

2. Transition Module

3. Complete PRKF

4. Reinforcement Module for assigning reinforcement points

5. Final Relaxation Period: Audio/Visual Relaxation Module

6. Homework

a. Introduction to homework for deep breathing

b. If possible, client downloads audio instructions for deep breathing, with timing sequences on the tape

c. Client prints out homework assignment sheet for deep breathing & PRKF

d. Online completion of forms is possible

e. Client has access to Breathing Module during week for review

III. Session 3: Attention & Awareness Training

A. Attention and Awareness Training (Attention & Awareness Training Module)

1. Attention and Awareness Training (AAT)

2. Demonstration

B. Generalized Assessment Module: Interactive Response-Based Tests

1. Introduction & instructions to interactive tests

2. Demonstration of testing through video/animation

3. Introduction to specific tests

4. Client completes Attention and Concentration Test Batter

5. Client receives summary report

6. Client informed as to specific tasks he/she will train

C. Attention and Awareness Training Module (AAT))

1. Instructions regarding specific AAT exercises

2. Client views demonstration of training exercises they will complete

3. Client practices with specific AAT exercises

4. Client re-assessed as to progress to determine necessity for further training

5. Client does brief self-monitoring exercise & records tension level (SUDs score, other data) at end of each session on the Personal Record Keep Form (PRKF in the Report and Forms Generator Module

6. Client given brief report of results

7. Reinforcement Module for assigning reinforcement points

8. Brief transitional relaxation through the Audio/Visual Relaxation Module

9. Homework

i. Introduction & instructions for PC/Online homework assignment through the Report & Form Generator Module

ii. Client has access to AAT program exercises during week for review

IV. Session 4 Progressive Relaxation Training 1

A. Progressive Relaxation Application 1 (Single Behavioral Response Training Module)

1. Introduction to Progressive Relaxation Training for Single Muscle Groups (PRT-SG)

2. Demonstration

B. PhysioScan Module: Learns to monitor tension levels physiological sensations & feelings that are related to anxiety & tension, as well as relaxation, levels

1. Introduction & instructions to self-monitoring

2. Demonstration of self-monitoring technique

3. Introduction to self-monitoring practice

4. Client practices self-monitoring with program

5. Client practices self-monitoring without program

6. Assign reinforcement points in Reinforcement Module

7. Homework assignments

C. Progressive Muscle Relaxation for Single Muscle Groups (PRT-SG)

1. Instructions regarding PRT-SG exercise

2. Client views PRT-SG single muscle groups demonstration

3. Client practices with PRT-SG single muscle groups with the program

4. Introduction & instructions to practice without

5. Client practices brief self-monitoring to assess tension level—from monitoring skill learned above

6. Client does brief self-monitoring exercise & records tension level (SUDs score, other data) on Personal Record Keep Form (PRKF) in the Report & Forms Generator Module

7. Client given brief report of results

8. Reinforcement Module for assigning reinforcement points

9. Brief transitional relaxation through the Audio/Visual Relaxation Module

10. Homework

a. Introduction & instructions for PRT-SG homework assignment through the Report & Forms Generator Module

b. Client prints-out and/or downloads homework sheet for PRT-SG

C. Client has access to PRT program during week for review

V. Session 5: Progressive Relaxation Training 2

A. Progressive Relaxation Application 2 (Parallel Behavioral Response Training Module)

1. Introduction to Progressive Relaxation Training (PRT-SQ)

2. Demonstration

B. Client completes PRKF and PhysioScan Quick Scan

C. Progressive Muscle Relaxation for Single Muscle Groups: Module1 (PRT-SQ)

1. Deductions regarding PRT-SQ exercise

2. Client views PRT-SQ for single muscle groups demonstration

3. Client practices with PRT-SQ for single muscle groups with the program

4. Introduction & instructions to practice without

5. Client practices brief self-monitoring to assess tension level—from monitoring skill learned above

6. Client does brief self-monitoring exercise & records tension level (SUDs score, other data) on Personal Record Keep Form (PRKF) in the Report & Forms Generator Module

7, Client given brief report of results

8. Reinforcement Module for assigning reinforcement points

9. Brief transitional relaxation through the Audio/Visual Relaxation Module

10. Homework

a. Introduction & instructions for PRT-SQ homework assignment through the Report & Forms Generator Module

b. Client prints-out and/or downloads homework sheet for PRT-SQ

c. Client has access to PRT-SQ program during week for review

VI. Session 6: Progressive Relaxation Training 3

A. Progressive Relaxation Application 3 (Parallel Behavioral Response Training Module)

1. Introduction to Progressive Relaxation Training for Parallel Muscle Groups (PRT-SQ)

2. Demonstration

B. Client completes PRKF and PhysioScan Quick Scan

C. Progressive Muscle Relaxation for Parallel Muscle Groups: Module1 (PRT-PL)

1. Instructions regarding PRT-PL exercise

2. Client views PRT-PL for a single muscle group demonstration

3. Client practices with PRT-PL for single muscle groups with the program

4. Introduction & instructions to practice without

5. Client practices brief self-monitoring to assess tension level—from monitoring skill learned above

5. Client does brief self-monitoring exercise & records tension level (SUDs score, other data) on Personal Record Keep Form (PRKF) in the Report & Forms Generator Module

6. Client given brief report of results

7. Reinforcement Module for assigning reinforcement points

8. Brief transitional relaxation through the Audio/Visual Relaxation Module

9. Homework

A. Introduction & instructions for PRT-PL homework assignment through the Report & Forms Generator Module

B Client prints-out and/or downloads homework sheet for PRT-PL

C. Client has access to PRT-PL program during week for review

VII. Session 7: Relaxation by Recall

A. Relaxation by Recall Training (Relaxation by Recall Training Module)

1. Introduction to Relaxation by Recall Training (RbR)

2. Demonstration

B. Client completes PRKF and PhysioScan Quick Scan

C. Relaxation by Recall Training (RbR)

1. Instructions regarding RbR exercise

2. Client views RbR for parallel muscle groups demonstration

3. Client practices with RbR for parallel muscle groups with the program

4. Introduction & instructions to practice without

5. Client practices brief self-monitoring to assess tension level—from monitoring skill learned above

6. Client does brief self-monitoring exercise & records tension level (SUDs score, other data) on Personal Record Keep Form (PRKF) in the Report & Forms Generator Module

7. Client given brief report of results

8. Reinforcement Module for assigning reinforcement points

9. Brief transitional relaxation through the Audio/Visual Relaxation Module

10. Homework

a. Introduction & instructions for RbR homework assignment through the Report & Forms Generator Module

b. Client prints-out and/or downloads homework sheet for RbR

c. Client has access to RbR program during week for review

VIII. Session 8: Relaxation by Cued-Recall

A. Relaxation by Cued-Recall Training Module

1. Introduction to Relaxation by Recall Training (RCR)

2. Demonstration

B. Client completes PRKF and PhysioScan Quick Scan

C. Relaxation by Cued-Recall Training (RCR)

1. Instructions regarding RCR exercise

2. Client views RCR for parallel muscle groups demonstration

3. Client practices with RCR for parallel muscle groups with the program

4. Introduction & instructions to practice without

5. Client practices brief self-monitoring to assess tension level—from monitoring skill learned above

6. Client does brief self-monitoring exercise & records tension level (SUDs score, other data) on Personal Record Keep Form (PRKF) in the Form & Report Generator Module

7. Client given brief report of results

8. Reinforcement Module for assigning reinforcement points

9. Brief transitional relaxation through the Audio/Visual Relaxation Module

10. Homework

a. Introduction & instructions for RCR homework assignment through the Forms & Report Generator Module

b. Client prints-out and/or downloads homework sheet for RCR

c. Client has access to RCR program during week for review

IX. Session 9: Autogenic Training & Meditation Module

A. Autogenic Training & Meditation

1. Introduction to Autogenic Training & Meditation Module

2, Demonstration video/animation demonstration of ATM

3, Instructions to Autogenic Training & Meditation (ATM)

4, Client completes PRKF and PhysioScan Quick Scan

5. Client selects either Autogenic Training or Meditation

a, PRKF and Report & Form Generator Module informs choice

b. Client receives detailed instructions on technique he/she selects

6. Autogenic Training and/or Meditation Training Initiated

7. Reinforcement Module for assigning reinforcement points

8. Transitional relaxation through the Audio/Visual Relaxation Module

9. Homework

a. Introduction & instructions for ATM homework assignment through the Forms & Report Generator Module

b. Client prints-out and/or downloads homework sheet for ATM

c. Client has access to ATM program during week for review

X. Session 10: Guided Imagery & Audio/Visual Relaxation Training Module

A. Guided Imagery & Relaxation with Audio/Visual Stimuli

1. Introduction to Guided Imagery Training—Audio/Visual Relaxation Training Module

2. Demonstration of GI with animation/video

3. Instructions to Guided Imagery (GI)

4. Client completes PRKF and PhysioScan Quick Scan

5. Guided Imagery Training Initiated

6. Reinforcement Module for assigning reinforcement points

7. Transitional relaxation through the Audio/Visual Relaxation Module

8. Homework

a. Introduction & instructions for GI homework assignment through the Report & Forms Generator Module

b. Client prints-out and/or downloads homework sheet for GI

c. Client has access to GI program during week for review

XI. Session 11: Applications to Everyday Life: Systematic Desensitization Training Module

A. Systematic Desensitization

1. Introduction to Systematic Desensitization Training

2, Demonstration with animation/video

3. Detailed Instructions to Systematic Desensitization (SD)

4. Client completes PRKF and PhysioScan Quick Scan

5. Systematic Desensitization Training Initiated

6. Reinforcement Module for assigning reinforcement points

7. Transitional relaxation through the Audio/Visual Relaxation Module at end of session

8. Homework

a. Introduction & instructions for SD homework assignment through the Report & Forms Generator Module

b. Client prints-out and/or downloads homework sheet for SD

c. Client has access to SD program during week for review

Introduction: This program employs the principles previously delineated to form a general Cognitive Self-Regulation Protocol for Anxiety and Depression with a number of applications to everyday life problems

Cognitive Self-Regulation Protocol for Anxiety and Depression

I. Session 1-2: Introduction to Cognitive Self-Regulation (CSR) for Anxiety and Depression

A. Brief Introduction to Cognitive Self-Regulation—Text & Voice Presentation Module

1. Introductory text & voice material prepared for this module Introductory text & voice material on using CSR for Anxiety and Depression prepared for this module

2. Generalized Assessment Module

a. Introduction to the Evaluation Process

b. Assessment Instruments—Self-Report Questionnaires

i. General Introduction

ii. Introduction to specific tests

iii. Administration of specific tests

1. Anxiety Tests

2. Depression Tests

3. Other Specific Tests

3. PhysioScan Module

A. Introduction

B. Specific Assessments

1. Pulse Rate

2. Respiration Rate

3. Surface Temperature

4. Blood Pressure

4. PhysioScan Self-Report

C. Cognitive Self-Monitoring and Self-Report Module

1. Pain Assessment Form

a, Instructions

b. Maladaptive Thinking Styles Questionnaire

c. Brief Survey of Irrational Thoughts and Beliefs

d. Cognitive Narrative Report Form

D. Personal Record Keeping Form (PRKF)

1. Introduction—Text & Voice Presentation Module

2. Designing forms specific for pain management—Design Form SubModule of the Report & Forms Generator Module

3. Select appropriate variables and parameters

4. Design personalized forms and “attach” to PRKF

D. First Baseline Data Completion

1. Full assessment with PhysioScan assessments

2. Anxiety measures

3. Pain measures

4. Initial Assessment Report—Report & Forms Generator Module

A. Client Summary

B. Client Interpretation

C. Online and Printed Results—

4. Homework

a. Introduction—Text & Voice Presentation Module

b. Online completion of homework & record keeping

c. Printed Homework of Personal Record Keeping Form

7. Reinforcement Module

A. Introduction to the concept of reinforcement

B. Defining the reinforcement schedule sheet

C. Selecting the details of the reinforcements

8. Final Relaxation Period

A. Audio/Visual Relaxation Module

B Client sets basic parameters with suggestions from program

III. Session 3: Attention & Awareness Training

A. Attention & Awareness Training Module

1. Attention and Concentration Training (AAT)

2. Demonstration

B. Generalized Assessment Module: Interactive Response-Based Tests

a. Introduction & instructions to interactive tests

b. Demonstration of testing through video/animation

c. Introduction to specific tests

d. Client completes Attention and Concentration Test Battery

e. Client receives summary report

f. Client informed as to specific tasks he/she will train

C. Attention and Awareness Training Module (AAT))

d. Instructions regarding specific AAT exercises

e. Client views demonstration of training exercises they will complete

f. Client practices with specific AAT exercises

g. Client re-assessed as to progress to determine necessity for further training

h. Instructions for specific attentional techniques to use in cognitive self-regulation to modify or to change irrational and maladaptive thoughts and beliefs related to depression and anxiety

i. Self-Awareness Training SubModule

j. Training to internalize focus of attention

i. PhysioScan Technique

1. Focusing on the physiological sensations

2. Training in systematic and programmatic graded exposure to various internal responses

1 PhysioScan Module

2 Progressive Muscle Relaxation Module 1

ii. Meditation and Autogenic Training Module

1. Interoception—awareness of internal states

2. Programmatic training in sustained awareness to thoughts and images

1 Awareness techniques

2 Extinction and habituation techniques

iii. Audio/Video Relaxation Module and Cognitive Practice and Rehearsal Module

1. Training in detecting and identifying preconscious thoughts and images

2. Training is self-awareness techniques to enhance ability to bring into immediate awareness and/or to extract preconscious thoughts

k. Client does brief self-monitoring exercise & records tension level (SUDs score, other data) at end of each session on the Personal Record Keep Form (PRKF) in the Report & Forms Generator Module

l. Client given brief report of results

m. Provide self-reinforcement through Reinforcement Module

m. Brief transitional relaxation through the Audio/Visual Relaxation Module

k. Homework

i. Introduction & instructions for PC/Online homework assignment through the Report & Forms Generator Module

ii. Client has access to AAT program exercises during week for review

1. Practice attentional techniques that need reinforcement

2. Practice special attention & awareness techniques for pain management.

IV. Session 4-5: Relaxation Training

A. Select Relaxation Training Method for Training or Practice

1. Introduction to Relaxation Training

2. Diaphragmatic Breathing Module (Required; Session 4)

i. Introduction

ii. Demonstration

iii. Breathing Technique Training

iv. Complete Personal Record Keeping Form

v. Client does brief self-monitoring exercise & records tension level (SUDs score, other data) at end of each session on the Personal Record Keep Form (PRKF) in the Report & Forms Generator Module

vi. Client given brief report of results

vii. Provide self-reinforcement through Reinforcement Module

viii. Homework specific for diaphragmatic breathing

a. Introduction to homework for deep breathing

b. Client prints out homework sheet for deep breathing

c. Printout of Personal Record Keeping Form (unless client fills it in online)

d. Client has access to Diaphragmatic Breathing Module during week for review

ix. Brief transitional relaxation through the Audio/Visual Relaxation Module

3. Choice of Techniques (Session 5)

i. Progressive Relaxation Training Modules

ii. Autogenic Training Module

iii. Guided Imagery Training Module

d. Meditation Training Module

4. Advanced Relaxation Training (Both Are Required)

i. Relaxation by Recall Module

ii. Relaxation by Cued-Recall Module

B. PhysioScan Module: Learns to monitor the physiological sensations that are correlated with various feeling states, including anxiety, tension, pain, and relaxation levels

a. Introduction & instructions to self-monitoring

b. Demonstration of self-monitoring technique

c. Introduction to self-monitoring practice

d. Client practices self-monitoring with program

e. Client practices self-monitoring without program

f. Homework assignments

V. Cognitive Restructuring Module for cognitive self-regulation of maladaptive and irrational thoughts and beliefs in anxiety and depression (sessions 6-10)

A. Introduction to Cognitive Restructuring

B. Introduction to Cognitive Restructuring for cognitive self-regulation of thoughts, images, and covert verbalizations in anxiety and depression

C. Client reviews assessments pertaining to maladaptive thinking & irrational beliefs from the Generalized Assessment Module

1. Maladaptive Thinking Styles Survey

2. Brief Survey of Irrational Thoughts and Beliefs

3. Brief Bindler Anxiety Scale

C. Cognitive Self-Monitoring & Self-Report Module

1. Differentiating between anxiety and deression

2. Identifying and recording Irrational thoughts and beliefs concerning anxiety using the Cognitive Narrative Report Form

A. Descriptive data of manner client may think irrationally

B. Frequency and intensity of anxiety related thoughts

C. Narrative data concretizing irrational thoughts in several specific examples

3. Identifying and recording Irrational thoughts and beliefs concerning anxiety using the Cognitive Narrative Report Form

A. Descriptive data of manner client may think irrationally

B. Frequency and intensity of anxiety related thoughts

C. Narrative data concretizing irrational thoughts in several specific examples

D. Cognitive Restructuring

1. Introduction

A. Using examples that concretize general maladaptive thinking styles as a vehicle for challenging irrational thoughts

B. Dissecting example into component parts

1. Each part reflects one irrational thought

2. Do this with each example

1. Disproving and refuting irrational thoughts and beliefs

A. Disproving, rebutting, & refuting irrational beliefs about related to anxiety

1. Disproving a person's usual, but irrational, outcomes

2. Using Rebuttal and Refutation of Irrational Thoughts Form

a. Prove anxiety-based beliefs & thoughts are not rational

b. Show there is absence of evidence for irrational beliefs

c. Show there is no truth to beliefs

B. Disproving, rebutting, & refuting irrational beliefs about related to depression

1. Disproving a person's usual, but irrational, outcomes

2. Using Rebuttal and Refutation of Irrational Thoughts Form

1. Prove depression-based beliefs & thoughts are not rational

2. Show there is absence of evidence for irrational beliefs

3. Show there is no truth to beliefs

C. Disproving, rebutting, & refuting irrational beliefs about related to Combined anxiety and depression

1. Disproving a person's usual, but irrational, outcomes

2. Using Rebuttal and Refutation of Irrational Thoughts Form

1. Prove depression-based beliefs & thoughts are not rational

2. Show there is absence of evidence for irrational beliefs

3. Show there is no truth to beliefs

3. Disproving irrational beliefs that refraining from usual irrational beliefs & thoughts that are related to depression will have a negative outcome

A. Disproving, rebutting, & refuting irrational beliefs about refraining about related to anxiety

1. Disproving a person's usual, but irrational, outcomes

2. Using Irrational Thoughts Outcome Challenge Form

a. Prove beliefs & thoughts are not rational

b. Show there is absence of evidence for irrational beliefs

c. Show there is no truth to beliefs

B. Disproving, rebutting, & refuting irrational beliefs about refraining about related to depression

1. Disproving a person's usual, but irrational, outcomes

2. Using Irrational Thoughts Outcome Challenge Form

a. Prove beliefs & thoughts are not rational

b. Show there is absence of evidence for irrational beliefs

c. Show there is no truth to beliefs

C. Disproving, rebutting, & refuting irrational beliefs about refraining about related to combine anxiety and depression

1. Disproving a person's usual, but irrational, outcomes

2. Using Irrational Thoughts Outcome Challenge Form

a. Prove beliefs & thoughts are not rational

b. Show there is absence of evidence for irrational beliefs

c. Show there is no truth to beliefs

3. Substituting positive, rational, and adaptive thoughts and behaviors for maladaptive & irrational thoughts

A. Introduction

B. For irrational anxiety-related thoughts explore and implement alternative ways person could approach the situation in the example

1. Deconstruct example into discreet components using the Cognitive Narrative Report Form

2. Develop alternative positive & adaptive thoughts and responses to each component using the interactive Restructuring, Modifying, and Changing Cognitions & Self-Talk Form

3. Show how alternative positive & adaptive strategies could result in healthier outcomes using the interactive Restructuring, Modifying, and Changing Cognitions & Self-Talk Form

a. Apply to specific components of example

b. Connect positive outcomes to enhance sense of well-being and positive affect

C. For irrational depression-related thoughts explore and implement alternative ways person could approach the situation in the example

1. Deconstruct example into discreet components using the Cognitive Narrative Report Form

2. Develop alternative positive & adaptive thoughts and responses to each component using the interactive Restructuring, Modifying, and Changing Cognitions & Self-Talk Form

3. Show how alternative positive & adaptive strategies could result in healthier outcomes using the interactive Restructuring, Modifying, and Changing Cognitions & Self-Talk Form

a Apply to specific components of example

b. Connect positive outcomes to enhance sense of well-being and positive affect

D. For irrational combined anxiety and depression-related thoughts explore and implement alternative ways person could approach the situation in the example

1. Deconstruct example into discreet components using the Cognitive Narrative Report Form

2. Develop alternative positive & adaptive thoughts and responses to each component using the interactive Restructuring, Modifying, and Changing Cognitions & Self-Talk Form

3. Show how alternative positive & adaptive strategies could result in healthier outcomes using the interactive Restructuring, Modifying, and Changing Cognitions & Self-Talk Form

a. Apply to specific components of example

b. Connect positive outcomes to enhance sense of well-being and positive affect

4. Homework

A. Client is given specific homework assignments using examples & forms in each section to practice their techniques

B. Client can use online animations/movies presenting scenarios that the client has to analyze in terms of the sections techniques and strategies they are working on

C. Client completes forms

i. Online

ii. Printed copy & data is input into the computer in subsequent session

5. Reinforcement Module

A. Review and change, if necessary, Reinforcement Hierarchy and/or Reinforcement Schedule

B. Assign reinforcement points for session or homework

VI. Cognitive Rehearsal & Practice Module (Sessions 11-14)

A. Introduction to cognitive practice & rehearsal (CPP)

B. Introduction to practicing disproving irrational thoughts concerning pain through CRP

C. Practicing and rehearsing disproving irrational pain related thoughts through CRP

D. Introduction to practicing disproving irrational thoughts concerning refraining from ones usual maladaptive pain related thoughts and behavior through CRP

1. For anxiety

2. For depression

3. For combined anxiety and depression

E. Practicing and rehearsing disproving irrational thoughts concerning refraining from ones usual maladaptive thoughts & behaviors about pain through CRP

1. For anxiety

2. For depression

3. For combined anxiety and depression

F. Introduction to practicing substituting positive & adaptive cognitions and behaviors pain and factors associated with pain for irrational thoughts through CRP

1. For anxiety

2. For depression

3. For combined anxiety and depression

G. Practicing and rehearsing substituting positive & adaptive pain related cognitions for irrational pain related thoughts through CRP

1. For anxiety

2. For depression

3. For combined anxiety and depression

Habit Control Protocol

Introduction: This program employs the principles previously delineated to form a general Habit Control Protocol with a number of applications to everyday life problems.

I. Session 1: Introduction to Habit Control Module

1. Brief Introduction to Habit Control—Habit Control Module

2. Generalized Assessment Module

a. Introduction to the Evaluation Process

b. Assessment Instruments—Self-Report Questionnaires

i. General Introduction

ii. Introduction to specific tests

iii. Administration of specific tests

3. PhysioScan Module

A. Introduction

B. Specific Assessments

1. Pulse Rate

2. Respiration Rate

3. Surface Temperature

4. Blood Pressure

4. PhysioScan Self-Report

4. Personal Record Keeping Form

A. Introduction

B. Design Form Module

C. First Baseline Data Completion

4. Initial Assessment

A. Client Summary

B. Client Interpretation

C. Online and Printed Results

5. Final Relaxation Period

A. Audio/Visual Relaxation Module

B. Client selects parameters; suggestions by program

6. Homework (Printed by client)—

a. Introduction

b. Printed Homework of Personal Record Keeping Form

6. Reinforcement Module

A. Introduction to the concept of reinforcement

B. Defining the reinforcement schedule sheet

C. Selecting the details of the reinforcements

7. Transitional relaxation through the Audio/Visual Relaxation Module at end of session

II. Session 2: Diaphragmatic Breathing

2. Diaphragmatic Breathing Module

a. Introduction

b. Demonstration

c. Breathing Technique Training

2. Transition Module

3. Complete Personal Record Keeping Form (PRKF)

4. Reinforcement Module for assigning reinforcement points

5. Final Relaxation Period: Audio/Visual Relaxation Module

6. Homework

a. Introduction to homework for deep breathing

b. Client prints out homework sheet for deep breathing

c. Printout of Personal Record Keeping Form (unless client fills it in online)

c. Client has access to Breathing Module during week for review

III. Session 3: Attention & Awareness Training

A. Attention & Awareness Training Module

1. Attention and Awareness Training (AAT)

2. Demonstration

B. Generalized Assessment Module: Interactive Response-Based Tests

1. Introduction & instructions to interactive tests

2. Demonstration of testing through video/animation

3. Introduction to specific tests

4. Client completes Attention and Concentration Test Batter

5. Client receives summary report

6. Client informed as to specific tasks he/she will train

C. Attention and Awareness Training Module (AAT))

1. Instructions regarding specific AAT exercises

2. Client views demonstration of training exercises they will complete

3. Client practices with specific AAT exercises

4. Client re-assessed as to progress to determine necessity for further training

5. Client is trained in specific techniques to become aware of habit behavior from Self-Awareness Training SubModule

A. Mirror Technique

B. Response Exaggeration

C. Response Interruption

6. Client does brief self-monitoring exercise & records tension level (SUDs score, other data) at end of each session on the Personal Record Keep Form (PRKF) in the Report & Forms Generator Module

7. Client given brief report of results

8. Reinforcement Module for assigning reinforcement points

9. Brief transitional relaxation through the Audio/Visual Relaxation Module

10. Homework

A. Introduction & instructions for PC/Online homework assignment through the Report & Forms Generator Module

i. Client has access to AAT program exercises during week for review

IV. Session 4 Relaxation Training

A. Select Relaxation Training Method for Training or Practice

1. Introduction to Relaxation Training

2. Choice of Techniques

i. Progressive Relaxation Training Modules

ii. Autogenic Training Module

iii. Guided Imagery Training Module

iv. Meditation Training Module

3. Advanced Relaxation Training (Both Are Required)

i. Relaxation by Recall Module

ii. Relaxation by Cued-Recall Module

B. PhysioScan Module: Learns to monitor physiological sensations reflective of anxiety & tension, as well as relaxation, levels

1. Introduction & instructions to self-monitoring

2. Demonstration of self-monitoring technique

3. Introduction to self-monitoring practice

4. Client practices self-monitoring with program

5. Client practices self-monitoring without program

6. Homework assignments

7. Reinforcement Module to assign reinforcement points

8. Transitional relaxation through the Audio/Visual Relaxation Module at end of session

V. Behavior Modification & Habit Control Module

A. Introduction to Behavior Modification and Habit Control

C. Awareness of the disruptive and bothersome features of the maladaptive behavior or habit

1. Awareness

2. Record Keeping

B. Identifying Primary Maladaptive and Disruptive Habitual Behaviors

1. Awareness Training Techniques

a. Bringing the habit behavior into consciousness

b. becoming aware of the specific response details of the habit

c. Becoming aware of the sequence of the response details of the primary habit behavior

2. Record Keeping

C. Identifying secondary behaviors associated with the primary maladaptive & disruptive habit behaviors

1. Awareness Training Techniques

a. Becoming aware of secondary behaviors associated with the habit

b. Becoming aware of the detailed component responses of the habit behavior

c. PhysioScan technique to assess sensations prior to overt behavioral manifestations

2. Record keeping and forms completion (PRKF)

D. Identifying situations and settings within which the primary and secondary habit responses occur

1. Introduction & animation/video

2. Awareness Training Techniques

a. becoming aware of where and when the primary behaviors occur

b. Becoming aware of where and when the secondary behaviors occur

3. Record keeping and forms completion (PRKF)

E. Response Substitution Technique

1. Introduction to substituting a behavior for the primary habit behavior

2. Response substitution to stop and disrupt the primary habit behavior

3. Response substitution to substitute for the primary habit behavior

F. Relaxation Techniques to Disrupt Primary Habit Behaviors

1. Introduction to using relaxation to disrupt the primary habit behavior

2. Using behavioral aspects of the relaxation response to block or disrupt the primary behavior

G. Complete Reinforcement Module

H. Transitional relaxation through the Audio/Visual Relaxation Module at end of session

I. Homework Assignments: Rehearsal & Practice

1. Using in homework to practice & review the techniques in a particular session

2. Using the Cognitive Rehearsal & Practice Module

a. Enhance the effects of relaxation techniques to disrupt habit behavior

b. Enhance relaxation effect, reduce tension, anxiety,

c. Enhance relaxation effect with PhysioScan Technique to heighten, awareness of primary and secondary habit behaviors and nervousness associated with the habit

2. Record keeping

a. Collect data

b. Input into computer in next session

H. Complete Reinforcement Module

Pain Management Protocol

This program employs the principles previously delineated to form a general Pain Management Protocol with a number of applications to everyday life problems.

I. Session 1: Introduction to Pain Management

1. Brief Introduction to Pain Management—Text & Voice Presentation Module

A. Introductory text & voice material prepared for this module

2. Generalized Assessment Module

a Introduction to the Evaluation Process

c. Assessment Instruments—Self-Report Questionnaires

i. General Introduction

ii. Introduction to specific tests

iii. Administration of specific tests

3. PhysioScan Module

A. Introduction

B. Specific Assessments

1. Pulse Rate

2. Respiration Rate

3. Surface Temperature

4. Blood Pressure

4. PhysioScan Self-Report

C. Cognitive Self-Report SubModule

1. Pain Assessment Form

a, Instructions

b. Location of Pain survey

c. Pain Frequency Rating Scale

d. Pain Intensity Rating Scale

D. Personal Record Keeping Form (PRKF)

1. Introduction—Text & Voice Presentation Module

2. Designing forms specific for pain management—Design Form SubModule of the Report & Forms Generator Module

3. Select appropriate variables and parameters

4. Design personalized forms and “attach” to PRKF

D. First Baseline Data Completion

1. Full assessment with PhysioScan assessments

2. Anxiety measures

3. Pain measures

4. Initial Assessment Report—Report & Forms Generator Module

A. Client Summary

B. Client Interpretation

C. Online and Printed Results—

7. Final Relaxation Period

A. Audio/Visual Relaxation Module

B Client sets basic parameters with suggestions from program

8. Homework

a. Introduction—Text & Voice Presentation Module

b. Online completion of homework & record keeping

c. Printed Homework of Personal Record Keeping Form

8. Reinforcement Module

A. Introduction to the concept of reinforcement

B. Defining the reinforcement schedule sheet

C. Selecting the details of the reinforcements

II. Session 2: Diaphragmatic Breathing

3. Diaphragmatic Breathing Module

a. Introduction

b. Demonstration

c. Breathing Technique Training

2. Transition Module

3. Complete Personal Record Keeping Form

4. Final Relaxation Period: Imagery, & Music—Audio/Visual Relaxation Module

5. Homework

a. Introduction to homework for deep breathing

b. Client prints out homework sheet for deep breathing

c. Printout of Personal Record Keeping Form (unless client fills it in online)

c. Client has access to Diaphragmatic Breathing Module during week for review

III. Session 3: Attention & Awareness Training

A. Attention & Awareness Training Module

1. Attention and Concentration Training (ACT)

2. Demonstration

B. Generalized Assessment Module: Interactive Response-Based Tests

a. Introduction & instructions to interactive tests

b. Demonstration of testing through video/animation

c. Introduction to specific tests

d. Client completes Attention and Concentration Test Battery

e. Client receives summary report

f. Client informed as to specific tasks he/she will train

C. Attention and Awareness Training Module (AAT))

d. Instructions regarding specific AAT exercises

e. Client views demonstration of training exercises they will complete

f. Client practices with specific AAT exercises

g. Client re-assessed as to progress to determine necessity for further training

h. Instructions for specific attentional techniques to use in pain management to modify pain experience—Self-Awareness Training SubModule

i. Directing Focus To the Pain Techniques

i. Focusing on the sensations of pain & restructuring the meaning of these sensations

ii. Sustained focusing on the sensations of pain for extinction of pain response

1. Graded practice of this technique so client becomes used to it

2. Assess impact if reducing pain

j. Redirecting Focus Away From the Pain Techniques

i. Find other internal or external stimuli as alternative attentional focus

ii. Train attentional focus toward new stimulus to move awareness away from the pain

j. Client does brief self-monitoring exercise & records tension level (SUDs score, other data) at end of each session on the Personal Record Keep Form (PRKF) in the Report & Forms Generator Module

k. Client given brief report of results

l. Provide self-reinforcement through Reinforcement Module

m. Brief transitional relaxation through the Audio/Visual Relaxation Module

k. Homework

i. Introduction & instructions for PC/Online homework assignment through the Report & Forms Generator Module

ii. Client has access to AAT program exercises during week for review

1. Practice attentional techniques that need reinforcement

2. Practice special attention & awareness techniques for pain management.

IV. Session 4: Relaxation Training

A. Select Relaxation Training Method for Training or Practice

a. Introduction to Relaxation Training

b. Choice of Techniques

i. Progressive Relaxation Training Modules

ii. Autogenic Training Module

iii. Guided Imagery Training Module

d. Meditation Training Module

c. Advanced Relaxation Training (Both Are Required)

i. Relaxation by Recall Module

ii. Relaxation by Cued-Recall Module

B. PhysioScan Module: Learns to monitor the physiological sensations that are correlated with various feeling states, including anxiety, tension, pain, and relaxation levels

a. Introduction & instructions to self-monitoring

b. Demonstration of self-monitoring technique

c. Introduction to self-monitoring practice

d. Client practices self-monitoring with program

e. Client practices self-monitoring without program

f. Homework assignments

V. Cognitive Restructuring Module for Pain Management

A. Introduction to Cognitive Restructuring

B. Introduction to Cognitive Restructuring for Pain Management

C. Review assessments pertaining to maladaptive thinking & irrational beliefs from the Generalized Assessment Module

1. Maladaptive Thinking Styles Survey

2. Irrational Beliefs Assessment Scale

C. Cognitive Self-Monitoring & Self-Report Module

1. Irrational Thoughts & Beliefs Concerning Pain Form

A. Descriptive data of how person thinks about pain in irrational ways

B. Frequency and Intensity of Pain Rating Scales

C. Narrative data concretizing irrational thoughts in several specific examples

2. General Irrational Thoughts & Beliefs Concerning Anxiety About Pain Form

A. Descriptive data of how person thinks about anxiety related to pain in irrational ways

B. Frequency and Intensity of Pain Rating Scales

C. Narrative data concretizing irrational thoughts in several specific examples

D. Cognitive Restructuring Module

1. Introduction

A. Using examples that concretize general maladaptive thinking styles as a vehicle for challenging irrational thoughts

B. Dissecting example into component parts

1. Each part reflects one irrational thought

2. Do this with each example

2. Disproving, rebutting, & refuting irrational beliefs about pain

A. Disproving a person's usual, but irrational, outcomes

1. Prove beliefs & thoughts are not rational

2. Show there is absence of evidence for irrational beliefs

3. Show there is no truth to beliefs

B. Disproving irrational beliefs that refraining from usual irrational beliefs & thoughts will have a negative outcome

1. Prove beliefs & thoughts are not rational

2. Show there is absence of evidence for irrational beliefs

3. Show there is no truth to beliefs

3. Substituting positive, rational, and adaptive thoughts and behaviors for maladaptive & irrational thoughts

A. Introduction

B. Explore alternative ways person could approach the situation in the example

1. Deconstruct example into discreet components

2. Develop alternative positive & adaptive thoughts and responses to each component

C. Show how alternative positive & adaptive strategies could result in healthier outcomes

1. Apply to specific components of example

2. Connect positive outcomes to enhance sense of well-being and positive affect

4. Homework

A. Client is given specific homework assignments using examples & forms in each section to practice their techniques

B. Client can use online animations/movies presenting scenarios that the client has to analyze in terms of the sections techniques and strategies they are working on

C. Client completes forms

i. Online

ii. Printed copy & data is input into the computer in subsequent session

5. Reinforcement Module

A. Introduction to the concept of reinforcement

B. Defining the reinforcement schedule sheet

C. Selecting the details of the reinforcements

VI. Cognitive Rehearsal & Practice Module

A. Introduction to cognitive practice & rehearsal (CPP)

B. Introduction to practicing disproving irrational thoughts concerning pain through CRP

C. Practicing and rehearsing disproving irrational pain related thoughts through CRP

D. Introduction to practicing disproving irrational thoughts concerning refraining from ones usual maladaptive pain related thoughts and behavior through CRP

E. Practicing and rehearsing disproving irrational thoughts concerning refraining from ones usual maladaptive thoughts & behaviors about pain through CRP

F. Introduction to practicing substituting positive & adaptive cognitions and behaviors pain and factors associated with pain for irrational thoughts through CRP

G. Practicing and rehearsing substituting positive & adaptive pain related cognitions for irrational pain related thoughts through CRP.

Modules Section

Outlined below are a few of the modules used in conjunction with the system and method of the present invention.

Contingency Management Training

Function

Contingency Management Training is a technique where the client learns to re-think situations that they characteristically handle in a maladaptive and unhealthy fashion. The procedure allows the client to develop alternative, healthier, and more adaptive solutions to their problems. The client must first learn to detect and to identify the automatic negative thoughts that usually are beneath the surface of awareness, yet control much of the client's negative behavior patterns. This self-monitoring process includes identifying characteristic cognitive distortions that sustain the automatic negative thoughts. These distortions include categorical thinking (“all-or-none” thinking), over-amplification of the meaning of events (“making mountains out of molehills”) and personalization (to easily taking things to heart or being overly sensitive).

One of the main functions in the second phase of this module is to use an expert system based approached to decision making and problem solving. This approached is based around having the client be guided by the expert system through a series of if . . . then relationships which help the client test possible consequences and outcomes of the manner in which they often think about and respond to in situations where their overall set ob thought→action sequences are maladaptive and negative. The same system also helps the client assess a variety of healthier and more adaptive ways to respond. The system is an expert system model incorporating principles form general heuristics, adaptive questioning systems, motivational interviewing, and rule-based problem solving methodologies.

The system focuses on thought_→action→outcome sequences. Thoughts are seen as causative or initiating variable resulting in a specific action on the part if the client. One such decision-tree analysis is the Consequences of Irrational & Maladaptive Thoughts Decision Tree. This is an expert system based interpretive query of the outcomes of the client's irrational beliefs and maladaptive thoughts. It is an “if . . . then” questioning agent designed to facilitate the client's ability to determine the various outcomes or consequences of their irrational and distorted thinking. Once the client has assessed the various negative consequences of their thoughts, they then explore what might happen if they did not think and feel the way they did during the example the decision-tree is exploring. Finally, the client is asked to explore the impact of having proactive, constructive, and adaptive thoughts that could mitigate the impact of the experience in the way they normally do. Thus, the CIMTFT does a composite Act-Outcomes analysis of:

A. The negative effects of the client's attitudes, thoughts, feelings and beliefs

B. The impact of not thinking about and acting the way the client normally does in the example.

C. The impact of positive, adaptive, and constructive thoughts and actions in the same situation

The decision tree attempts to test a number of variants at each decision node. Thus, the client might be led to believe there is some positive consequence to their behavior during an intermediary analysis. However, the tree continues by evaluating subsequent outcomes to these immediate acts Thus, the client will be able to understand and visualize that sometimes a negative and antagonistic Thought→Action sequence is reinforced by an immediate, but temporary reinforcement, which has longer and more negative consequences that the client cannot connect. In fact, the intermediate reinforcement strengthens and fortifies deleterious Action→Outcome sequences, which dampen the client's ability to see the overall harmful impact of earlier behaviors, and thus fortifies a longer and more destructive chain of events.

Once the client has successfully completed the first part of CIMTFT, he or she continues the decision analysis by exploring what might happen if they no thought and responded to the incident in their characteristic manner. For example, what are the possibilities that might accrue to no longer thinking angry thoughts if someone disagreed wit them, or no longer acting and behaving angrily in this situation.

The final thread of the CIMTFT is to then explore what positive, proactive, and constructive thoughts might the client engage in to resolve the situation. For example, instead of anger and aggressive behavior, the person could chose to remain calm and act assertively (noting that, as is often misunderstood, assertion is not aggression).

In general the module focuses on several cognitive-behavioral, thought and response patterns:

1. Identifying maladaptive thought patterns & irrational beliefs

2. Classifying & recording automatic and reflexive thought patterns

3. Learning to use specific examples to concretize maladaptive behavior patterns and negative thoughts

4. Identifying specific and detailed antagonistic elements in specific examples

5. Decision-tree analysis of negative and positive outcomes of the specific examples

6. Decision tree-analysis of developing and exploring specific alternative behavioral and cognitive patterns

Parameter Matrix Variables

Please note: Models below refer to animations or live movies of humans.

1. Examples of specific maladaptive thinking styles

2. Specific forms and self report questionnaires to help client identify and classify cognitive and behavioral patterns

3. Variations in nodes of decision-tree analyses

4. Variation in possible outcomes of decisions tree analysis

5. Variation in examples in decision-tree analysis

6. Sex of the animation model

7. Age of the animation model

8. Ethnic/Social background of animation model

Module Implementation: Programming Steps

1. Screen 1: Entry/Gateway Screen

2. Screen 2: Contingency Management Training (CTM). The client receives brief Instructions as to the basic nature of CTM. The basic flow of this module is as follows:

A. Define clearly and precisely the goal of the client. What are the main key elements of this goal? Define them in cognitive-behavioral terms.

B. What are the specific behaviors, thoughts, images, feelings, beliefs, & ideas to change or to modify?

C. What are the antecedent factors that provide the initial context for the items in Item B.

1. Situational Factors

2. Other individuals

3. Physiological & Health Related Factors

5. Other behaviors or thoughts that of the client that act as a precipitating stimulus

D. What are the outcomes of the behaviors in behavioral, cognitive, emotional, & interpersonal factors of the factors in Item B?

E. What are the motivational & intentional variables that influence the factors in Item B; what are the intrinsic reinforcement factors that tend to sustain negativistic behavior.

F. What are the possible outcomes for the client of not engaging in the factors in Item B?

G. What are the possible outcomes of modifying or changing the items in B but substituting healthier, more adaptive responses?

H. What reinforcement facts can be applied to the outcomes in item G to strengthen these responses

I. How can the client rehearse the new behaviors to strengthen these responses?

3. Screen 3. The current module then accesses or calls the Cognitive Self-Monitoring & Self-Reporting Module to begin Phase I.

4. Note: The Contingency Management Module instructs the Cognitive Self-Monitoring and Self-Reporting Expert Systems Module (CSMSRM_ES) as to which assessment instruments and techniques to utilize

5. Note: The results of the CSMSRM_ES provide the Contingency Management Module with the following information:

A. What are the client's constructive forms of thinking and what are their distorted forms of thinking

B. What is the anxiety proneness?

C. What are the client's main areas of anxiety?

D. What are the client's major irrational belief systems?

E. What problem areas are of most concern?

F. What are the client's main irrational beliefs in terms of their main problem area

G. What are typical examples of Item F? This example is then deconstructed into its component Thought→Action patterns, with each pattern illustration 1 or 2 core irrational beliefs.

6. When the client completes the training in the Cognitive Self-Monitoring & Self-reporting Module_ES calls the Contingency Management Module to continue.

7. Changing or Modifying Irrational Thoughts & Beliefs. The client is given an overview how to restructure negative thinking and irrational beliefs. This overview also explains the use of specific examples as illustrations of these irrational thought patterns. This includes:

A. Following a systematic exploration of the negative and positive consequences of thinking in this way.

B. Implementing alternative self-talk statements which would refute the a) irrational ideas and b) implement the positive thoughts to extinguish or diminish the impact of the negative thoughts

C. Rehearsing & practicing though the Guided Imagery Module the situation described to implement Item E.

D. Rehearsing & practicing though the Guided Imagery Module similar situations described to implement Item E.

8. Screen 4: The client is then introduced to cognitive-behavioral strategies for changing and/or modifying cognitions by restructuring maladaptive thought patterns and negative contents. The client is given general instructions for rebutting thoughts that are irrational, negative, and maladaptive. There are three parts to this process. The client is given instructions at the appropriate part they are in.

9. Consequences of Irrational & Maladaptive Thoughts Decision Tree (CIMTDT). This is an expert system based interpretive query of the outcomes of the client's irrational beliefs and maladaptive thoughts. If is an “if . . . then” questioning agent designed to facilitate the client's ability to determine the various outcomes or consequences of their irrational and distorted thinking. Once the client has assessed the various negative consequences of their thoughts, they then explore what might happen if they did not think and feel the way they did during the example the decision-tree is exploring. Finally, the client is asked to explore the impact of having proactive, constructive, and adaptive thoughts that could mitigate the impact of the experience in the way they normally do. Thus, the CIMTDT does a composite Act-Outcomes analysis of:

A. The negative effects of the client's attitudes, thoughts, feelings and beliefs

B. The impact of not thinking about and acting the way the client normally does in the example.

C. The impact of positive, adaptive, and constructive thoughts and actions in the same situation

The decision tree attempts to test a number of variants at each decision node. Thus, the client might be led to believe there is some positive consequence to their behavior during an intermediary analysis. However, the tree continues by evaluating subsequent outcomes to these immediate acts. Thus, the client will be able to understand and visualize that sometimes a negative and antagonistic Thought→Action sequence is reinforced by an immediate, but temporary reinforcement, which has longer and more negative consequences that the client cannot connect. In fact, the intermediate reinforcement strengthens and fortifies deleterious Action→Outcome sequences, which dampen the client's ability to see the overall harmful impact of earlier behaviors, and thus fortifies a longer and more destructive chain of events.

Once the client has successfully completed the first part of CIMTDT, he or she continues the decision analysis by exploring what might happen if they no thought and responded to the incident in their characteristic manner. For example, what are the possibilities that might accrue to no longer thinking angry thoughts if someone disagreed wit them, or no longer acting and behaving angrily in this situation.

The final thread of the CIMTDT is to then explore what positive, proactive, and constructive thoughts might the client engage in to resolve the situation. For example, instead of anger and aggressive behavior, the person could chose to remain calm and act assertively (noting that, as is often misunderstood, assertion is not aggression).

10. Note: Given below are some of the symbols for the AI_OPS sequences:

1. rT^{P}=Rational Preconscious Thought

2. rT^{C}=Rational Conscious Thought

3. iT^{P}=Rational Conscious Thought

4. iT^{C}=Irrational Conscious Thought

5. mA=Maladaptive Action

6. aA=Adaptive Action

7. eO=Expected Outcome

8. dO=Distorted Perceived Outcome

9. pO=Possible or Potential Outcome

10. aO=Actual Outcome

11. O^{Nd}=Delayed Negative Outcome

12. O^{Ni}=Immediate Negative Outcome

13. O^{Pd}=Delayed Positive Outcome

14. O^{Pi}=Immediate Positive Outcome

15. AF=Antecedent Factor

16. iS^{R}=Immediate Reinforcement

17. mS^{R}=Intermediate Reinforcement

18. dS^{R}=Delayed Reinforcement

19. iS^{R}=Immediate Negative Reinforcement

20. mS^{R}=Intermediate Negative Reinforcement

21. dS^{R}=Delayed Negative Reinforcement

22. iS^{P}=Immediate Punishment

23. mS^{P}=Intermediate Punishment

24. dS^{P}=Delayed Punishment

25. M=Motivation

26. I=Intention

11. Screen 5: Instructions for the Consequences of Irrational & Maladaptive Thoughts Decision Tree (CIMTDT). This decision tree will inform the client as to the nature of how their thoughts results in maladaptive outcomes. It will also test for intermediary reinforcements that sustain components of the cognitive-behavioral chain. One type of intermediate rein forcer that sustains a maladaptive Thought→Action contingency is a perceived positive outcome that is really negative. That is to say clients might feel the outcome was positive when they are able to embarrass their colleague at work, yet the delayed outcome of disproval form other workers resulted in a real negative outcome for clients. But at the time the outcome was seen as positive, it could have reinforcing properties and strengthened the Thought→Action sequence that preceded it. The primary goal of this decision tree is to enable the client to refute, rebut, or disprove the validity of their irrational thoughts through an “if . . . then” analysis of 1) the truth-value of, 2) the rationality of, and 3) the evidence for the irrational belief.

1. Irrational thought results in maladaptive action sequence with a negative outcome:

iT→mA→aO^{Ni}

2. Irrational thought results in maladaptive action which is results in an outcome that that is perceived in such a way that it has a reinforcing effect on the maladaptive behavior, even though a negative, aversive outcome came later.

iT^{P}→mA→pO^{Pi}[S^{Rim}]→aO^{Nd}

12. Screen 6. Several animations are presented illustrating an incident or event that is broken into component parts, each reflecting an irrational belief. Each thought→action [symbol] outcome sequence is demonstrated.

13. Screen 7: Several animations illustrating an incident or event that is broken into component parts, each reflecting an irrational belief. Each segment has several possible outcomes. Client records their own choice, then selects it form menu of choices to see how the animation continues. Client compares his expected outcome to that presented in the animation. Each Thought→Action sequence is demonstrated.

14. Screen 8. Client then competes the CIMTDT based on examples encoded previously. Client tracks intermediate rein forcers and in terms of negative outcomes.

15. Antecedent Factors Decision Tree (AFDT). In order for the client to get an even clearer picture of the of the factors that result in irrational thinking and maladaptive behavior they must be aware of the factors that may precipitate or elicit an irrational and maladaptive Thought→Action sequence. This is also important because interventions can be made here to alter the contingency that result in maladaptive, irrational behavior.

16. Screen 9: Instructions for the AFDT. This decision tree will inform the client as to the nature of how their thoughts results in maladaptive outcomes. It will also test for intermediary reinforcements that sustain components of the cognitive-behavioral chain.

1. Antecedent Factors serve as discriminative stimuli that can set the occurrence of for irrational emotional and cognitive patterns that result in a maladaptive behavior with an immediate negative outcome.

AF[S^{D}]→E→M→I→iT→mA→aO^{Ni}[Pⁱ]

2. Antecedent Factors serve as discriminative stimuli that can set the occurrence of for irrational emotional and cognitive patterns (which are for the most part preconscious) that result in a maladaptive behavior with an immediate negative outcome that is distorted and perceived as positive. This perception results in an immediate reinforcement of the sequence of events resulting in the outcome, and has its strongest effect on the maladaptive behavior.

AF[S^{D}]→E→M→I→iT^{P}→mA→dO^{Ni}[S^{Rim}]→aO^{Nd}

17. Screen 10. Several animations illustrating an incident or event that is broken into component parts, each reflecting an antecedent condition of an irrational Thought→Action→Negative Outcome sequence is demonstrated.

18. Screen 12: Several animations illustrating an incident or event that is broken into component parts, each reflecting an antecedent condition to an irrational belief. Each segment has several possible outcomes. Client records their own choice, then selects it form menu of choices to see how the animation continues. Client compares his expected outcome to that presented in the animation. Each Antecedent→Thought→Action→Outcome sequence is demonstrated.

19. Screen 13. Client then competes the AFDT based on examples encoded previously. Client tracks intermediate rein forcers that sustain the power of the antecedent factor to act as a discriminative stimulus for the Thought→Action sequence.

20. Motivation, Emotion & Intention Decision Tree (MIEDT). In this section the client explores the motivation, emotions and intentions they had prior to the initiation of the Thought→Action sequence. The client works through the MIEDT to see how their motivations, emotions & intentions can result in an irrational thought. Emotion often serves to energize a Thought→Action sequence, while motivation impels the action. The intention is the conscious aspect of the cognitive process that actualizes the primary irrational belief in terms of a behavior outcome. The MEIDT also tests for motivational and/or emotional states which serve as intermediary reinforcements that sustain components of the cognitive-behavioral chain. The client is then processed further through the tree through challenging the various forms a validity that the client has ascribed to his motivations, thoughts, feelings and intentions. The decision tree requires the client to refute or disprove the validity of the motivation or intention to act through an “if . . . then” analysis, which shows how the wrong motivation or intention can result in or amplify an irrational belief.

1. Negative emotional states elicited by the antecedent factors result in triggering and irrational thought, which then motivates or impels the individual to action, first creating an intention to act on the irrational thought. This intention becomes concretized in individual's maladaptive behavior.

AF[S^{D}]→E^{N}→iT^{P}→→M^{N}I^{N}→→mA→dO^{Ni}[S^{Rim}]→aO^{Nd}

21. Screen 14: Instructions for the MEIDT. This decision tree challenges the client's motivations and intentions to revel their part in the overall irrational sequences of events resulting in maladaptive and dysfunctional behavior.

22. Screen 15. Several animations illustrating an incident or event that is broken into component parts, each reflecting how motivation, emotion, and intention can initiate a Thought→Action→Negative Outcome sequence is demonstrated.

23. Screen 16: Several animations illustrating an incident or event that is broken into component parts, each reflecting either an emotional, motivational, or intentional component in the formation of an irrational belief. Each segment has several possible outcomes. Client records their own choice, then selects it form menu of choices to see how the animation continues. Client compares his expected outcome to that presented in the animation. Each Antecedent→Thought→Action→Outcome sequence demonstrated.

24. Screen 17. Client then competes the MEIDT based on examples encoded previously. Client tracks intermediate rein forcers that sustain the power of the antecedent factor to act as a discriminative stimulus for the Thought→Action sequence.

25. Refraining from Irrational Beliefs & Maladaptive Behavior Decision Tree (RIBMBDT). In this section the client explores the implication of refraining from their usual irrational Thought→Action sequences. The client works through the RIBMBDT to refute or to disprove the irrational ideas they may have regarding not acting or responding in the situations where their typical reactions are maladaptive and dysfunctional, and they are inspired by irrational thoughts. Usually, the client has irrational beliefs and negative thoughts concerning refraining from action; they feel they have to do something, even if it is irrational. The RIBMBDT also tests for motivational and/or emotional states which serve as intermediary reinforcements that sustain components of the cognitive-behavioral chain. This is particularly true of the maladaptive and irrational behaviors themselves. Since the client, in part, intends the behavior, there is some gratification in its performance. This, in turn, reinforces the preceding cognitive sequence, i.e., the irrational thought. Even if there is a subsequently negative outcome that the client experiences as aversive, the reinforcement of the earlier period of gratification comes closer in time to the irrational thought. This tends to reinforce its immediate antecedent, the irrational thought. This sequence is common in many maladaptive behaviors. For example, in overeating, the bloated feeling of comfort and relaxation that comes immediately after eating precedes the disgust and negative feelings because one has overeaten. Therefore, it is closer to the eating behavior as a positive reinforcement, than is the feeling of disgust, the punishment. The client is then processed further through the RIBMB through challenging the various forms a validity that the client has ascribed to the ideas they have about not refraining from reacting in the situations embodied in their examples. The decision tree requires the client to refute or disprove the validity of these ideas through an “if . . . then” analysis, which proves these beliefs are untrue, irrational, and invalid.

1. The individual practices refraining from whatever aspect of their conscious thoughts, and those preconscious thoughts that they have now practiced techniques to be aware of. The client is queried as to the possible positive outcomes that might accrue to refraining from those negative thoughts, feeling, motivations, intentions and behavior that usually lead to negative outcomes.

AF[S^{D}]→E^{N}→iT^{p,c}→→M^{N}I^{N}→[mA]→[aO^{Ni}]|→→→pO^{Pi,d}

26. Screen 18: Instructions for the RIBMBDT. This decision tree challenges the client's concerns about refraining from the usual, irrational way they handle the situations described in their examples. The RIBMBDT also explores the positive benefits of refraining from their irrational Thought→Action patterns.

27. Screen 19. Several animations illustrating an incident or event that is broken into component parts, each reflecting how motivation, emotion, and intention can initiate a Thought→Action→Negative Outcome sequence is demonstrated.

28. Screen 20: Several animations illustrating an incident or event that is broken into component parts, each reflecting a component in the formation of an irrational belief concerning not refraining. Each segment has several possible outcomes. Client records their own choice, then selects it form menu of choices to see how the animation continues. Client compares his expected outcome to that presented in the animation.

29. Screen 21: Client then completes the RIBMBDT based on examples encoded previously. Client tracks intermediate rein forcers that sustain the influence of irrational beliefs. The Antecedent→Thought→Action→Outcome sequence is deconstructed into its components, an assessed as to its relative importance in forming, eliciting, or sustain the irrational belief or thought.

30. Substituting Rational & Adaptive Thoughts for Irrational Beliefs Decision Tree (SRATIBDT). In this section the client explores the implication of substituting positive and adaptive thoughts for their usual irrational Thought→Action sequences. The client works through the SRATIBDT to supplant their irrational ideas and beliefs in the situations where their typical reactions are maladaptive and dysfunctional, and they are inspired by irrational thoughts. The SRATIBDT also tests for motivational and/or emotional states which serve as intermediary reinforcements that sustain components of the cognitive-behavioral chain. The SRATIBDT tests for antecedent factors as well. The program guides the client through finding the appropriate substitute emotional reactions, motivation, intentions, thoughts, beliefs, images, ides, behaviors, and rein forcers. The program helps the client test the validity of the substitution. The decision tree requires the client to affirm or prove the validity of these ideas through an “if . . . then” analysis, which proves these beliefs are untrue, irrational, and invalid.

1. Refraining from the irrational Thought→Action sequence coupled with substitution of a consciously rational thought and adaptive behavior which has the potential to result in a positive outcome which also reinforces the new set of thoughts, feelings and actions/resulting a

AF[S^{D}]→E^{N}→iT^{p,c}→→M^{N}I^{N}→[mA]→[aO^{Ni}]|→rT^{C}→M^{P}→I^{P}→aA→pO^{Pi}[S^{R}]

31. Screen 22: Instructions for the SRATIBDT. This decision tree challenges the client's concerns about refraining from the usual, irrational way they handle the situations described in their examples. The SRATIBDT also explores the positive benefits of refraining from their irrational Thought→Action patterns.

32. Screen 23: Several animations illustrating an incident or event that is broken into component parts, each reflecting how motivation, emotion, and intention can initiate a Thought→Action→Negative Outcome sequence is demonstrated.

33. Screen 24: Several animations illustrating an incident or event that is broken into component parts, each reflecting a component in the formation of an irrational belief concerning not refraining. Each segment has several possible outcomes. Client records their own choice, then selects it form menu of choices to see how the animation continues. Client compares his expected outcome to that presented in the animation.

34. Screen 25. Client then completes the RIBMB based on examples encoded previously. Client tracks intermediate rein forcers that sustain the influence of irrational beliefs. The Antecedent→Thought→Action→Outcome sequence is deconstructed into its components, an assessed as to its relative importance in forming, eliciting, or sustain the irrational belief or thought.

35. Screen 26. Homework: The client is instructed to use other examples developed in the Cognitive Self-Monitoring and Self-Reporting Modules to continue training with the Contingency Management Training Module. They can have access to the forms online or they can print a copy to complete by hand. It is suggested they scan in (if the they have a scanner with OCR) or type in their homework in the online form at the start of a subsequent session. The printed form has written instructions in the event the client forgot how to complete a step. The written assignments are based on a flowchart type of strategy to duplicate the essence of the expert system approach in an abbreviated form. The client can practice online as well, using the regular expert system based modules to track each formulated example through the system. The online form has “buttons” they client can click for a voice and text based presentation of the instructions. In the event the client needs more examples the client can click another button to return to the appropriate section of the Cognitive Self-Monitoring and Self-Reporting Module to create additional example scenarios.

36. Screen 27: At the end of each session, the client is sent to the Reinforcement Module the client assigns themselves sufficient reinforcement a) to strengthen their learning curve and b) to enhance motivation, b) practice & rehearsal, and c) to continue in the program. The Reinforcement Module is designed to provide an appropriate degree of reinforcement so that in the substitution phase of the treatment, and during the practice and rehearsal phase the client receives sufficient level of reinforcement to keep the rate of the likelihood of occurrence of each Thought→Action substitution high. If the iterative analysis of the expert system indicates the need for either stronger or higher rate of reinforcement, the Reinforcement Module can be adjusted accordingly.

37. Screen 28: Before exiting the session the client is given the option of taking a few minutes to upwind by selecting either a multimedia brief relation session in the Audio/Visual Relaxation Module or a short sequence of exercises designed to help you unwind even at a desk. This routine is called from the Exercise module.

38. Screen 29:The client is informed briefly about the next session and then the session terminates the program

39: Cognitive Practice & Rehearsal: In the final phase of the cognitive restructuring module the client will practice and rehearse their skills of refraining from their irrational beliefs and their ability to substitute positive & rational beliefs for irrational ones. They will rehearse this by using their imaginative capacities to visualize the examples they previously reported and then practice either a) imaging what would happen if they refrained from their usual irrational beliefs and actions. The material they recorded in terms of negating the irrational beliefs will guide them in this and negative thoughts they had if the would refrain. Next, they practice imagining the same example again, but this time substituting positive, rational and practice thoughts and beliefs for their irrational ones. The client first begins each training episode by imagining the derails of the example. They then go through it again visualizing the scene by refraining from their irrational thoughts and behaviors. Finally, they again visualize the scene while substituting the positive thoughts. The impact of this technique is to strengthen the client's skills so they are better prepared to transfer them to real life activities. It has been demonstrated that this form of imaginative rehearsal has a significant impact on generalizing skills learned in these protocols to everyday life. The practice and rehearsal is conducted in the context of a relaxed state. When a person is in a deep state of de-arousal and relaxation their ability to imagine and to visualize is enhanced. The practice & Rehearsal Module first ensures that the client can relax y the method of Relaxation by Cued-Recall. Then after a 4-minute relaxation, they begin their visualization exercises. To heighten the visualization, the rehearsal is conducted in the context of relaxation backgrounds provided through the audio/visual relaxation module.

54: For those clients that have difficulty with visualizations, they can practice the tasks as 1) a covert or internal self-dialogue, 2) a verbal rehearsal of the task by recording it into the computer or a tape-recorder, or 3) as a writing exercise by typing it onto the computer screen

40. The client can also use the textual display of the material to do the exercise with their eyes open as they think about it or use vocal recordings with their eye closed

41. Note: The computer times the length of the visualization and the number of practice trials or episodes. The client begins slowly and then builds up the length of and the number of visualizations

42. Note: The program sends the Cognitive Practice & Rehearsal Module the following parameters of its parameter matrix (Note: 1 & 2 are Called from the Cognitive Self-Monitoring & Self-Reporting Module; 3-8 are Called from the Cognitive Restructuring Module):

1. The example to be used in the visualization in the form of a textual description.

2. The example as a voice recorded file (if available)

3. The refutations, and the relevant portions of the example, to the client's belief's that they should not refrain from their usual irrational thoughts, beliefs, and actions in the form of a textual description

4. The refutations against not refraining as a voice recorded file (if available)

5. The thought substitutions, and the relevant portions of the example, the client's irrational thoughts and beliefs in the form of a textual description

6. The substitution for the client's irrational thoughts and beliefs as a voice-recorded file (if available)

7. The length of each visualization trial or episode

8. The number of practice trials or episodes

43. Screen 34: The client is provided a brief introduction to cognitive practice and rehearsal.

44. Screen 35: The program is Returned from the Cognitive Practice and Rehearsal Module. The program queries the client to make sure the client has the homework and has completed the Reinforcement Module. If not, the client has “buttons” available to go to the relevant areas.

45. Screen 36. Logoff Screen. Session ends.

Generalized Assessment Module

Function

To present to the client a variety of tests to assess cognitive, behavioral, emotional, and personality factors that have know influences on stress and anxiety. One part of the generalized assessment module is designed to present test items in a self-report or survey style questionnaire. Other parts of the module present online interactive tests where the client responds to changing stimuli on the computer screen. In such tests, scores like reaction time and error rate would be measured (as for example in the attention and perception test battery). In addition, the module has the ability to present to the client, when necessary, results of the assessment. Furthermore, the module has the ability to perform basic statistical analysis of the data This is primarily in terms of descriptive statistics of the client's data, which is used to monitor and to chart the client's progress. In the preferred embodiment, there is also the ability to compare the subject's scores to normative sample statistics available on a number of the tests. Moreover, an expert system based from of interpretative system will allow this module to present an interpretation of the results and thus it is integrated closely with a forms and report generator module. The output of the testing will also be used to inform the training and treatment modules as well. Thus, some of the tests provided by this module are used to monitor the client's progress, and provided appropriate modules with information critical in deciding whether to continue or modify the current course of treatment.

Parameter Matrix Variables

1. Specific tests

a. Self-Report

i. Questionnaire

ii. Survey

iii. Inventory

b. Interactive Response-based

i. Reaction Time

ii. Error Rate

iii. Logical Analyses

iv. Number of Steps to Completion

v. Method Used

vi. Path Followed

2. Type of response set

a. Liker

b. True/False

c. Yes/No

d. Never—Always

e. Reaction Time

f. Error Rate

g. Logical Analyses (e.g., how solved problem, number of steps, etc.

3. Format of the response

a. Check-box

b. Recessed-rectangle

c. Raised-rectangle

d. List-box

e. Check-circle

f. Fill-in through keyboard

g. Voice-response

4. Types of statistical analyses

a. Item Totals

b. Test Mean

c. Subscale Totals

d. Subscale Means

e. Standard Deviation

f. Inter-item Correlations

g. Split-Test Correlations

h. Normalized scores to compare to population samples

5. Level and type of test interpretation and integration

a. Simple data presentation with charts

b. Summary of progress, and suggestions for change, if necessary

c. Expert system based interpretation

Some of the tests exclusively developed in conjunction with the present invention include:

1. The Bindler Anxiety Scale

2. The Bindler Anxiety Scale—Short-Form

3. The Absorption/Immersion Scale

4. The Level of Functionality Scale

5. The Cognitive Styles Inventory

6. The Interactive Attention & Perception Battery

7. The Interactive Learning & Memory Skills Battery

8. Test of Visual Logical Skills

Module Design

Self-Report Questionnaires

For the self-report items, this module is designed to present to the client individual test items, one at a time, on the computer screen. Below each item is a ‘type’ of response the client has to make. In one embodiment, the client has to pick a number from 1 to 10, answer according a dimension ranging from Never to Always, etc. The form of the response could be typing in a number, clicking an answer box, clicking a circle, etc. Prior to the test itself, the client is given a brief description of what is going to happen, without revealing too much, so we do not bias their answers. Then, they are given instructions on how to take the test, and test begins.

Each test item remains on the screen until the client answers. After a response is given, the item fades, and the next item appears on the screen. If a client does not respond to an item within 2 minutes, a beeper sounds, and a red warning flashes over the item indicating the client has not responded.

Upon completion of responding to the items, the module returns to the main screen. The client may have to complete additional tests, and will be instructed to do so. The client will have the option of terminating the session after any given test, if it is absolutely necessary, and continue during the next session. In many instances, the client will also be given some type of feedback as to what their test scores showed for them. This will be provided in the forms of scripts prepared for each test indicating that various ranges in the test scores mean. For example, there are scripts indicating what a score falling in the range of 0-12 in the Bindler Anxiety Scale means. In addition to the descriptive statistical summary, the scripts are based on an expert system form of interpretation of the data. The data is also available to the Personal Record Keeping Form, which is the main form to track the client's progress.

The design of these modules is such as to use their associated parameter matrices and to make them generic enough to accomplish similar tasks easily. Thus, the parameter matrix would “store” response types, for example, Likkert scales like 1-5, 1-10, or Yes/No response types etc. You would then have only to define the questions or dimension associated with these responses. For example, “On a scale of 1 to 10 rate the following question: Chocolate is my favorite food

1 2 3 4 5 6 7 8 9 10

Completely

Completely

Disagree

Agree

The type of response is also stored in the parameter matrix. Thus, forms could easily be designed to have a variety of response indices, like check boxes, buttons, etc, as shown in FIG. 3. Thus, a variety of response options are stored in the system and are available when designing new tests.

Alternative Design:

In some embodiments, when the test taker has only a short period of time to take the tests, or when there are many questions in a particular questionnaire, the module can be programmed to present several questions at a time on the page on the person could answer these before going on to the next set.

Interactive Tests Programs Measuring Client's Responses

The generalized assessment module will also have to present, analyze, and interpret PC & Online-based interactive tests involving the measurement of the subject's response on the keyboard, mouse, or some other input device. This is primarily accomplished through a hyperlink to the specific test. The test can then export back the data as an ASCII file, which is then analyzed and interpreted by the generalized assessment module in conjunction with the form & report generator module. Within the parameters of the generalized assessment module's parameter matrix certain tests can also be developed within the module itself as well.

Module Design Steps

1. Screen 1: Display text that describes the test to the client.

2. Screen 2: Display text giving instructions to the client

3. Screen 3 (Self-Report): Display test item, item response type, and item response format. This page repeats N times, where N=the number of test items.

4. Screen 4: Displays test results to client if required by the main program implementing this module.

5. Note: Descriptive Statistics calculated at end of test:

a Total Score (TS)=Sum of all test scores

b. Mean Test Score=TS/N

c. If there are subscales, for each subscale:

i. Subscale Score (SSS)=sum of subscale score

ii. Mean Subscale Score=SSS/Nss

6. Note: Comparison to sample population if normative data available

d. Normalized Score

e. Deviation from Group Mean

f. Percentile Score

7. Screen 3 (Interactive Response): Client is hyperlinked to specific tests. Upon competition reports to the Generalized Assessment Module and proceeds as other tests.

8. Screen 4: See step 4 above

9. Screen 4: If Program requires, data is integrated with the Forms & Report Generator Module for further processing and presentation to the client.

PhysioScan Module

Function

The basic function of the PhysioScan module is to provide the client with the means to monitor a variety of basic physiological responses with either 1) no apparatus, 2) simple household tools and devices (e.g., an inexpensive thermometer), 3) very inexpensive devices & equipment (e.g., stress dots), or 4) utilizing computer equipment already generally available (e.g., a sound card and microphone; after all a sound card is a DSP). One purpose of this type of monitoring, when either another individual is not present, or when more sophisticated biofeedback equipment is not available, is to provide the client the means for assessing baseline physiological responses in order to determine 1) if the response in question is outside of normal limits and therefore pathological, and 2) to assess the impact of techniques they will learn on these response to see if they are responding to training or treatment. Thus, an anxious client shows low hand temperature during training. One would expect that during the training phase an increase in hand temperature as the client learns to relax. Thus, the PhysioScan module incorporates as many possible modalities that the client can use to monitor physiological processes either through training in cognitive monitoring techniques that have been developed, those that are in the public domain (e.g., finger pulse), or using very simple devices.

Implementation

In the preferred embodiment the PhysioScan module is intended for the following purposes:

1. Self-monitoring techniques to establish baseline response rates.

2. Self-monitoring techniques to assess the impact of training.

3. Self-monitoring techniques for programs that require assessing baselines and treatment for psychophysiological disorders (e.g., asthma, low back pain, migraines. Irritable bowel syndrome, Raynaud's disease

4. Relaxation training using motoric responses like Progressive Relaxation Training

5. Muscle Response Discrimination Training

6. Autogenic Training

7. Physical rehabilitation exercises

8. Exercises for physical fitness

9. Sports optimization training

These type of modules are often integrated with a cognitive training module where some form of imagery exercise or attention training is correlated or coupled worth the exercises and techniques in the PhysioScan module. This module will also be interfaced with the biofeedback training module.

Parameter Matrix Variables

It should be noted that models below refer to animations or live movies

1. Specific behavioral response pattern (broken into component parts when necessary) of certain of the monitoring techniques, like taking pulse rate

2. Sex of the animation model

3. Age of the animation model

4. Ethnic/Social background of animation model

5. Measurement of physiological parameters of the response:

a Microphone based (vocal responses & dynamics)

b. Instrument based

c. Non-instrument based

Module Design

Overall, the PhysioScan module (PSM) consists of 2 major divisions. One component is the cognitive physiological self-monitoring training (CPSMT), which consists of training techniques to facilitate the individual's ability to focus on, to identify, and to record physiological sensations in the body. The second component is simple self-monitoring devices and techniques (SSMDT) where the client learns to use simple devices and instruments of low cost to monitor basic physiological functioning.

For ease of implementation, the PSM centers on the PhysioScan Technique itself (PST). The PST trains the client to identify basic physiological sensations associated with skeletal muscle activation and autonomic nervous system arousal. This is a cognitive-behavioral methodology and does not intrinsically necessitate instrumentation However, to enhance the accuracy, scope, and quality of the training it can, when available, be supplemented with other means of monitoring physiological states. As an adjunct to the PSM, we will incorporate three techniques that meet the above stated criteria (SSMDT). In addition, when available to the client the PST can also be enhanced through the monitoring capacities provided by the instrumentation in the biofeedback training module.

To implement the aforementioned strategy the PST retains center-stage, while the SSMDT techniques are brought in collaterally, on a PRN basis (i.e., buttons on the screen bring the client to screens specified for a specific technique). Thus the SSMDT is conceptualized as “plug-ins” to the CPSMT portion of the module. This plug-in design strategy will be implemented through a sub-module design approach, similar to that taken previously.

In implementing the stress management protocol, all the techniques will be taught linearly at first. That is, initially the client will be taught all the techniques. However, depending on the place in the program, one or more aspects of the main module or the sub-modules can also be incorporated. It is important to first program the PSM as a unit, and develop a strategy that allows sufficient flexibility to utilize aspects of the PSM in the various protocols.

PhysioScan Technique Section:

The PhysioScan Self-Monitoring Technique (PSSMT)

1. Screen 1. Entry/Gateway Screen

2. Screen 2. Introduction to PhysioScan Self-Monitoring Technique (PDT).

3. Screen 3. This is the first part of PSSMT in which the client learns an exercise to learn how to differentiate between various levels of muscle tension. In this technique they are taught to clench there hands gently and record the level of tension they detect in 3 different degrees of muscle tensing. The animation/movie will show first the model tensing the fingertips to the second row of muscle, 2) then to the base part of the fingers, and 3) then the whole fist. The model closes its eyes and arrows indicate where it is “focusing” its attention. The Screen will show that the animation is asked to determine the quality and the degree of tension. First, it must indicate the qualitative aspect of the feelings (e.g., tingling, tightness) and then indicate the overall degree of tension on a scale of 1-10, 10 being very tense and tight. The data are recorded by the animation software in the section of the screen for record keeping. The animation will repeat the three exercise 2 full times. VocieFile: PSSMTs2; VideoFile: PSSMTv1).

4. Screen 4: At the end of the 2 repetitions by the animation, the client is asked to play the instructions again and to practice the monitoring while watching the screen. Client is asked to record their results on the Personal Record Keeping Form displayed on the screen. The client will do this 2 times watching the animation. Then the client will be asked to do the exercise of clenching their fists in 3 successive stages with their eyes closed. At the end of each clenching they must record the qualitative aspects of their experience and the degree of tension in the recording keeping section of the screen.

PhysioScan Monitoring Methods Section

Wrist Pulse-Rate Sub-Module

Function

To train individuals to measure there pulse in the manner a physician takes pulse on the wrist.

Implementation

1. Screen 1: Entry/Gateway screen

2. Screen 2: Introductory screen explaining what the client will learn. This will be correlated with a voice file or TTS. Client is also introduced to the Record Keeping Screen and shown how to record and print their data. VoiceFile: WPRs1.

3a. Screen 3: Video and voice of the technique. This will be either a movie or animation. There is also a section on this screen to present a brief text on screen outlining the technique. There is also a portion of the screen to record data and a print button to print our results. Video and sound clip will be able to be reviewed by the client through AVI control. VoiceFile: WPRs2. VidoeFile: WPRv1.

3b. Screen 3: At the end of the presentation the client is asked to play the instructions again and to practice the monitoring while watching the screen. Client is asked to record their results on the record-keeping portion of the screen.

3c. The client is then asked to practice the technique 2-3 more times and to record their data.

4. Screen4. This is a homework screen. First, the technique is briefly reviewed. Then, the client can print out a sheet of homework instructions and a record-keeping sheet. The client can also download an audio file (WAV or MP3) to play on their computer or to be transferred to an MP3 recorder or a cassette recorder. The client is also informed how to access this module if they want to return to practice before their nest “session” in a protocol. The data from the homework will be input into some portion of whatever protocol the WPR sub-module is used.

Animator Instructions: Animation of two hands and wrist of one hand. The left hand is facing palm up with the wrist exposed. The right hand is placed with the fingertips over the wrist of the left hand with the tips gently resting on the wrist. The area of the wrist is over the area immediately below the wrist area behind the left thumb.

Microphone Respiration-Rate Sub-Module (MRRSubMod)

Function

To train individuals to measure their respiration rate (RR) & breath duration (BD).

Implementation

1. Screen 1: Entry/Gateway screen

2. Screen 2: Introductory screen explaining what the client will learn. This will be correlated with a voice file or TTS. Client is also introduced to the record keeping screen and shown how to record and print their RR & BD data. VoiceFile: MRRs1.

3a Screen 3: Video and voice of the technique. This will be either a movie or animation. There is a brief text on screen outlining the technique. There is also a section of this screen to record data and a print button to print our results. Video and sound clip will be able to be reviewed by the client through AVI control. VoiceFile: MRRs2. VideoFIle: MRRv1.

3b. Screen 3: At the end of the presentation the client is asked to play the instructions again and to practice the monitoring while watching the screen. The will also see the line graph in a portion of the screen that shows their RR & BD Client is asked to record their results on the record keeping portion of the screen.

4. Screen4: The client is then asked to practice the technique 2-3 more times and to record their data. While the client practices the technique, they will see a line graph of their breathing, as shown in FIG. 4, so that the line is high during the count and low when they finished the exhalation. There is an associated sound file near the graph toe exemplify the technique.

The client's Respiration Rate is given by:

$$\frac{Number of counts}{60 seconds}$$

Furthermore, the client's Mean Breath Duration is given by:

$$\frac{Sum of all BD ' s}{Number of all counts}$$

4. Screen4. This is the homework screen. First the technique is briefly reviewed. Then the client can print out a sheet of homework instructions and a record-keeping sheet. The client can also download an audio file (WAV or MP3) to play on the client's computer or to be transferred, by the client, to an MPR3 player or cassette recorder. The client will also have the option to download a small program to run on their computer to practice respiration. to hear on their computer. The client is also informed how to access this module if they want to return to it to practice before their nest “session” in a protocol. The data from the homework will be input into some portion of whatever protocol the WPR sub-module is used.

Animator/Movie Instructions:

The model places the microphone close to the lips (about 1 inch away). The client hears instructions of deep breathing, at a moderate rate. The client will rehearse in the practice section at the current rate they are at. The model is seen counting into the microphone, extending the sound for the duration of the exhalation. The model will demonstrate this to the count of five.

Liquid Crystal Temperature Monitor Submodule (LCTMSubMod)

Function

To train individuals to measure their peripheral surface temperature through some inexpensive liquid crystal device that changes color with temperature in a systematic fashion. These devices are generally available and are inexpensive, Like StressDots®, which are small dots one places on the surface of the skin. In one embodiment, cards with images such as a company logo, etc., have the liquid crystal embedded in them and also have instructions on how to use them. FIG. 5 illustrates how the liquid crystal's colors are correlated with temperature.

Surface temperature is typically correlated with the person's level of stress. Generally, the higher the temperature the more relaxed the person is.

Implementation

1. Screen 1: Entry/Gateway screen

2. Screen 2: Introductory screen explaining what the client will learn. This will be correlated with a voice file or TTS. Client is also introduced to the record keeping screen and shown how to record and print their data. VoiceFile: LCTMs1.

3a. Screen 3: Video and voice of the technique. This will be either a movie or animation. There is also a section on this screen to present a brief text on screen outlining the technique. There is also a portion of the screen to record data and a print button to print our results. Video and sound clip will be able to be reviewed by the client through AVI control. The client will be taught how to use the liquid crystal device. This entails reading the colors from the device and correlating them with temperature numbers (as shown in FIG. 5). They will then record these numbers in the data entry screen

3b. Screen 3: At the end of the presentation the client is asked to play the instructions again and to practice the monitoring while watching the screen. Client is asked to record their results on the record-keeping portion of the screen.

3c. The client is then asked to practice the technique 2-3 more times and to record their data.

4. Screen4. This is the homework screen. First, the technique is briefly reviewed. Then, the client is able to print out a sheet of homework instructions and a record-keeping sheet. The client is also able to download an audio file (WAV or MP3) to play on their computer or to be transferred to an MP3 recorder or a cassette recorder. The client is also informed how to access this module if they want to return to it to practice before their nest “session” in a protocol. The data from the homework will be input into some portion of whatever protocol the WPR sub-module is used.

Animator/Movie Instructions:

The model takes the card in the left hand. The model then places its forefinger of the right hand over the liquid crystal display for 30 seconds. The model then removes its forefinger and the color of the liquid crystal is determined. The corresponding temperature is determined and recorded. Use arrows to show the correlation of color & temperature.

Breathing Training Module

Function

To train clients in a variety of breathing techniques for a variety of purposes. Some of the breathing techniques include:

1. Relaxation Training

2. Respiration Training for Disorders of Speech

3. Breathing Control to abort panic attacks and episodes of intense anxiety

4. Respiration training for asthmatics

5. Breathing control for hyperventilation syndrome (related to panic disorder)

6. Respiration control for other health conditions

a. Currently investigating use of breathing control in regulating heart-rate variability and respiratory-sinus arrhythmia for various medical conditions

In general the module focuses on several parameters:

1. The form & pattern of the breathing behavior

2. The respiration rate (breaths per minute)

3. The respiration depth (measured by the duration of each breath; there are more sophisticated ways of measuring this through instruments)

4. The client will also be taught to monitor pulse-rate as a useful collateral measure in respiration training

Parameter Matrix Variables

Please note: Models below refer to animations or live movies

1. Type of breathing exercise (broken into component parts; see below)

2. Sex of the animation model

3. Age of the animation model

4. Ethnic/Social background of animation model

5. Measurement methods for reparation parameters

a. Microphone based

b. Instrument based

c. Non-instrument based

Module Design

This module will focus on diaphragmatic breathing since it is the most commonly form of respiration training used across the disciplines mentioned above. This is a two-session design, where the client practices certain basic responses in the first week, and then refines their techniques during the second week of training. Further refinement occurs if the client chooses to practice subsequent to the basic two-week training period of this module. The basic design of the module is such the client is brought through a series of behavioral exercises in which they are trained in the components of the particular breathing technique. In general they are shown the behavior they are requested to learn and then they have to repeat it. As with learning many behavioral techniques, they can seem difficult to the client, so the breathing technique is broken into small component parts that are easy to master. The client must master one level before going on to the next. The client is also given various ways to monitor their activity to insure they are performing correctly.

The four major behaviors in this module the client must master are:

1. The form & pattern of the breathing technique

2. The rate of breathing

3. The depth of breathing

4. Measuring pulse rate

The form & pattern behaviors are divided into the following components:

1. Movement and position of chest and abdomen pre-inhalation

2. Movement and position of chest and abdomen pre-exhalation

3. Movement and position of chest and abdomen during inhalation

4. Movement and position of chest and abdomen during exhalation

After clients learns the proper form and pattern of the response they are taught to slow their breathing done by increasing the duration of each breath. This in turn also lowers the over all respiration rate.

Module Implementation: Programming Steps

6. Screen 1. Display text that describes why correct breathing is necessary and what breathing training does to the client. In this screen this is a small animation/video showing incorrect and correct breathing patterns.

7. Screen 2. Display text giving general instructions concerning the training to the client

8. Screen 3. Display first breathing animation with instructions to client. After client reads instructions, they “click” a button to initiate the animation. The first animation shows the model standing in an upright position with one hand on the chest and one hand on the abdomen. The animation then begins to lowly push the abdomen out, with the chest remaining still. Then the animation begins to push the abdomen in, again with chest remaining still. The animation, repeats this sequence 4 times. No mention of breathing is made at this time. The animation then stops. The client is asked if they wish to see it again. It should be noted that the client has access to standard AVI controls to repeat the animations as often as desired in any module. When they client feels they do not require the animation further at this point that are asked to practice this behavior 8 times. They must stand up, place their hands accordingly, and practice the behavior.

9. Screen 4. The client then goes on to the next animation. In this animation the client while practice combining the movement of the abdomen with inhalation and exhalation. The client is first given a set of instructions and then asked to “click” on a button to initiate the animation. In this animation, the model is in a standing, upright position, with its hands on the abdomen and chest. The animation then begins to extend the abdomen while breathing in through the nose, and while the chest remains still. After about 4 seconds, the model begins to push in the abdomen while breathing out through the mouth The exhalation will last about 6 seconds. To show that air is entering and leaving the air passages, there will be an animated airflow diagram within the module illustrating the flow of the air. When they client feels they do not require the animation further at this point that are asked to practice this behavior 8 times. Clients must stand up, place their hands accordingly, and practice the behavior.

10. Screen 5. The client then goes on to the next animation. In this animation they are taught to pace there breathing. They are given brief instructions and they asked to “click” on the start button. The third animation is imitated. This animation is a repetition of the second animation with auditory counting of the inhalation and exhalation (e.g., “Inhale . . . 2 . . . 3 . . . Exhale . . . 2 . . . 3 . . . 4). The animation will start with a count of inhaling to 4 and exhaling to 6. The client however, will be told to start with inhaling with 3, and exhaling with 4. The animation model will demonstrate this 4 times. When the modeling period is complete the client will be asked to practice this as well. However, they will now be prompted and paced by the animation file (adjusted to the lower pace for the client practice trials) or an auditory file from the PC/Internet. The client first “clicks” on the animation or auditory file. Again, standing in the upright position, with their hands on their chest and abdomen they are instructed to inhale to a count of 3 and then exhale to a count of 6. Initially, it is probably best if they practice also while watching the animation and hearing the counts. The client practices this 8 times.

11. Screen 6. Monitoring breathing rate through microphone. To check on the client to make sure they are breathing at the appropriate rate they are then taught to use the microphone as a means to assess respiration rate (RR). They are asked to hold the microphone near their mouth. They are then told to watch a timer on the screen. The counter will time their inhalations and exhalations. During the exhalation, they are then asked to count the number of the breath in a sequence of 10 breaths for the duration of the exhalation. Thus, for example, they say “ONNNNNNNNEEEEEEEEEEEEEEE”, while they watch the counter during exhalation. As the client speaks into the microphone a rectangle line graph will show the length of the exhalation. They practice this for 8 times. Then the clients repeat the exercise, without the counter, but counting to themselves. The program records the client's exhalation times. The client's mean exhalation rate is compared to the target rate.

12. Screen 7. Respiration Monitoring Screen. In this screen the client is asked to hold the microphone as in Screen 6 and to breath for a series of 10 breaths as outlined in the exercise in Screen 6 (for whatever rate the client is required to practice at that time). They will see the graphical display of their response. The program records their exhalation times. The client's mean exhalation rate is compared to the target rate. FIG. 6 illustrates the graphical display of a respiration monitor screen.

13. Screen 7. Pulse monitoring screen. In this screen they will learn to monitor their pulse. Clients see an animation that will show them how to place the tips of the fingers of one hand on the wrist of the opposing hand to monitor their pulse. The client is given a set of instructions and then they are asked to “click” the start button of the video. The video will repeats the behavior twice, and offers the client the opportunity to repeat it. Then, clients are asked to practice the task on their own. When they are ready to go on they are once more afforded the opportunity to see the video again. They are asked to affirm that they understood the procedure and practiced it. They are also asked to input their pulse rate.

14. Screen 8. Pulse monitoring screen. This screen is used whenever the program needs to assess the clients pulse rate. It prompts the user to take their pulse rate and to input their answer. It also has an icon that will replay the Pulse Monitoring Training Animation so the client has it available if they need to check it.

15. Screen 9. Homework screens. In this screen the client has the option to download both a written assignment sheet as well as an auditory practice file (WAV or MP3 format). The client will be given specific homework assignments and be asked to monitor certain variables they will have input into the computer.

16. Screen 10. Homework review screen. In this screen clients have to input the data collected from their homework assignment. Based on this data the computer will inform clients if they need to further practice any of the items that they were required to practice during their homework.

Sample Session Sequences

1. Session 1

a. Screen 1

b. Screen 2

c. Screen 7

d. Screen 3

e. Screen 4

f. Screen 8

g. Screen 9

2. Session 2

a Screen 2

b. Screen 10

c. Screen 8

d. Screen 4 (modified for review)

e. Screen 5

f. Screen 6

g. Screen 7

h. Screen 8

i. Screen 9

Animation Instructions

In the Animation#1 the subject is standing up, initially with the hands to the sides. After 10 sec, the subject is seen placing one hand over the abdomen and one hand on the chest. Then the model slowly pushes the abdomen out over a period of about 4 seconds. Clients should be able to see the hand over the abdomen rise, while the chest remains still. After the fourth second, the model shows the abdomen going back in, and the hand following, but still no chest movement. The model does this 8 times in a row.

It should be noted that in this, and the other animation, there will also be an animation in a sidebar that is more like an outline that more clearly shows the movement of the abdomen.

In Animation#2 the subject is standing up, initially with the hands to the sides. After 10 sec, the subject is seen placing one hand over the abdomen and one hand on the chest. Then the subject begins to breathe slowly & deeply using the technique of diaphragmatic breathing. That is, as the client inhales, the abdomen is gently pushed out. After inhalation is complete, an exhalation is performed, by gently pushing the abdomen in. There should be a moving flowing arrow, internal to the model, showing the flow of the air, going in through the nose down into the lungs during inhalation; and then up from the lungs and out the mouth during exhalation. Inhalation should be about 4 sec, exhalation about 6 sec. The subject should be showing this 8 times in a row. It should be apparent in the animation as to the direction of the breathing. In the correct form of breathing, only the abdomen is seen moving, not the chest.

A demonstration is also provided of the incorrect breathing pattern for the beginning introductory discussion. This can be a simpler animation. The subject sucks in the abdomen when performing an inhalation, and pushes the abdomen out when performing an exhalation. In the incorrect form of breathing, the subject should be shown with the abdomen going in & chest rising when the subject breathes in, and the chest lowering & and the abdomen going out when exhaling. In the incorrect form of breathing, it is the chest, not the abdomen that controls much of the breathing. Paralleling this, there should also be a simpler animation of correct breathing that could be used in the introductory discussion.

Attention & Perception Training Module

Function

To present to the client a variety of tests to assess cognitive factors, and in particular attention and concentration, that have know influences on stress and anxiety. These variables are also amenable to training, thus enhancing the overall outcome of the stress management protocol. Furthermore, self-control is a central concept in relaxation techniques, and a key concept in learning self-control or self-regulation strategies is the ability to regulate, focus, and sustain ones attention. The client must learn, in many of the exercises, to sustain their attention to external stimuli, physiological sensations, images, thoughts, and feelings. This is often difficult for many people. In particular, stress and anxiety are known to have an extremely disruptive influence on attention and concentration. In many of the modules provided, their ability to sustain attention will approve with the task at hand. The attention & perception training module is intended to enhance this process by a) identifying specific areas of attentional control, and b) providing training strategies to ameliorate or enhance their attentional capacities, thus enhancing their overall success at the stress management protocol. In addition, attention training will be of use in other modules related to the protocol, where attention to details and awareness of problems is important, as in the habit control module or the pain control module.

The first component of the module is to use some of the interactive tests from the generalized assessment module where the client may have to respond to changing stimuli on the computer screen. These tests, which comprise the attention and perception battery, measures the client's reaction time and error rate via a computer. In particular, some of these tests are outlined below:

1. Attentional Modes Test—In this test clients have to deploy various modes of attention ranging from concentration to vigilance. They also have to change their mode between trials, thereby indicating their flexibility in responding to changes in the environment. Thus, the test measures how the client performs on a variety of attentional tasks and how well they can adapt to changing demands on their attentional style.

2, Concentration Test—assess how well the client can maintain their attention to a specific task.

3. Boredom Susceptibility Test—assesses how well the person can tolerate a boring situation and still maintain their attentional capabilities

4. Vigilance Task—this tests measures how well the person is able to scan their environment and detect rapidly changing stimuli in that environment

5. Cognitive Search Test—this test assess how well the individual can search complex field of information and detect relevant information. The test also looks at the person's strategies for detecting the relevant information

6. Divided Attention Test—this test determines how well the person can attend to 2 simultaneously occurring stimuli and detect correct stimulus combinations

7. Attention & Memory Test—assesses the degree to which memory influences the client's ability for sustained concentration

8. The Anxiety & Attention Test—this test measures how the client's responses are influenced by stress

The second phase of the attention and perception control module is to train the client to improve their attentional skills. The client is first informed where, if any, there are deficiencies in their attentional processes (in terms of their percentile score referenced against a sample of subjects having previously taken these tests). For those tests, the client is then instructed to click on a designated button where they enter the training section of the module. In this section, they essentially practice the tests cited above, which have been transformed into interactive game-like experiences where they are, in essence, practicing their attentional skills. The client is then periodically re-assessed on the tests they showed some difficulty to assess their current level of performance, and to determine if further training is necessary.

In addition, the module will have the ability to present to the client, when necessary, results of the assessment. The module has the ability to perform basic statistical analysis of the data. Descriptive statistics are used to present the client's data, which can be used to monitor and to chart the client's progress. The client's scores are also compared to normative sample statistics to assess their performance in terms of how other individual's perform on these tests. Furthermore, an expert system based from of interpretative system will allow this module to present an interpretation of the results and thus it is integrated closely with the Forms and Report Generator Module. The output of the testing will also be used to inform the training and treatment modules as well. Thus, some of the tests provided by this module are used to monitor the client's progress, and provided appropriate modules with information critical in deciding whether to continue or modify the current course of treatment.

Parameter Matrix Variables

1. Interactive Response-based Scores

i. Reaction Time

ii. Error Rate

iii. Logical Analyses

iv. Number of Steps to Completion

v. Method Used

vi. Path Followed

2, Type of Input Device

d. Keyboard

e. Mouse

f. Microphone

g. Other

3, Types of statistical analyses

h. Item Totals

i. Test Mean

j. Subscale Totals

k. Subscale Means

l. Standard Deviation

m. Inter-item Correlations

n. Split-Test Correlations

o. Normalized scores to compare to population samples

4. Level and type of test interpretation and integration

p. Simple data presentation with charts

q. Summary of progress, and suggestions for change, if necessary

r. Expert system based interpretation

Current Tests and Training Modules Based on the present invention:

1. Modes of Attention Test

2. Concentration Test

3. Distractibility Test

4. Vigilance Test

5. Divided Attention Test

6, Attention & Memory Test

7. Boredom Susceptibility Test

8. Cognitive Search Test

Module Design

Interactive Tests Programs Measuring Client's Responses

The generalized assessment module will also have to present, analyze, and interpret PC and Online-based interactive tests involving the measurement of the subject's response on the keyboard, mouse, or some other input device. This primarily accomplished through a hyperlink to the specific test. The test can then export back the data as an ASCII file, which can be analyzed and interpreted by the generalized assessment module in conjunction with the form and report generator module. Within the parameters of the generalized assessment module's parameter matrix certain tests can also be developed within the module itself as well.

Module Design: Programming Steps

1. Screen 1: Display text that describes the test to the client.

2. Screen 2: Display text giving instructions to the client

3. Screen 3: Display a particular test form the Attention & Perception Test Battery. These tests are accessed from the Generalized Assessment Module.

4. Screen 4: Upon completion of the previous battery the next test is displayed until the client completes all 8 tests on Screens 4-10.

5. Screen 11: The Data from this section is sent to the Form and Report Generator Module which displays test results to client, showing their individual and percentile scores, a graph of normalized scores, mad an interpretative explanation. The tests also suggest which of the attentional attributes require further training.

6. Note: Descriptive Statistics calculated at end of test:

a. Total Score (TS)=Sum of all test scores

b. Mean Test Score=TS/N

c. If there are subscales, for each subscale:

i. Subscale Score (SSS)=sum of subscale score

ii. Mean Subscale Score=SSS/Nss

7. Note: Comparison to sample population if normative data available

a. Normalized Score

b. Deviation from Group Mean

c. Percentile Score

8. Screen 12: This screen uses the Text and Sound Presentation Module (TSPM) to explain the general nature of the Attention and Perception Training Techniques.

9. Screen 13: This screen uses the Text and Sound Presentation Module (TSPM) to explain the specific tests of the Attention and Perception Training Techniques the client will be training on.

10. Screen 14: This screen uses the Audio/Visual Relaxation Module to present the series of training tests the client will be using. The client will be given 1-minutes of training on each areas in need of training. If there are more than 4, then the client must continue the session at another time (A minimum 2 hour rest period is required).

11. Screen 4: At the end of each session data is integrated with the Forms & Report Generator Module for further processing and presentation to the client. The client is informed as to the progress that has been made, and to the extent training should continue. If the results of the training tests indicate the client has reached a certain level, they retake the original test assessing that attentional factor. If the results confirm the initial finding, the client is instructed that they are done, If not the client must continue training.

Single Behavioral Response Training Module

Progressive Relaxation Application 1

SubModule I. Behavioral Response Pattern #1: Hands & Arms

SubModule II. Behavioral Response Pattern #2: Shoulders & Face

SubModule III. Behavioral Response Pattern #3: Chest, Stomach, & Back

SubModule IV. Behavioral Response Pattern #4: Feet & Legs

Function

Overview

To train individuals in specific behavioral response patterns typically involving some form of motor response pattern. This module is designed to train the client, in one simple form, a behavioral response that usually will be chained together with other simple responses to form more complex forms of response. In this way the behavioral technique of response is used in shaping and developing complex patterns of behavior over the Internet. Thus, by constructing our basic behaviors appropriately the client has a relatively easy time learning these responses. Then it becomes just a matter of linking these simple behaviors together to build more complex forms of behavior. This is essentially a version of the methodology of training target or goal behaviors through successive approximations. The behavioral sequences are relatively simple and easily mastered, thus insuring success. In turn, the success at the task functions is one form of reinforcement for the behavior. The reinforcer, in turn, increases the likelihood that the response it follows will recur. This the central principal of operant or instrumental conditioning:

R→S^{R}

A reinforcer is a stimulus that follows a response and increases the probability of the occurrence of that response

Implementation

The behavioral response training modules are intended for the following purposes:

1. Relaxation training using motoric responses like Progressive Relaxation Training

2. Muscle Response Discrimination Training (a technique that has been developed and that is related to PhysioScan)

3. Physical rehabilitation exercises

4. Exercises for physical fitness

5. Sports optimization training

These type of modules are often integrated with a cognitive training module where some form of imagery exercise or attention training is correlated or coupled with the exercise in the behavioral response training module. These modules are also interfaced with the physiological monitoring module and the biofeedback training module.

Parameter Matrix Variables

It should be noted that models below refer to animations or live movies

1, Specific behavioral response pattern (broken into component parts when necessary)

2. Sex of the animation model

3. Age of the animation model

4. Ethnic/Social background of animation model

5. Measurement of physiological parameters of the response:

a. Microphone based (vocal responses & dynamics)

b. Instrument based

c. -instrument based

Module Design

It should be noted that the hands and arms response pattern is used to exemplify this module. During the animation and voice sequences appropriate changes will be made for the relevant response pattern. Otherwise, the details of the module design are similar unless otherwise noted.

The basic design of the module is such the client is brought through a series of behavioral exercises that train the clients in the components of a specific response. While it is possible, and often desirable, to train one simple motor response pattern, this is often not necessary or it is inefficient. Typically, the response in a module is elemental to begin with, so its components, are even simpler. In general, the rule is to select a level of behavior that is easy for the client to learn, yet keeps the learning efficient and interesting. Thus, within a module simple behaviors are often the result of chaining together even smaller segments of behavior.

The basic design of the module is for the client to integrate the four behavioral components the client previously learned. It is a modified response chaining procedure. First, the client is trained to proceed through the four responses sequentially, one response pattern followed by another. Then the client is trained to produce all the response patterns at one time. This is also referred to as parallel chaining.

In general, the procedure is to 1) instruct the client in terms of the behavioral pattern they are requested to learn, 2) to give a demonstration of the behavior pattern through a video or an animation, and 3) to have the client practice and rehearse the behavior pattern after the demonstration. First, the client practices with instructions and the visual display, and then they practice without any prompting. The client has controls, through AVI or equivalents, the animation if they encounter a problem and need further prompting. As with learning any behavioral technique, they seem difficult to the client. Therefore, complex behavior patterns are reduced to their component behaviors, which are usually that easier to master. The client must master one behavior level or activity before going on to the next. The client is also given various ways to monitor their activity to insure they are performing the behavior pattern correctly. Once the simpler forms of behavior are mastered they are linked or chained together (in another module). This allows for a precision and fine-tuning in learning behavioral responses, particularly when there is no other individual available to monitor the client's activity.

Behavioral Response Pattern #1: Hands & Arms

In this module, the client will learn to relax their hands & arms. This response pattern is the first behavioral sequence in the Progressive Relaxation Module. The goal of this exercise is to train the client 1) to differentiate between states of tension and relaxation in the hands & arms, 2) to be able to identify the qualitative aspects of these states, and 3) to promote and facilitate relaxation in the hands & arms. The major behavior or response pattern in this module the client must master in this exercise is to progressively and gradually clench and release their hands & arms in a systematically timed fashion.

This exercise is associated with the PhysioScan module. Through PhysioScan methodology the client learns

1. To differentiate or discriminate among various levels of muscle tension as the arms become tense in the first phase of the exercise,

2. To identify the qualitative aspects of the physical sensations of tension

3. To differentiate changes in physical sensations as the hands and arms begin to relax, in the second phase of the exercise

4. To identify the qualitative aspects of the physical sensations of relaxation

5. To promote the sensations of relaxation This may be further enhanced by other techniques in other modules as in the Biofeedback Training Module or the Autogenic Training Module

6. To control attention and focus to internal physiological signals or events (related to the concept of interoception)

Through learning to discriminate their internal feeling states generated by physiological systems and to induce states of relaxation by focused attention procedures and stimulus control techniques (repetitive stimulus techniques, discriminative stimuli, etc.)

Module Implementation: Programming Steps

1. Screen 1. Display text that describes the idea of relaxation techniques in general and Progressive Relaxation in particular. Describes the course of the Progressive Relaxation training and its component steps.

2. Screen 2. Display text giving general instructions concerning the training to the client. This screen will describe how to tense and relax muscles. For example, that it must be done gently, not hard. The client is told that these exercise are not like exercise for physical fitness. They are further informed that these exercises are to help them to become aware of their bodies to differentiate their internal feelings. That this is natural for the mind to do, but that anxiety disrupts this process. Animation/Voice #1: This screen will have an animation illustrating the discussion of the text. Voice: Optimally the text will be presented vocally in sequence with the animation. The client has access to AVI controls to repeat the sequence as often as they wish

3. Screen 3; Part 1. In this screen the client receives training for the Hands & Arms training. First the client will be given Instructions. Text#1: They are presented with instructional text describing the Hands & Arms response patterns. Voice#1: The will hear voice presentation of Text#1. After client hears/reads instructions, they “click” a button to initiate training animation sequence. Animation/Voice#2. This is an animation of the Hands & Arms response pattern with a correlated audio file generated by the PhysioScan Module. Animation#2. The animation begins with the model sitting in an upright position with the palms of their hands up on their lap. The model then begins to slowly make a fist. After the fist is complete the model slowly brings the hands to the shoulders and holds it in that position for several seconds. Then the model begins to bring the hands slowly back to the lap and returns the hands to their original position. The animation, repeats this sequence 4 times. The animation then stops. Voice#2 (please see below for an example): The vocal sequence for this module is generated via the techniques embedded in the PhysioScan Module and the autogenic training module (please see these modules for details). The vocal sequence correlates with the three components of the behavioral response: tensing, relaxing, relaxation facilitation. The PhysioScan techniques are relevant to phases 1 and 2 by focusing the client on the salient physiological sensations, on their location, intensity & quality, while autogenic training centers on enhancing relaxation through inducing the relevant sensations and feelings.

4. The client is then given instructions to practice this task twice while watching the animation and listening to the instructions. They must sit upright in their chair, place their hands & position themselves accordingly, initiate the animation, and practice the behavior. Then the client is given instructions to repeat the task twice again with their eyes closed following the instructions given in a voice file. The client clicks on the voice file, which the client knows will not begin the voice sequence for 30 seconds, sits upright in the chair, positions the hands, closes the eyes, and readies oneself to begin. The voice file begins, and the client practices the response, using the reduction in stimulation produced by the eyes being closed to help the client focus on the internal bodily states.

It should be noted that the client has access to standard AVI controls to repeat the animations as often as desired in any module. Thus, if clients are uncertain at any point they are still uncertain about some aspect of the response they can “pause” the session and “play” the animation at will.

5. Screen 4; Part 1. The client then goes to the stress monitoring screen from the PhysioScan module (please refer to this module for details). They will record measure and record their SUDs score, PhysioScan scores, pulse rate, and respiration rate. The computer will determine their composite stress index and report it to the client with an interpretation.

5. Screen 3; Part 2: At this point all clients will again practice the hands and arms exercise twice while watching the animation and twice with their eyes closed using the voice file.

7. Screen 4; Part 2. The client then goes to the stress monitoring screen from the PhysioScan module (please refer to this module for details). They will record measure and record their SUDs score, PhysioScan scores, pulse rate, and respiration rate. The computer will determine their composite stress index and report it to the client with an interpretation.

8, Screen 3; Part 2: At this point if the client is relaxed enough they will be informed they can go on to the next part of the session, although it will be suggested they practice the hands and arms response another 2-4 times. If their score is too low, they will be urged to practice another 4 times and take their measures again. Thus, the client would return to screen 3. If the client's score was in the relaxed region, they would practice once with the animation, and once on their own with just the audio file. If the score was low they would have to practice with animation twice, and practice twice with just the audio file and their eyes closed.

9. Screen 4; Part 3: Clients with a low score must also repeat Screen 4.

10. Screen 5. This is the homework assignment screen and it is the last screen of the module. In this screen the client has sever al options to download instructions to practice the exercise before the next online session. They will have the option of downloading the Voice#2 file in either WAV or MP3 formats, which are the instructions for the particular behavioral response pattern +the PhysioScan exercise +the autogenic training exercise. It is assumed clients have MP3 and WAV file options. The client could also transfer this file to an MP3 player, or a digital or cassette recorder. They will also be able to print out a hard copy of the voice file text. The client will also have to print out a homework record log sheet to keep track of various types of data they will record as they practice during the week. Table in FIG. 7 summarizes the basic data the client records, typically before (B) & after (A) homework practice sessions. These sessions will evolve and diversify with the various protocols and modules we are developing. The data the client records will be input back into the computer at the beginning of the clients next session for processing and the information is used by the protocol to make determinations about the client (e.g., do they need to practice this current behavior response pattern further before they go on to the next step?). This task is accomplished via the homework data collection and processing module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to his or her own home PC.

11. Finally, the client should have access to the particular session they are working whenever they want via the Internet. In the case of this module, they may want to see the video/animation of the hands and arms response pattern because they were unsure of some aspect of the behavior. FIG. 7 illustrates an example of sample personal record keeping form.

Animator Instructions

1. Hands & Arms

Subject begins with palms up on lap. After about 10 sec., the subject slowly and gently begins to make a fist while palms are on the lap. The movement should be slow and easy—a mild tensing effort. This should take about 6 sec. The subject should then slowly and gently begin to raise both the fists to the shoulders, showing how to tense the forearms and biceps. This should also take 6-7 sec. The subject should hold this position for 10 sec. Then the subject slowly begins to return the hands to the lap, taking again about 7 sec. The hands should return to the lap so that the subject will slowly open the hands on the lap, taking 6 sec, so that the palms are facing up. The animation should continue in this resting position for another 45 sec.

2. Shoulders and Face

Subject begins in same position as A. After 10 sec the subject will slowly & gently raise the shoulders toward the head, almost as if the subject is hunching the shoulders. This movement should take about 7 sec. While the shoulders are raised, the subject should appear to be squinting the eyes, lowering the forehead, and opening the mouth wide. This should take about 6 sec. The subject then holds this shoulder and face position for 10 sec. The subject then “relaxes” the face to the original resting position, and slowly lowers the shoulders to the starting position. This should take about 7 sec. The subject should then be shown in this relaxed position for about 45 sec.

3. Chest, Stomach, and Back

The subject begins in the same position as in A. After 10 sec the subject begins by taking a slow and gentle deep breath, sucking in the stomach and expanding the chest. This should take about 10 sec. Then the subject should be shown slowly and gently arching the back, taking about 6 sec. The subject then holds this position for about 10 sec. Then the subject begins to slowly straighten the back, and then lower the chest, and then releases the stomach. This part should take about 10 sec. Then the subject is shown in the relaxed position for about 45-sec.

Legs and Feet

The subject begins as in A. The subject then raises the legs straight out. The client then points the toes toward the head while holding the legs straight out. This should take about 12 sec. The subject then holds this position for 10 sec. The subject then relaxes the foot, and slowly and gently returns the legs to the floor. This should take about 10 sec. The subject is then shown in the relaxed position for another 45-sec.

Sequential Behavioral Response Training Module

Progressive Relaxation Application 2

Behavioral Response Pattern: Sequential Production and Relaxation 4 Response Patterns through Parallel Response Chaining & Linking

Function

Overview

To train individuals in specific behavioral response patterns typically involving some form of motor response pattern. This module is designed to train the client in one simple form a behavioral response that usually will be chained together with other simple responses to form more complex forms of response. In this way the behavioral technique of response are used in shaping and developing complex patterns of behavior over the Internet. Thus, by constructing our basic behaviors appropriately the client will have a relatively easy time learning these responses. Then it becomes just a matter of linking these simple behaviors together to build more complex forms of behavior. This is essentially a version of the methodology of training target or goal behaviors through successive approximations. The behavioral sequences are relatively simple and easily master, thus insuring success. In turn, the success at the task functions as one form of rein forcer for the behavior. The reinforcer, in turn, increases the likelihood that the response it follows will recur. This the central principal of operant or instrumental conditioning:

R→S^{R}

A rein forcer is a stimulus that follows a response and increases the probability of the occurrence of that response Implementation

The Behavioral Response Training Modules are currently intended for the following purposes:

1. Relaxation training using motoric responses like Progressive Relaxation Training

2. Muscle Response Discrimination Training (a technique that has been developed and that is related to PhysioScan)

3. Physical rehabilitation exercises

4. Exercises for physical fitness

5. Sports optimization training

These type of modules are often integrated with a cognitive training module where some form of imagery exercise or attention training is correlated or coupled worth the exercise in the behavioral response training module. These modules will also be interfaced with the Physiological Monitoring Module and the Biofeedback Training Module.

Parameter Matrix Variables

Please note: Models below refer to animations or live movies

1. Specific behavioral response pattern (broken into component parts when necessary)

2. Sex of the animation model

3. Age of the animation model

4. Ethnic/Social background of animation model

5. Measurement of physiological parameters of the response:

a. Microphone based (vocal responses & dynamics)

b. Instrument based

c. Non-instrument based

Module Design

The basic design of the module is such the client is to integrate the four behavioral components the client previously learned. It is a modified response chaining procedure. First, the client is trained to proceed through the four responses sequentially, one response pattern followed by another. Then, the client is trained to produce all the response patterns at one time. This is called parallel response chaining & linking.

In general, the procedure is to 1) instruct the client in terms of the behavioral pattern they are requested to learn, 2) to give a demonstration of the behavior pattern through a video or an animation, and 3) to have the client practice and rehearse the behavior pattern after the demonstration. First, the client practices with instructions and the visual display, and then they practice without any prompting. The client has available, through AVI, or similar, controls, the animation if they encounter a problem and need further prompting. As with learning any behavioral technique, they can seem difficult to the client. Therefore, complex behavior patterns are reduced to their component behaviors, which are usually that easier to master. The client must master one behavior level or activity before going on to the next. The client is also given various ways to monitor their activity to insure they are performing the behavior pattern correctly. Once the simpler forms of behavior are mastered they are linked or chained together, which is accomplished in this module. This allows for a precision and fine-tuning in learning behavioral responses, particularly when there is no other individual available to monitor the client's activity.

Sequential Response Chaining & Linking

In this module, the client will first learn to sequentially relax their 1) hands & arms, 2) shoulders & head, chest, 3) stomach & back, 4) legs & feet. This training represents my technique of sequential response chaining & linking (SRCL). SRCL is part of the progressive relaxation training module. SRCL is the first phase in training the client in being able to successfully produce all the response patterns at one time. The goal of this exercise is to train the client to sequentially produce all 4 of the behaviors they previously learned and to 1) differentiate between states of tension and relaxation in their entire body, 2) be able to identify the qualitative aspects of these states, and 3) promote and facilitate relaxation in their entire body. The client must produce in succession each major behavior or response pattern learned in previous modules. For each individual response pattern the client must progressively and gradually clench and release the particular muscle group defined as a behavioral pattern in a systematically timed fashion.

This exercise is associated with the PhysioScan Module. Through PhysioScan methodology the client learns

1. To differentiate or discriminate among various levels of muscle tension in each muscle group as it becomes tense in the first phase of the exercise,

2. To identify the qualitative aspects of the physical sensations of tension

3. To differentiate changes in physical sensations as the hands and arms begin to relax, in the second phase of the exercise

4. To identify the qualitative aspects of the physical sensations of relaxation

5. To promote the sensations of relaxation. This may be further enhanced by other techniques in other modules as in the Biofeedback Training Module or the Autogenic Training Module

6. To control attention and focus to internal physiological signals or events (related to the concept of interoception)

Through learning to discriminate their internal feeling states generated by physiological systems and to induce states of relaxation by focused attention procedures and stimulus control techniques (repetitive stimulus techniques, discriminative stimuli, etc.)

Module Implementation: Programming Steps

1. Screen 1. Display text that reinforces and amplifies previous ideas presented concerning relaxation techniques in general and Progressive Relaxation in particular. Describes the course of the Progressive Relaxation training and its component steps.

2. Screen 2. Display text giving general instructions concerning the training to the client. This screen will review how to tense and relax muscles. For example, that it must be done gently, not hard. The client is told that these exercise are not like exercise for physical fitness. They are further informed that these exercises are to help them to become aware of their bodies to differentiate their internal feelings. That this is natural for the mind to do, but that anxiety disrupts this process. Animation/Voice #1: This screen will have an animation illustrating the discussion of the text. Voice: Optimally the text will be presented vocally in sequence with the animation. The client has access to AVI controls to repeat the sequence as often as they wish

3. Screen 3; Part 1. In this screen the client receives training for SCRL Training. First the client will be given Instructions. Text#1: They are presented with instructional text describing the SCRL Training. Voice#1: The will hear voice presentation of Text#1. After client hears/reads instructions, they “click” a button to initiate training animation sequence. Animation/Voice#2. This is an animation of SCRL Training with a correlated audio file generated by the PhysioScan Module. Animation#2. The animation begins with the model sitting in an upright position with the palms of their hands up on their lap. The model then begins to slowly & gently make a fist. After the fist is complete the model slowly brings the hands to the shoulders and holds it in that position for several seconds. Then the model begins to bring the hands slowly back to the lap and returns the hands to their original “relaxed” position. After 1 minute of “relaxing the hands & arms with its eyes closed,” the animation then begins to slowly raise their shoulders to their head. At the same time the animation lowers (furls) its forehead, squints its eyes, and opens its mouth wide. After about 7-10 seconds it begins to lower its shoulders slowly, while also slowly un-furling its brow, opening its eyes, and closing its mouth. The mouth is left slightly open to show the jaw is slightly dropped, and not tense. Once returned to the “relaxed position,” the animation remains that way for one minute, “relaxing wit its eyes closed.” Then, The animation begins to slowly suck in its stomach, raise its chest, and arch its back. After 7-10 seconds, the animation begins to slowly release its stomach lower its chest, and straighten its back. Once returned to the “relaxed position,” the animation remains that way for one minute while “relaxing with its eyes closed.” Then the animation stretches its legs straight out in front of it, points its toes toward the head & and toward each other, thus showing how to gently tense the leg. After holding this position for about 7-10 seconds, the animation slowly returns its feet to the floor, to the “relaxed position.” After “relaxing with its eyes closed” for approximately 1 minute the animation sequence is ended. It should be noted that since this a long sequence, when the procedure is first demonstrated to the client, the one minute relaxation periods will be reduced to 10 seconds. The client will be informed of this, and will be told that during the actual exercise, the relaxation period will be one minute. The animation repeats this sequence 4 times. The animation then stops. Voice#2 (please see below for an example): The vocal sequence for this module is generated via the techniques embedded in the PhysioScan Module and the Autogenic Training Module (please see these modules for details). The vocal sequence correlates with the three components of the behavioral response: tensing, relaxing, relaxation facilitation. The PhysioScan techniques are relevant to phases 1 & 2 by focusing the client on the salient physiological sensations, on their location, intensity & quality, while autogenic training centers on enhancing relaxation through inducing the relevant sensations and feelings.

4. The client is then given instructions to practice this task twice while watching the animation and listening to the instructions. They must sit upright in their chair, position themselves accordingly, initiate the animation, and practice the behavior. Then the client is given instructions to repeat the task twice again with their eyes closed following the instructions given in a voice file. The client clicks on the voice file, which the client knows will not begin the voice sequence for 30 seconds, sits upright in the chair, positions oneself, closes the eyes, and readies oneself to begin. The voice file begins, and the client practices the response, using the reduction in stimulation produced by the eyes being closed to help the client focus on the internal bodily states.

It should be noted that the client has access to standard AVI controls to repeat the animations as often as desired in any module. Thus, if the client is uncertain at any point they he/she is still uncertain about some aspect of the response they can “pause” the session and “play” the animation at will.

5. Screen 4; Part 1. The client then goes to the Stress Monitoring Screen from the PhysioScan Module (please refer to this module for details). They will record measure and record their SUDs score, PhysioScan Scores, Pulse Rate, and Respiration Rate. The computer will determine their composite stress index and report it to the client with an interpretation.

6. Screen 3; Part 2: At this point all clients will again practice the SCRL Training twice while watching the animation and twice with their eyes closed using the voice file.

7. Screen 4; Part 2. The client then goes to the Stress Monitoring Screen from the PhysioScan Module (please refer to this module for details). They will record measure and record their SUDs score, PhysioScan Scores, Pulse Rate, and Respiration Rate. The computer will determine their composite stress index and report it to the client with an interpretation.

8. Screen 3; Part 2: At this point if the client is relaxed enough they will be informed they can go on to the next part of the session, although it will be suggested they practice the SCRL Training another 2-4 times. If their score is too low, they will be urged to practice another 4 times and take their measures again. Thus, the client would return to screen 3. If the client's score was in the relaxed region, they would practice once with the animation, and once on their own with just the audio file. If the score was low they would have to practice with animation twice, and practice twice with just the audio file and their eyes closed.

9. Screen 4; Part 3: Clients with a low score must also repeat Screen 4.

10. Screen 5. This is the homework assignment screen and it is the last screen of the module. In this screen the client has sever al options to download instructions to practice the exercise before the next online session. They will have the option of downloading the Voice#2 file as a WAV or MP3 file, which are the instructions for the particular behavioral response pattern +the PhysioScan exercise+the Autogenic Training exercise. The client would also have the option of transferring this information to an MP3 player, or a digital or cassette recorder. They will also be able to print out a hard copy of the voice file text. The client will also have to print out a homework record log sheet to keep track of various types of data they will record as they practice during the week These sessions will evolve and diversify with the various protocols and modules we are developing. The data the client records will be input back into the computer at the beginning of the clients next session for processing and the information is used by the protocol to make determinations about the client (e.g., do they need to practice this current behavior response pattern further before they go on to the next step?). This task is accomplished via the homework data collection and processing module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to his or her own home PC.

11. Finally, the client should have access to the particular session they are working whenever they want via the PC and/or Internet. In the case of this module, they may want to see the video/animation of the SCRL Training because they were unsure of some aspect of the behavior.

1. Hands & Arms

Subject begins with palms up on lap. After about 10 sec., the subject slowly and gently begins to make a fist while palms are on the lap. The movement should be slow and easy—a mild tensing effort. This should take about 6 sec. The subject should then slowly and gently begin to raise both the fists to the shoulders, showing how to tense the forearms and biceps. This should also take 6-7 sec. The subject should hold this position for 10 sec. Then the subject slowly begins to return the hands to the lap, taking again about 7 sec. The hands should return to the lap so that the subject will slowly open the hands on the lap, taking 6 sec, so that the palms are facing up. The animation should continue in this resting position for another 45 sec.

2. Shoulders and Face

Subject begins in same position as A. After 10 sec the subject will slowly & gently raise the shoulders toward the head, almost if the client was hunching the shoulders. This movement should take about 7 sec. While the shoulders are raised, the subject should appear to be squinting the eyes, lowering the forehead, and opening the mouth wide. This should take about 6 sec. The subject then holds this shoulder and face position for 10 sec. The subject then “relaxes” the face to the original resting position, and slowly lowers the shoulders to the starting position. This should take about 7 sec. The subject should then be shown in this relaxed position for about 45 sec.

3. Chest, Stomach, and Back

The subject begins in the same position as in A. After 10 sec the subject begins by taking a slow and gentle deep breath, sucking in the stomach and expanding the chest. This should take about 10 sec. Then the subject should be shown slowly and gently arching the back, taking about 6 sec. The subject then holds this position for about 10 sec. Then, the subject begins to slowly straighten the back, and then lower the chest, and then the subject releases the stomach. This part should take about 10 sec. Then the subject is shown in the relaxed position for about 45-sec.

Legs and Feet

The subject begins as in A. The subject then raises the legs straight out and points the toes toward the head while holding the legs straight out. This should take about 12 sec. The subject then holds this position for 10 sec. The subject then relaxes the foot, and slowly and gently returns the legs to the floor. This should take about 10 sec. The subject is then shown in the relaxed position for another 45-sec.

Parallel Behavioral Response Training Module

Progressive Relaxation Training Application 3

Behavioral Response Pattern: Simultaneous & Integrated Productions of all 4 Response Patterns trough Parallel Response Chaining & Linking

Function

Overview

To train individuals in specific behavioral response patterns typically involving some form of motor response pattern. This module is designed to train the client in one simple form a behavioral response that usually will be chained together with other simple responses to form more complex forms of response. In this way we are able to use the behavioral technique of response shaping to develop complex patterns of behavior over the Internet. Thus, by constructing our basic behaviors appropriately we can assure ourselves that the client will have a relatively easy time learning these responses. Then it becomes just a matter of linking these simple behaviors together to build more complex forms of behavior. This is essentially a version of the methodology of training target or goal behaviors through successive approximations. The behavioral sequences are relatively simple and easily master, thus insuring success. In turn, the success at the task functions as one form of rein forcer for the behavior. The reinforcer, in turn, increases the likelihood that the response it follows will recur. This the central principal of operant or instrumental conditioning:

R→S^{R}

A rein forcer is a stimulus that follows a response and increases the probability of the occurrence of that response

Implementation

The behavioral response training modules is intended for the following purposes:

1. Relaxation training using motoric responses like Progressive Relaxation Training

2. Muscle Response Discrimination Training (a technique that has been developed and that is related to PhysioScan)

3. Physical rehabilitation exercises

4. Exercises for physical fitness

5. Sports optimization training

These type of modules are often integrated with a cognitive training module where some form of imagery exercise or attention training is correlated or coupled worth the exercise in the behavioral response training module. These modules will also be interfaced with the physiological monitoring module and the biofeedback training module.

Parameter Matrix Variables

Please note: Models below refer to animations or live movies

1. Specific behavioral response pattern (broken into component parts when necessary)

2. Sex of the animation model

3. Age of the animation model

4. Ethnic/Social background of animation model

5. Measurement of physiological parameters of the response:

a. Microphone based (vocal responses & dynamics)

b. Instrument based

c. Non-instrument based

Module Design

The basic design of the module is such the client is to integrate the 4 behavioral components the client previously learned. It is a modified response chaining procedure. First the client is trained (in the SRCL SubModule) to proceed through the four responses simultaneously, one response pattern followed by another. In this sub-module the client is trained to produce all the response patterns at one time. This is referred to as parallel response chaining and linking.

In general, the procedure is to 1) instruct the client in terms of the behavioral pattern they are requested to learn, 2) to give a demonstration of the behavior pattern through a video or an animation, and 3) to have the client practice and rehearse the behavior pattern after the demonstration. First, the client practices with instructions and the visual display, and then they practice without any prompting. The client has controls available, through AVI or equivalents, for the animation if they encounter a problem and need further prompting. As with learning any behavioral technique, they can seem difficult to the client. Therefore, complex behavior patterns are reduced to their component behaviors, which are usually that easier to master. The client must master one behavior level or activity before going on to the next. The client is also given various ways to monitor their activity. to insure they are performing the behavior pattern correctly. Once the simpler forms of behavior are mastered they are linked or chained together, which is accomplished in this module. This allows for a precision and fine-tuning in learning behavioral responses, particularly when there is no other individual available to monitor the client's activity.

Parallel Response Chaining & Linking

In this module, the client will first learn to simultaneously relax their 1) hands & arms, 2) shoulders & head, chest, 3) stomach & back, 4) legs & feet. This training represents my technique of parallel response chaining & linking (pRCL). pRCL is part of the progressive relaxation training module. pRCL is the second phase in training the client in being able to successfully produce all the response patterns at one time. The goal of this exercise is to train the client to simultaneously produce all four of the behaviors they previously learned and to 1) differentiate between states of tension and relaxation in their entire body, 2) be able to identify the qualitative aspects of these states, and 3) promote and facilitate relaxation in their entire body. The client must produce simultaneously in an integrated fashion each major behavior or response pattern learned in previous modules. For each individual response pattern the client must progressively and gradually clench and release the particular muscle group defined as a behavioral pattern in a systematically timed fashion.

This exercise is associated with the PhysioScan module. Through PhysioScan methodology the client learns

1. To differentiate or discriminate among various levels of muscle tension in each muscle group as it becomes tense in the first phase of the exercise,

2. To identify the qualitative aspects of the physical sensations of tension

3. To differentiate changes in physical sensations as the hands and arms begin to relax, in the second phase of the exercise

4. To identify the qualitative aspects of the physical sensations of relaxation

5. To promote the sensations of relaxation. This may be further enhanced by other techniques in other modules as in the Biofeedback Training Module or the Autogenic Training Module

6. To control attention and focus to internal physiological signals or events (related to the concept of interoception)

Through learning to discriminate their internal feeling states generated by physiological systems and to induce states of relaxation by focused attention procedures and stimulus control techniques (repetitive stimulus techniques, discriminative stimuli, etc.)

Module Implementation: Programming Steps

1. Screen 1. Display text that reinforces and amplifies previous ideas presented concerning relaxation techniques in general and Progressive Relaxation in particular. Describes the course of the Progressive Relaxation training and its component steps.

2. Screen 2. Display text giving general instructions concerning the training to the client. This screen will review how to tense and relax muscles. For example, that it must be done gently, not hard. The client is told that these exercise are not like exercise for physical fitness. They are further informed that these exercises are to help them to become aware of their bodies to differentiate their internal feelings. That this is natural for the mind to do, but that anxiety disrupts this process. Animation/Voice #1: This screen will have an animation illustrating the discussion of the text. Voice: Optimally the text will be presented vocally in sequence with the animation. The client has access to AVI controls to repeat the sequence as often as they wish

3. Screen 3; Part 1. In this screen the client receives training for PRCL Training. First the client will be given Instructions. Text#1: They are presented with instructional text describing the PRCL Training. Voice#1: The will hear voice presentation of Text#1. After client hears/reads instructions, they “click” a button to initiate training animation sequence. Animation/Voice#2. This is an animation of PRCL Training with a correlated audio file generated by the PhysioScan Module. Animation#2. The animation sequence begins with the model sitting in an upright position with the palms of their hands up on their lap. The model then begins to slowly & gently make a fist. After the fist is complete the model slowly brings the hands to the shoulders and holds it in that position for several seconds. At the same time, the animation begins to slowly its their shoulders to its head, while it also lowers (furls) its forehead, squints its eyes, and opens its mouth wide. At the same time, the animation begins to slowly suck in its stomach, raise its chest, and arch its back. At the same time, the animation stretches its legs straight out in front of it, points its toes toward the head & and toward each other, thus showing how to gently tense the leg. After holding this position for all four behavior patterns together for about 7-10 seconds, the model begins to bring the hands slowly back to the lap and returns the hands to their original “relaxed” position. At the same time, it begins to lower its shoulders slowly, while also slowly un-furling its brow, opening its eyes, and closing its mouth, returning all the muscle groups to their original “relaxed” position. The mouth is left slightly open to show the jaw is slightly dropped, and not tense. At the same time, the animation begins to slowly release its stomach lower its chest, and straighten its back, returning all the muscle groups to their original “relaxed” position. At the same time, the animation slowly returns its feet to the floor, to the “relaxed position.” Once all the all the behavioral patterns are at their original start or “relaxed” positions, the model remains that way for one minute while “relaxing with its eyes closed.” After “relaxing with its eyes closed” for approximately 1 minute the animation sequence is ended. Please Note: Since this a long sequence, when the client is first demonstrated the procedure, the one minute relaxation periods will be reduced to 10 seconds. The client will be informed of this, and will be told that during the actual exercise, the relaxation period will be one minute. The animation repeats this sequence 4 times. The animation then stops. Voice#2 (please see below for an example): The vocal sequence for this module is generated via the techniques embedded in the PhysioScan Module and the Autogenic Training Module (please see these modules for details). The vocal sequence correlates with the three components of the behavioral response: tensing, relaxing, relaxation facilitation. The PhysioScan techniques are relevant to phases I & 2 by focusing the client on the salient physiological sensations, on their location, intensity & quality, while autogenic training centers on enhancing relaxation through inducing the relevant sensations and feelings.

4. The client is then given instructions to practice this task twice while watching the animation and listening to the instructions. They must sit upright in their chair, position themselves accordingly, initiate the animation, and practice the behavior. Then the client is given instructions to repeat the task twice again with their eyes closed following the instructions given in a voice file. The client clicks on the voice file, which the client knows will not begin the voice sequence for 30 seconds, sits upright in the chair, positions oneself, closes the eyes, and readies oneself to begin. The voice file begins, and the client practices the response, using the reduction in stimulation produced by the eyes being closed to help the client focus on the internal bodily states.

Note: The client will have access to standard AVI controls to repeat the animations as often as desired in any module. Thus, if the client is uncertain at any point they he/she is still uncertain about some aspect of the response they can “pause” the session and “play” the animation at will.

5. Screen 4; Part 1. The client then goes to the Stress Monitoring Screen from the PhysioScan Module (please refer to this module for details). They will record measure and record their SUDs score, PhysioScan Scores, Pulse Rate, and Respiration Rate. The computer will determine their composite stress index and report it to the client with an interpretation.

6. Screen 3; Part 2: At this point all clients will again practice the PRCL Training twice while watching the animation and twice with their eyes closed using the voice file.

7. Screen 4; Part 2. The client then goes to the Stress Monitoring Screen from the PhysioScan Module (please refer to this module for details). They will record measure and record their SUDs score, PhysioScan Scores, Pulse Rate, and Respiration Rate. The computer will determine their composite stress index and report it to the client with an interpretation.

8. Screen 3; Part 2: At this point if the client is relaxed enough they will be informed they can go on to the next part of the session, although it will be suggested they practice the PRCL Training another 2-4 times. If their score is too low, they will be urged to practice another 4 times and take their measures again. Thus, the client would return to screen 3. If the client's score was in the relaxed region, they would practice once with the animation, and once on their own with just the audio file. If the score was low they would have to practice with animation twice, and practice twice with just the audio file and their eyes closed.

9. Screen 4; Part 3: Clients with a low score must also repeat Screen 4.

10, Screen 5. This is the homework assignment screen and it is the last screen of the module. In this screen the client has sever al options to download instructions to practice the exercise before the next online session. They will have the option of downloading the Voice#2 file as either a WAV o MP3 file, which are the instructions for the particular behavioral response pattern+the PhysioScan exercise+the Autogenic Training exercise. It is assumed that clients have MP3 and WAV file options. They could transfer these files to an MP3 player, digital recorder, or cassette player as well. They will also be able to print out a hard copy of the voice file text. The client will also have to print out a homework record log sheet to keep track of various types of data they will record as they practice during the week. These sessions will evolve and diversify with the various protocols and modules we are developing. The data the client records will be input back into the computer at the beginning of the clients next session for processing and the information is used by the protocol to make determinations about the client (e.g., do they need to practice this current behavior response pattern further before they go on to the next step?). This task is accomplished via the Homework Data Collection & Processing Module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to the home PC.

11. Finally, the client should have access to the particular session they are working whenever they want via the Internet. In the case of this module, they may want to see the video/animation of the PRCL Training because they were unsure of some aspect of the behavior.

Animator Instructions

1. Hands & Arms

Subject begins with palms up on lap. After about 10 sec., the subject slowly and gently begins to make a fist while palms are on the lap. The movement should be slow and easy—a mild tensing effort. This should take about 6 sec. The subject should then slowly & gently begin to raise both the fists to the shoulders, showing how to tense the forearms and biceps. This should also take 6-7 sec. The subject should hold this position for 10 sec. Then the subject slowly begins to return the hands to the lap, taking again about 7 sec. The hands should return to the lap so that the subject will slowly open the hands on the lap, taking 6 sec, so that the palms are facing up. The animation should continue in this resting position for another 45 sec.

2. Shoulders & Face

Subject begins in same position as A. After 10 sec the subject will slowly and gently raise the shoulders toward the head, almost as if the subject is hunching the shoulders. This movement should take about 7 sec. While the shoulders are raised, the subject appears to be squinting the eyes, lowering the forehead, and opening the mouth wide. This should take about 6 sec. The subject then holds this shoulder and face position for 10 sec. The subject then “relaxes” the face to the original resting position, and slowly lowers the shoulders to the starting position. This should take about 7 sec. The subject should then be shown in this relaxed position for about 45 sec.

3. Chest, Stomach, & Back

The subject begins in the same position as in A. After 10 sec the subject begins by taking a slow and gentle deep breath, sucking in the stomach and expanding the chest. This should take about 10 sec. Then the subject should be shown slowly and gently arching the back, taking about 6 sec. The subject then holds this position for about 10 sec. Then the subject begins to slowly straighten the back, and then lower the chest, and then the subject releases the stomach. This part should take about 10 sec. Then the subject is shown in the relaxed position for about 45-sec.

4. Legs & Feet

The subject begins as in A. The subject then raises the legs straight out and points the toes toward the head while holding the legs straight out. This should take about 12 sec. The subject then holds this position for 10 sec. The subject then relaxes the foot, and slowly and gently returns the legs to the floor. This should take about 10 sec. The subject is then shown in the relaxed position for another 45-sec.

Autogenic Training & Meditation Module

Function

The basic function of this module is to provide the user/client with two methods that are, in essence, related relaxation techniques: autogenic training and meditation. Based on response to questionnaires the user initially completed (from the generalized assessment module, the PhysioScan module, and the personal record keeping form) the user be informed as to the likelihood that they will profit from this training. However, the client can still choose the training even if their profile would suggest otherwise. In addition, this module can integrate the auditory and visual stimuli of the audio/visual relaxation module to deepen the relaxation achieved through either autogenic training or meditation.

Many of these exercises utilize the body's capacity to relax when exposed to tranquil images and sounds. While ordinary imagery techniques, which rely on mental imagery, these techniques provide a deeper and richer experience because they can be integrated with external multimedia stimuli that focus attention, enhance relaxation, and deepen motivation. Many individuals have a difficult time using mental images, and frequently people have little or no capacity for mental images. Also mental images are difficult to control and as the mind wanders attention to the image is lost. By providing external images and sounds attention is more easily sustained and the experience becomes deeper. This process also provides a gateway to training the subject to enhancing their mental image and their ability to concentrate on these images. Also, it is relatively easy to compile databases of sounds and visual images to accommodate almost every individual's preference.

From a theoretical perspective, meditative type exercises, of which autogenic training is one, partially achieve their effect by the repetitive quality of these exercises. That is, the exercises described here, often-called mantra meditation have the client repeat over and over essential the same word or phrase. This has the effect of causing a state of lowered anxiety, specifically because the repetitive quality of the stimuli has an effect of producing physiological de-arousal (specifically the sympathetic) nervous system. The primary mechanism for this is habituation wherein physiological responses decrease or habituate with continued exposure. For more complex stimuli, the process of extinction may also be involved, whereby stimuli conditioned to produce a certain effect lose their potency when repetitively presented in the absence of the rein forcer that sustains them. The meditative exercises also gently compels and turning of attention inward with practice, attunes the individual with their bodily sensations. Removing ones focus from the external world of intense stimulation, to a quieter inner world also reduces arousal (a kind of “mini” sensory deprivation, if you will).

Meditation per se involves focusing on a single word or phrase and repeating it slowly and gently over time. The word of phrase may be repeated out loud (albeit softly) or in the mind. The first method is preferable for those individuals who have difficulty concentrating, especially on mental images or thoughts. Usually the technique is coupled with a slow breathing method like diaphragmatic breathing, to help pace the individuals repetition. However, a soft and gentle metronome, timer, or digital timer with a soft tone on the computer would work as well. These techniques are to ensure that the breath is slow, deep, and regular. This helps pace the meditative exercise. In autogenic training, the difference mainly lies in the content of the meditative words and phrases. Like progressive relaxation, the autogenic phrases target specific parts of the body at first. And, again like progressive relaxation, the focus on progressively larger muscle groups until the phrases include the whole body. The autogenic phrases are otherwise repeated in a similar fashion as any other meditative word or phrase in a mantra meditation.

Implementation

The Autogenic Training & Meditation Module is intended for the following purposes:

1. Providing additional relaxation techniques that the client can use in everyday life.

2. Provide techniques to deepen and enhance the relaxation techniques taught in other modules.

3. Provide techniques to enhance relaxation in specific areas of the body.

4. Provide techniques that can be used either separately, or in with relaxation techniques to treat a variety of anxiety and stress conjunction related disorders.

5. Provide alternative relaxation techniques for individuals who are not comfortable with techniques like Progressive Relaxation.

In general the module focuses on learning the following skills:

1. Learning to use imagery and internalized images as a means of relaxation.

2. Learning simple meditative exercises and autogenic phrases to achieve relaxation.

3. Learning to use respiration rate as a means of controlling the meditative process.

4. Learning to integrate meditative exercise with other relaxation techniques, and, in particular, with other imagery techniques.

5. Learning to use autogenic training and meditation in everyday life.

Parameter Matrix Variables

1, Type of meditative technique

2. Type of meditative word or phrase

3. Type of autogenic phrase

4. Sex of the animation model

5. Age of the animation model

6. Ethnic/Social background of animation model

Module Design

Thus module will focus on 1) basic meditative techniques, learning Autogenic Training, 3) using diaphragmatic breathing to pace the meditative and autogenic exercises. This is a two-phase modular design where the client practices certain basic responses, in conjunction with the computer, and then refines their techniques during the second phase of training. Further refinement can occur if the client chooses to practice the homework assignments, and/or continues practice with the program beyond the three-week minimum required for practice with this module. The basic design of the module is such that the client is exposed to a series of cognitive-behavioral exercises in which they are trained in the components of the particular technique. In this case each of the meditative and autogenic exercises are dissected into small, easily learned exercises. The client is shown the behavior they are requested to learn and then they have to repeat it. As with learning many behavioral techniques, they can seem difficult to the client, so when necessary the technique is broken into small component parts that are easy to master. The client must master one level before going on to the next. The client is also given various ways to monitor their activity to insure they are performing correctly. This data is collected in the Personal Record Keeping Form.

The nine major behaviors in this module the client must master are:

1. Learning the basic mantra meditation

2. Using Diaphragmatic Breathing (see Breathing Training Module) to pace meditative exercises

3. Learning basic Autogenic Training

4. Learning specific autogenic phrases

5. Learning to internalize visualization techniques for use in the absence of external stimuli

6. Using meditative exercises to relax

7, Using Autogenic Training to relax

8. Learning to apply autogenic and meditative techniques to everyday life

9, Using PhysioScan techniques and self-report measures to monitor the relaxation process

In the Breathing Training Module the user/client learns the correct form & pattern for diaphragmatic breathing and then they are taught to slow their breathing down by increasing the duration of each breath. This in turn also lowers the over all respiration rate. They also learn to use this low breathing rate as a kind of biological timer to time other events.

Module Implementation: Programming Steps

1. Screen 1. Displays text explaining the values of Meditation or Autogenic Training in achieving relaxation. They text with auditory accompaniment indicates how it will help them to calm their mind, reduce external distractions, and to focus attention.

2. Screen 2. The client is further informed that these exercises, as those in the PhysioScan module, help them to become aware of their bodies in order to differentiate their internal feelings. That this is natural for the mind to do, but that anxiety disrupts this process. The client has access to AVI controls to repeat the sequence as often as they wish.

3. Screen 3. This screen briefly suggests which type of training would seem best suited for the client based on their previous scores in the Assessment Module. The client is given a Menu of 3 choices: 1) Meditation, 2) Autogenic Training, and 3) Other Imagery Exercises (which would return the client to the Audio/Visual relaxation Module, which, as related techniques, might be more appropriate for them). Each button then leads to next Submenu screen.

4. Screen 4. Depending on the client's choice, the they are sent to the specific screen giving a general Overview and Instructions pertaining to the technique they have selected, These instruction s will be presented as a text screen combined with an auditory accompaniment.

A. Meditation A (Text/Voice#1). In this section the client is instructed in a simple form of mantra meditation. In this form of meditation the client/user selects one simple word or phrase like “Relax” or “One” and is instructed to repeat it over and over. In the beginning the client can say the word out loud, but softly. As part of the training, they will have the opportunity to internalize the meditative word or phrase, repeating over in their mind. The client is instructed to first slow their breathing for one minute in the manner taught in the Breathing Module. Then they are then instructed to repeat the phrase out loud each time they exhale (and later in training to repeat it in their mind each time they exhale). They are also instructed that if and when they lose attention to the mantra then they should simply return their attention to it and to continue their paced repetition. The client is told that they will begin with 5-minute training segments (which they can reduce if they find 5 minutes too difficult initially). Eventually they will build up to 20-30 minutes. The client is told to begin with a soft, out loud repetition of the meditative word or phrase. When they are proficient at this task for 20 minutes, then they can begin to try to repeat some of the last minutes of the training segment in their mind and not out loud. The client is also told that once they have advanced in their practice they could combine their meditation with one of the visual, auditory, or combined stimuli mentioned above.

B. Meditation B (Text/Voice #2). In this section the client is introduced to Concentrative Meditation. The client selects from a variety of common objects that will be presented (usually in 3D) on the screen. This could be an image like a flickering flame, or something as simple as a vase. The client is instructed to simply focus on the visualization If their mind wanders, they are told to simply return their focus as soon as they become aware of the fact that they had wandered-off. The training begins with a relatively brief duration of 1-3 minutes, depending on what the client can tolerate, and builds up over sessions to 20-30 minutes. Homework practice can consist of returning to the visualization on the computer or using some real-life object whenever possible. When the client has become proficient, at this task, they are then taught to have the image as a mental image, if at all possible. This would increase its utility in everyday life.

C. Autogenic Training (Text/Voice #3). This exercise is similar to the Meditation Training, except that the client is taught to use phrases that either 1) emphasize inducing relaxation in a specific body region (e.g., “My arms feel warm and heavy”) or 2) inducing general relaxation (e.g., “I am calm,” “I feel relaxed,” or “I feel warms and heavy).) The client is told that they will first be brought through a specified sequence of Autogenic Exercises. The autogenic phrases first focus on specific body parts (similar to those of Progressive Relaxation. Ten the muscle groupings become progressively larger, until the client is repeating the general autogenic phrases cited above. After the competition of the training they are offered the option to return to the Autogenic section at any time and practice specific phrases on their own. The Initially training session can last between 22 to 44 minutes depending if the client wants to go through the sequence once or twice. As the muscle groupings become larger, the training time decreases. The client is also told that once they have advanced in their practice they could combine their Autogenic Training with the stimuli form the Audio/Visual Relaxation Training Module. The client is instructed to first say the autogenic phrases out loud. They are encouraged to trying repeating them only in their mind when they gain proficiency. This internalized response sequence makes the technique more practical in certain situations of everyday life.

5. Screen 5. Screen presents the Personal Record Keeping Form combining cognitive & behavioral self-reports from the initial entries in the Personal Record Keeping Form, the results of the Generalized Assessment Module and portions of the PhysioScan module to assess client's initial (baseline) stress and anxiety response (including Surface Temperature, Respiration Rate, Pulse Rate, SUDs score and anxiety ratings. The client then clicks a button that brings them to Screen 6.

6. Screen 6. In this screen the client receives the particular multimedia experience they selected for Meditative Exercises or Autogenic Training (or alternatively if they selected the button to go to the Audio/Visual Relaxation Module, Imagery Training, Auditory Relaxation, Combined Auditory & Visual, or Guided Imagery (or Meditation or Autogenic Training if they selected that module). They click the Start Button to initiate the experience. Alternatively, if the client wishes they have the option of backing up to the instructions in Screen 4 or going back to generate a new multimedia experience.

7. Screen 6 (continued). In this screen the client will see and/or hear material relevant to the particular training methodology chosen. Note: In many of the exercises the client is required to practice with their eyes closed for a certain period of time. Therefore, in the upper hand right hand corner of the screen is a small digital timer that emits a gentle beep when the appropriate time is ended. Instructions to the client will be presented both textually and vocally. The programming sequences for Meditation and Autogenic Training are presented below.

Meditation A (Mantra Meditation)

1. AV controls allow the client to repeat any aspect of the training screen to refresh, reinforce, or clarify instructions. In this screen the client will be presented with a specific word or brief phrase that they will slowly repeat in their mind every time they exhale. They will be presented with a list of words and phrases from which they will click on one to initially use. The client will also have the option of entering their own word or phrase and recording the phrase vocally, through Microsoft Voice Recorder or a similar program, if they have the appropriate equipment. However, the client will be encouraged to chose one of the presented words or phrases and only use their own after they become proficient at the task. After clicking on the selected word or phrase all remaining stimuli will disappear and the chosen stimulus will appear in the center of the screen.

2. Then the subject will be asked to slow down their breathing to a level established in the baseline PhysioScan session (see above). They will have the option of going to the Breathing Nodule if they need to rehearse the Diaphragmatic Breathing Technique. If their initial level was to fast, the client will be asked to slow their respiration rate slightly. A timer with a gentle metronome sound will appear on the top right corner of the screen to pace the client for 30 seconds. The client will then be instructed to watch the screen as they breath slowly. The timer will disappear after 30 seconds. To demonstrate the process, they will see the meditative word or phrase flash at their breathing rate as they hear the word softly repeated. The demonstration will last about 30-seconds.

3. The client will then be asked to continue their deep breathing. The meditative stimulus will continue to flash at first to help pace the client and ensure a slow breathing rate. The client will then repeat the meditative word or phrase out loud when it appears on the screen. The client will practice this for a 3-minute segment. After the 3-minute practice, there is a 30-second break. They will then practice this cycle 4 times. At this point the first session terminates and the client completes the Personal Record Keeping Screen. The client will also be given their homework assignment (see below

4. In the beginning of the next session the client will complete steps b & c for one cycle. The next 3 practice cycles will have client repeat their meditative word or phrase out loud, but without the pacing of the word on the screen. They will be instructed to keep their breathing slow and deep while saying the meditative word or phrase when they exhale. The timer will appear as a flashing blue light that will set the pace in the second practice cycle. The client will then have 3 more practice cycles without the flashing blue light. At this point the second session terminates and the client completes the Personal Record Keeping Screen. The client will also be given their homework assignment (see below).

5. In the third training session the client will practice by saying their meditative word or phrase out loud for 3 cycles. The client will then be instructed to close their eyes, continue their slow breathing, and repeat their meditative word in their mind with each exhalation (the word or phrase is not said out loud). The client will then asked to practice the technique of repeating their word or phrase in their mind, but with their eyes open. This method will allow the client to ultimately use this technique more practically in everyday life experiences. They will be instructed to maintain their focus on the word or phrase for as long as possible, but gently without effort. The client is told that if their mind wanders, they should return to the image as quickly as possible. They are further told not to worry about this, particularly since this is often a problem in the initial phases of learning meditation. They are also instructed that if an extraneous or intrusive thought just to gently observe it and let it pass through consciousness, and then return to the meditative word or phrase. With practice their ability to extend their ability to pay attention generally improves. At this point the third session terminates and the client completes the Personal Record Keeping Screen. The client will also be given their homework assignment (see below).

6. Note: For the Meditation and Autogenic Training modules, on the Persona Record Keeping Form. The subject has to rate on a 1-10 scale 1) how easy or difficult they felt the exercise was, and 2) to what degree they were able to maintain their focus on the meditative device. Depending on the client's time commitment, they should follow this 3-session protocol with the homework. In subsequent sessions, they will have the option to set the timer to change the 3-minute training periods in order to increase the amount of time for repeating the meditative word or phrase an additional 1-5 minutes. This will depend on how comfortable they feel with the practice and how well they are able to maintain their focus of attention on the meditative device or mantra. This issue will be further clarified by data input from the homework exercises (see below). As meditation is a task that takes time to practice, it usually will not be used as a brief session-terminating exercise. For optimal results, the client should practice with the PC/Online Meditation module 2-3 times a week for each session. As noted below, the client should practice the homework exercises daily. After this 3-week training period, the client should continue with their daily exercises and return to the Meditation Module when they feel they need a “refresher” course or reinforcement.

7. Note: After the first three weeks, the client will have the option to select visual images or auditory stimuli form the Audio/Visual Relaxation Module. These calming background stimuli can enhance the meditative experience. Furthermore, by practicing meditation while watching an animation or movie, the client will learn to use their meditation to relax with their eyes open with other external stimuli. This is an important tool in learning how to relax in everyday life environments. After completing the training screen, the client is returned to the Personal Record Keeping Module, with the additional ratings for the meditation session. The client has the option for terminating the session after each training episode, if they are limited in time. Whenever they exit the session, the client must first complete the Personal Record Keeping Form.

8. Homework: The client is presented with a set of instructions in line with the type of meditative exercise they learned in the session. The client will be informed that they should practice their meditation exercise twice a day, and a minimum of once a day for optimal benefits. They are instructed to set in a comfortable chair and attempt to minimize any potential interruptions (e.g., shut off the phone ringer). The client will have the option of printing out a sheet with instructions as to how to practice their meditation exercise without the use of a computer. In addition, they will have the option of continuing practice by returning to the program or website at any time to practice the online meditative exercise, and use the timer to time their practice periods. They will also be instructed to use a simple egg timer, which they can muffle with a cloth to provide a low-tone indicator when their meditation period is terminated. If the client is in the PC or Online, they then go to the Personal Record Keeping Form that includes Stress Monitoring Screen from the PhysioScan Module (please refer to this module for details). They will record measure and record their SUDs score, self-report data, PhysioScan Scores, Pulse Rate, Surface Temperature and Respiration Rate. In addition, they will complete the additional ratings on the difficulty of the meditative exercise and the degree to which they were able to maintain their focus on the meditative device. If the client is not online, they can use a printed set of instructions from the PhysioScan module and a set of forms so they can collect this data in written form. (A sample report is printed below). The PhysioScan techniques are also relevant to Meditation Training by focusing the client on the salient physiological sensations, on their bodily location, intensity & quality, and by helping the client note what changes occur internally when the client relaxes. The client will input the data collected during the homework exercises into the computer during the next training session to inform the program as to what parameters to set in that session. The homework data, with that collected during sessions, will help determine what modifications are needed to make the technique more successful. Alternatively this information may be used to suggest a technique more appropriate for the client. The computer will determine their composite stress index and meditation index and report it to the client with an interpretation, and with further suggestions if necessary.

Meditation B (Concentrative Meditation)

1. AV controls will allow the client to repeat any aspect of the training screen to refresh, reinforce, or clarify instructions. In this screen the client will be presented with a specific image they will use as the focus of their meditation. The client will be presented with a list of images from which they will click on one to initially use. The client will also have the option of scanning in entering their own image if they have the appropriate equipment. However, the client will be encouraged to chose one of the presented images and only use their own after they become proficient at the task. After clicking on the selected image all remaining stimuli will disappear and the chosen stimulus will appear in the center of the screen.

2. Then the subject will be asked to slow down their breathing to a level established in the baseline PhysioScan session (see above). They will have the option of going to the Breathing Nodule if they need to rehearse the Diaphragmatic Breathing Technique. If their initial level was to fast, the client will be asked to slow their respiration rate slightly. A timer with a gentle metronome sound will appear on the top right corner of the screen to pace the client for 30 seconds. The client will then be instructed to watch the screen as they breath slowly. The timer will disappear after 30 seconds. To demonstrate the process, they will see an animation/movie of someone focusing their attention on the meditative image as they breath slowly and deeply. Gently flowing lines will reinforce the cycle of attention: attention to the object, and information about the object brought back to the person. The client is told simply to focus on the image, but without effort. The client is further instructed to gently concentrate and pay attention. If their mind wanders, once they become aware of it they are to regain their focus. They are told that particularly in the beginning, people have a difficulty concentrating. With practice, this usually improves. The demonstration will last about 30-seconds.

3. The client will then be asked to continue their deep breathing. The meditative stimulus will remain on the screen. The client will practice a 3-minute concentration segment, after which there is a 30-second break. They will then practice this cycle 6 times. At this point the first session terminates and the client completes the Personal Record Keeping Screen. The client will also be given their homework assignment (see below).

4. In the beginning of the next session the client will complete steps b & c for two cycles. The client will be required to increase their focus time to 6-minutes. The third practice cycle will have client attempt to image their meditative image with their eyes closed. They will be instructed to keep their breathing slow and deep while maintaining their concentration on the meditative image for as long as possible. The imaginal segments, at this point will be for only 3-minutes. An onscreen timer will sound a soft tone at the end of the 3-minute segment The client will then have 3 more practice cycles alternating viewing the actual image and an imaginal one. At this point the second session terminates and the client completes the Personal Record Keeping Screen. The client will also be given their homework assignment (see below).

5. The client will have the option through an onscreen control to reduce their concentration time if they find it too difficult, and increase it when they feel they are ready.

6. In the third training session the client will practice by viewing their meditative image for 9 minutes, and viewing the imaginal image for 6-minutes. The client should do this for 3 cycles if possible. If the client's time is limited they should be encouraged o complete at least 2 cycles and then repeat this session one more time before terminating.

7. When possible, the client should be encouraged to repeat the last session one more time with their eyes open during the imaginal phase. This method will allow the client to ultimately use this technique more practically in everyday life experiences. They will be instructed to maintain their focus on the image for as long as possible, but gently without effort. The client is told that if their mind wanders, they should return to the image as quickly as possible. They are further told not to worry about this, particularly since this is often a problem in the initial phases of learning meditation. They are also instructed that if an extraneous or intrusive thought just to gently observe it and let it pass through consciousness, and then return to the meditative word or phrase. With practice their ability to extend their ability to pay attention generally improves. At this point the third session terminates and the client completes the Personal Record Keeping Screen. The client will also be given their homework assignment (see below).

8. For the Meditation and Autogenic Training modules, on the Personal Record Keeping Form. The subject will have to rate on a 1-10 scale 1) how easy or difficult they felt the exercise was, and 2) to what degree they were able to maintain their focus on the meditative device. Depending on the client's time commitment, they should follow this 3to 4 session protocol with the homework. In each session, they will have the option to set the timer to change the training intervals in order to increase or decrease the amount of time for repeating the meditative image within a 1-5 minutes range. This will depend on how comfortable they feel with the practice and how well they are able to maintain their focus of attention on the meditative image. This issue will be further clarified by data input from the homework exercises (see below). As meditation is a task that takes time to practice, it usually will not be used as a brief session-terminating exercise. For optimal results, the client should practice with the PC/Online Meditation module 2-3 times a week for each session. As noted below, the client should practice the homework exercises daily. After this 3 to 4 week training period, the client should continue with their daily exercises and return to the Meditation Module when they feel they need a “refresher” course or reinforcement.

9. After the first three weeks, the client will have the option to select visual images or auditory stimuli form the Audio/Visual Relaxation Module. These calming background stimuli can enhance the meditative experience. Furthermore, by practicing meditation while watching an animation or movie, the client will learn to use their meditation to relax with their eyes open with other external stimuli. This is an important tool in learning how to relax in everyday life environments. After completing the training screen, the client is returned to the Personal Record Keeping Module, with the additional ratings for the meditation session. The client has the option for terminating the session after each training episode, if they are limited in time. Whenever they exit the session, the client must first complete the Personal Record Keeping Form.

10. Homework: The client is presented with a set of instructions in line with the type of meditative exercise they learned in the session. The client will be informed that they should practice their meditation exercise twice a day, and a minimum of once a day for optimal benefits. They are instructed to set in a comfortable chair and attempt to minimize any potential interruptions (e.g., shut off the phone ringer). The client will have the option of printing out a sheet with instructions as to how to practice their meditation exercise without the use of a computer. For example, they will be instructed to take a real world object similar to the one they used on the computer as the meditative device. In addition, they will have the option of continuing practice by returning to the program or website at any time to practice the online meditative exercise, and use the timer to time their practice periods. They will also be instructed to use a simple egg timer, which they can muffle with a cloth to provide a low-tone indicator when their meditation period is terminated. If the client is in the PC or Online, they then go to the Personal Record Keeping Form that includes Stress Monitoring Screen from the PhysioScan Module (please refer to this module for details). They will record measure and record their SUDs score, self-report data, PhysioScan Scores, Pulse Rate, Surface Temperature and Respiration Rate. In addition, they will complete the additional ratings on the difficulty of the meditative exercise and the degree to which they were able to maintain their focus on the meditative device. If the client is not online, they can use a printed set of instructions from the PhysioScan module and a set of forms so they can collect this data in written form. (A sample report is printed below). The PhysioScan techniques are also relevant to Meditation Training by focusing the client on the salient physiological sensations, on their bodily location, intensity & quality, and by helping the client note what changes occur internally when the client relaxes. The client will input the data collected during the homework exercises into the computer during the next training session to inform the program as to what parameters to set in that session. The homework data, with that collected during sessions, will help determine what modifications are needed to make the technique more successful. Alternatively this information may be used to suggest a technique more appropriate for the client. The computer will determine their composite stress index and meditation index and report it to the client with an interpretation, and with further suggestions if necessary.

Autogenic Training

1. The Autogenic Module is identical to the Meditation Module except for the nature of the meditative word or phrase and some technical changes in the sequencing of events. There are two phases in Autogenic training. In the first phase (see below) they will be presented with a list of 16 phrases (see below) that focus on various body parts. They will be instructed to repeat these phrases in a similar manner to the Meditation Training, with some procedural modifications. These phrases are intended to relax each of the body parts, just as the various exercises in Progressive Relaxation relax different body parts. Once the client is successful in relaxing each of the 16 body areas, they learn to relax larger body areas; only they have to repeat 8 phrases (see below) that focus on larger body areas. Subsequent to this they then focus on phrases that concentrate on 4 major body areas (see below). In this manner they learn to relax larger areas of the body rapidly and efficiently. It should be noted that if this sequence is to arduous it is possible to truncate it in a way that the client will still be motivated to learn the technique and s till profit from the training, For example the modular design of the system would easily allow for an 8-4-2 sequence as well. In the description below the prototypical case will be the 16-8-4 sequences.

2. In Autogenic Training relaxation is accomplished by using relaxation-inducing cognitions coupled with meditative procedure to accomplish this task. Theoretically, this is understood in two ways. The first is the known influence that cognitions can have on physiological arousal. Maladaptive, negative thoughts induce anxiety. Pleasant, adaptive images induce states of low arousal. If the individual is already anxious, it is harder for them to maintain these positive images. Thus, the client begins slowly, and with continued practice builds the positive valence to the extent that they can counteract the negative, anxiety inducing thoughts. In addition, the meditative component, with its emphasis on slow repetitive stimulus presentation facilitates relaxation by decreasing sympathetic nervous system arousal. This is a well documented finding that continuous or repetitive stimuli have the effect of decreasing physiological arousal, thereby enhancing relaxation.

3. When the client has successfully learned to relax at least 4 major body areas, they are ready for Phase 2 of Autogenic Training. In this second phase the client is presented with more general phrases that they begin to repeat after they are able to relax each body part relatively easily. Thus, they learn to induce total mind and body relaxation quickly and efficiently. Through this means they now have another effective tool to rapidly relax when necessary in anxiety provoking situations of everyday life. In the Autogenic Training screen the client will be presented with a series of specific phrases that they will slowly repeat in their mind every time they exhale. They will be presented with a specific list of phrases (e.g., “My arms feel warm and heavy”). After the client has completed their training they will also have the option of entering their own word or phrase and recording the phrase vocally, through Microsoft Voice recorder or a similar program, if they have the appropriate equipment. This will allow them to incorporate phrases and ideas that they feel might further their relaxation and will also facilitate their involvement with the process and enhance their motivation. However, the client will first have to complete the prescribed sequence before they can experiment with their own material.

4. To begin, the client will first be instructed to slow down their breathing to a level established in the baseline PhysioScan session (see above). If this level was to fast, the client will be asked to slow their respiration rate slightly. The client will then be instructed to watch the screen as they breath slowly. To demonstrate the process, they will see an autogenic phrase flash slowly on the at their breathing rate as they hear the word softly repeated. The demonstration will last about 30-seconds. They client will then be asked to continue their deep breathing. A timer above the autogenic phrase and a low volume repetitive tone will be played to ensure a slow breathing rate. After 1 minute of eyes open breathing practice the client will be asked to close their eyes and practice slow breathing, with pacing by the tone. In the third minute they will be instructed to continue deep breathing with out any pacing device. In the fourth minute they will be asked to begin to repeat the autogenic phrase in their mind, each time they exhale. They will be instructed to maintain their focus on the word or phrase for as long as possible, but gently without effort.

5. The client is told that if their mind wanders, they should return to the image as quickly as possible. They are further told not to worry about this, particularly since this is often a problem in the initial phases of learning meditation. They are also instructed that if an extraneous or intrusive thought just to gently observe it and let it pass through consciousness, and then return to the meditative word or phrase. With practice their ability to extend their ability to pay attention generally improves. They will be instructed to practice the meditative word or phrase for 3 minutes. The timer described above will indicate the end of the practice period. After a 30-second break they be presented with the next autogenic phrase on the screen with vocal accompaniment. They will be asked to close their eyes, re-establish their slow breathing pattern, and practice the autogenic phrase for another 3-minutes. This cycle will continue until all 16-body parts are completed. As this is an arduous task, the initial training segment will be broken down into four sessions where the client will complete 4 body areas at a time.

6. After each training segment, as well as before and after the session, the client completes the Personal Record Keeping Form assessment tool. For Autogenic Training there will be additional autogenic report forms assessing the degree to which the client felt each of the body areas of that session were relaxed. If there is an indication that further training in a particular area, the client can chose to continue with that area in the current session, or wait until the next session. Once the client is successful at relaxing the first 4 areas, they can continue with the next 4on a subsequent session, and continue in this way until all 16 body areas have achieved an adequate degree of relaxation. The client then enters the second phase where they are presented with autogenic phrases for 8 body areas. This can generally be accomplished in 1 or 2 sessions.

7. After each session the client must, in particular, complete the PhysioScan Stress Assessment with the additional ratings for the specific body areas trained in that session (which will be incorporated into the client's Personal Record Keeping Form) if they chose this technique. They must achieve an appropriate level of relaxation for most body regions before they go to Phase 3.\

8. In Phase 3 they learn to relax 4 major body areas through appropriate autogenic phrases (see below). Once they have demonstrated a sufficient level of relaxation in these areas though data in the Personal Record Keeping Form for the 4 body areas of Phase 3 they are ready to enter phase 4 In phase 4, as inn Phases 1-3, the client first is presented with the respiration rate timing screen to slow down tier breathing. Then they are presented with the 4 autogenic phrases of stage 3, which they repeat for 1-minute each. They are then presented with several general phrases that are intended to induce total body relaxation. (e.g., “I am clam”, “I feel warm and heavy”). In initially these phrases are presented after the first 4 phrases to associate them with deep relaxation.

9. After 2 sessions, unless the results of the Personal Record Keeping Form and the PhysioScan assessment indicate otherwise, they can practice these general phrases on their own. They should continue using the PC/Online program for at least 1 to 2 weeks depending on their session results and homework data. After this period they can continue the training on their own.

10. In addition to the regular Personal Record Keeping Form and PhysioScan self-report assessments, the subject will have to rate on a 1-10 scale 1) how easy or difficult they felt the exercise was, and 2) to what degree they were able to maintain their focus on the meditative device. The Autogenic Training Module is designed so that adjustments in the parameter matrix can decrease the training intervals for clients with less time. There are appropriate indicators suggesting that a mire-dedicated adherence to the program have a chance of producing better results. However, it should be noted that clinical experience indicates that abbreviated autogenic training also can be beneficial to the client. This issue will be further clarified by data input from the homework exercises (see below). As meditative tasks like Autogenic Training are tasks that take time to practice, it usually will not be used as a brief session-terminating exercise. For optimal results, the client should practice with the PC/Online Autogenic Training module 2-3 times a week until the data indicate sufficient capacity for the client to continue on their own. As noted below, the client should practice the homework exercises daily.

11. After the client completes the PC/Online training the client should continue with their daily exercises and return to the Autogenic Training Module when they need a “refresher” course or reinforcement. In addition, after the programmatic training period is ended, the client will have the option to select visual images or auditory stimuli form the Imagery and Music Modules to combine with repeating their autogenic phrases. These calming background stimuli can enhance the relaxation engendered by Autogenic Training. Furthermore, by practicing the Autogenic Phrases while watching an animation or movie, or listening to some form of auditory stimuli, the client will learn to use their autogenic techniques to relax with their eyes open and when there are other forms of environmental; stimuli present. This is an important tool in learning how to relax in everyday life environments.

12. After completing each training screen, the client is returned to the Personal Record Keeping Form to complete, including a final PhysioScan assessment, with the additional ratings for the autogenic training session. The client has the option for terminating the session after each training episode, if they are limited in time. They first must complete the PhysioScan Module before exiting the program. The program will allow for the option of resuming where the client left off.

13. Homework: The client will be informed that they should practice their autogenic phrases twice a day, and a minimum of once a day for optimal benefits. They are instructed to sit in a comfortable chair and attempt to minimize any potential interruptions (e.g., shut off the phone ringer). The client will have the option of printing out a sheet with instructions as to how to practice their autogenic phrase exercise without the use of a computer. In addition, they will have the option of downloading WAV files or MP3 files with instructions and the autogenic phrases, as will as soft auditory signals that will indicate the time intervals that will alert the client when to change to the next autogenic phrase through a soft auditory signal. They will also have the option of continuing practice by returning to the program or website at any time to practice the online autogenic exercises, and use the timer in the program to time their practice periods. They will also be instructed to use a simple egg timer, which they can muffle with a cloth to provide a low-tone indicator when their they have achieved the appropriate time for each autogenic phrase. With time, most clients begin to internalize the appropriate level of timing so they would not be continuously dependent on the timer. If the client is on the PC or online, then they go to the Stress Monitoring Screen from the PhysioScan Module (please refer to this module for details). They will record measure and record their SUDs score, self-report data, PhysioScan Scores, Pulse Rate, Surface Temperature and Respiration Rate. In addition, they will complete the additional ratings on the difficulty of the autogenic exercises and the degree to which they were able to maintain their focus on the on the autogenic phrases. If the client is not online, they can use a printed set of instructions from the PhysioScan module and a set of forms so they can collect this data in written form. (A sample report is printed below). The PhysioScan techniques are also relevant to Autogenic Training by focusing the client on the salient physiological sensations, on their bodily location, intensity & quality, and by helping the client note what changes occur internally when the client relaxes. The client will input the data collected during the homework exercises into the computer during the next training session to inform the program as to what parameters to set in that session. The homework data, with that collected during sessions, will help determine what modifications are needed to make the technique more successful. Alternatively this information may be used to suggest a technique more appropriate for the client. The computer will determine their composite stress index and meditation index and report it to the client with an interpretation, and with further suggestions if necessary

Technical Specifications

1. The client will have access to standard AVI controls to repeat the animations and auditory sequences in applicable screens as often as desired in any module. Thus, if the client is uncertain at any point they he/she is still uncertain about some aspect of the response they can “pause” the session and “play” the animation at will.

2. The client will also have continuous access to the program wither on the PC or online. Thus, if they need further clarification of a point, or want to see an animation again, or upgrade their stress profile, they will be able to do so whenever they desire.

2. Homework instructions are generally provided 1) as a hard copy printout, 2) as a WAV file download, or 3) as a an MP3 file download. When necessary, if an animation or movie needs to be download it will be provided in a variety of options selectable by the client, generally these will be formats that can be used in Microsoft Media Player, Real Player, or QuickTime formats. If the file is exceptionally large, they client will have the option of requesting a CD at minimal or no cost

3. The client will be able to print out a hard copy of the voice file. The hard copy will typically include other information, such as log sheet to keep track of various types of data they will record as they practice during the week. The Data Log module provides the instructions and forms for these printouts and downloads. These forms can be completed online or on a printed sheet. When the client records the information on a printed sheet, they will be able to enter the data in the data log module when the return to their current session. The PhysioScan Module and Personal Record Keeping Form are tightly integrated to provide an overall stress index for the client, to pinpoint specific areas of concern that need further work, and to print reports for the client concerning their progress in the program. The client records, typically records their data 1) before a session, a specific points during the session when necessary, 3) at the end of the session, and before and after homework assignments. This allows for a highly interactive approach to the programs responsiveness to the clients needs, thus providing an efficient, adaptive, and effective program. Furthermore, this insures the training will evolve and diversify with the various protocols and modules,

4. The data the client records will be input back into the computer at the beginning of the clients next session for processing and the information is used by the protocol to make determinations about the client (e.g., do they need to practice this current behavior response pattern further before they go on to the next step?). This task is accomplished via the Data Collection & Processing Module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to the home PC.

Audio/Visual Relaxation Module

Function

The basic function of this module is to provide the user/client with relaxing images, animation, movies, and music to facilitate relaxation. In addition, there is the option to provide relaxing music to further facilitate relaxation. The user/client will be able to select from a variety o visual and auditory stimulate which will facilitate relaxation. Based on response to questionnaires the user initially completed the user will also be suggested as too which of the stimuli they should start with that would most suit their needs. For example, those individuals who score on the Absorption Index would most profit from images like sunsets and forests which would enhance their ability to internalize their. Those who score low on the index would more likely profit from certain forms of music, repetitive auditory stimulation, or nature sounds because these sounds act as a focal referent for attention. In addition, this module integrates the auditory and visual stimuli with instructions for either deepening relaxation through these stimuli. In addition, these stimuli can also be integrated with instructions for meditative type of exercises that also deepen relaxation.

Many of these exercises utilize the body's capacity to relax when exposed to tranquil images and sounds. While ordinary imagery techniques that rely on mental imagery, these techniques provide a deeper and richer experience. Many individuals have a difficult time using mental images, and frequently people have little or no capacity for mental images. Also mental images are difficult to control and as the mind wanders attention to the image is lost. By providing external images and sounds attention is more easily sustained and the experience becomes deeper. Also, it is relatively easy to compile a database of sounds and visual images to accommodate almost every individual's preference.

Implementation

The Audio/Visual Relaxation Module is intended for the following purposes:

1. Providing additional relaxation techniques that eh user/client can use in everyday life.

2. Provide techniques to deepen and enhance the relaxation techniques taught in other modules.

3. Provide techniques to enhance relaxation in specific areas of the body.

4. Provide brief transitional exercises subsequent to the main training in other modules

In general the module focuses on several cognitions and behaviors:

1. Learning to use imagery and internalize images as a means of relaxation.

2. Learning simple meditative exercises to achieve relaxation.

3. Learning to use respiration rate as a means of controlling the meditative process.

4. Learning to integrate meditative exercise with other relaxation techniques.

5. Learning to use imagery and meditative exercises in everyday life.

Parameter Matrix Variables

Please note: Models below refer to animations or live movies with human models

1. Type of visual image (e.g., running river, sunset, forest scene)

2. Type of auditory stimulation or music (e.g., the repetitive sound of rain, baroque music, country music, the sounds of a heart beating)

3. Toe of meditative technique and/or meditative phrase employed

4. Sex of the animation model

5. Age of the animation model

6. Ethnic/Social background of animation model

Module Design

Thus module will focus on 1) visual relaxation images, movies, & animations 2) relaxing music and sounds, and 3) combined auditory and visual relaxation images. These multimedia stimuli can be used independently as a relaxation technique where thee client can experience the stimuli and let their mind “wander off and relax. This module can also provide background multimedia stimuli against which to practice other exercises. In addition, this module provides several guided images where the client can experience soothing and relaxing sounds and images while they can either read and/or scripts that facilitate relaxation. The module is so designed that one of its parameters allows for the addition of scripts for the guided image exercises.

The four major behaviors in this module the client must master are:

1. Utilizing images and sounds to relax

2. Learning to internalize visualization techniques for use in the absence of external stimuli

3. Learning to relax during guided images

4. learning to apply these techniques to everyday life

5. Learning to monitor stress & relaxation by integrating PhysioScan techniques and self-report measures to monitor the relaxation process

Module Implementation: Programming Steps

1. Screen 1. Displays text explaining the values of imagery, auditory stimulation, or guided imagery in achieving relaxation. They text with auditory accompaniment indicates how it will help them to calm their mind, reduce external distractions, and to focus attention.

2. Screen 2. They are further informed that these exercises, as those in the PhysioScan module, help them to become aware of their bodies to differentiate their internal feelings. That this is natural for the mind to do, but that anxiety disrupts this process. The client has access to AVI controls to repeat the sequence as often as they wish.

2. Screen 3. This screen briefly suggests which type of training would seem best suited for the client based on their previous scores in the Assessment Module. The client is given a Menu of 5 choices: 1) Visual Relaxation, 2) Auditory Relaxation, 3) Combined Auditory & Visual Relaxation 4) Guided Imagery, buttons to the Meditation and Autogenic Training Module since these are very related techniques. Each button then leads to next Submenu screen.

4. Screen 4. Depending on the client's choice, the they are sent to the specific screen giving a general Overview and Instructions pertaining to the technique they have selected, These instruction s will be presented as a text screen combined with an auditory accompaniment.

A. Visual Imagery (Text/Voice#2): The client/user is offered a variety of AVI animations or movies that have shown to have a calming and relaxing effects such as sunsets, rivers flowing, and forest scenes. These choices the options controlled generally by the user, unless specified by the program manager for some specified reason. The client is told that they are to recline in their chair and just let their mind flow onto the image much as if they were watching a movie or reading a fascinating book.

B. Auditory Stimuli (Text/Voice#3): The client/user is offered a variety of WAV or MP3 file selections that have calming and relaxing effects such as Baroque music, soft country music, or classical music. In addition, a variety of nature sounds will be offered that have calming effects, like the sound of rain, or waves on the beach. In particular, the nature sounds will have a variety of options with a repetitive quality to calm the nervous system through the effect of rhythmic stimulation on the nervous system (e.g., pouring rain, gentle wind, a flowing river). These choices the options controlled generally by the user, unless specified by the program manager for some specified reason. The client is told that they are to recline in their chair and just let their mind flow into the sound or music much as if they were listening to a favorite piece of music or just enjoying the patter of the rain.

C. Combined Auditory and Visual Stimuli (Text/Voice#4). This section offers the client/user a variety of combinations of the stimuli offered in A & B, unless restricted by the program manger for some specified reason.

5. Screen 5. Screen presents the Personal Record Keeping Form combining cognitive & behavioral self-reports from the initial entries in the Personal Record Keeping, Form, the results of the Generalized Assessment Module and portions of the PhysioScan module to assess client's initial (baseline) stress and anxiety response (including Surface Temperature, Respiration Rate, Pulse Rate, SUDs score and anxiety ratings. The client then clicks a button that brings them to Screen 6.

6. Screen 6. [NOTE: PLEASE SEE ANIMATORS INSTRUCTIONS AND VOICE FILES FOR GREATER DETAILS] In this screen the client receives the particular multimedia experience they selected for Imagery Training, Auditory Relaxation, Combined Auditory & Visual, or Guided Imagery (or Meditation or Autogenic Training if they selected that module). They click the Start Button to initiate the experience. Alternatively, if the client wishes they have the option of backing up to the instructions in Screen 4 or going back to generate a new multimedia experience.

7. Screen 6 (continued). In this screen the client will see and/or hear material relevant to the particular training methodology chosen. Note: In many of the exercises the client is required to practice with their eyes closed for a certain period of time. Therefore, in the upper hand right hand corner of the screen is a small digital timer that emits a gentle beep when the appropriate time is ended. Instructions to the client will be presented both textually and vocally.

A, Visual Imagery In this screen the client will be presented with the relaxing image, animation or movie for initial 5 minutes. If this image is used for the final phase of another training session the module will terminate at this point. For example, it is used often as final relaxation segment at the end of many training modules. If the imagery experience itself is used as a training technique the module will continue. After a 30 second break the client will be told the image will recur for another 5 minutes. After another 30-second break the client will receive 2 further 7-minute segments, punctuated by a 30 second breaks. Screen 7: The client is then asked to close their eyes and instructed to try image the scene they just experienced for a period of 2 minutes. They are instructed to keep their attention on the image for as long as possible,. If their mind wanders, they are told to return to the image as quickly as possible. They are instructed not to worry about their mind wandering, as this is often common in the beginning of this type of experience. With practice their ability to extend their ability to pay attention generally improves. After completing the training screen, the client is returned to the Personal Record Keeping Form for a final assessment. The client has the option for terminating the session after each training episode if they are limited in time. They first must complete the Personal Record Keeping Form before exiting the program. In subsequent sessions they will be asked to experience the scenes for longer intervals, with the number and/or duration of the multimedia stimulus presentations truncated. They will also be asked to expand the time they are imaging the scene with eyes closed. This experience gives the client the opportunity to practice using the technique so they can use it when a computer CD or Internet access is not available, or when they need to relax outside the home or office. When the results indicated by the Personal Record Keeping Form show that they have become proficient at internalizing the image, they are asked to use some practice periods online and during homework with eyes open. This makes the technique even more practical, as it broadens its applicability to every day life. The exact progress in this regard depends on the degree of relaxation achieved in the Personal Record Keeping form and the analysis provided by the Report and Form Module. Homework: The client will have the option of printing out a sheet with instructions as to how to practice their imagery exercise without the use of a computer. In addition, they will have the option of continuing practice by returning to the program or website at any tome to practice the online imagery exercises. If the client is in the PC or Online, they then also compete the Personal Record Keeping Form online. They will measure and record their SUDs score, PhysioScan Scores, Pulse Rate, Surface Temperature and Respiration Rate. If the client is not online, they can use a printed set of instructions and forms from the Report & Report Generator Module so they can collect this data and input it into the computer at the beginning of the next session (a sample report is printed below). The PhysioScan techniques are relevant to Imagery training by focusing the client on salient physiological sensations, and on their location, intensity & quality. This helps the client to identify the changes occur internally when they are tensed or relaxed. This becomes a practical, everyday life tool to help the client monitor their anxiety and stress levels so they can make appropriate and timely interventions before their stress accumulates to serious proportions. If they do not achieve an appropriate degree of relaxation using the imagery techniques (as indicated by their results) this might suggest changing the quality of the multimedia experience or even changing the technique itself. Furthermore, the computer will determine their composite stress index and report it to the client with an interpretation, The client will input the information he/she gathers in subsequent homework in the next training session to facilitate the programs decisions in terms of continuing the course of training or changing it.

B. Auditory Training. The procedure for auditory training is identical to Visual Training except the client hears the sound or music while the computer screen remains blank, homework. For auditory training requires the subject to download either a WAV or an MP3 file for homework practice. As with the visual technique, they should practice in the points allocated above for training to recall the sound or music in their minds eye to see if they can retains, with clarity, the sounds presented. As with the Visual Training, they can return to the program to rehearse and practice their technique. They should try to practice the sounds without the external distracting sounds of everyday life. They should practice in a quiet environment, and use inexpensive ear plugs if necessary. They also need to complete the Personal Record Keeping Form to monitor and assess the efficacy of this technique, and to determine if another technique may be more beneficial.

C. Combined Visual & Auditory Training. The procedure for this training is identical to A & B above, except that both the auditory and visual stimuli are being presented together. During the period the client is asked to practice with their eyes closed, they are instructed to first practice the imagery alone for 2 minutes, the auditory stimulus for 2 minutes, and then the auditory-visual stimulus combined for 2 minutes.

D. Guided Imagery. During of the multimedia experience provided by the images, animations, movies, music, and sounds the client will also have option of selecting a guided image, which can be presented textually and/or aurally. These scripts guide the client to focus on certain thoughts and images that facilitate relaxation. In addition, specific scripts can be created by the client or by other processional for specific purposes. Each script can be presented against any combination of available multimedia stimuli. The most useful way is have, at a minimum, the scripts reading a low, soothing, slow voice. The voice and be mixed with music or other sounds to enhance the experience. For the scripts accompanying the system the program will suggest a multimedia background suited for the particular script.

E. Background Setting. It should be noted that many of the multimedia experiences in the Audio/Visual Relaxation Module could also be used as backgrounds against which to practice other relaxation exercises. It is often the case that other exercises integrated with relaxing visual and auditory stimuli are enhanced by the integration with these multimedia stimuli.

Technical Specifications

1. The client will have access to standard AVI controls to repeat the animations and auditory sequences in applicable screens as often as desired in any module. Thus, if the client is uncertain at any point they he/she is still uncertain about some aspect of the response they can “pause” the session and “play” the animation at will.

2. The client will also have access, at any time they desire, to the program whether on the PC or online, Thus, if they need further clarification of a point, or want to see an animation again, or upgrade their stress profile, they will be able to do so whenever they desire.

2. Homework instructions are general provided through al) a hard copy print out, ) as a WAV file download, or as a MP3 file download. When necessary, if an animation or movie needs to be download it will be provided in a variety of options selectable by the client, generally these will be formats that can be used in Microsoft Medias Player Real Player, or QuickTime formats. If the file is exceptionally large, they client will have the option of requesting a CD at minimal or no cost

3. The client will be able to print out a hard copy of the voice file. The hard copy will typically include other information, such as log sheet to keep track of various types of data they will record as they practice during the week. The Data Log module provides the instructions and forms for these printouts and downloads. These forms can be completed online or on a printed sheet. When the client records the information on a printed sheet, they will be able to enter the data in the data log module when the return to their current session. The PhysioScan Module and Personal Record Keeping Form are tightly integrated to provide an overall stress index for the client, to pinpoint specific areas of concern that need further work, and to print reports for the client concerning their progress in the program. The client records, typically records their data 1) before a session, a specific points during the session when necessary, 3) at the end of the session, and before and after homework assignments. This allows for a highly interactive approach to the programs responsiveness to the clients needs, thus providing an efficient, adaptive, and effective program. Furthermore, this insures the training will evolve and diversify with the various protocols and modules,

4. The data the client records will be input into the computer at the beginning of the clients next session for processing and the information is used by the protocol to make determinations about the client (e.g., do they need to practice this current behavior response pattern further before they go on to the next step?). This task is accomplished via the Data Collection & Processing Module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to the own home PC.

Systematic Desensitization Module

Function

The Systematic Desensitization Module (DSM) is designed to allow clients who have successfully learned how to relax rapidly by the method of Cued Recall to use their relaxation training to minimize anxiety or stress they have to specific external stimuli. For example, this technique could be useful for an individual who has a phobia of crossing bridges to minimize or eliminate their fear. The method is based on the concept of exposing the client to a set of stimuli form a “behavioral hierarchy” beginning with stimuli that provoke relatively mild anxiety and end with the target goal, like crossing the bridge. The behavioral hierarchy represents a chain of stimuli that are in some fashion linked to the end goal. The beginning stimuli elicit relatively mild anxiety. The client is taught to learn to relax in the presence of this mild anxiety until such time they feel their anxiety has reached a very low level on their anxiety rating indices. Once this step has been accomplished the client goes to the next stimulus, which elicits a slightly higher level of anxiety. Again, after successfully learning to relax at this level the client then goes on to the next step. Thus, the client learns to overcome their specific fear through systematically and progressively presenting the client with a graded set of stimuli that allows them to learn to relax from minimally anxiety provoking anxiety to the target goal. The method of systematic desensitization provides a tool that allows the client to use their relaxation techniques not only as a generalized way to minimize anxiety and stress, but also as a specific tool to overcome particularly difficult anxiety issues. The success of the technique centers on the client learning to use their relaxation skills to overcome a degree of anxiety of anxiety at any given step in the behavioral hierarchy that is relatively easy to manage. And they can only continue to the next level when they have mastered the current s level. Thus, they progressively reach the goal without having to bear an excessive level of anxiety at any given instance. FIG. 8 illustrates the method of the systematic desensitization module. First, maladaptive thinking patterns are identified (802) and preliminary parameters are set for client based on initial assessment (804). Next, the client is put through a set of relaxation training exercises. Lastly, one or more modules are used to modify maladaptive behaviors (808). The client is also able to practice and rehearse online.

In the Systematic desensitization Module the client is able to use this technique on their PC or over the Internet. In addition, instead of having to rely on mental imagery, as is usually the case in this technique, using the advantages of multimedia computers the client can now be presented with stimuli that are more vivid and lifelike. For example, instead of imaging a bridge, which is usually the case when this technique is used, hey can see a video, animation, or digital photograph of a bridge with auditory events that can enhance the experience. Mental images generally do not have a vivid or intense quality. In addition, many individuals have a difficult time having mental images. And, these forms of images are often unstable and people have a difficult time sustaining their attention to them. That is why this form of in vivo treatment lacks the degree of success it might when the client begins to transfer their learning experience to everyday life. In addition, the PC/Online version allows the client to return to the their training level as often as they like to continue their practice, something which is generally not possible in the therapist's office.

The basic procedure of the technique is to first establish a behavioral hierarchy in which the client constructs a list of 10 stimuli from the least anxiety provoking to the end goal. The client is instructed to use stimulus situations that are evenly spread over the 10 stimuli so that at each level there is a sufficient degree of anxiety the client must dissipate, but that it is at such a level that mastery is fairly easy. Table in FIG. 9 shows an example of a behavioral hierarchy with its relative anxiety level ratings. The ability to master each level with relative ease also reinforces and motivates the client when they see that they are able to achieve the goal. At each step in the hierarchy the client is first exposed to the stimulus and then rates its level of anxiety. The stimulus is then removed, and the client uses their Cued-Recall Relaxation to relax deeply, and then they are re-exposed to the stimulus. They are instructed to view the stimulus while relaxing until they reach a 0 or 1 in their relaxation index. For each stimulus exposure, this is done a minimal of 4 times, or until the client reaches the desired level of relaxation during stimulus exposure. If the client is unable to reach this level, then the hierarchy must be reassessed to make the stimuli at that level less noxious. This process continues until the client reaches the target goal. FIG. 9 illustrates an example of behavioral hierarchy with subjective anxiety ratings.

Parameter Matrix Variables

Please note: Models below refer to animations or live movies of humans

1. Specific components of the behavioral hierarchy

2. Specific auditory, textual, and auditory stimuli of the behavioral hierarchy

3. Sex of the animation model

4. Age of the animation model

5. Ethnic/Social background of animation model

6. Measurement of physiological parameters of the response:

a. Microphone based (vocal responses & dynamics)

b. Instrument based

Module Design

The basic design of the module is to first instruct the client as to the nature of the process and a description of the procedure they will be going through. This includes and animation/video demonstration of the systematic desensitization method and a sample behavioral hierarchy. The client will then be required to pick a target goal which would be something they feel is relatively anxiety provoking. Then they will be required to develop a behavioral hierarchy. This will be facilitated by a variety of menus and prompts that will make the development of the behavioral hierarchy relatively straightforward. This will include selecting multimedia stimuli such as animations, videos, sounds, and texts that will be used for the hierarchy. If the clients have the ability to scan in their own images or input their own sounds, the program allows for this as well. There are also commercial services that could prepare this material for the client to input this material into their computer. Once the behavioral hierarchy is established, the client begins the training process. The client is exposed to the first stimulus, and rates its anxiety level through the various indices on the Personal Record Keeping form. Then the stimulus is masked, and the client is asked to relax using the Cured-Recall Method. When the client has reached a sufficient level of relaxation, the stimulus is reintroduced, and client is asked to continue to relax until they have reached a 1 or 2 on their SUDs score. At this point there is a 30 second interval, and the process is begun again. The client must achieve a SUDs score of 0 or 1 for four consecutive exposures to the stimulus until they are ready to go on to the next level. If the client has not reached this goal within 10 exposures of the stimulus, the client must return to the section where the behavioral hierarchy was created and reevaluate the steps around where he/she was unable to go forward. Thus the program is an iterative process through which the client refines their progress until the final goals has been achieved.

Module Implementation: Programming Steps

1. Screen 1: Text with auditory accompaniment of the systematic desensitization method. There will be a brief animation/video demonstration of the technique and an example of a behavioral hierarchy.

2. Screen 2. Display text that reinforces and amplifies previous ideas presented concerning relaxation techniques in general and Cued-Recall Relaxation in particular. This screen will review technique relaxation by Cued-Recall. For example, they will be instructed how to use their personal cue to achieve a deep state of relaxation. The text will be accompanied by an audio description with an animation sitting quietly “practicing” the technique. The client will also be reminded that if they lose track of the cue to gently return to it and begin repeating it again.

3. Screen 3. Display text with audio accompaniment giving general instructions concerning the development of the behavioral hierarchy. . Animation/Voice #1: This screen will have an animation illustrating the discussion of the text. The text will also be accompanied by voice. This screen will illustrate how the client will develop their own behavioral hierarchy, illustrating the principles involved. The client has access to AVI controls to repeat the sequence as often as they wish

4. Screen 4A. This is the screen where the clients begin to build their own behavioral hierarchy. To simplify the process, the client is presented with a variety of common anxiety provoking situations from which they can chose to develop their own hierarchy (e.g., fear of plying, crossing bridges, taking tests, large crowds, etc. If the client chooses from one of these menu items they are brought to a screen that a textual list of 10 graded stimuli providing a generic behavioral hierarchy as that described above. The client is asked to rate each stimulus on an anxiety scale of 1 to 10 for each stimulus. For each stimulus the client can rank between 1 and 10. Thus, if there were too many 2s, this would not be an adequate hierarchy. If the anxiety scores seem reasonably dispersed across the stimuli then, with the client's approval this will be the hierarchy the client will work with. If the client disagrees with any of the descriptions, or if the scores are not evenly dispersed, the client has the option of entering any changes they desire. Again the client must rank each stimulus, and the hierarchy will only be finalized when there is a reasonable distribution of anxiety rankings. Even if there are some duplicate anxiety ratings, this is adequate. However, the client will be asked to prioritize the 10 stimuli from the least to most anxiety provoking, using their anxiety rankings as a guide. At each step of the process the client is prompted by text and voice as to what their next step should be, thus giving the client clear guidance in the process.

5. Screen 4B: If the client does not find any of the situations provided in the Behavioral Hierarchy Main Menu that is appropriate for them, then they are brought to a screen with 10 blank entries itemized 1-10. The screen instructs the client to fill in the entries, with number 10 being their target goal. After this, the instructions are the same as above, with the person refining the categories and then finally prioritizing them for the final hierarchy. At each step of the process the client is prompted by text and voice as to what their next step should be, thus giving the client clear guidance in the process.

6. Screen 5: This screen presents both textual and auditory instructions of the second phase of the systematic desensitization process similar to the description provided above.

7. Screen 6: The client is presented with the visual/auditory stimuli selected for the behavioral hierarchy (beginning with the first stimulus in the hierarchy). The client then rates the anxiety-evoking effects of the stimulus on their Personal Record Keeping Form (see below).

8. Screen 7: The stimulus is then masked, and the client is given 3-minutes to relax deeply through the method of Relaxation by Cued-Recall.

9. Screen 8: They will then be exposed to the appropriate stimulus of the behavioral hierarchy for an additional 3-minutes. In the first exposure they are presented, for example, with the first stimulus, which is the least anxiety provoking. The client is then instructed to maintain their relaxation while exposed to the stimulus. They will be given three minutes to achieve the appropriate level of relaxation during exposure to the noxious stimulus,

10. Te client then records their SUDs on their Personal Record Keeping Form.

11, The client then returns to step 7 again.

12. Note: If the client achieves 3 successful periods here their SUDs scores are 2 or less then they exit the systematic desensitization Modulo. That is to say, they are able to achieve a SUDs score of 2 or less during three 3-minute exposures to the stimulus on the hierarchy they have completed this training session, and will exit to the homework section.

13. Note: If the subject does not succeed in achieving the appropriate level of relaxation when exposed to the noxious stimulus after 5 attempts to maintain a SUDs score of 2 or less during the 3-minute Relaxation+Exposure periods they are returned to the Behavioral Hierarchy Main Menu which has a button that will send the client to a section where they can reevaluate the stimuli at that segment of training. Usually this will entail adding some intermediary stimuli. For example, if stimulus #6 is too difficult, the client can add 1 or more intermediate stimuli as a transition to the Stimulus #6 level.

14. Screen 8: At the completion of every session, whether successful or not, the client then goes to the full Personal Record Keeping Form and completes all the relevant information. They will record measure and record their SUDs score, PhysioScan Scores, Pulse Rate, Surface Temperature, Respiration Rate, and the cognitive and anxiety indices. This information will also be sent to the Report & Form Generator Module that will provide the client with the appropriate data (including their specific stress scores and Composite Stress Index), an interpretation of the results, and suggestions for further training. The client will have the option of printing out these results. They are also stored in the computer for future reference.

15. Note: The Form and Report Generator Module will also provide the client with their Homework Assignment based on the data of the session and the specific training protocol. The client will have the option to print this assignment.

16. Homework: The homework assignments will consist of real life exercises similar to the exercises in the session. For example, taking along a printed copy of the Personal Record Keeping Form, the client would go 3 miles from a bridge. They would then rate their anxiety and turn away from the scene. They would then do 3 minutes of Relaxation by Cued Recall, and then face the scene while continuing to relax. After three minutes the client stops, look away from the scene, and then begin to relax again while confronting the scene. The client would do this four times, and then stop. At the initial exposure to the image, and before and after each exposure to the scene the client would fill out the Personal Record Keeping Form, and later on input the data into the computer.

17. Note: The client will continue the above process until the target goal has been achieved.

Cognitive Restructuring Module

Function

Cognitive Restructuring is a technique where the client learns to re-think situations that they characteristically handle in a maladaptive and unhealthy fashion. The procedure allows the client to develop alternative, healthier, and more adaptive solutions to their problems. The client must first learn to detect and to identify the automatic negative thoughts that usually are beneath the surface of awareness, yet control much of the client's negative behavior patterns. This self-monitoring process includes identifying characteristic cognitive distortions that sustain the automatic negative thoughts. These distortions include categorical thinking (“all-or-none” thinking), over-amplification of the meaning of events (“making mountains out of molehills”) and personalization (to easily taking things to heart or being overly sensitive). The structure of this module is less formal than the more generalized Contingency Management Training Module. While it is in some ways less rigorous, it provides the client with a more rapid PC/Internet based program for diminishing less arduous irrational beliefs and maladaptive behaviors. It also forms the basis for a less formal program for modifying habits (see Habit Control Module).

There are three phases to the Cognitive Restructuring Processes. Phase 1 is performed by the Cognitive Self-Monitoring & Self-Reporting Module (CSMSRM). The CSMSRM module describes how the individual can learn to become more aware and cognizant of their maladaptive cognitions and thought patterns. The module provides a systematic process for the individual to achieve this awareness. The structure of the module is useful in that it facilitates the process of becoming aware of preconscious thoughts, images, and feelings that are generally automatic and reflexive.

In Phase 1 the Cognitive Self-Monitoring & Self-Reporting Module receives instructions from the Cognitive Restructuring Module as to which forms to implement. In the Cognitive Self-Monitoring & Self-Reporting Module The client is lead through a series of lists and questions that will help them identify their 1) maladaptive thinking styles, 2) the negative contents of their cognitions, and 3) their dysfunctional behavior patterns associated with negative cognitions. The client will then be taught to concretize their characterization of their irrational beliefs and negative thinking in the form of a specific example. The client chooses a real-life incidence exemplifying as many of the patterns they identified & detected previously. They will be asked to do this several times until they feel comfortable about describing the information as described below.

After completing the Phase 1, the client is returned to the Cognitive Restructuring Module. The client now begins Phase 2. They are now asked a series of questions to highlight the consequences of negative thinking as portrayed in the example. This clarifies the client's specific pattern of negative thinking was unproductive and produced antagonistic outcomes. Next, the client is asked to consider what might have happened in the incidence had they not thought the way they did and responded in the manner that produced the undesirable result. Finally, the client is asked a number of questions to help them substitute more positive, productive, and adaptive thoughts and responses to the situation

In the third phase, first, the client chooses (or learns, if not already having done so) a relaxation exercise (see various relaxation modules). First the client must go to the Diaphragmatic Breathing Module for training or practice to be sure they can breath slowly and deeply with diaphragmatic breathing. If the client has previously learned a relaxation technique, they can choose from a menu presented the practice submodule of the relaxation technique. They are given 5-minutes to practice their Relaxation by Cued-Recall. They then perform a PhysioScan assessment and the brief anxiety and relaxation assessments in the Personal Record Keeping Form. If they meet the criteria for relaxation then they continue in the Cognitive Restructuring Module. If they do not meet the criteria, they must relearn that method of relaxation (or another one if so indicated in their initial assessment in the Generalized Assessment Module). If the client has not learned a relaxation technique they must choose the training submodule of the technique they must learn. The program will indicate which method will most likely suit them. However, the client has some latitude of choice. If they want to choose another technique after they have read a brief description of the one they wanted to train in, they can return to the menu and select another technique. However, the client cannot continue in the Cognitive Restructuring Module until they have mastered Relaxation by Cued-Recall from at least on relaxation technique.

The client is then instructed to use the Relaxation by Cued-Recall to enter into a very relaxed state, which facilitates a heightening of imaginative capacities, like vividness of the experience and it can also enhance suggestibility, While in the relaxed stat, the client will be asked to imagine the incident as clearly as possible. They first remember it in as much detail as they can. They are then asked to re-imagine the incident, but now they do not think their typical thoughts or act in the same way. They try, in their imagination to be as neutral as possible. Finally, the re-imagine the incident again, but now implementing the positive and adaptive cognitions they reported previously. If the client has a difficult time using visual imagination, the client can make up the story as a verbal inner dialogue. If this is still a problem for the client, the computer will supply a “blank page” where the client even literally write down the assignment while in the relaxed state.

Implementation: Cognitive-Behavioral Processes

In general the module focuses on several cognitive-behavioral, thought and response patterns:

7. Identifying maladaptive thought patterns & irrational beliefs

8. Classifying & recording automatic and reflexive thought patterns

9. Learning to use specific examples to concretize maladaptive behavior patterns and negative thoughts

10. Identifying specific and detailed antagonistic elements in specific examples

11. Analysis of negative and positive outcomes of the specific examples

12. Analysis of developing and exploring specific alternative behavioral and cognitive patterns

13. Learning to record data observed when negative cognitions and maladaptive behaviors are identified and concretized in the example

14. Analysis of negative and positive outcomes of the specific examples

15. Analysis of developing and exploring specific alternative behavioral and cognitive patterns

Parameter Matrix Variables

Models below refer to animations or live movies

9. Examples of specific maladaptive thinking styles

10. Specific forms and self report questionnaires to help client identify and classify cognitive and behavioral patterns

11. Variations probe questions to elicit maladaptive thinking styles and contents of thought

12. Variation in type of example in animation/movie examples

13. Variation in outcomes in animation/movie examples

14. Variation in questions to elicit 1) negative outcomes, 2) outcomes of refraining form negative thinking & behaving, and 3) positive out comes of substituting positive thoughts

15. Sex of the animation model

16. Age of the animation model

17. Ethnic/Social background of animation model

Module Implementation: Programming Steps

1. Screen 1. Entry/Gateway Screen

2. Screen 2. Cognitive Restructuring & Internal Self-Talk. The client receives brief instructions as to the first phase of cognitive self-monitoring & self-reporting. Signal Protocol Sequencing Module to continue.

3. Phase I. Screen 3. The current module then accesses or calls the Cognitive Self-Monitoring & Self-Reporting Module to begin Phase I.

4. Note: The Cognitive Restructuring Module instructs the Cognitive Self-Monitoring and Self-Reporting Module as to which assessment instruments and techniques to utilize

5. When the client completes the training in the Cognitive Self-Monitoring & Self-reporting Module calls the Cognitive Restructuring Module to continue.

6. Phase II (Parts 1-3): Changing or Modifying Irrational Thoughts & Beliefs. the client is given

an overview how to restructure negative thinking and irrational beliefs. This overview also explains the use of specific examples as illustrations of these irrational thought patterns. This includes

A. Following a systematic exploration of the negative and positive consequences of thinking in this way.

B. Implementing alternative self-talk statements which would refute the a) irrational ideas and b) implement the positive thoughts to extinguish or diminish the impact of the negative thoughts

C. Rehearsing & practicing though the Guided Imagery Module the situation described to implement Item E.

D. Rehearsing & practicing though the Guided Imagery Module similar situations described to implement Item E.

7. Screen 5: The client is then introduced to cognitive-behavioral strategies for changing and/or modifying cognitions by restructuring maladaptive thought patterns and negative contents. The client is given general instructions for rebutting thoughts that are irrational, negative, and maladaptive. There are three parts to this process. The client is given instructions at the appropriate part they are in.

Phase II: Part 1 (Session 3)

8. Screen 6. Client is presented with more detailed instructions for Part I: Changing or Modifying Irrational Thoughts & Beliefs. In this section the client is shown how to provide what the consequences of their negative thinking has. Usually these outcomes are negative. However, at times, in the middle of some conflict or problematic situation there is a temporary positive gain which reinforces elements of the disturbing cognitions & dysfunctional behavior pattern (e.g., embarrassing someone you are angry with, feeling good about it, Then layer on you discover people feel contempt for what you did, and you are embarrassed).

9. Screen7: The client will be exposed to a number of common irrational beliefs and distorted thinking styles. For each one, they will be given examples of how refute or disprove each statement. Hey will be shown a) how to demonstrate or prove the idea is irrational, b) that there is no evidence for it, or c) that the idea is not true. This process the syllogistic, if . . . then methodology described above.

10. Note: For each irrational idea, and its correlated negative expectations of not acting will be presented in text and voice.

11. Screen 8: In this screen the client sees either an animation or video of an individual with a particular problem and how they learn to identify the thoughts or images that produce their maladaptive behavior (Video File: CDCRv1-4P1). There will be 4 possible videos of different common problem situations from which the individual can select to see the demonstration of this technique. The client can select as many of these AVI clips as they want, and repeat them as frequently as they desire though the provided AVI controls. These videos or animations will also demonstrate how to refute, rebut, or disprove the specific irrational and negative thoughts embedded in the example they chose. They are exposed to a basic syllogistic reasoning to derive the consequences of their thinking. For example: Alice feels life is unfair. If this idea is true then there must be evidence for it. Is there evidence for life always being unfair? Is life sometimes fair? Yes. Is the idea of fairness appropriate to an abstraction like life? No. Thus, the idea that life is unfair has been disproved.

12. Note: The main questions asked of the client appear below in the Rebuttal and Refutation of Irrational Thoughts Form below.

13. Screen 9: After completing the demo video, the client will have an additional set of 4 animations or videos to watch and record the data without the animations providing this part of the process. They will first receive the instructions provided in Screen 5. The client will be prompted to input a) possible negative consequences of the irrational ideas portrayed, and b) what might happen if the characters did not think or act they way they did, and c) what substitute positive and adaptive thoughts & acts might the characters have used to achieved the desired result,

14. Screen 10: The client's responses will then be displayed against those that where inherently built into the scenario. The client will be able to assess the degree to which they were successful, and see what type of errors they missed. This will further enhance their training in this technique. The client will be encouraged to try all 4 tests animations/videos, and particularly if they do not show reasonably accurate results in their first try.

15. Screen 11: The client is asked to record their results on the Personal Record Keeping Form (PRKF), which will be displayed in the lower portion of the demo. This PRKF is a section of the Report and Form Generator Module that will be implemented in many other modules. This module design the necessary forms for the client to collect data, it collects the data either directly or from other modules, analyzes the data, and generates a report. [As indicated above, a number of tests & surveys from the Cognitive Self-Report SubModule of the Generalized Assessment Module will be often used in conjunction with the PRKF and the data collected in the PhysioScan Module. This data is index to the PRKF. In addition, the client will take several standardized tests, which help assess their irrational beliefs and distorted thinking. The results of this test are summarized on the PRKF.]

16. Screen 12: Client then receives instructions on how to refute, rebut, or disprove their own irrational beliefs and negative thinking.

17. Screen 13: In this screen the client is presented with their irrational ideas. The irrational ideas, thoughts, and beliefs in this section are derived from the forms previously completed. The irrational elements are reflected in the real-life examples.

18. Screen 13 (continued): The first irrational idea is presented. It is presented at the top left hand corner of the Rebuttal and Refutation of Irrational Thoughts Form (RRITF).

19. Screen 13 (continued): As per the previous instructions, the client then completes the training process by going though the RRITF. The client is prompted at each step by voice in review of the previously given instructions. The process includes the various steps (see above) to refute and rebut the irrational idea

20. Note: There are Windows buttons on the screen that the client can click to see and/or hear instructions for each portion of the screen.

21. Screen 14. Homework: The client is instructed to use other examples developed in the Cognitive Self-Monitoring and Self-Reporting Modules to continue training with the RRITF. They can have access to the form online or they can print a copy to complete by hand. It is suggested they scan in (if the they have a scanner with OCR) or type in their homework in the online form at the start of a subsequent session. The printed form has written instructions in the event the client forgot how to complete a step. The online form has “buttons” they client can click for a voice and text based presentation of the instructions. In the event the client needs more examples the client can click another button to return to the appropriate section of the Cognitive Self-Monitoring and Self-Reporting Module to create additional example scenarios.

20. Note: After the completion of each session of the Cognitive Self-Monitoring & Self-Reporting Module the client is sent, by the Protocol Sequencing Module, to the Reinforcement Module.

22. Screen 15: In the Reinforcement Module the client assigns themselves sufficient reinforcement a) to strengthen their learning curve and b) to enhance motivation, b) practice & rehearsal, and c) to continue in the program.

23. Screen 16: Before exiting the session the client is given the option of taking a few minutes to upwind by selecting either a multimedia brief relation session in the Audio/Visual Relaxation Module or a short sequence of exercises designed to help you unwind even at a desk. This routine is called form the Exercise module.

Part II (Session 4)

24. Screen 17: Client is presented with detailed instructions for Part II: Irrational Thoughts Outcome Challenge Form. In this section the client is shown how to challenge their expected outcomes by examining what would happen if they refrained from their usual course of action. The client is first presented with a series of common expectations people have if they do not respond in the way they do in maladaptive situations. That is to say, they are ask to explore what might happen to them if they did not think, or at least not act, in the irrational way they usually do in the situations described in their examples.

25. Screen 18: The client will be exposed to a number of common irrational beliefs and distorted thoughts people have when refraining from either their irrational thoughts and/or behaviors. For each one, they will be given examples that reflect this thinking. They will then be given examples of how to disprove or refute each statement. They will be shown a) how to demonstrate or prove the idea is irrational, b) that there is no evidence for it, or c) that the idea is not true. This process the syllogistic, if . . . then methodology described above.

26. Note: For each irrational idea, and its correlated negative expectations of not acting will be presented in text and voice.

27. Screen 19: In this screen the client sees either an animation or video of an individual with a particular problem and how they learn to identify the thoughts or images that produce their maladaptive behavior (Video File: CDCRv1-4PI). There will be 4 possible videos of different common problem situations from which the individual can select to see the demonstration of this technique. The client can select as many of these AVI clips as they want, and repeat them as frequently as they desire though the provided AVI controls. These videos or animations will also demonstrate how to refute. rebut, or disprove the specific irrational and negative thoughts and behaviors pertaining to refraining from thinking and acting in an irrational manner. Embedded in the example they chose. They are exposed to a basic syllogistic reasoning to derive the consequences of their thinking. For example: Alice feels life is unfair. If this idea is true then there must be evidence for it. Is there evidence for life always being unfair? Is life sometimes fair? Yes. Is the idea of fairness appropriate to an abstraction like life? No. Thus, the idea that life is unfair has been disproved.

28. Note: The main questions asked of the client appear below in the Irrational Thoughts Outcome Challenge Form below.

29. Screen 20: After completing the demo video, the client will have an additional set of 4 animations or videos to watch and record the data without the animations providing this part of the process. They will first receive the instructions provided in Screen 5. The client will be prompted to input a) possible positive consequences of the of refraining from the irrational ideas and actions portrayed. That is to say, what might happen if the characters did not think or act they way they usually did in the examples portrayed.

30. Screen 21: The client's responses will then be displayed against those that where inherently built into the scenario. The client will be able to assess the degree to which they were successful, and see what type of errors they missed. This will further enhance their training in this technique. The client will be encouraged to try all 4 tests animations/videos, and particularly if they do not show reasonably accurate results in their first try.

31. Screen 22: The client is asked to record their results on the Personal Record Keeping Form (PRKF), which will be displayed in the lower portion of the demo. This PRKF is a section of the Report and Form Generator Module that will be implemented in many other modules. This module design the necessary forms for the client to collect data, it collects the data either directly or from other modules, analyzes the data, and generates a report. [As indicated above, a number of tests & surveys from the Cognitive Self-Report SubModule of the Generalized Assessment Module will be often used in conjunction with the PRKF and the data collected in the PhysioScan Module. This data is index to the PRKF. In addition, the client will take several standardized tests, which help assess their irrational beliefs and distorted thinking. The results of this test are summarized on the PRKF.]

32. Screen 23: Client then receives instructions on how to refute, rebut, or disprove their own irrational beliefs and negative thinking concerning refraining from their typical irrational and maladaptive thoughts and actions.

33. Screen 24: In this screen the client is presented with their irrational ideas. The irrational ideas, thoughts, and beliefs in this section are derived from the forms previously completed. The irrational elements are reflected in the real-life examples.

34. Screen 24 (continued): The first irrational idea is presented. It is presented at the top left hand corner of the Irrational Thoughts Outcome Challenge Form (TOCF).

34. Screen 24 (continued): As per the previous instructions, the client then completes the training process by going though the TOCF. The client is prompted at each step by voice in review of the previously given instructions. The process includes the various steps (see above) to refute and rebut the irrational idea.

35. Note: There are Windows buttons on the screen that the client can click to see and/or hear instructions for each portion of the screen.

36. Screen 25: Homework: The client is instructed to use other examples developed in the Cognitive Self-Monitoring and Self-Reporting Module to continue training with the Irrational Thoughts Outcome Challenge Form (TOCF). They can have access to the form online or they can print a copy to complete by hand. It is suggested they scan in (if the they have a scanner with OCR) or type in their homework in the online form at the start of a subsequent session. The printed form has written instructions in the event the client forgot how to complete a step. The online form has “buttons” they client can click for a voice and text based presentation of the instructions. In the event the client needs more examples the client can click another button to return to the appropriate section of the Cognitive Self-Monitoring and Self-Reporting Module to create additional example scenarios.

37. Note: After the completion of each session of the Cognitive Self-Monitoring & Self-Reporting Module the client is sent, by the Protocol Sequencing Module, to the Reinforcement Module.

38. Screen 26: In the Reinforcement Module the client assigns themselves sufficient reinforcement a) to strengthen their learning curve and b) to enhance motivation, b) practice & rehearsal, and c) to continue in the program.

39. Screen 27: Before exiting the session the client is given the option of taking a few minutes to upwind by selecting either a multimedia brief relation session in the Audio/Visual Relaxation Module or a short sequence of exercises designed to help you unwind even at a desk. This routine is called from the Exercise module.

40. Screen 28::The client is informed briefly about the next session and then the session terminates the program

PART 3 (Session 4)

41. Screen 29: Client is presented with detailed instructions for Part III: Restructuring, Modifying, and Changing Cognitions & Self-Talk. In this section the client is shown how to substitute or significantly replace their expected outcomes by examining what would happen if they replaced their negative self-talk with positive, adaptive, and productive thoughts and actions.

42. Screen 30: The client is first presented with a series of common irrational ideas and maladaptive behaviors. They are then shown what might happen to them if they replaced the irrational ideas with rational and proactive ones. That is to say, what are potential positive results of 1) refraining from the irrational way one usually might in the situations described in their examples, and 2) substituting rational and positive cognitions and response patterns.

43. Screen 30 (continued): The client will be successively exposed to a number of common irrational beliefs and distorted thoughts people have. For each one, they will be given examples that reflect this thinking. They will then be given examples of how to substitute positive, rational thoughts for each example of specific irrational thinking. They will be shown a) how to demonstrate or prove that there are healthier ways to respond in the situation, b) that there is evidence that this is a better way to think or act, or c) that there is truth to the new set of ideas. This process is the syllogistic, if . . . then methodology described above.

44. Note: For each irrational idea, and its correlated positive expectations and adaptive thinking, will be presented in text and voice.

45. Screen 31: In this screen the client sees either an animation or video of an individual with a particular problem and how they learn to change or modify thoughts or images that produce their maladaptive behavioral by restructuring their thinking and substituting positive cognitions (Video File: CDCRv1-4P1). There will be 4 possible videos of different common problem situations from which the individual can select to see the demonstration of this technique. The client can select as many of these AVI clips as they want, and repeat them as frequently as they desire though the provided AVI controls.

39. Note: These videos or animations will also demonstrate how to substitute, modify, change, and/or restructure specific irrational and negative thoughts and behaviors pertaining to the examples they chose. They are exposed to a basic syllogistic reasoning to derive the consequences of their thinking. For example: Alice feels life is unfair. We have already demonstrated that this idea is irrational, lacks proof, and is untrue. Thus, the idea that life is unfair has been disproved. If this idea has been disprove, then there must be a more adaptive, and positive way to think in this situation. For example, Alice might say to herself, “I just should try to do my nest and be responsible for myself. If I take charge of my own life, then generally things should be OK.”

40. Note: The main questions asked of the client appear below in the Restructuring, Modifying, and Changing Cognitions & Self-Talk.

6 Screen 5: After completing the demo video, the client will have an additional set of 4 animations or videos to watch and record the data without the animations providing this part of the process. They will first receive the instructions provided in Screen 5. The client will be prompted to input a) possible positive thoughts, images, and beliefs for the irrational ideas and actions portrayed. That is to say, what might happen if the characters would think or act more appropriately than the way the characters did.

41. Screen 26: The client's responses will then be displayed against those that where inherently built into the scenario. The client will be able to assess the degree to which they were successful, and see what type of errors they missed. This will further enhance their training in this technique. The client will be encouraged to try all 4 tests animations/videos, and particularly if they do not show reasonably accurate results in their first try.

42. Screen 27: The client is asked to record their results on the Personal Record Keeping Form (PRKF), which will be displayed in the lower portion of the demo. This PRKF is a section of the Report and Form Generator Module that will be implemented in many other modules. This module design the necessary forms for the client to collect data, it collects the data either directly or from other modules, analyzes the data, and generates a report. [As indicated above, a number of tests & surveys from the Cognitive Self-Report SubModule of the Generalized Assessment Module will be often used in conjunction with the PRKF and the data collected in the PhysioScan Module. This data is index to the PRKF. In addition, the client will take several standardized tests, which help assess their irrational beliefs and distorted thinking. The results of this test are summarized on the PRKF.]

43. Screen 28: Client then receives instructions on how to redefine their thinking in the situations that they recorded exemplifying their motifs of their irrational thinking and maladaptive response patterns.

44. Screen 29: In this screen the client is presented with their irrational ideas. The irrational ideas, thoughts, and beliefs in this section are derived from the forms previously completed. The irrational elements are reflected in the real-life examples.

45. Screen 29 (continued): The first irrational idea is presented. It is presented at the top left hand corner of the Restructuring, Modifying, and Changing Cognitions & Self-Talk Form (RMCCSTF).

46. Screen 29 (continued): As per the previous instructions, the client then completes the training process by going though the TOCF. The client is prompted at each step by voice in review of the previously given instructions. The process includes the various steps (see above) to substitute positive and adaptive thoughts for their irrational idea.

47. Note: There are Windows buttons on the screen that the client can click to see and/or hear instructions for each portion of the screen.

48. Screen 30. Homework: The client is instructed to use other examples developed in the Cognitive Self-Monitoring and Self-Reporting Modules to continue training with the Restructuring, Modifying, and Changing Cognitions & Self-Talk Form (RMCCSTF). They can have access to the form online or they can print a copy to complete by hand. It is suggested they scan in (if the they have a scanner with OCR) or type in their homework in the online form at the start of a subsequent session. The printed form has written instructions in the event the client forgot how to complete a step. The online form has “buttons” they client can click for a voice and text based presentation of the instructions. In the event the client needs more examples the client can click another button to return to the appropriate section of the Cognitive Self-Monitoring and Self-Reporting Module to create additional example scenarios.

49. Note: After the completion of each session of the Cognitive Self-Monitoring & Self-Reporting Module the client is sent, by the Protocol Sequencing Module, to the Reinforcement Module.

50. Screen 31: In the Reinforcement Module the client assigns themselves sufficient reinforcement a) to strengthen their learning curve and b) to enhance motivation, b) practice & rehearsal, and c) to continue in the program.

51. Screen 32: Before exiting the session the client is given the option of taking a few minutes to upwind by selecting either a multimedia brief relation session in the Audio/Visual Relaxation Module or a short sequence of exercises designed to help you unwind even at a desk. This routine is called from the Exercise module.

52. Screen 33::The client is informed briefly about the next session and then the session terminates the program

Phase III: (Session 5)

53: Cognitive Practice & Rehearsal: In the final phase of the cognitive restructuring module the client will practice and rehearse their skills of refraining from their irrational beliefs and their ability to substitute positive & rational beliefs for irrational ones. They will rehearse this by using their imaginative capacities to visualize the examples they previously reported and then practice either a) imaging what would happen if they refrained from their usual irrational beliefs and actions. The material they recorded in terms of negating the irrational beliefs will guide them in this and negative thoughts they had if the would refrain. Next, they practice imagining the same example again, but this time substituting positive, rational and practice thoughts and beliefs for their irrational ones. The client first begins each training episode by imagining the derails of the example. They then go through it again visualizing the scene by refraining from their irrational thoughts and behaviors. Finally, they again visualize the scene while substituting the positive thoughts. The impact of this technique is to strengthen the client's skills so they are better prepared to transfer them to real life activities. It has been demonstrated that this form of imaginative rehearsal has a significant impact on generalizing skills learned in these protocols to everyday life. The practice and rehearsal is conducted in the context of a relaxed state. When a person is in a deep state of de-arousal and relaxation their ability to imagine and to visualize is enhanced. The practice & Rehearsal Module first ensures that the client can relax y the method of Relaxation by Cued-Recall. Then after a 4-minute relaxation, they begin their visualization exercises. To heighten the visualization, the rehearsal is conducted in the context of relaxation backgrounds provided through the audio/visual relaxation module.

54: For those clients that have difficulty with visualizations, they can practice the tasks as 1) a covert or internal self-dialogue, 2) a verbal rehearsal of the task by recording it into the computer or a tape-recorder, or 3) as a writing exercise by typing it onto the computer screen

55. The client can also use the textual display of the material to do the exercise with their eyes open as they think about it or use vocal recordings with their eye closed

54. Note: The computer times the length of the visualization and the number of practice trials or episodes. The client begins slowly and then builds up the length of and the number of visualizations

55. Note: The program Sends the Cognitive Practice & Rehearsal Module the following parameters of its parameter matrix (Note: 1 & 2 are Called from the Cognitive Self-Monitoring & Self-Reporting Module; 3-8 are Called from the Cognitive Restructuring Module):

1. The example to be used in the visualization in the form of a textual description

2. The example as a voice recorded file (if available)

3. The refutations, and the relevant portions of the example, to the client's belief's that they should not refrain from their usual irrational thoughts, beliefs, and actions in the form of a textual description

4. The refutations against not refraining as a voice recorded file (if available

5. The thought substitutions, and the relevant portions of the example, for the client's irrational thoughts and beliefs in the form of a textual description

6. The substitution for the client's irrational thoughts and beliefs as a voice-recorded file (if available

7. The length of each visualization trial or episode

8. The number of practice trials or episodes

56. Screen 34: The client is provided a brief introduction to cognitive practice and rehearsal.

57. Screen 35: The program is Returned from the Cognitive Practice and Rehearsal Module. The program queries the client to make sure the client has the homework and has completed the Reinforcement Module. If not, the client has “buttons” available to go to the relevant areas.

58. Screen 36. Logoff Screen. Session ends. FIGS. 10 a-d illustrate various forms associated with the cognitive restructuring module.

Cognitive Rehearsal & Practice Module

Function

The basic function of this module is to provide the user/client with relaxing images, animation, movies, and music to facilitate a state of relaxation to facilitate imaginative or covert, as well as overt, rehearsal & practice. The user/client will be able to select from a variety o visual and auditory stimulate which will facilitate relaxation. Based on response to questionnaires the user initially completed the user will also be suggested as too which of the stimuli they should start with that would most suit their needs. For example, those individuals who score on the Absorption Index would most profit from images like sunsets and forests which would enhance their ability to internalize their. Those who score low on the index would more likely profit from certain forms of music, repetitive auditory stimulation, or nature sounds because these sounds act as a focal referent for attention.

The relaxation stimuli are generally simple, rather than complex and potentially distracting. Usually, clients will want to close their eyes during this experience, so relaxing auditory stimuli and music will often be used. For those who wish to practice their techniques mentally with their eyes open, this module provides a variety of opportunities for this experience as well. Much of the auditory and visual stimuli are drawn from the Auditory/Visual Relaxation Module.

There are those individuals who have a difficult time experiencing mental images, if at all. However, some of these individuals can use internal self-dialogue to rehearse their tasks. Indeed, many rehearsal and practice procedures are coupled with some form of self-talk or self-dialogue to accomplish the teaks (e.g., in cognitive restructuring when the individual rehearses and practices refuting irrational ideas). For those who have a difficult time using any form of mental task, and prefer using writing or speaking to practice, this module will also provide s form for the client to rehearse through either a) typing their thoughts into the computer, or b) recording their thoughts into the computer by voice (assuming they have the appropriate hardware and software).

This module integrates the auditory and visual stimuli with either covert or overt rehearsal and practice of techniques taught in a particular session. The calling module is the module that uses the Cognitive Practice & Rehearsal Module as part of its routine to strengthen and reinforce specific cognitions. Repetitive practice of many behaviors and cognitive patterns strengthens them. They become more ingrained, and automatic, operating almost reflexively. In this way, they develop agonistic capacity against what appear to be the very strong durability of maladaptive and irrational thoughts, beliefs, feeling, and ideas. The module is designed to accept a variety of parameters that control the repetitive quality of the stimuli presented in this module, including number of repetitions and repetition rate. After the practice or rehearsal period is over, the Cognitive Practice & Rehearsal Module returns control of the program to the original calling module.

Implementation

Module Goals

1. Provide a simple, yet relaxing background to enhance the relaxation effect for Deepening covert and over rehearsal and practice.

2. Heighten the vividness and intensity of the imaginative element or rehearsal practice.

3. Coordinate the various parameters controlling the frequency of occurrence, number of repetitions, and the timing of event-intervals related to cognitive rehearsal and practice strategies.

4. Associate practice effects with de-arousal states to generalize the client's Internal cognitive and physiological cues which elicit relaxation.

Module Behaviors & Cognitive Patterns

16. Learning to covertly rehearse cognitive-behavioral strategies through imaginative involvement.

17. Learning to covertly rehearse cognitive-behavioral strategies through self-talk and self-dialogue (internal verbal scripts).

18. Learning to practice overt cognitive-behavioral strategies through writing external (onscreen) scripts.

19. Learning to integrate imagery and meditative relaxation techniques with cognitive-behavioral rehearsal

20. Conditioning covert self-talk and self-dialogue to relaxation and de-arousal states.

Parameter Matrix Variables

18. Type of visual image (e.g., running river, sunset, forest scene)

19. Type of auditory stimulation or music (e.g., the repetitive sound of rain, baroque music, country music, the sounds of a heart beating)

20. Toe of meditative technique and/or meditative phrase employed

21. Sex of the animation model

22. Age of the animation model

23. Ethnic/Social background of animation model

Module Design

Thus module provides 1) images, photographs, movies, & animations, 2) relaxing music and sounds, and 3) combined auditory and visual relaxation images as the background for cognitive-behavioral practice and rehearsal strategies. In addition, it implements the counting and timing functions necessary to determine the amount of time spent in each rehearsal segment or stimulus presentation, and 2) the number of practice segments in each rehearsal or practice session. The multimedia stimuli utilized in this module facilitate relaxation, image vividness & intensity, and imaginative involvement. Thus, the multimedia capacities of the module enhance the practice experience by intensifying it and by associating the practice stimuli with de-arousal.

Module Implementation: Programming Steps

1. Screen 1: Displays text accompanied by voice explaining the value of imagery, auditory stimulation, or guided imagery in a) achieving relaxation and b) enhancing cognitive practice and rehearsal. They text with auditory accompaniment indicates how it will help them to calm their mind, reduce external distractions, and to focus attention on the thoughts, images, and internal self-talk & self-dialogue

2. Note: The client has access to AVI controls to repeat the instructions, demonstrations, and behavioral sequences (when appropriately designated by the program) as often as they wish.

3. Screen 2: This screen briefly suggests which type of relaxation training to learn, if they have not already done so, to use in this module. These recommendations are based on tests in the General Assessment Module and other data that may have collected and stored in the client's Personal Record Keeping Module. The client is given a menu of 6 choices of relaxation techniques:

c. Diaphragmatic Breathing (All clients must learn this technique)

d. Progressive Relaxation,

e. Autogenic Training

f. Audio/Visual Relaxation

g. Guided Imagery

f. Meditation

4. Screen 2 (continued): The client has the option of selecting either Training (to learn a technique) or Practice (to practice and rehearse a technique already learned).

5. Note: If they choose Practice for a particular technique, they are first assessed to see how well they induce a relaxed state using Relaxation by Cued-Recall. If they meet the criteria for relaxation, they are returned to this module. If they do not, the assessment process will help them determine if they just need to practice Relaxation by Cued-Recall, or if they need reinforcement and practice in earlier parts of the relaxation technique training.

6. Note; The Relaxation Menu will indicate that all clients must either first train or practice Diaphragmatic Breathing before beginning another technique.

7. Note: Once the client is able to meet the criteria for deep relaxation by the method of Relaxation by Cued-Recall they first enter the relevant information in their Personal Record Keeping Form are returned to the Behavior Modification & Habit Control Module. As part of their daily homework assignments, they will be asked to practice their Relaxation by Cued-Recall at least twice per day.

8. Screen 3: Depending on the client's choice, the they are sent to the specific screen giving a general overview and instructions pertaining to the relaxation technique they have selected. These instructions will be presented as a text screen combined with a voice accompaniment. The client will either first train in the relaxation technique before using the Cognitive Practice & Rehearsal Module, or use the relaxation module's practice screen to review and practice the relaxation technique

9. Screen 4: The client will complete the Personal Recording Keeping Form (PRKF) at will complete the PRKF at the beginning of the Cognitive Practice & Rehearsal Module to insure the client has achieved a sufficient level of relaxation by the method of Relaxation the appropriate places in the particular relaxation technique's module. In Screen 4 they by Cued-Recall. Assuming that this is the case, the client can continue in the current module. Otherwise, they are referred back to the particular relaxation techniques module for further practice and reinforcement until they can achieve a sufficient level of relaxation by the method of Relaxation by Cued-Recall.

10. Screen 5A: The client will be instructed to relax using the method of Relaxation by Cued-Recall. The client will be given 5-minutes to practice to insure a deep state of relaxation. This should not be too difficult if the client has sufficiently practiced their entire relaxation training and met the specified parameters for achieving training goals.

11. Screen 5A (continued): After the instructions are completed, the screen “blanks out,” turning white after the instructions to practice their relaxation. There are two small buttons on the screen. One is for review of the instructions. The other is to continue with the program.

12. Screen 5B: The client can choose to Call the Audio/Visual Relaxation Module during the initial relaxation period in order to deepen their relaxation with a relaxing audio and/or visual background. At this time the client will select the audio/visual experience, to use during their practice and rehearsal. The client is presented with a set of menu choices that represent a subset of selections from the Audio/Visual Relaxation Module. As noted above, the audio/visual backgrounds provided in this module are fairly subdued, so as to enhance relaxation and imagery, but not be distracting in its own right. The client is also given some suggestions (as noted above) for the type of background that would be most conducive to their practice activities. This information is derived from the results of the Generalized Assessment Module and the PRKF. However, the client has, within the constraints of the module itself, latitude to select their own choices.

13. Screen 6A: The client then completes a SUDs scale, Anxiety Level Scale, and Degree of Relaxation Scale. If the relaxation us deep enough, the client continues. If it is not, the client is instructed to continue the Relaxation by Cued-Recall.

14 Screen 6B: If the client's level of relaxation is acceptable, the Cognitive Practice & Rehearsal Module then signals the module that initially called it. The calling module then presents instructions to the client as to what contents of the cognitive rehearsal and practice consists of.

15. Note: This practice can be covert as in imaginative rehearsal or practice or overt as in writing or recording the routines to be practice.

16. The client is given general instructions the concerning cognitive practice & rehearsal. They are told about the various ways to imagine something and then either:

1. Repeat in their mind over and over (like meditation)

2. To focus on a thought, image, emotion, or sensation (e.g., guided imagery, PhysioScan))

3. To focus away from a thought, image, emotion, or sensation, and refocus on something else (e.g., pain management)

4. To review in their mind some particular situation, scene, or event (e.g., cognitive self-monitoring)

5. To react to some particular situation, scene, or event (e.g., in refuting irrational ideas)

17. Screen 7A: Covert or Imaginative Practice & Rehearsal. When the client has to practice a routine or technique covertly they begin to imagine the image or think the thoughts as per the instructions. Screen 7 automatically presents the pre-selected backgrounds to facilitate relaxation and imaginative involvement.

18. Screen 7B: Overt Behavioral Practice & Rehearsal: For those individuals who have difficulty practicing covertly either with images or verbally, they can have the option to write down or vocally record their thoughts. After having received instructions from the calling module, the module provides a white screen where the client is prompted to write down the flow of their thoughts as they think through their practice exercise. Alternatively, they can press the verbal recorder start button and record their thoughts through the microphone. When down, the client presses the Stop button. The client has the option to hear the playback. The written and the voice-recorded material are all stored in the program. This data can be “attached’ to the Personal Record Keeping Form.

19. Note: If the time to imagine a scene is delimited by the calling program, an onscreen timer in the upper right hand corner of the screen. The time parameter can be set by program, or by the client when appropriate. (Note: the timer's visibility parameter can be set by the program, or by the client when appropriate. When the time interval is over, a tone softly beeps to indicate the end of the rehearsal segment. If the time parameter is not set, the default value is 10-minutes.

20. Note: The repetition frequency parameter is the number of times a particular overt rehearsal or practice period is to be repeated. The rate of repetition is how quickly or slowly a practice period is to be completed. The repetition parameter is the same as the inter-practice period. Both the repetition frequency parameter and the repetition rate parameter can be set by the program, or by the client when appropriate.

21. Note: Based on the criteria set for the repetition frequency parameter, the client will repeat Screen N number of times, where N is the number of times the client must rehearse or practice the covert set of thoughts and actions. The default values is N=2.

22. Screen 8: After the rehearsal or practice period is completed, the Personal Record Keeping Form, combining cognitive & behavioral self-reports from the initial entries in the Personal Record Keeping, Form, the results of the Generalized Assessment Module and portions of the PhysioScan module to assess client's initial (baseline) stress and anxiety response (including Surface Temperature, Respiration Rate, Pulse Rate, SUDs score and anxiety ratings.

23. The module then Calls the Reinforcement Module so that the client can record their appropriate point values for the session or homework. The Reinforcement Module then Returns control to the Practice and Rehearsal Module.

24. Screen 8 (continued): The client then clicks a Return button on Screen 8 that brings them tack to the appropriate area in the original calling program.

25. Screen 9: Homework. The client is then provided instructions for their homework. For each example, the client is required to practice each phase 4 more times a day between sessions. They can do more if the wish. If they complete the entire initial set of examples, they can work through the Cognitive Self-Monitoring & and Self-Recording Module and the Cognitive Restructuring Module to develop additional material. Once the client becomes familiar with the training steps in each module, they can be accomplished fairly quickly. The client can use relaxing music of their own (e.g., CD, cassette tape, radio with relaxing music)as a background or they can return to the current module for relaxing background stimuli. They also must continue to use the Relaxation by Cued-Recall before the practice begins. And, they should practice Relaxation by Cued-Recall for 2-3-minutes twice each day independently of the visualizations, in order to maintain a high level of relaxation skill. Instructions for the homework are online, can be printed out, and downloaded as a WAV or MP3 file. The downloaded files can also provide relaxing music for the client to use during their homework. The client can also use the other methods of practice and rehearsal by going to the appropriate homework area of the current module and type in their practice or verbally record it online. Alternatively, they could do their homework on regular paper, or by recording into a tape recorder. Before and after each homework session the client must complete the brief rating scales on the PRKF, including level of anxiety, degree of relaxation, degree of visualization, and the quality of the practice.

26. Note: The homework instructions indicate that if the client chooses their own relaxing music, it must be relaxing, but not necessarily in the sense of entertaining. The music should not just be enjoyable, but help calm the person down. Music that is arousing may be fun to listen to, but it will not facilitate relaxation in the sense of lowered levels of physiological arousal and mental quietude.

27. Screen 10: If this module was called by another module, it now Returns control to that module, as will be indicated by instructions on Screen 10. Other wise Screen 10 signals the end of the Session, and Returns control to the Main Menu.

Cognitive Self-Monitoring and Self-Reporting Module

Function

Brief Overview:

Thought & Response Pattern Awareness, Identification, Description and Narrative

The basic function of this module is to help the individual become more Aware of their thought patterns and associated responses, either for changing maladaptive patterns or for optimizing positive patterns. The client learns how to Identify the specific components and details of these thought or behavior sequences. They then learn to accurately Describe and record the details of these patterns to heighten their awareness of them so they are amenable to modification or change. They also learn to construct Narrative reports that will be used in thought and behavior modification protocols, and in particular protocols that will require the narrative for covert imaginative rehearsal, or overt written or vocally recorded rehearsal.

This module trains the individual in techniques so they can learn to become more aware and cognizant of their maladaptive cognitions and thought patterns. The module provides a systematic process for the individual to achieve this awareness. The structure of the module is useful in that it facilitates the process of becoming aware of preconscious thoughts, images, and feelings that are generally automatic and reflexive. The client is lead through a series of lists and questions that will help them identify their 1) maladaptive thinking styles, 2) the negative contents of their cognitions, and 3) their dysfunctional behavior patterns associated with negative cognitions. The client will then be taught to concretize their characterization of their irrational beliefs and negative thinking in the form of a specific example. The client chooses a real-life incidence exemplifying as many of the patterns they identified & detected previously. They will be asked to do this several times until they feel comfortable about describing the information as described below.

Implementation: Cognitive-Behavioral Processes

1. Identifying maladaptive thought patterns & irrational beliefs

2. Classifying & recording automatic and reflexive thought patterns

3, Learning to use specific examples to concretize maladaptive behavior patterns and negative thoughts

4, Identifying specific and detailed antagonistic elements in specific examples

5. Analysis of negative and positive outcomes of the specific examples

6. Analysis of developing and exploring specific alternative behavioral and cognitive patterns

Parameter Matrix Variables

Note: Models below refer to animations or movies

1. Examples of specific maladaptive thinking styles

2. Specific forms and self report questionnaires to help client identify and classify cognitive and behavioral patterns

3. Variations probe questions to elicit maladaptive thinking styles and contents of thought

4. Variation in type of example in animation/movie examples

5. Variation in outcomes in animation/movie examples

6. Sex of the animation model

7. Age of the animation model

8. Ethnic/Social background of animation model

Implementation: Programming Steps

1. Screen 1. Entry/Gateway Screen. Note: This module is typical accessed or Called by another module.

2. Screen 2. Introduction to Cognitive Self-Monitoring Technique (CSMT)

3. Screen 3. This is the first part of CSMT in which the client learns how to become aware of, to detect, and to monitor negative cognitions. In this screen the client is given a basic introductions to the methodology

4. Screen 4: In this screen the client sees either an animation or video of an individual with a particular problem and how they learn to identify the thoughts or images that produce their maladaptive behavior (Video File: CDMTv1-4). There will be 4 possible videos of different common situations the individual can select from to see the demonstration of this technique. The client can select as many of these AVI clips as they want, and repeat them as frequently as they desire though the provided AVI controls. These videos or animations will also demonstrate how to use the forms to collect the relevant data generated by the cognitive self-monitoring process.

5. Screen 5: After completing the demo video, the client will have an additional set of 4 animations or videos to watch and record the data without the animations providing this part of the process. They will first receive the instructions provided in Screen 4. After they have entered their responses as to what they thought the negative and maladaptive cognitions were in the animation/video. Their responses will then be displayed against those that where inherently built into the scenario. The client will be able to assess the degree to which they were successful, and see what type of errors they missed. This will further enhance their training in this technique. The client will be encouraged to try all 4 tests animations/videos, and particularly if they do not show reasonably accurate results in their first try.

6. Screen 6: The client is asked to record their results on the Personal Record Keeping Form (PRKF), which will be displayed in the lower portion of the demo. This PRKF is a section of the Report and Form Generator Module that will be implemented in many other modules. This module design the necessary forms for the client to collect data, it collects the data either directly or from other modules, analyzes the data, and generates a report. The Cognitive Self-Report Form will be often used in conjunction with the PRKF and the data collected in the PhysioScan Module. This data is index to the PRKF. In addition, the client will take several standardized tests, which help assess their irrational beliefs and distorted thinking. The results of this test are summarized on the PRKF.

7. Screen 7: This screen will show a variety of self-report data forms. Any of these specific self-report forms will be integrated into the Personal Record Keeping Form. These forms will also be the forms printed out whereby the client records their data from homework exercises by hand and later input them into the computer.

8. Note: The Generalized Assessment Module has a number of assessment forms available for a variety of problems, difficulties, symptoms, diagnosis, and complaints. It also has forms for positive cognitions and behaviors that are related to progress, optimization of performance, and reinforce. Many of these forms are modifiable and can be accessed by the Design Form (from the Report & Form Generator Module. These forms can also be customized to the individual problems. The user can also use the Design Form Module to customize a completely new form if the ones available for the client are not appropriate.

9. Screen 8: n the Design Form (from the Report & Form Generator Module) screen, the client will be presented with a list of common ailments, symptoms, and complaints often associated with stress. These will include both physiological and psychological symptoms. When the client checks an appropriate box, an appropriate form of self-report will appear on the data collection form. Thus, if the person selects migraines or tension headaches, the data collection form will included appropriate measures to rate the frequency of the migraine, its intensity, and when they are most likely to occur.

10. Note: The rating scales used in this system are typically 5-point Likert scales ranging from mild or not at all to very painful and or very frequently. Once the form for the particular client is established, it can be completed immediately online whenever it appears as part of the protocol sequence.

11. Note: For the Cognitive Restructuring Module these questionnaire-forms include the following forms: 1) Maladaptive Thinking Styles Questionnaire, 2) The Brief Survey of Irrational Thoughts & Beliefs, and 3) The Bindler Anxiety Scale SV (short version). These tests will help the client define precisely which areas they most frequently have difficulty and the general nature of the way the think adversely.

12. Note: For the Cognitive Restructuring Module the client also fills in Narrative Cognitive Report Form, which provides a means for the client to input a description of, thought patterns they wish to modify and change. This form structures the client's narrative in away that will make the responses (behavioral or cognitive) clear, unambiguous, and as simple as possible.

13. Note: The Narrative Cognitive Report Form focuses the client on:

A. A generally disturbing pattern of behavior (e.g., frequently getting into arguments)

B. Picking a specific example of the situation and recording the details.

C. Recording the specific self-talk the client experiences during the incident

D. Recording basic emotional state during specific event.

14. Note: In addition, portions of the narrative that are recorded by voice are formulated in a way that the client can use them as stimuli in the cognitive restructuring process (as well as other module). The textual narrative integrated with the voice narrative provides some of the stimulus output for the client during the cognitive restructuring training.

15. Note: In order to input voice material the client requires a 1) sound card, 2) speakers/headset 3) microphone, and 4) software to record voice like Microsoft Media Player.

16. Note: Alternatively, if the client uses the printed version, they can input their collected data the next time they logon. The form displayed is usually organized in the following way. At the outset, the data is collected as an initial baseline. Subsequently the form can be used to track the patient's ailments through various periods of the day. In addition, the client will always enter data immediately prior to and immediately after a training period. This helps to monitor progress and provide the program with information it can use to modify or change strategies if the current techniques are not successful.

17. Note: Finally, the client fills in the Personal Record Keeping Form at the end of training. When possible, the client should also record their data after 4, 6, 9, and 13 months as a follow-up. This is not only useful to determine the efficacy of the program, but also serves as a possible reminder that the client needs to resume training because they are not keeping up to their expected levels.

17. Note: A typical cognitive-behavioral self-monitoring data collection form appears below, as it would be integrated into the Personal Record Keeping Form:

18. Note: After the completion of each session if the Cognitive Self-Monitoring & Self-Reporting Module the client is sent by the Protocol Sequencing Module, to the Reinforcement Module so the client assigns to themselves sufficient reinforcement a) to strengthen their learning curve and b) to enhance motivation, b) practice & rehearsal, and c) to continue in the program. Forms related to the cognitive self-monitoring and self-reporting module are illustrated in FIGS. 11a-e.

Behavior Modification & Habit Control Module

Function

The function of this module is to provide the client with a systematic and progressive strategy to modify, change, or eliminate undesirable & disruptive maladaptive behavior patterns of negative (“bad”) habits. The approach is rooted in a behavioral formulation of response conditioning, shaping, and extinction. The first part of the training consists of what is called herein behavioral self-monitoring training. This technique is designed to help the client 1) to become more aware and conscious of the response they wish to modify or change, and 2) to identify and to record all the particular characteristics of the behavioral response by delineating their specific details, like the form of the response (e.g., nail biting), its frequency of occurrence, the intensity of the responses, the circumstances under which it occurs, the physiological sensations experienced prior to or during the occurrence of the behavior, and various other properties of the response In order to successfully change any behavior, one must be able to be aware of it and to clearly define it, by detailing the parameters as just noted. This is the essence of the Behavioral Self-Monitoring Technique (BSMT) in which the client learns how to become aware of, to detect, and to monitor negative, maladaptive, dysfunctional behavior response patterns.

In order to change maladaptive, habitual responses one needs to gain a stronger awareness of the activity, particularly at the moment it occurs. The fact that people with dysfunctional behavior patterns lack an immediate and clear perceptual acuity regarding their behavior is a primary reason they cannot control it. Since it is generally outside the immediacy of awareness means they cannot use self-control strategies to modify or change the behavior. You obviously cannot change something of you are not aware of it. Additionally, since the client is not aware of it and cannot control it, many individuals with maladaptive behavior patterns and negative habitual responses often are embarrassed by their behavior when :caught” doing it in public (e.g., picking one's nose)

Self-Awareness Training an extremely important and vital aspect of BSMT. As was noted, in order to modify habits and other forms of disruptive, dysfunctional and maladaptive behavior, the client has to learn how to become aware of all the variables pertaining to the habit. Without this information, the client could not possibly know what it is that they must change. Thus, the client must have trained in both the Attention and Awareness Training Module and the PhysioScan Technique and the other components of physiological self-monitoring in the PhysioScan Module before continuing in the current module. These modules train the client in the attention & awareness techniques they need to know if want to change their dysfunctional an maladaptive behavior or unhealthy and adverse habitual behaviors. In Attention & Awareness Training and the PhysioScan Technique the client learns to enhance their attention, focusing, and concentration abilities and to learn techniques that will heighten their awareness of their maladaptive behavior. In particular, the client needs to learn methods to bring into the immediacy of consciousness all the details surrounding their disruptive behavior pattern including a) the occurrence of the behavior, b) the details & sequence of the details of the behavior, c) other behaviors & sensations associated with the behavior, and d) the situations within which the behavior occurs.

As part of the Attention & Awareness Module there is a submodule for self-awareness training, which trains the client in specific techniques to become more cognizant of their own disruptive and repetitive behaviors that are generally outside the immediacy of their consciousness. The PhysioScan Technique is particularly useful in this section because it trains the client to be aware of bodily sensations, and how they are associated with emotional arousal, thoughts, images, and behaviors. Through the PhysioScan Technique the client can learn to identify even more subtle cues that are associate with their maladaptive and habitual behavior patterns. Therefore, in later stages of the behavior modification procedure, when the client learns to disrupt their behavior early in its occurrence, the sensations detected as an covert antecedent factor could allow the client to disrupt their behavior at an even earlier stage.

The client learns to use these techniques to heighten their awareness of their own specific maladaptive behavior or disruptive habit. After detailing the behavior, and identifying the circumstances under which it occurs, they then learn to modify it. One of the primary techniques is to implement a competing response that is of a character that it blocks the occurrence of the habit or maladaptive behavior by the physical characteristics of the response. For example, fist clenching in a manner that hides the fingertips could be used for a nail biting habit. The client now uses their increased awareness of their negative behavior to implement the competing response at every occurrence of the negative behavior. They need to hold the responses for approximately 3-minutes, which is sufficient time for the impulse or the need to indulge the desire for the negative behavior to subside.

Another technique is to learn a relaxation technique, with the end-point of being able to relax by the method of Relaxation by Cued-Recall. This allows the client to become deeply relaxed and enter a state of de-arousal fairly easily and quickly. Using relaxation techniques at least twice daily in the beginning will train the client to relax, and thereby reduce some of the anxiety and tension that “fuels” the maladaptive behavior. Bad habits, for example, are often preconscious means of re-channeling the client's nervous energy into a symptomatic behavior expression. This is similar to the way many individuals somatize their states of tension. That is to say, their anxiety and stress is manifested in or exacerbates physiological symptoms like migraine & tension headaches, hypertension, Raynaud's disease, excessive perspiration, excessive muscle tension and muscle spasms, ulcers, and the hyperventilation syndrome.

Relaxation techniques are also used to disrupt the Maladaptive or habitual behavior sequence. Once the response is detected, the client relaxes immediately by the method of Relaxation by Cued-Recall. Firstly, the relaxation reduces some of the tension manifested in the disruptive behavior. Secondly, one can use, for some forms of behavioral responses like ticks, the relaxation limp & loose posturing characteristic of relaxation to block or disrupt the negative behavior. Other techniques are also available to block or disruptive a maladaptive behavior sequence or a habitual response pattern. As the client practices, they should try to disrupt the behavior as early into the sequence as possible. The less of a chance any aspect of response has to occur, the more likely it will extinguish over time. Furthermore, by implementing the PhysioScan Technique, the client may even be able to identify covert physiological sensations that precede the overt manifestation of the negative behavior. This would allow the client to make an intervention even before they detect its behavioral presence.

The client is assigned homework practice with sufficient frequency that if the client follows the protocol, they should be able to eliminate these disruptive behaviors within two-weeks. To increase their motivation, they are referred to the Reinforcement Module to enter pints that will result in sufficiently strong reinforcement that will 1) enhance motivation, 2) strengthen the competitive responses that block the behavior, 3) facilitate extinction of the maladaptive behavior, and 4)enhance concentration, focus, and awareness.

Implementation

Module Goals

1. To train the individual to monitor and to become more cognizant of habit behaviors and other forms of disruptive and dysfunctional response patterns.

2. To learn to de-construct the primary negative behavior into its component parts.

3. To be aware of the sequence of the component parts, or their interconnectedness.

4. To become aware of the discriminative stimuli associated with the primary negative behavior pattern.

5. To become aware of other responses and behaviors that are not in the class of behavior identified for the primary behavior, but are commonly associated d with the primary negative behavior.

6, To learn to disrupt and to extinguish the primary negative behavior sequence by a competitive response.

7. To learn to disrupt and to extinguish the primary negative behavior sequence by a assuming a relaxed posture.

8. To learn to disrupt and to extinguish the primary negative behavior sequence by general deep relaxation on a daily basis to reduce the anxiety and tension substrate often associated with habits and other forms of disruptive behavior.

9. To practice and rehearse the awareness, relaxation, competitive response daily and to record their data in the Personal Record Keeping Form.

Module Behaviors & Cognitive Patterns

21. Enhanced concentration, focus and awareness.

22. Greater awareness of the occurrence of habits and other negative behaviors.

23. Monitoring and identifying ones one behaviors and physiological sensations.

24. Learning to block one response by another

25. Learning to relax to reduce nervousness

26. Using relaxation posture to block some forms of negative behavior.

Parameter Matrix Variables

24. Type of visual image (e.g., running river, sunset, forest scene)

25. Type of auditory stimulation or music (e.g., the repetitive sound of rain, baroque music, country music, the sounds of a heart beating)

26. Toe of meditative technique and/or meditative phrase employed

27. Sex of the animation model

28. Age of the animation model

29. Ethnic/Social background of animation model

30. Possible competing responses for common “bad” habits and other types of maladaptive behavior

31. Various relaxation techniques accessed by Calls to the pertinent relaxation modules

Module Design

This module provides 1) images, photographs, movies, & animations, 2) relaxing music and sounds, and 3) combined auditory and visual relaxation images as the background for cognitive-behavioral practice and rehearsal strategies. In addition, it implements the counting and timing functions necessary to determine the amount of time spent in each rehearsal segment or stimulus presentation, and 2) the number of practice segments in each rehearsal or practice session. The multimedia stimuli utilized in this module facilitate relaxation, image vividness & intensity, and imaginative involvement. Thus, the multimedia capacities of the module enhance the practice experience by intensifying it and by associating the practice stimuli with de-arousal.

Module Implementation: Programming Steps

1. Note: For any class of behavioral dysfunction, there will be 1-4 videos of different common examples. For example, for habit dysfunctions, there are movie clips of 1) nail biting, 2) hair pulling, 3) tics, and 4) stuttering. The client can select from one or more of these demonstrations. They must select one before continuing in the module.

2. Note: The client can select as many of these AVI clips as they want, and repeat them as frequently as they desire through the provided AVI controls. These videos or animations will also demonstrate how to use the online & printed versions of forms to collect the relevant data generated by the behavioral self-monitoring process. These data forms are provided through the Report & Forms Generator Module. These forms are also attached to the Personal Record Keeping Form (PRKF).

3. Screen 1. Entry/Gateway Screen

4. Screen 2. Self-Awareness Training. The client is given an overview of the Behavioral Self-Monitoring Technique (BSMT) and its role in Self-Awareness Training. In this screen the client is introduced more fully into the concept of self-monitoring & self-awareness. Behavioral self-monitoring is the general terms for the various techniques employed in identifying behavioral responses, and delineating their specific details, like the form of the response (e.g., nail biting), its frequency of occurrence, the intensity of the responses, the circumstances under which it occurs, the physiological sensations experienced prior to or during the occurrence of the behavior, and various other properties of the response (see above). In order to successfully change any behavior, one must be able to clearly define it, by detailing the parameters as just noted. This is the essence of BSMT in which the client learns how to become aware of, to detect, and to monitor negative, maladaptive, dysfunctional behavior response patterns. In this screen the client is given a more detailed introduction to the methodology and why it is useful. In order to change maladaptive, habitual responses one needs to gain a stronger awareness of the activity, particularly at the moment it occurs. The fact the people with dysfunctional behavior patterns lack an immediate and clear perceptual acuity regarding their behavior is a primary reason they cannot control it. Since it is generally outside the immediacy of awareness means they cannot use self-control strategies to modify or change the behavior. You cannot change something of you are not aware of it. Additionally, since the client is not aware of it and cannot control it, many individuals with maladaptive behavior patterns and negative habitual responses often are embarrassed by their behavior when :caught” doing it in public (e.g., picking one's nose)

4. Note: Attention & Awareness Training. An extremely important and vital aspect of modifying habits is becoming aware of all the variables pertaining to the habit. Without this information, the client could not possibly know what it is that they must change. Thus, the client first must have either completed both the Attention Training Module and the PhysioScan Module or do so at this time. These modules train the client in the attention & awareness techniques they need to know if want to change their dysfunctional an maladaptive behavior or unhealthy and adverse habitual behaviors. The module now queries the client if they already completed a) the Attention & Awareness Training Module, which includes a section on self-awareness training, and b) PhysioScan Technique. f they have they can continue in the current module. If they have not, they must now train in either or both (depending on their previous training) the Attention & Awareness Training Module and the PhysioScan Module to enhance their attention, focusing, and concentration abilities and to learn techniques that will heighten their awareness of their maladaptive behavior, In particular, the client needs to learn methods to bring into immediacy of awareness all the details surrounding their disruptive behavior pattern including a) the occurrence of the behavior, b) the details & sequence of the details of the behavior, c) other behaviors & sensations associated with the behavior, and d) the situations within which the behavior occurs. The informed that through the remainder of the current module they will have access to the Attention and Awareness Training Module through a “button” in the various training screens below.

Note: The PhysioScan Technique Is particularly useful in this section because it trains the client to be aware of bodily sensations, and how they are associated with emotional arousal, thoughts, images, and behaviors. Through the PhysioScan Technique the client can learn to identify even more subtle cues that are associate with their maladaptive and habitual behavior patterns. Therefore, in later stages of the behavior modification procedure, when the client learns to disrupt their behavior early in its occurrence, the sensations detected as an covert antecedent factor could allow the client to disrupt their behavior at an even earlier stage than awareness of overt behavioral change.

7. Screen 5: The client is questioned as to whether or not they have completed both the Attention & Awareness Training particularly the Self-Awareness Procedures) and the PhysioScan Technique. If they have, they can continue in the current module. If they have not they must train in either or both procedures, depending on their prior training experience. There are onscreen “buttons” that the client can use to select these options. Each of the two training buttons accesses or “Calls” the appropriate training module.

7. Identifying Effects of Disruptive, Bothersome & Frustrating Behaviors. In this sections the client will be systematically questioned to ascertain what aspects of their maladaptive and dysfunctional Behaviors indicates to them that it is a problem. The goal is to define how these behaviors frustrate and annoy the client as a means of motivating to complete the procedure. The more aware of how bothersome and embarrassing their behavior pattern is, and how it affects the way the live will serve as an impetus for them to change.

9. Screen 5A: The client is given an overview and general instructions as how to determine what the disruptive, bothersome, annoying, and frustrating aspects of their disruptive or habitual behavior are.

8. Screen 5B: the client is shown a animated vignette or a movie on how behaviors of this type can influence an initial, for example, thorough embarrassment, and people avoiding them, and being personally annoying. If there is a specific issue at hand, like habit control, the vignette will focus on this issue.(Video File: BSMT1v1-4.

5. Screen 5C: After completing the demo video, the client will have an additional set of 4 animations or videos (Video File: BSMT to watch and record behavioral data (the animations will not show this part as above). The client is instructed as to how to make these observations and complete the associated online forms.

6. Screen SD: They are then provided with the opportunity to enter online their responses as to what they thought the bothersome and frustrating effects were in the animation/video. Their responses will then be displayed against those that where inherently built into the scenario. The client will be able to assess the degree to which they were successful, and see what type of errors they missed. This will further enhance their training in this technique. The client will be encouraged to try all the demonstration animations/videos, and particularly if they do not show reasonably accurate results in their first try.

Screen 5E. Ins this screen the client is instructed to complete the Influence of Disruptive Behaviors and Bad Habits Survey. This survey allows the person simply to record in al the various ways their maladaptive behavior influences their lives.

8. Screen 5F: The client is then complete the Influence of Disruptive Behaviors and Bad Habits Survey online. They have the option of printing a copy of the form so they can additional items when not online and input them in a following session.

10. Relaxation Training. At this point the client needs to either learn a relaxation technique or reinforce the techniques they have already learned, to the point of being able to use Relaxation by Cued-Recall. Relaxation is used in the Behavior Modification Procedure to a) to reduce the level of nervousness, tension, and anxiety often associated with maladaptive and habitual behaviors, and b) as a technique later in the procedure to disrupt the negative behavior in is early stage of occurrence. This second step is implemented once the client gains some facility with being able to identify and to become aware of their negative behavior patterns.

9. Screen 6: The client is presented a menu of relaxation techniques. The client has the option of selecting either Training (to learn a technique) or Practice (to practice and rehearse a technique already learned).

10. Note: If they choose Practice for a particular technique, they are first assessed to see how well they induce a relaxed state using Relaxation by Cued-Recall. If they meet the criteria for relaxation, they are returned to this module. If they do not, the assessment process will help them determine if they just need to practice Relaxation by Cued-Recall, or if they need reinforcement and practice in earlier parts of the relaxation technique training.

11. Note; The Relaxation Menu will indicate that all clients must either first train or practice Diaphragmatic Breathing before beginning another technique.

12. Note: Once the client is able to meet the criteria for deep relaxation by the method of Relaxation by Cued-Recall they first enter the relevant information in their Personal Record Keeping Form are returned to the Behavior Modification & Habit Control Module. As part of their daily homework assignments, they will be asked to practice their Relaxation by Cued-Recall at least twice per day.

9. Increased Awareness of the Specific Response Details of Maladaptive Behavior. In the next step the client is required to become more aware of the disruptive and maladaptive behavior when it occurs. In addition, they must learn to focus on and to identify the various details of how the behavior occurs. For example, before pulling out one's eyebrows, the client sees that he or she always pulls on their nose a few times first. This procedure helps to diminish the automat city of awareness that accompanies the maladaptive behavior. Therefore, by making the client more aware and conscious of the behavior and the specific details of the behavior the procedure allows the client to gain access to responses that can be modified by the procedures below.

12. Note: The client is then taught a number of techniques to increase his or her awareness of their disruptive and maladaptive behavior pattern. A number of these techniques are available in Attention & Awareness Training Module, which the client must* complete before beginning this module.

12. Screen 7: This screen shows the options in the Attention & Awareness Training Module that the client has access to if they need reinforcement or re-training on a particular technique. They will also be reminded that through the remained of the current module they will have access to the Attention and Awareness Training Module through a “button” in the various training screens below.

13. Screen 8: The client will be taught (or reinforced, if they have already practice the techniques) several attention and awareness enhancing techniques specific for maladaptive and disruptive behavior patterns. In Screen 8: they will be given an overview and general instructions for these techniques. These techniques are accessed from the Attention Training Module. These techniques are particularly useful in learning to control disruptive habitual behavior.

12. Screens 9: The Mirror Technique. The client is given instructions in this technique. It is accompanied by a voice description and an animation/movie of a person practicing this technique. The client is told: In this task you must stand in front of a mirror and do the habit behavior like a jerk response or rapid eye blinking. Carefully observe all the components of the behavior. Exaggerate it a little bit, like in the animation (movie). Practice this at least 3 times day for at least 3-5 minutes”

13. Screen 10: Habit Concentration & Interruption: This technique is particularly useful once the client has gained some sensitivity to their habitual behavior. The client is given instructions in this technique. It is accompanied by a voice description and an animation/movie of a person practicing this technique. The client is told: “Now that you are more aware of your habit, when you see your self engaged in the behavior, focus on it, concentrate on all the details for about two minutes, then abruptly force yourself to stop the behavior for at least 10 minutes. Record your self-observations on your PRKF, Enter the information into the computer at the beginning of next session.”

14. Screen 14: Exaggeration and Deconstruction of Disruptive or Habitual Behavior. The client is given instructions in this technique. The instructions are also presented voice and integrated wit an animation/movie in which the technique is demonstrated. The client is told: “In this technique I want you to really exaggerate and examine the particulars of your habitual behavior. Go through the motions very slowly and deliberately. Also describe to yourself in as much details as you can the sequence of your behaviors, like you saw the animation do. You can also do this exercise in front of a mirror if you cannot see certain aspects of the sequence. After you is done record your description in the space provided in the Personal Record Keeping Form.”

7. Primary Maladaptive Behaviors & Habit Patterns. The client now learns to identify and to classifying the main or primary responses that form the class of behavior defined as the problem (e.g., nail biting includes cuticle biting). The client will be instructed in a variety of techniques to observe and to identify their primary maladaptive and habitual behaviors. Primary behaviors are those behaviors that constitute the class or category that incorporates these behaviors (e.g., nail biting includes biting cuticles).

11. Screen 6: The client is then given the shown an animation or video strategies and techniques to identify the details of how to become more aware of their maladaptive behavior, to become more aware of the details of that behavior, and 3) to discover where and under what circumstances this behavior occurs. In this screen the client sees either an animation or video of an individual with a particular problem (e.g., a habit like nail biting) and how they are shown how to identify the different responses that comprise the more generic behavioral pattern of associated behaviors (e.g., biting nails, biting cuticles, picking at cuticles) (Video File: BSMT1v1-4).

5. Screen 5: After completing the demo video, the client is presented with an additional set of 4 animations or videos (Video File: BSMT). In these video/animations only the disruptive or habitual behavior pattern is presented, not the methodology to observe the details and sequence of the behavior. An onscreen “button” is available to hear and see instructions as to how to make these types of observations if the client needs help. The client is required to make these observations and record them online in a form presented in ,a portion of the screen. After they have entered their responses, they are displayed against those that where inherently built into the scenario. The client will be able to assess the degree to which they were successful, and see what type of errors they missed. This will further enhance their training in this technique. The client will be encouraged to try all the demonstration animations/videos, and particularly if they do not show reasonably accurate results in their first try.

12. Using the PhysioScan Technique to Detect Antecedent Sensations of the Primary Maladaptive Response. The PhysioScan Technique can be useful in identifying physiological sensations that precede the overt manifestation of the primary maladaptive behavior. The client is instructed in applying the PhysioScan Technique after that have gained skill at rapidly and frequently being able to identify the occurrence of the maladaptive or habitual behavior, including the details, and the sequence of the details. Thus before any of the exercises where they must examine or exaggerate a behavior, they should use s Rapid PhysioScan of the whole body, and the particular region of the body where the maladaptive behavior occurs. Through this scan, they attempt to identify any physiological sensations that may occur prior to the overt manifestation of the response. If they do, they can use these sensations later in the protocol when the client is attempting to disrupt the maladaptive behavior and substitute another behavior for that.

6. Screen 6: Primary Maladaptive & Habit Behaviors Form. The client is now instructed as to how to develop a Primary Maladaptive & Habit Behaviors Form. This form will help the client to identify, to observe the details of, to track and to record all aspects of their primary maladaptive behavior. This screen provides the opportunity for the client to view the various behavioral self-report forms selected for their particular problem. By clicking on a thumbnail view of any particular form, the client can view an example of a completed form. The client is further instructed in completing these forms as a means of collecting data from a behavioral perspective. Any of these specific self-report forms will be integrated into the Personal Record Keeping Form. Online and printed versions of these forms are also used to collect data during homework. The data collected during homework are input into the computer during the next session.

8. Note: Part or all of these forms can be customized to the specific requirements of the client's problem. The Design Form SubModule in conjunction with the Behavioral Self-Report SubModule of the Report & Forms Generator Module can create an individualized form to track behavioral data. For example, to create a self-monitoring and self-tracking form for habits, the client first selects from a list their particular habit (e.g., nail biting). At the top of the screen, there is a precise definition of the behavioral pattern constituting the habit. The client is brought to the next screen, which lists numerous acts, responses, and behaviors that fit the class of behaviors defined by the habit pattern (e.g., nail biting, cuticle biting, picking teeth with nail). The client clicks on the “check-boxes” next to the behaviors that typify their maladaptive behavior pattern. In addition, the client has the option of adding up to five additional behaviors that are not on the list.

9. Note: When the client finishes, they exit the screen and a form appears with the client's list of particularized habit behaviors. In addition, three other columns appear establishing the parameters of the data collection: 1) the time of occurrence of the behavior, 2) the severity of the behavior, and 3) where the behavior occurred.

10. Note: For a behavior or response pattern that does not meet the classification criteria in the module, the client has the option of a) putting together a form which has input from a number of the lists. In addition, the client has the option inputting up to ten more behaviors. The client will have the opportunity to update the assessment instrument as their behavioral self-monitor & self-monitoring skills improve,

9. Note: The rating scales used in this system are typically 5-point Likert scales ranging from mild or not at all to very painful and or very frequently. Once the form for the particular client is established, it can be completed immediately online whenever it appears as part of the protocol sequence 12. Note: For the Behavior Modification Module the current list of behaviors maladaptive habit patterns, relatively mild addictions (e.g., smoking, coffee), and mild tic disorders. These self-report assessment schedules will help the client define precisely which behaviors or responses are the targets of the behavioral modification and change techniques. The also have a hierarchical index of relative severity of each behavior, which predicts a greater resistance to modification.

11. Note: The client has the option of completing forms online, even during homework. Alternatively, the client can chose to print out a copy of the form. If the client selects the printed version, then during the next session they can input into the computer the data that was collected.

13. Note: The form displayed is usually organized in the following way. At the outset, the data is collected as an initial baseline. Subsequently the form can be used to track the patient's negative behavioral patterns through various periods of the day. In addition, the client will always enter data immediately prior to and immediately after a training period. This helps to monitor progress and provide the program with information it can use to modify or change strategies if the current techniques are not successful.

11.Screen 15: The client is then instructed on how to complete the Primary Disruptive & Habitual Behaviors Form. They are given instructions on using their attention and awareness techniques to track their behavior. The client is then asked to exit the session and practice the techniques they learned to identify the specific details of how and where the specific behaviors occurred. This form will allow the client to track and collect the relevant data from the attention and awareness techniques that apply to their maladaptive behavior and habit patterns. The client prints out the form, and completes after each practice session (see homework section below).

12. Secondary Behaviors Associated with the Primary Disruptive or Habitual Behavior. The maladaptive or disruptive behavior or habit pattern the client wishes to change or modify is considered the primary behavior. In tracking and monitoring their main or primary behavior, the client also need to tack behaviors associated with it that are not directly part of the primary behavior's response pattern. This is called the secondary behavior. A secondary behavior is connected to the primary behavior but it does not actually meet the criteria for the primary set of behaviors. For example, nail biters frequently smoke and/or touch their cheeks. In this form the client also has to rate to what degree each of these associated behaviors are linked to the Primary Maladaptive Behavior. Identifying and monitoring these behaviors serves to enhance the client's awareness of the primary behavior by extending their awareness to the entire domain of its function and influence.

11. Screen 6: The client is then given the shown an animation or video strategies and techniques to identify the details of how to become more aware of the secondary behaviors associated with their maladaptive or habitual behavior, to become more aware of the details of secondary behaviors, and to discover where and under what circumstances they occur. In this screen the client sees either an animation or video of an individual with a particular problem (e.g., a habit like nail biting) and how they are shown how to identify the different responses that comprise the secondary behaviors associated with the primary maladaptive response (Video File: BSMT1v1-4).

5. Screen 5: After completing the demonstration video the client is presented with an additional set of 4 animations or videos (Video File: BSMT). In these videos or animations only the disruptive or habitual behavior pattern is presented, not the methodology to observe the details and sequence of the secondary behaviors associated with it. An onscreen “button” is available to hear and see instructions as to how to make these types of observations if the client needs help. The client is required to make these observations and record them online in a form presented in ,a portion of the screen. After they have entered their responses, they are displayed against those that where inherently built into the scenario. The client will be able to assess the degree to which they were successful, and see what type of errors they missed. This will further enhance their training in this technique. The client will be encouraged to try all the demonstration animations/videos, and particularly if they do not show reasonably accurate results in their first try.

13. Screen 16: The client is then instructed on how to complete the Secondary Behaviors Associate with Disruptive and Habitual Behaviors Form. They are given instructions on using their attention and awareness techniques to track their behavior. The client is then asked to exit the session and practice the techniques they learned to identify the specific details of how and where the specific behaviors occurred. This form will allow the client to track and collect the relevant data from the attention and awareness techniques that apply to their maladaptive behavior and habit patterns. The client prints out the form, and completes after each practice session (see homework section below). In addition, they are instructed to carry Part B of this form with them so they can track where these behaviors occur when they notice them. If the behavior occurs very often in the beginning, they are instructed to record this information once every half-hour.

14. Screen 7. In this screen the client will complete Secondary Disruptive or Habitual Behaviors Form. In this form the client will go through the same process as in the Primary Disruptive and Habitual Behaviors Form. However, they will now select response patterns characteristic of behaviors that the client associates with the primary behaviors

15. Note: The client has to also indicate whether the associated behavior is an antecedent of the PMB, simultaneous with the PMB, subsequent to the PMB.

8. Note: Situational Occurrences of Disruptive and Habitual Behaviors. As part of the process of becoming aware of the primary behaviors, the client must also be able to detect where they occur. The client goes through the final phase of the forms development process by creating a form which reflects the degree to which the client feels particular situations are more like to elicit or ac as a discriminative stimulus for the occurrence of the maladaptive behavior. For example, people who overeat, when they diet should eat in a different place, with new utensils. The usual place of eating was rife with conditioned discriminative stimuli. In essence, this means they were conditioned stimuli that could elicit the eating response.

11. Screen 6: The client is then given the shown an animation or video strategies and techniques to identify the details of how to become more aware of the situations within which their maladaptive or habitual behavior occur and to identify which settings may actually elicit their maladaptive behavior pattern. In this screen the client sees either an animation or video of an individual with a particular problem (e.g., a habit like nail biting) and they are shown how to identify the situations and settings within which the behavior occurs, and what events may actually trigger the behavior (Video File: BSMT1v1-4).

5. Screen 5: After completing the demonstration video the client is presented with an additional set of 4 animations or videos (Video File: BSMT). In these videos or animations only the disruptive or habitual behavior pattern is presented, not the methodology to observe the situational factors associated with the behavior. An onscreen “button” is available to hear and see instructions as to how to make these types of observations if the client needs help. The client is required to make these observations and record them online in a form presented in a portion of the screen. After they have entered their responses, they are displayed against those that where inherently built into the scenario. The client will be able to assess the degree to which they were successful, and see what type of errors they missed. This will further enhance their training in this technique. The client will be encouraged to try all the demonstration animations/videos, and particularly if they do not show reasonably accurate results in their first try.

9/ Screen19. The client is instructed in completing the situational Occurrences Form. They are instructed to carry this form with them so they can track where these behaviors occur when they notice them. If the behavior occurs very often in the beginning, they are instructed to record this information once every half-hour.

10. Learning and Implementing a Competing Reaction or Response. The final phase of the Behavior Modification & Habit Control Module is to train the client to formulate a response or reaction to the disruptive or habitual behavior. The competing response is the behavior that initially disrupts, and can ultimately come to substitute for the maladaptive behavior. Of major significance is the competing response is incompatible with the primary disruptive one. That is to say, when one is engaged in the competing response it is not possible to engage in the primary one. For example, a competing response for nail biting is to grasp your hand moderately tightly so that the nails and cuticles are not even visible. Another important aspect of the competing response is that one should be able to maintain it for sever minutes and yet not look odd or stagnate to other people. The competing response also should be of such a nature that it heightens your awareness of the absence of your disruptive or habit behavior. Finally, the competing response should be of such a nature that it does not ordinarily interfere with your other activities.

11. Screen13. In this screen the client is introduced to the topic of competing responses and their functioning controlling a disrupting or habitual behavior. They are

4. Screen 4: In this screen the client sees either an animation or video of an individual with a particular problem (e.g., a habit like nail biting) and how they learn to y=use a competing response to disrupt and/or to substitute for the primary maladaptive behavior or habit pattern. The client sees how this strategy is implemented and how to record the data appropriate to checking the success of the method (Video File: BMHCT1v1-4).

5. Note: For any class of behavioral dysfunction, there will be 1-4 videos of different common examples. For example, for habit dysfunctions, there are movie clips of competing responses for 1) nail biting, 2) hair pulling, 3) tics, and 4) stuttering. The client can select from one or more of these demonstrations. They must select one before continuing in the module.

6. Note: The client can select as many of these AVI clips as they want, and repeat them as frequently as they desire through the provided AVI controls. These videos or animations will also demonstrate how to use the online & printed versions of forms to collect the relevant data generated by the behavioral self-monitoring process. These data forms are provided through the Report & Forms Generator Module. These forms are also attached to the Personal Record Keeping Form (PRKF).

5. Screen 13. After watching the demonstration, the client then has an opportunity to select an appropriate competing response from a menu of choices of common disruptive behaviors and habits. There are usually several possibilities for the competing response. If the client's particular problem des not match those in the menu choices, they have a button to click which brings them to an instructional page which instructs them in detail (with a voice accompaniment) on hoe to choose their own behavior based on the characteristics of a competing response described above.

6. Screen 14. The client is then instructed how to use their competing response in everyday life. They first start out with their attention and awareness techniques that allow them to identify when the primary disruptive response is occurring. By this time they should be well versed in these techniques, and their primary behaviors should be readily noticeable to them.

8. Using Relaxation to Disrupt the Maladaptive or Habitual Behavior. Relaxation techniques can also be used to disrupt maladaptive behavior patterns. The client is instructed to use relaxation in a similar way to disrupt their maladaptive behavior. As early into the behavioral sequence as possible, the client should begin to relax using the method of Relaxation by Cued-Recall to relax as rapidly as possible. This is particularly useful when the client is aware of nervousness, anxiety, or tension associated with their behavior. As the client has already learned and should be practicing their relaxation two times per day, they should be well skilled in developing a deep state of relaxation rapidly.

12. Screen 5: The client is instructed by voice and associated text how to use relaxation techniques to alt the occurrence of the maladaptive or habitual behavior

11. Screen 6: The client is then given the shown an animation or video strategies and techniques to identify the details of how to use relaxation techniques as a means of stopping or disrupting the maladaptive behavior. In this screen the client sees either an animation or video of an individual with a particular problem (e.g., a habit like nail biting) and how they use relaxation to halt the primary maladaptive behavior or associated secondary behavior sequences after it is initially detected. (Video File: BSMT1v1-4).

7. Homework: Basically the client is to implement the competing response every time they notice the occurrence of the negative behavior. They are instructed to maintain the competing response for a least 3 minutes when it is used. After this amount of time the urge or impulse to engage in the primary disruptive or habitual response will have subsided. The client is also instructed to implement competing response as soon as they detect any of the components of the primary or secondary responses. The client is al instructed to now to use the Mirror Techniques mentioned above to practice implementing the competing response. The client basically acts out the behavior (if not occurring naturally) and within one or two seconds begins using the competing response to disrupt the primary disruptive or habit behavior. It is suggested to the client that they practice the Mirror Technique for at least 2-times per day in the beginning. For the first week they slightly exaggerate the responses and its associated behaviors. Within a second or two of this exaggeration the client should engage in the competing response for 3-minutes. In the second week, the client practices the Mirror Technique without exaggerating the response.

Screen 8. Before this session terminates, the client fills in the Personal Record Keeping Form at the end of training. The forms generated by the Form Design SubModule in conjunction with the Behavioral Self-Report SubModule (in the Report & Forms Generator Module) will be often used in conjunction with the PRKF and the data collected in the PhysioScan Module. This data is indexed to the PRKF. In addition, the client will take several standardized tests, which help assess their irrational beliefs and distorted thinking. The results of this test are summarized on the PRKF. When possible, the client should also record their data after 4, 6, 9, and 13 months after training or treatment has terminated, as a follow-up. This is not only useful to determine the efficacy of the program, but also serves as a possible reminder that the client needs to resume training because they are not keeping up to their expected levels.

9. A typical cognitive-behavioral self-monitoring data collection form appears below, as it would be integrated into the Personal Record Keeping Form:

5. Screen 2. This screen briefly suggests which type of relaxation training to learn, if they have not already done so, to use in this module. These recommendations are based on tests in the General Assessment Module and other data that may have collected and stored in the client's Personal Record Keeping Module. The client is given a menu of 6 choices:

a. Diaphragmatic Breathing (All clients must learn this technique)

b. Progressive Relaxation,

c. Autogenic Training

d. Audio/Visual Relaxation

e. Guided Imagery

f. Meditation

6. Screen 3. Depending on the client's choice, they are sent to the specific screen giving a general overview and instructions pertaining to the relaxation technique they have selected. These instructions will be presented as a text screen combined with a voice accompaniment. The client will either first train in the relaxation technique before using the Cognitive Practice & Rehearsal Module, or use the relaxation module's practice screen to review and practice the relaxation technique.

7. Screen 4: The client will complete the Personal Recording Keeping Form (PRKF) at the appropriate places in the particular relaxation technique's module. In Screen 4 they will complete the PRKF at the beginning of the Cognitive Practice & Rehearsal Module to insure the client has achieved a sufficient level of relaxation by the method of Relaxation by Cued-Recall. Assuming that this is the case, the client can continue in the current module. Otherwise, they are referred back to the particular relaxation techniques module for further practice and reinforcement until they can achieve a sufficient level of relaxation by the method of Relaxation by Cued-Recall.

8. Screen 5A: The client will be instructed to relax using the method of Relaxation by Cued-Recall. The client will be given 5-minutes to practice to insure a deep state of relaxation. This should not be too difficult if the client has sufficiently practiced their entire relaxation training and met the specified parameters for achieving training goals.

9. Screen 5A (continued): After the instructions are completed, the screen “blanks our, turning white after the instructions to practice their relaxation. There are two small buttons on the screen. One is for review of the instructions. The other is to continue with the program.

10. Screen 5B: The client can choose to call the Audio/Visual Relaxation Module during their initial relaxation period to present audio and/or visual background to deepen their relaxation. At this time the client will select the audio/visual experience, to use during their practice and rehearsal. The client is presented with a set of menu choices that represent a subset of selections from the Audio/Visual Relaxation Module. As noted above, the audio/visual backgrounds provided in this module are fairly subdued, so as to enhance relaxation and imagery, but not be distracting in its own right. The client is also given some suggestions (as noted above) for the type of background that would be most conducive to their practice activities. This information is derived from the results of the Generalized Assessment Module and the PRKF. However, the client has, within the constraints of the module itself, latitude to select their own choices.

11. Screen 6:The client then completes a SUDs, Anxiety Level Scale, Degree of Relaxation Scale. If the relaxation us deep enough, the client continues. If it is not, the client is instructed to continue the Relaxation by Cued-Recall.

12. Screen 6: If the client's level of relaxation is acceptable, the Cognitive Practice & Rehearsal Module then signals the module that initially called it. The calling module then presents instructions to the client as to what the cognitive rehearsal and practice consists of.

13. Note: This practice can be covert as in imaginative rehearsal or practice or overt as in writing or recording the routines to be practice.

14. They are told that whey have to imagine something and then either:

a. Repeat in their mind over and over (like meditation)

b. To focus on a thought, image, emotion, or sensation (e.g., guided imagery, PhysioScan))

c. To focus away from a thought, image, emotion, or sensation, and refocus on something else (e.g., pain management)

d. To review in their mind some particular situation, scene, or event (e.g., cognitive self-monitoring)

e. To react to some particular situation, scene, or event (e.g., in refuting irrational ideas)

15. Screen 7A: Covert or Imaginative Practice & Rehearsal. When the client has to practice a routine or technique covertly they begin to imagine the image or think the thoughts as per the instructions. Screen 7 automatically presents the pre-selected backgrounds to facilitate relaxation and imaginative involvement.

16. Screen 7B: Over Behavioral Practice & Rehearsal: For those individuals who have difficulty practicing covertly either with images or verbally, they can have the option to write down or vocally record their thoughts. After having received instructions from the calling module, the module provides a white screen where the client is prompted to write down the flow of their thoughts as they think through their practice exercise. Alternatively, they can press the verbal recorder start button and record their thoughts through the microphone. When down, the client presses the Stop button. The client has the option to hear the playback. The written and the voice-recorded material are all stored in the program. This data can be “attached’ to the Personal Record Keeping Form.

17. Note: If the time to imagine a scene is delimited by the calling program, an onscreen timer in the upper right hand corner of the screen. The time parameter can be set by program, or by the client when appropriate. (Note: the timer's visibility parameter can be set by the program, or by the client when appropriate. When the time interval is over, a tone softly beeps to indicate the end of the rehearsal segment. If the time parameter is not set, the default value is 10-minutes.

18. Note: The repetition frequency parameter is the number of times a particular overt rehearsal or practice period is to be repeated. The rate of repetition is how quickly or slowly a practice period is to be completed. The repetition parameter is the same as the inter-practice period. Both the repetition frequency parameter and the repetition rate parameter can be set by the program, or by the client when appropriate.

19. Note: Based on the criteria set for the repetition frequency parameter, the client will repeat Screen N number of times, where N is the number of times the client must rehearse or practice the covert set of thoughts and actions. The default values is N=2.

20. Screen 8: After the rehearsal or practice period is completed, the Personal Record Keeping Form, combining cognitive & behavioral self-reports from the initial entries in the Personal Record Keeping, Form, the results of the Generalized Assessment Module and portions of the PhysioScan module to assess client's initial (baseline) stress and anxiety response (including Surface Temperature, Respiration Rate, Pulse Rate, SUDs score and anxiety ratings.

21. The client then clicks a Return button that brings them tack to the appropriate area in the original calling program. FIGS. 12a-b illustrate tables associated with the behavior modification and habit control module.

Self-Affirmations: Coping Skills Module

Function

The basic function of this module is to provide the user/client with techniques to modify maladaptive thought patterns and cognitions that sustain anxiety and stress. The module presents a number of standardized techniques to modify thought patterns. One for of modification uses relatively simple techniques to implement, making it relatively easy for the client to implement. The second part of the module involves more complete and interactive design based on an expert system approach to helping the client discover for them=selves ways to modify their thinking patterns. This module also draws from a number of other modules to provide, text, voice, images, animation, movies, and music to facilitate the thought change process. In addition, there is the option to provide relaxing music to further facilitate relaxation.

Based on response to questionnaires the client initially completed they will be given suggestions as to which techniques to begin with. For example, those individuals who tend to be high absorbers and also tend to obsessive, ruminative thinking would most profit from a technique like thought stopping. In this technique, the client is shown a relatively easy technique to disrupt their ruminative and obsessive thinking style. In addition, this module integrates tits techniques with the main Stress and Anxiety Management Protocol, as learning relaxation techniques is one of the most fundamental methods for reducing the anxiety basis of maladaptive cognitions.

Implementation

The Cognitive Modification & Coping Skills Module is intended for the following purposes:

1. Enhance self-awareness

2. Reduce or eliminate negative thoughts sustaining stress and anxiety

3. Enhance self-esteem

4. Provide positive reinforcements for changing ones behavior

5. Clarifying the maladaptive ways one thinks about and interacts with the world

In general the module focuses on these techniques

27. Learning to use self-talk and imagery to enhance self-esteem.

28. Learning to use self-affirmations to learn more positive ways to cope with stress

29. Learning to use thought stopping to minimize or eliminate maladaptive thoughts.

30. Learning to use re-labeling and cognitive-restructuring to change one's perception of reality and one “self” in a more positive way

31. Learning to integrate the above techniques with relaxation methods to facilitate their efficacy.

32. Learning to use the above methods in a practical manner in everyday life/

Parameter Matrix Variables

Note: Models below refer to animations or movies

32. Type of visual image (e.g., running river, sunset, forest scene)

33. Type of auditory stimulation or music (e.g., the repetitive sound of rain, baroque music, country music, the sounds of a heart beating)

34. Toe of meditative technique and/or meditative phrase employed

35. Sex of the animation model

36. Age of the animation model

37. Ethnic/Social background of animation model

Module Design

Thus module will focus on 1) visual relaxation images, movies, & animations 2) relaxing music and sounds, and 3) combined auditory and visual relaxation images. These multimedia stimuli can be used independently as a relaxation technique where thee client can experience the stimuli and let their mind “wander off and relax. This module can also provide background multimedia stimuli against which to practice other exercises. In addition, this module provides several guided images where the client can experience soothing and relaxing sounds and images while they can either read and/or scripts that facilitate relaxation. The module is so designed that one of its parameters allows for the addition of scripts for the guided image exercises.

The four major behaviors in this module the client must master are:

1. Utilizing images and sounds to relax

2. Learning to internalize visualization techniques for use in the absence of external stimuli

3. Learning to relax during guided images

4. learning to apply these techniques to everyday life

5. Learning to monitor stress & relaxation by integrating PhysioScan techniques and self-report measures to monitor the relaxation process

Module Implementation: Programming Steps

Self-Affirmations

Overview

Self-affirmations are a meditative type of technique where the person repeats over, either out loud or in one's mind, positive phrases in a relaxed state to build one's sense of self-esteem and assertiveness. It uses the deeply relaxed state to allow the affirmations to enter deep into ones consciousness so that they are readily available at times when the person most needs them. The positive affirmations become conditioned to the relaxed state, which enhances the affirmation's ability to negate the negative thought patterns.

Module Implementation

22. Screen 1. Displays text explaining the values of self-affirmations and how they work. They text with auditory accompaniment indicates how it will help them to calm their mind, build confidence, and enhance self-esteem.

23. Screen 2. They are further informed that this exercises will help to eliminate negative cognitions by supplanting them with more positive and adaptive ones. Through the power of self-repetition and auto-suggestion, practice with this technique can produce a profound influence on one's thinking pattern. Combined with relaxations and the techniques described in the PhysioScan module this can become a profound way to eliminate the negative thoughts hampering a healthier existence. The client has access to AVI controls to repeat the sequence as often as they wish.

24. Relaxation Training. The client will practice their affirmations in a relaxed state, which is also enhanced by the diaphragmatic breathing they will use to practice their affirmations. They will be given an opportunity so select a relaxation technique to learn before they continue with this module. If they have already learned the technique they are sent to the practice area of the relaxation technique to assess their proficiency and to practice the final phase of the technique to ensure they are achieving a deep state of relaxation. If they have not achieved this criteria they will have to re-train in the technique. The program will suggest a technique based on their assessment in the Generalized Assessment Module. However, they have the latitude to select another technique, but the must meet the criteria for achieving a deep state of de-arousal and relaxation. The criteria are that they must be able to relax by the method of Relaxation by Cued-Recall before continuing in this submodule.

25. Screen 3: Relaxation techniques Menu from which the client will select either Training or Practice from the technique they choose.

26. Screen 4: This screen provides the client with the basic instructions (in textual format with auditory accompaniment) for using self-affirmations. The essence of the technique is similar to Autogenic Training, except that the statements repeated by the client focus on positive, self-oriented phrases like “I feel confident.” The phrases may be repeated one at a time for a brief period of time. Or the client can chose to repeat several phrases sequentially as a cluster which is it repeated a number of times.

27. Screen 5. The client is presented with a screen with a number of common positive self-affirmations. Several may be highlighted as having potentially the most benefit for the client passed on their results from the Generalized Assessment Module, the PhysioScan module, and the Personal Record Keeping Form.

28. Screen 5 (continued): The client will have the capacity to input their own phrases, and record them in voice if the have the appropriate hardware and software (soundcard, microphone Microsoft Recorder). However, they will be encouraged to first use the available affirmations before experimenting with their own. The client will use the mouse to select up to six phrases.

29. Screen 6: This screen presents the Personal Record Keeping form so the client can enter all their initial stress and anxiety ratings.

30. Screen 7: This screen presents the client with the opportunity to practice 1) their Relaxation by Cued-Recall and 2) their diaphragmatic breathing to slow down their respiration rate. If their initial rate (as indicated on the Personal record keeping Form_ is too fast, an onscreen metronome will help the client establish their pace. Their respiration-rate will ultimately be the “timer” for their rate at which they repeat their positive affirmations.

31. Screen 8: The client is instructed to first relax by the method of Relaxation by Cued-Recall for 5-minutes. The instructions are text and voice prompted.

32. Screen 9: Initially the client will repeat out loud only one phrase at a time for a period of 3-minutes. The client will then repeat a second phrase for a 3-minute interval, after a 30-second rest. This cycle continues until all five phrases are completed. Screen 5 will display an animation/movie of a person performing the task.

33. Screen 10: The client will then see the affirmation flash on the screen and they will repeat the affirmation each time the word appears. The repetition rate will be close to that of the initial assessment of the client's respiration rate. The client will then see the second phrase and repeat for a 3-minute interval, after a 30-second rest. This cycle continues until all six phrases are completed.

34. Screen 11: In this screen the client will be told that two affirmations will be repeated as a set. Thus Affirmation A will be repeated, followed by repeating affirmation B. The client will be required to repeat each set of affirmations for 3-minutes, followed by a 30-scond break between animations.

35. Screen 12: The client will then see Affirmation A flash on the screen and they will repeat the affirmation out loud, followed by Affirmation B. The repetition rate will be close to that of the initial assessment of the client's respiration rate. Each of the three sets will be repeated for 3-minutes, followed by a 30-second rest interval.

36. Screen 13: This ends the training segment of the first session. The client then completes the Personal Record Keeping Form with the full PhysioScan profile.

37. Screen 14: In the next session the client first completes their full Personal Record Keeping Form. At this point, the client will be given the opportunity to change up to 3 of the affirmations to either new ones, or ones of their own creation.

38. Screen 15: Then the client will begin with two sets of 3 affirmations each. Each repetition period consists of 4-minutes, followed by a 30-second rest period. 39. Screen 16: The client inputs their anxiety, attention, and SUDs rating in their Personal Record Keeping Form.

40. Screen 17: Then the client is given 6-minutes to repeat all six affirmations as one set.

41. Screen 18: The client then completes the Personal Record Keeping Form with the full PhysioScan profile. This completes the portion of the training where the client repeats the positive affirmations out loud

42. Note: The client then repeats the training again, changing the out loud repetition to a “silent” one, where they repeat the affirmation in their mind.

43. Note: The client is encouraged to practice each session on the computer at least three times per week in the initial training. They are also encouraged to use it to facilitate their homework exercises.

44. At the end of each session, the submodule then calls the Reinforcement Module so the client can enter the appropriate points they scheduled for reinforcement.

45. Screen 19: Homework: The client will have the option of printing out a sheet with instructions as to how to practice their Positive Affirmations exercise without the use of a computer. In addition, they will have the option of continuing practice by returning to the program or website at any time to practice. If the client is on the PC or Online, they then also complete the Personal Record Keeping Form online. They will measure and record their anxiety ratings, attention ratings, SUDs score, PhysioScan Scores, Pulse Rate, Surface Temperature. and Respiration Rate. If the client is not online, they can use a printed set of instructions and forms from the Report & Report Generator Module so they can collect this data and input it into the computer at the beginning of the next session (a sample report is printed below). The computer will determine their composite stress index and report it, and other relevant data, to the client with an interpretation. The client will input the information he/she gathers during homework in the next training session, in order to facilitate the programs decisions in terms of continuing the course of training or changing it.

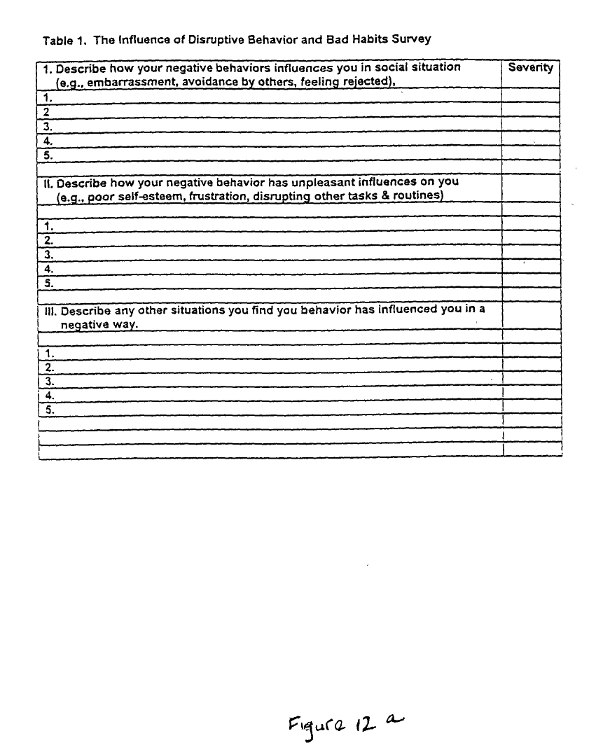

46. When time permits, the client can have access to the Audio/Visual Relaxation Module for an enjoyable, brief relaxation exercise. FIG. 13 illustrates a sample PRKF used in self-affirmations training.

Thought Stopping: Coping Skills Module

Function

The basic function of this module is to provide the user/client with techniques to modify maladaptive thought patterns and cognitions that sustain anxiety and stress. The module presents a number of standardized techniques to modify thought patterns. One for of modification uses relatively simple techniques to implement, making it relatively easy for the client to implement. The second part of the module involves more complete and interactive design based on an expert system approach to helping the client discover for themselves ways to modify their thinking patterns. This module also draws from a number of other modules to provide, text, voice, images, animation, movies, and music to facilitate the thought change process. In addition, there is the option to provide relaxing music to further facilitate relaxation.

Based on response to questionnaires the client initially completed they will be given suggestions as to which techniques to begin with. For example, those individuals who tend to be high absorbers and also tend to obsessive, ruminative thinking would most profit from a technique like thought stopping. In this technique, the client is shown a relatively easy technique to disrupt their ruminative and obsessive thinking style. In addition, this module integrates tits techniques with the main Stress and Anxiety Management Protocol, as learning relaxation techniques is one of the most fundamental methods for reducing the anxiety basis of maladaptive cognitions.

Implementation

The Cognitive Modification & Coping Skills Module is intended for the following purposes:

1. Enhance self-awareness

2. Reduce or eliminate negative thoughts sustaining stress and anxiety

3. Enhance self-esteem

4. Provide positive reinforcements for changing ones behavior

5. Clarifying the maladaptive ways one thinks about and interacts with the world

In general the module focuses on these techniques

33. Learning to use self-talk and imagery to enhance self-esteem.

34. Learning to use self-affirmations to learn more positive ways to cope with stress

35. Learning to use thought stopping to minimize or eliminate maladaptive thoughts.

36. Learning to use re-labeling and cognitive-restructuring to change one's perception of reality and one “self” in a more positive way

37. Learning to integrate the above techniques with relaxation methods to facilitate their efficacy.

38. Learning to use the above methods in a practical manner in everyday life/

Parameter Matrix Variables

Note: Models below refer to animations or movies

38. Type of visual image (e.g., running river, sunset, forest scene)

39. Type of auditory stimulation or music (e.g., the repetitive sound of rain, baroque music, country music, the sounds of a heart beating)

40. Toe of meditative technique and/or meditative phrase employed

41. Sex of the animation model

42. Age of the animation model

43. Ethnic/Social background of animation model

Module Design

Thus module will focus on 1) visual relaxation images, movies, & animations 2) relaxing music and sounds, and 3) combined auditory and visual relaxation images. These multimedia stimuli can be used independently as a relaxation technique where thee client can experience the stimuli and let their mind “wander off and relax. This module can also provide background multimedia stimuli against which to practice other exercises. In addition, this module provides several guided images where the client can experience soothing and relaxing sounds and images while they can either read and/or scripts that facilitate relaxation. The module is so designed that one of its parameters allows for the addition of scripts for the guided image exercises.

The four major behaviors in this module the client must master are:

6. Utilizing images and sounds to relax

7. Learning to internalize visualization techniques for use in the absence of external stimuli

8. Learning to relax during guided images

9. learning to apply these techniques to everyday life

10. Learning to monitor stress & relaxation by integrating PhysioScan techniques and self-report measures to monitor the relaxation process

Module Implementation: Programming Steps

Thought Stopping

Overview

Thought Stopping is a technique whereby the person learns to disrupt a thought pattern or Thought→Action sequence with a stimulus that has significant salience technique where the person repeats over, either out loud or in one's mind, positive phrases in a relaxed state to build one's sense of self-esteem and assertiveness. It uses the deeply relaxed state to allow the affirmations to enter deep into ones consciousness so that they are readily available at times when the person most needs them. The positive affirmations become conditioned to the relaxed state, which enhances the affirmation's ability to negate the negative thought patterns.

SubModule Implementation

1 Screen 1. Displays text explaining the values of the Thought Stopping technique and how it works work. They text with auditory accompaniment indicates how it will help them to eliminate disruptive and maladaptive thoughts that often result in negative behavior patterns. The are informed that this facilitates the de-construction of a recurring thought pattern by reducing its significance by not allowing the thought to go to completion. By so doing, it loses some of its reinforcement potential each time, an eventually it will extinguish. The earlier in the sequence of the thought pattern the disruption occurs, the greater the potential for eliminating the thought pattern all together.

2. Relaxation Training. The client is also informed that they will combine the thought stopping technique with relaxation training to facilitate their visualization or verbal thought process of the Negative Thought→Disruptive Stimulus they will use to practice their affirmations. They will be given an opportunity so select a relaxation technique to learn before they continue with this module. If they have already learned the technique they are sent to the practice area of the relaxation technique to assess their proficiency and to practice the final phase of the technique to ensure they are achieving a deep state of relaxation. If they have not achieved this criteria they will have to re-train in the technique. The program will suggest a technique based on their assessment in the Generalized Assessment Module. However, they have the latitude to select another technique, but the must meet the criteria for achieving a deep state of de-arousal and relaxation. The criteria are that they must be able to relax by the method of Relaxation by Cued-Recall before continuing in this submodule.

3. Screen 3: Relaxation techniques Menu from which the client will select either Training or Practice from the technique they choose.

4. Screen 4: This screen provides the client with the basic instructions (in textual format with auditory accompaniment) for using Thought Stopping. The essence of the technique is similar to 1) enter a relaxed state, 2) visualize verbally or imaginatively the negative thought, and 3) have a salient stimulus come on at first after 2-3 minutes of visualization. Over time the salient stimulus will occur earlier and earlier into the negative thought or image sequence.

5. Screen 5: This screen then prompts the client to record textually on the computer screen a set of irrational thoughts or beliefs that may have. This is accomplished by calling the Cognitive Self-Monitoring and Self-Reporting Module CSMSRM). This module assists the client in identifying and recording irrational thoughts and beliefs. The CSMSRM receives instructions to do this by the parameters Passed by the current module. For example, the current Module will indicate that the client must complete 1) the Brief Bindler Anxiety Scale, 2) the survey of Maladaptive & Irrational Beliefs, 3) The Maladaptive Thinking Styles Questionnaire, and 4) The Cognitive Narrative Report. The training provided in the CSMSRM results in a narrative script, which can also be recorded by voice. The Thought Stopping module uses this narrative. In addition, when the client is no longer using computer-displayed material, the client still requires this process to be able to identify and to monitor their irrational beliefs and thoughts so they can utilize thought stopping more effectively by clarifying the precise and detailed nature of these thoughts. Furthermore, the training CSMST facilitates the client's discovery of these irrational thoughts, which are usually preconscious, automatic and reflexive. Thus, they are not readily accessed by immediate awareness. This training assists the client in being able to “catch” these thoughts, to identify them, and to record them in a systematic fashion.

6. Screen 6. This module then calls the Cognitive Practice & Rehearsal Module, which will present the salient stimulus and time the events for the client, based on instructions sent to it by this module.

7. Screen 7: In the Cognitive Practice & Rehearsal Module(CPRM) they are given instructions to relax by the method of Relaxation by Cued-Recall.

8. Note: The CPRM has as one its parameters Passed to it by the current module whether the client will do the exercise with their eyes open or closed. If they do the latter parts of exercise with eyes opened they have the open of having to see the recorded thought pattern on the screen and/or accompanied by a vocal recitation of the text (e.g., test-to-speech processing, client recording their own voice and having it played back). The client can then follow the form of recorded material they chose while also attempting to mentally follow the pattern as a form of cover self-talk.

9. Note: This first stage of practice is particularly useful for most clients because the referenced self-talk of their negative and irrational thoughts and beliefs is generally preconscious, and therefore not readily accessible to immediate consciousness. Therefore, an initial form of overt practice helps to identify and to bring into immediate consciousness the irrational thoughts. As with other techniques, this for of self-awareness a key element in the self-control of automatic and reflexive thought patters. Once the irrational, negative though is on consciousness with greater clarity it is easier to bring it under control of other stimuli. The disruptive stimulus (e.g., STOP) also serves as a discriminative stimulus, which can also act to thwart the occurrence of the thought. As the disruptive cue is moved closer to the initiation of the negative thought pattern, it gains strength as a discriminative cue and helps to avert the occurrence of the thought. The disruptive cue, as it is aversive, further serves as a punisher for the occurrence of the negative thought. In this way, the conditioning occurring here is similar to an avoidance conditioning paradigm, insofar as the aversive thought develops an associative connection to the aversive internal cue. In this sense, using a covert internal stimulus may have greater efficacy than a noxious external cue (e.g., using a snap of a rubber band on the wrist) because of the potential to develop the associative chain whereby the negative, maladaptive thought comes, in a sense, to elicit the covert aversive stimulus. Refraining from the thought, avoids the aversive stimulus. It is likely that this covert associative link would operative with greater strength and rapidity than if the thought were connected to an external cue (which might not always be available, as for example, not having a rubber band on the wrist).

10. Screen 8: The client will first have the opportunity to practice Thought Stopping by seeing & hearing the material they had previously input into the computer as a description of their irrational thought. They are instructed to imagine or think the irrational thought along with the textual display and/or vocal recitation. Then at some point approximately 2-minutes after the initiation of the sequence the firs disruptive cue will come on. The client will see the screen go blank and vocal recitation ceases. They are given 30=seconds to continue refraining from the thought. Then the presentation begins again, and the disruptive cue will come on randomly anytime (within 2 minutes) after the initiation of the presentation trial.

11. Note. With continued practice the cue comes on earlier and earlier after the negative thought sequence is imitated. In addition, the amount of time they are given to continue to refrain from the negative thought patterns is also extended successively over trials. This allows for the opportunity of disrupting and extinguishing the thought pattern more quickly over time, and trains the client progressively to extend the post-disruption experience for a longer period of time.

12. Screen 9: After 10 trials or training episodes, the client completes an abbreviated segment of the PRKF, which also assess if the client felt a significant effect of the disruption. If this is the case, the disruptive stimulus then can occur randomly anytime within 1½-minutes of the initiation of the trial. After another 10 trials, the client is assessed again, until the disruptive stimulus is effective within 4-seocnds after the trial begins.

13. Note: The time interval decrease as follows starting at 2-min: 2-minutes, 1½-minutes, 1-minute, 30-seconds, 15-seconds, 5-seconds. Each stimulus presentation is a trial; each unified training segment is called an episode. For each irrational thought pattern, there are 10 trials per time duration, unless the client needs further training at any given duration.

14. Note: After the training with the computer display of the material, the client begins the phase of practicing without these prompts.

15. Screen 10: They are then asked to by text and voice instructions to visualize the negative thought pattern. If some form of covert visualization is difficult the CPRM offers overt practice and rehearsal alternatives. In this screen there is also the opportunity to have relaxing stimuli in the background to facilitate the visualization

16. Screen 11: After approximately 2-minutes the client will hear the word STOP in a loud voice over the computers speakers for three successive repetitions, with a 1-second interval between each vocalization. In addition, STOP appears on the computer screen in flashing, large red letters (for those doing the training with their eyes open).

17. Screen 12: After 10 trials or training episodes, the client completes an abbreviated segment of the PRKF, which also assess if the client felt a significant effect of the disruption. If this is the case, the disruptive stimulus then can occur randomly anytime within 1½-minutes of the initiation of the trial. After another 10 trials, the client is assessed again, until the disruptive stimulus is effective within 4-seocndsater the trial begins.

18. Note: Depending on how often the client had to repeat a training episode, the session for training in Thought Stopping will ordinarily time-out at around 20-minutes. The client resumes at a point where they left off previously.

19. Note. After the client complete the first phase of training, they will be instructed in Screen 7B that the will only hear a low tone randomly, at which point the client should yell out the word STOP. On screen 7C they will hear a low tone and scream out the word STOP only covertly, as a mental stimulus. By this last point, the homework will consist of practicing beginning an irrational thought, an immediately evoking the mental disruptive stimulus. Thus, the client will begin to have a technique they can use almost anywhere to immediately truncate an irrational thought pattern almost from the moment of its mere inception.

20. Note: The time interval decrease as follows starting at 2-minutes: 2-minutes, 1½-minutes, 1-minute, 30-seconds, 15-seconds, 5-seconds.

21. Screen 13: The client then completes the Personal Record Keeping Form with the full PhysioScan profile. This completes the portion of the training where the client reports on the effectiveness of the Thought Stopping technique for that session.

22. Note: The client is encouraged to practice each session on the computer at least three times per week in the initial training. They are also encouraged to use it to facilitate their homework exercises.

23. Note: At the end of each session, the submodule then calls the Reinforcement Module so the client can enter the appropriate points they scheduled for reinforcement.

24. Screen 14: Homework: The client will have the option of printing out a sheet with instructions as to how to practice their Thought Stopping exercise without the use of a computer. They will be instructed on how to make a “timing tape” on a cassette recorder, with and without the disruptive stimulus on the tape (depending on where they are in training). They can also download the timing and disruptive stimulus sequences as wither a WAV or MP3 file for use on their computer or storage on an MP3 device or tape recorder. In addition, they will have the option of continuing practice by returning to the program or website at any time to practice. If the client is on the PC or Online, they then also complete the Personal Record Keeping Form online. They will measure and record their anxiety ratings, attention ratings, SUDs score, PhysioScan Scores, Pulse Rate, Surface Temperature. and Respiration Rate. If the client is not online, they can use a printed set of instructions and forms from the Report & Report Generator Module so they can collect this data and input it into the computer at the beginning of the next session (a sample report is printed below). The computer will determine their composite stress index and report it, and other relevant data, to the client with an interpretation. The client will input the information he/she gathers during homework in the next training session, in order to facilitate the programs decisions in terms of continuing the course of training or changing it.

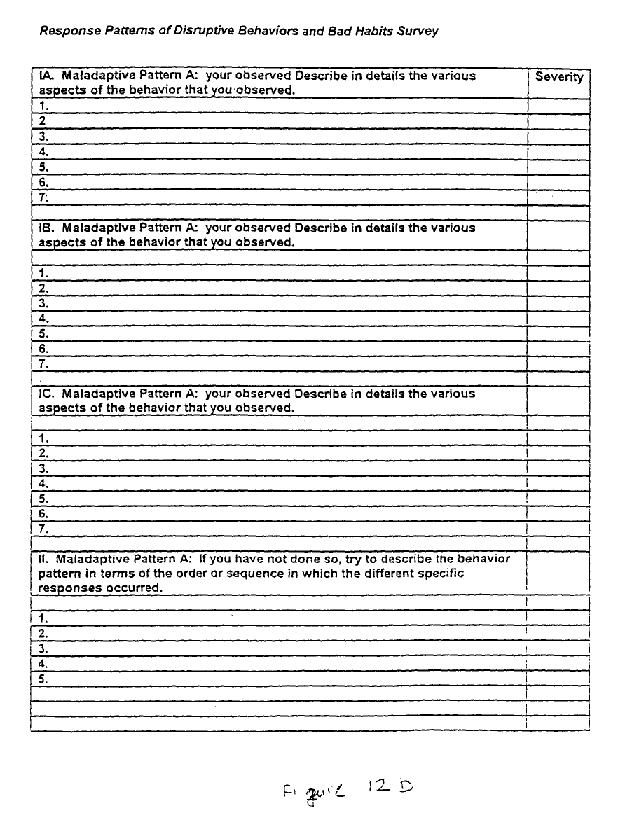

25. When time permits, the client can have access to the Audio/Visual Relaxation Module for an enjoyable, brief relaxation exercise. FIG. 14 illustrates a sample PRKF used in thought stopping training.

Reinforcement Module

Function

The function of the Reinforcement Module is to provide the individual with the opportunity to record points, after their session or homework, which gather in value until the client can translate the points into something they find rewarding and enjoyable. This may include going out an buying something the person wanted, or it may be anything else that the person wants, but cannot obtain or attain until they have med their goal in accumulated points. The scoring of the points should be done immediately after any set of training episodes to maximize the effectiveness of the reinforcement. According to behavior theory a rein forcer is any stimulus that increases the likelihood of the recurrence of a response that preceded it. Thus,

R→S^{R}

Response [R] is more likely to occur again if stimulus [S^{R}] is a rein forcer for that response. Furthermore, [R] is defined as a response set, whereby the rein forcer is said to potentially have the effect on any response that is a member of that set or class of responses. Thus, one can reinforce handshaking, whereby the likelihood of occurrence is not said to pertain to the handshake, which preceded the rein forcer, but any response that meets the requirements of handshaking behavior.

The client has to develop a reinforcement hierarchy in which they specify reasonably attainable objects or events, which are of significant value to act as a rein forcer. Depending on how quickly they wish to achieve the desired object or event, they can either “spend” their points immediately, or accumulate them, and “cash them in” at a later time. Generally, thee should be a mix of the two. Some points should be “cashed in” quickly, or after a short accumulation period. Some points should be accumulated, so that periodically the client obtains a significant rein forcer. As a general rule, it should be the case that the more points one accumulates, the more significant the rein forcer should be (even if it is used on little things, it should be many little things at one time.

There are two main criteria for gaining points. One is if the client completed the task at hand in terms of attempting the task and completing the required time period. Thus, the client is being reinforced for their commitment, compliance, and motivation. The second is if they met the actual training criteria of the session or homework. Generally, the number of points should be greater for the last part than the first. Furthermore, the rein forcers should be realistic. One should not commit to buying the luxury car they always wanted if they cannot afford it. Also, the rein forcer should not have embedded with it a hidden Punisher (i.e., something that will decrease the likelihood of the occurrence of the response). For example, if someone is on a diet, their reinforcement for accumulated points should not be a chocolate cake.

Having established the rein forcer hierarchy, one needs to set up the reinforcement schedule, which establishes the number of points of 1) compliance and 2) for meeting criteria The schedule also contains a chart of the points per training period, accumulated points, and criteria for “cashing” points in.” As each training module is different, the criteria for these values are discussed in each module, which contains recommendations for the various criteria, as well as instructions for how the client may modify them if the recommendations do no meet their needs. Having established these criteria, the program Passes them to the Reinforcement Module as parameters. In the beginning of any tanning protocol, the client initially enters the Reinforcement Module to fill in the Reinforcement Hierarchy and The Reinforcement Schedule. At the end of any training period, the client is sent by the protocol to the Reinforcement Module to enter the points for that session.

There are some occasions where the client may loose points. For any scheduled session or homework that was missed for no substantial reason the client looses the number of points they would have earned for just complying. A similar number of points can be lost if the client (who must be honest with themselves) feels that did not take a training session or homework seriously and just “goofed off.”

Parameter Matrix

1. Actual rein forcers

3. Compliance criteria for reinforcement

3. Performance criteria for reinforcement

4. Point values for compliance

5. Point values for performance

6, “Cash In” criteria

Module Design & Implementation

1. Screen 1: Gateway\Entrance Screen

2. Note: Parameters Sent by Calling module

3. Screen 2: Instructions for completing of Reinforcement Hierarchy

4, Screen 3: Client completes Reinforcement Hierarchy

5. Screen 4: Instructions for completing of Reinforcement Schedule

4, Screen 5: Client completes Reinforcement Schedule

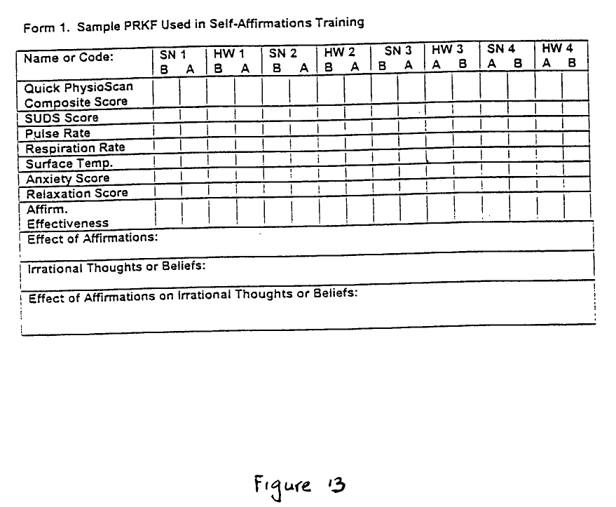

6. Screen 6: Client is informed that they are being returned to the module that called it FIGS. 15a-b illustrate forms associated with reinforcement hierarchy and reinforcement schedule.

Collateral Modules

Text & Voice Presentation Form

Function

This module serves to present textual material with or without voice and other auditory accompaniment. Additional auditory accompaniment may include music and other sounds, and these additional sounds may or may not be mixed with the voice. Other sounds could include special effects like the sound of rain or a train traveling past. The user will have simple onscreen controls to control the volume of the sounds and/or the mixture of several sounds (usually involving a simple slide switch setting the balance between two sounds, allowing the client to emphasize one sound over the other (e.g., making the voice more dominant over a mixed special effect). At times, there may be a movie of an individual speaking or an animation with lip-synchronized speech.

For Example:

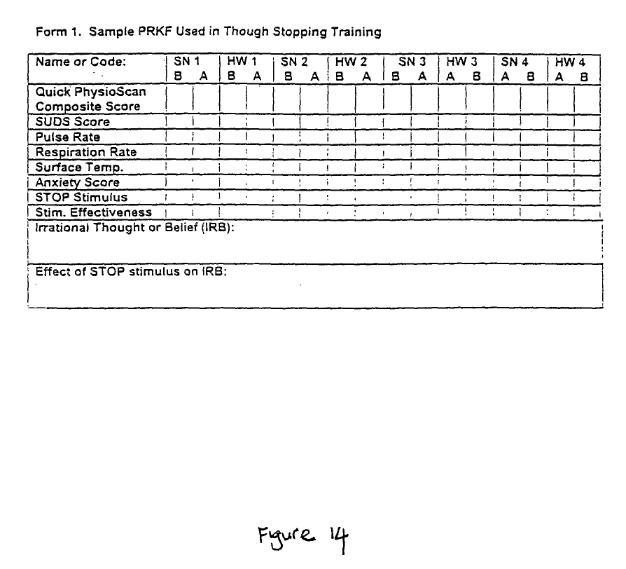

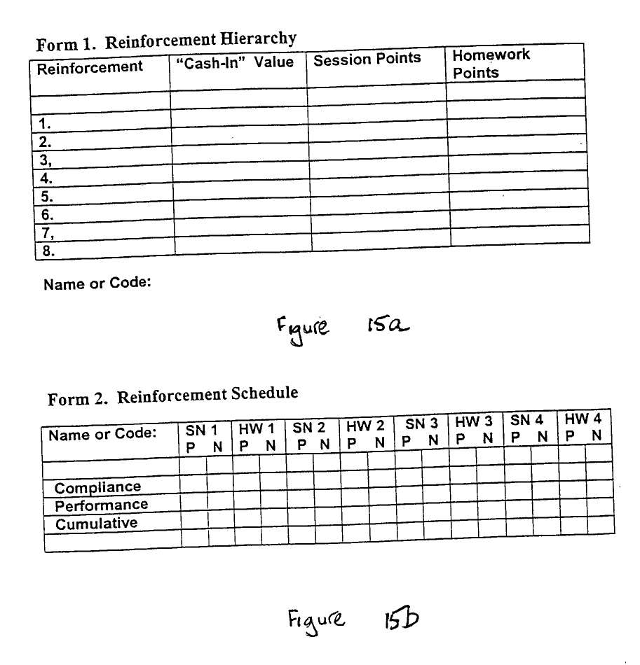

FIG. 16 illustrates an interface wherein a user is able to modify the volume from a range of soft to loud. Furthermore, in the illustrated interface, the balance is changeable from a text range to a music range. This module is used whenever textual material has to be presented, whether or not it is augmented by voice, music, or special sound effects. Thus, it is used to present introductory material, instructions, and material providing transitions between modules. In addition, this module provides for the placement of hyperlinks to other documents, bibliographic references, and other websites to supplement the basic material in the text.

Parameter Matrix Variables

1. Textual material to be presented

2. Font Style and other parameters of the characters

3. Design of text format

4. Special text effects

5. Voice material to be presented

6. Real or synthesized speech

7. Pitch, volume, and other qualities of the voice (if synthesized voice, there is even greater control over the speech qualities, although thee synthesized speech still has not yet reached near-human like quality as yet)

8. Music material to be presented

9. Character of the music sample that can be user modified

10. Sound material or special sound effects to be presented

11. Character of the sound or sound effects sample that can be user modified

12. Background design and theme

13. Gender, age, and other aspects of model in movie or animation

Module Design

This module is related to the Audio/Visual Relaxation Module. It is a general format module with characteristics designed into its properties to make it functional for a variety of purposes where text, speech, and/or sounds are needed for introductions, instructions, or transitions between modules.

Module Design: Programming Steps

1. Screen 1: Display text program needs to present to client.

2. Screen 1: If part of the display, present accompanying voice, music, or sound sample. Volume and balance controls are visible at the bottom of screen with help file link available. All sound files will also have related AVI controls so the client can Start, Stop, Pause, or Replay the sample.

3. Screen 1: If part of the display, present animation or movie with model reading the text. All sound files will also have related AVI controls so the client can Start, Stop, Pause, or Replay the sample.

Audio/Visual Relaxation Module

Function

The basic function of this module is to provide the user/client with relaxing images, animation, movies, and music to facilitate relaxation. In addition, there is the option to provide relaxing music to further facilitate relaxation. The user/client will be able to select from a variety o visual and auditory stimulate which will facilitate relaxation. Based on response to questionnaires the user initially completed the user will also be suggested as too which of the stimuli they should start with that would most suit their needs. For example, those individuals who score on the Absorption Index would most profit from images like sunsets and forests which would enhance their ability to internalize their. Those who score low on the index would more likely profit from certain forms of music, repetitive auditory stimulation, or nature sounds because these sounds act as a focal referent for attention. In addition, this module integrates the auditory and visual stimuli with instructions for either deepening relaxation through these stimuli. In addition, these stimuli can also be integrated with instructions for meditative type of exercises that also deepen relaxation.

Many of these exercises utilize the body's capacity to relax when exposed to tranquil images and sounds. While ordinary imagery techniques that rely on mental imagery, these techniques provide a deeper and richer experience. Many individuals have a difficult time using mental images, and frequently people have little or no capacity for mental images. Also mental images are difficult to control and as the mind wanders attention to the image is lost. By providing external images and sounds attention is more easily sustained and the experience becomes deeper. Also, it is relatively easy to compile a database of sounds and visual images to accommodate almost every individual's preference.

Implementation

The Audio/Visual Relaxation Module is intended for the following purposes:

1. Providing additional relaxation techniques that eh user/client can use in everyday life.

2. Provide techniques to deepen and enhance the relaxation techniques taught in other modules.

3. Provide techniques to enhance relaxation in specific areas of the body.

4. Provide brief transitional exercises subsequent to the main training in other modules

In general the module focuses on several parameters:

1. Learning to use imagery and internalize images as a means of relaxation.

2. Learning simple meditative exercises to achieve relaxation.

3. Learning to use respiration rate as a means of controlling the meditative process.

4. Learning to integrate meditative exercise with other relaxation techniques.

5, Learning to use imagery and meditative exercises in everyday life.

Parameter Matrix Variables

Please note: Models below refer to animations or live movies with human models

1. Type of visual image (e.g., running river, sunset, forest scene)

2. Type of auditory stimulation or music (e.g., the repetitive sound of rain, baroque music, country music, the sounds of a heart beating)

3. Tone of meditative technique and/or meditative phrase employed

4. Sex of the animation model

5. Age of the animation model

6. Ethnic/Social background of animation model

Module Design

Thus module will focus on 1) visual relaxation images, movies, & animations 2) relaxing music and sounds, and 3) combined auditory and visual relaxation images. These multimedia stimuli can be used independently as a relaxation technique where thee client can experience the stimuli and let their mind “wander off and relax. This module can also provide background multimedia stimuli against which to practice other exercises. In addition, this module provides several guided images where the client can experience soothing and relaxing sounds and images while they can either read and/or scripts that facilitate relaxation. The module is so designed that one of its parameters allows for the addition of scripts for the guided image exercises.

The four major behaviors in this module the client must master are:

1. Utilizing images and sounds to relax

2. Learning to internalize visualization techniques for use in the absence of external stimuli

3. Learning to relax during guided images

4. Learning to apply these techniques to everyday life

5. Learning to monitor stress & relaxation by integrating PhysioScan techniques and self-report measures to monitor the relaxation process

Module Implementation: Programming Steps

1. Screen 1. Displays text explaining the values of imagery, auditory stimulation, or guided imagery in achieving relaxation. They text with auditory accompaniment indicates how it will help them to calm their mind, reduce external distractions, and to focus attention.

2. Screen 2. They are further informed that these exercises, as those in the PhysioScan module, help them to become aware of their bodies to differentiate their internal feelings. That this is natural for the mind to do, but that anxiety disrupts this process. The client has access to AVI controls to repeat the sequence as often as they wish.

3. Screen 3. This screen briefly suggests which type of training would seem best suited for the client based on their previous scores in the Assessment Module. The client is given a Menu of 5 choices: 1) Visual Relaxation, 2) Auditory Relaxation, 3) Combined Auditory & Visual Relaxation 4) Guided Imagery, buttons to the Meditation and Autogenic Training Module since these are very related techniques. Each button then leads to next Submenu screen.

4. Screen 4. Depending on the client's choice, the they are sent to the specific screen giving a general Overview and Instructions pertaining to the technique they have selected, These instruction s will be presented as a text screen combined with an auditory accompaniment.

A. Visual Imagery (Text/Voice#2): The client/user is offered a variety of AVI animations or movies that have shown to have a calming and relaxing effects such as sunsets, rivers flowing, and forest scenes. These choices the options controlled generally by the user, unless specified by the program manager for some specified reason. The client is told that they are to recline in their chair and just let their mind flow onto the image much as if they were watching a movie or reading a fascinating book.

B. Auditory Stimuli (Text/Voice#3): The client/user is offered a variety of WAV or MP3 file selections that have calming and relaxing effects such as Baroque music, soft country music, or classical music. In addition, a variety of nature sounds will be offered that have calming effects, like the sound of rain, or waves on the beach. In particular, the nature sounds will have a variety of options with a repetitive quality to calm the nervous system through the effect of rhythmic stimulation on the nervous system (e.g., pouring rain, gentle wind, a flowing river). These choices the options controlled generally by the user, unless specified by the program manager for some specified reason. The client is told that they are to recline in their chair and just let their mind flow into the sound or music much as if they were listening to a favorite piece of music or just enjoying the patter of the rain.

C. Combined Auditory and Visual Stimuli (Text/Voice#4). This section offers the client/user a variety of combinations of the stimuli offered in A & B, unless restricted by the program manger for some specified reason.

5. Screen 5. Screen presents the Personal Record Keeping Form combining cognitive & behavioral self-reports from the initial entries in the Personal Record Keeping, Form, the results of the Generalized Assessment Module and portions of the PhysioScan module to assess client's initial (baseline) stress and anxiety response (including Surface Temperature, Respiration Rate, Pulse Rate, SUDs score and anxiety ratings. The client then clicks a button that brings them to Screen 6.

6. Screen 6. In this screen the client receives the particular multimedia experience they selected for Imagery Training, Auditory Relaxation, Combined Auditory & Visual, or Guided Imagery (or Meditation or Autogenic Training if they selected that module). They click the Start Button to initiate the experience. Alternatively, if the client wishes they have the option of backing up to the instructions in Screen 4 or going back to generate a new multimedia experience.

7. Screen 6 (continued). In this screen the client will see and/or hear material relevant to the particular training methodology chosen. Note: In many of the exercises the client is required to practice with their eyes closed for a certain period of time. Therefore, in the upper hand right hand corner of the screen is a small digital timer that emits a gentle beep when the appropriate time is ended. Instructions to the client will be presented both textually and vocally.

a. Visual Imagery—In this screen the client will be presented with the relaxing image, animation or movie for initial 5 minutes. If this image is used for the final phase of another training session the module will terminate at this point. For example, it is used often as final relaxation segment at the end of many training modules. If the imagery experience itself is used as a training technique the module will continue. After a 30 second break the client will be told the image will recur for another 5 minutes. After another 30-second break the client will receive 2 further 7-minute segments, punctuated by a 30 second breaks. Screen 7: The client is then asked to close their eyes and instructed to try image the scene they just experienced for a period of 2 minutes. They are instructed to keep their attention on the image for as long as possible. If their mind wanders, they are told to return to the image as quickly as possible. They are instructed not to worry about their mind wandering, as this is often common in the beginning of this type of experience. With practice their ability to extend their ability to pay attention generally improves. After completing the training screen, the client is returned to the Personal Record Keeping Form for a final assessment. The client has the option for terminating the session after each training episode if they are limited in time. They first must complete the Personal Record Keeping Form before exiting the program. In subsequent sessions they will be asked to experience the scenes for longer intervals, with the number and/or duration of the multimedia stimulus presentations truncated. They will also be asked to expand the time they are imaging the scene with eyes closed. This experience gives the client the opportunity to practice using the technique so they can use it when a computer CD or Internet access is not available, or when they need to relax outside the home or office. When the results indicated by the Personal Record Keeping Form show that they have become proficient at internalizing the image, they are asked to use some practice periods online and during homework with eyes open. This makes the technique even more practical, as it broadens its applicability to every day life. The exact progress in this regard depends on the degree of relaxation achieved in the Personal Record Keeping form and the analysis provided by the Report and Form Module. Homework: The client will have the option of printing out a sheet with instructions as to how to practice their imagery exercise without the use of a computer. In addition, they will have the option of continuing practice by returning to the program or website at any tome to practice the online imagery exercises. If the client is in the PC or Online, they then also compete the Personal Record Keeping Form online. They will measure and record their SUDs score, PhysioScan Scores, Pulse Rate, Surface Temperature. and Respiration Rate. If the client is not online, they can use a printed set of instructions and forms from the Report & Report Generator Module so they can collect this data and input it into the computer at the beginning of the next session (a sample report is printed below). The PhysioScan techniques are relevant to Imagery training by focusing the client on salient physiological sensations, and on their location, intensity & quality. This helps the client to identify the changes occur internally when they are tensed or relaxed. This becomes a practical, everyday life tool to help the client monitor their anxiety and stress levels so they can make appropriate and timely interventions before their stress accumulates to serious proportions. If they do not achieve an appropriate degree of relaxation using the imagery techniques (as indicated by their results) this might suggest changing the quality of the multimedia experience or even changing the technique itself. Furthermore, the computer will determine their composite stress index and report it to the client with an interpretation, The client will input the information he/she gathers in subsequent homework in the next training session to facilitate the programs decisions in terms of continuing the course of training or changing it.

b. Auditory Training. The procedure for auditory training is identical to Visual Training except the client hears the sound or music while the computer screen remains blank, Homework. For auditory training requires the subject to download either a WAV or an MP3 file for homework practice. As with the visual technique, they should practice in the points allocated above for training to recall the sound or music in their minds eye to see if they can retains, with clarity, the sounds presented. As with the Visual Training, they can return to the program to rehearse and practice their technique. They should try to practice the sounds without the external distracting sounds of everyday life. They should practice in a quiet environment, and use inexpensive ear plugs if necessary. They also need to complete the Personal Record Keeping Form to monitor and assess the efficacy of this technique, and to determine if another technique may be more beneficial.

c. Combined Visual & Auditory Training. The procedure for this training is identical to A & B above, except that both the auditory and visual stimuli are being presented together. During the period the client is asked to practice with their eyes closed, they are instructed to first practice the imagery alone for 2 minutes, the auditory stimulus for 2 minutes, and then the auditory-visual stimulus combined for 2 minutes.

d. Guided Imagery. During of the multimedia experience provided by the images, animations, movies, music, and sounds the client will also have option of selecting a guided image, which can be presented textually and/or aurally. These scripts guide the client to focus on certain thoughts and images that facilitate relaxation. In addition, specific scripts can be created by the client or by other processional for specific purposes. Each script can be presented against any combination of available multimedia stimuli. The most useful way is have, at a minimum, the scripts reading a low, soothing, slow voice. The voice and be mixed with music or other sounds to enhance the experience. For the scripts accompanying the system the program will suggest a multimedia background suited for the particular script.

e. Background Setting. It should be noted that many of the multimedia experiences in the Audio/Visual Relaxation Module could also be used as backgrounds against which to practice other relaxation exercises. It is often the case that other exercises integrated with relaxing visual and auditory stimuli are enhanced by the integration with these multimedia stimuli.

Technical Specifications

1. The client will have access to standard AVI controls to repeat the animations and auditory sequences in applicable screens as often as desired in any module. Thus, if the client is uncertain at any point they he/she is still uncertain about some aspect of the response they can “pause” the session and “play” the animation at will.

2. The client will also have access, at any time they desire, to the program whether on the PC or online, Thus, if they need further clarification of a point, or want to see an animation again, or upgrade their stress profile, they will be able to do so whenever they desire.

2. Homework instructions are general provided through al) a hard copy print out, ) as a WAV file download, or as a MP3 file download. When necessary, if an animation or movie needs to be download it will be provided in a variety of options selectable by the client, generally these will be formats that can be used in Microsoft Medias Player Real Player, or QuickTime formats. If the file is exceptionally large, they client will have the option of requesting a CD at minimal or no cost

3. The client will be able to print out a hard copy of the voice file. The hard copy will typically include other information, such as log sheet to keep track of various types of data they will record as they practice during the week. The Data Log module provides the instructions and forms for these printouts and downloads. These forms can be completed online or on a printed sheet. When the client records the information on a printed sheet, they will be able to enter the data in the data log module when the return to their current session. The PhysioScan Module and Personal Record Keeping Form are tightly integrated to provide an overall stress index for the client, to pinpoint specific areas of concern that need further work, and to print reports for the client concerning their progress in the program. The client records, typically records their data 1) before a session, a specific points during the session when necessary, 3) at the end of the session, and before and after homework assignments. This allows for a highly interactive approach to the programs responsiveness to the clients needs, thus providing an efficient, adaptive, and effective program. Furthermore, this insures the training will evolve and diversify with the various protocols and modules,

4. The data the client records will be input into the computer at the beginning of the clients next session for processing and the information is used by the protocol to make determinations about the client (e.g., do they need to practice this current behavior response pattern further before they go on to the next step?). This task is accomplished via the Data Collection & Processing Module. This module should have the option of collecting the data directly from the client if they save the data on their computer, or through direct input into a PC (as for example, at the client's worksite as part of a corporate Intranet). For example, instead of the form being printed out, the client could fill it in on a version downloaded to his or her own home PC.

Report & Form Generator Module

Function

The basic function of the Report and Form Generator Module is two-fold. The first function is to provide access to the Personal Record Keeping Form in order to 1) printout the Personal Record Keeping Form, 2) to provide PC/Online availability to allow the client to enter their data on online, and to 3) to provide access to the Personal Record Keeping Module at eh beginning of a training or treatment session so they client can enter homework data they recorded by hand. The Form Generator function also has the ability to access changes from other modules to update forms when necessary. Furthermore, due to the design of the module, it can perform similar functions with other types of forms that may be created in future enhancements of the protocols. In addition this Module also functions as a report Generator to provide both online and printed summaries of the client of their progress, what additional treatment or training they may need, and what changes might be implemented to either improve or enhance progress. The client will also be provided, when appropriate, interpretive summaries of their treatment or training process provided through an expert system methodology to interpret the data provided in the Personal Record Keeping Form.

Implementation

The Report & Form Generator Module is intended for the following purposes:

15. Provide either printed or online access to the Personal Record Keeping Form

16. To provide access to the data in the Personal Record Keeping Form to other modules that require these data for treatment or training decisions

17. To provide a printed form of the Personal Record Keeping Form for homework assignments.

18. The Report and Form Generator Module is interfaced to other modules that collect data and will have the capacity to motif the Personal Record Keeping form when necessary.

19. Provide online or printed summaries of patient's data and progress.

20. Provide interpretative summaries of the data when the protocols require these reports.

Parameter Matrix Variables

This module has no specific parameters as it receives its information from other modules

Module Design

This module is primarily a storage center that allows instant access to the { Personal Record Keeping Form. When a specific module calls for this form, it can be printed online or as a hard copy. The module also has the ability to provide other modules with data stored in the Report & Form Generator Module without actually displaying the data. The data in the Personal Record Keeping Form will be stored in a database to make access to the data to other modules a relatively easy task. It has the ability to do a similar function for other forms that may b created in the future. It also has the capacity to print out present online brief summaries or interpretative reports based on an expert system-like approach to analyzing and interpret ting the client's data. This particular module simply provides information to, or collects data from, other modules for purposes of acquiring or displaying data. It utilizes the screens designed in other modules.

Self-Report Data Collection and Processing Module

Function

The basic function of the Self-Report Data Collection Module is to provide the client with the means to monitor a variety of cognitions and behavioral responses. One purpose of this type of this module is to provide simple tools, usually as a set of integrated forms, which the client can use to monitor and track maladaptive thoughts and cognitions that result in stress and anxiety. This technique allows the client to become increasingly aware of these negative thoughts, and thus makes them more amenable to modification by techniques presented in other modules. In the initial assessment phase it also provides additional data to establish the clients baseline difficulties, which allows for a more appropriate matching of the clients needs and the techniques they would mist likely to be successful. This allows the program to determine 1) if the response in question is outside of normal limits and therefore dysfunctional to the point of requiring amelioration. Furthermore, many forms are used before and after the application of a training procedure or protocol. This provides a means for the training or treatment modules and protocols to assess the impact of techniques on the client. Thus, the program can determine the impact of the training or treatment in terms of the degree to which the client is or is not responding accordingly. This information allows the program to make adjustments that will facilitate training by changing techniques that may be more suitable to the client. Furthermore, the Self-Report Module is integrated with the PhysioScan module, so that both PhysioScan, physiological, behavioral and self-report data all entered into the programs decision-making processes. The PhysioScan Module also uses the self-report data to generate a report for client indicating their current status, what needs to still be accomplished, and what the client needs to do to ensure further success.

Implementation

The Self-Report data Collection & Processing Module is currently intended for the following purposes:

1. Self-monitoring techniques to establish baseline behavioral response rates.

2. Self-monitoring techniques to assess maladaptive cognitions and negative thoughts

3. Monitoring techniques to assess the impact of training.

4. Self-monitoring techniques for programs requiring assess baselines and treatment for psychophysiological disorders (e.g., asthma, low back pain, migraines, irritable bowel syndrome, Raynaud's disease

5. Autogenic Training

6. Physical rehabilitation exercises

7. Exercises for physical fitness

8. Sports optimization training

These type of modules are often integrated with the Cognitive Modification & Coping Skills Training Module, as well as with other modules, where some form of thought modification technique, imagery exercise, or attention training requires an assessment of the client's self-observations and self-report of their cognitive, behavioral, and perceptual responses. This module will also be interfaced with the Biofeedback Training Module.

Parameter Matrix Variables

Please note: Models below refer to animations or live movies

1. Specific behavioral response pattern (broken into component parts when necessary) of certain of the monitoring techniques (e.g. data requiring information on specific body areas)

2. Specific forms for collecting data relevant only to specific modules (e.g., Autogenic Training)

3. Forms that allow for collecting various types of cognitive data relevant to a particular module or behavioral technique

Module Design

Overall, the Self-Report Data Collection Module (SRDC) consists of 2 major sections. One component is the Cognitive Self-Monitoring Training (CSMT), which consists of training techniques to facilitate the individual's ability to focus on, to identify, and to record their maladaptive cognitions and negative though processes. The second component is a Report Generator the 1) collects data from other modules, particularly the PhysioScan Module, and 2) generates a report for the client indicating their current status, degree of progress, and suggestions for either modification of the training schedule or changing training techniques, when progress is not at expected levels.

The CSMT trains the client to detect and to identify cognitions, thoughts, images, and emotional states. This is a basic cognitive-behavioral methodology that allows the client to become more aware of the negative thoughts and maladaptive behavior patterns that interfere with healthy functioning.

The core methodology of CSMT is to provide the client first with a didactic set of instructions that trains them to be more observant of their thought patterns, particularly in situations where they feel anxious, fearful, worried, and/or depressed. They are then taught to use the forms provided by the Self-Report Module to record these observations in a meaningful way. Through the applications of these data collection forms the client typically enhances their awareness of the thought patterns underlying their difficulties. Thus material is input either directly into the PC/Online environment or copied into the computer from forms initially completed by hand. The CSMT is designed to be flexible to provide individualized forms suited to the client's specific problems. This is accomplished through the initial assessment provided by the Generalized Assessment Module. The data that are collected by these forms may change as the training proceeds, and new information becomes available.

The SRDC module also integrates data from the PhysioScan module and other modules to provide the report mentioned above when necessary. It is also the gateway through which information is input into the training modules to make adjustments in training when necessary.

Self-Report Module: Cognitive Self-Monitoring Technique (CSMT)

1. Screen 1. Entry/Gateway Screen

2. Screen 2. Introduction to Cognitive Self-Monitoring Technique (CSMT).

3. Screen 3. This is the first part of CSMT in which the client learns how to become aware of, to detect, and to monitor negative cognitions. In this screen the client is given a basic introductions to the methodology

4. Screen 4: In this screen the client sees either an animation or video of an individual with a particular problem and how they learn to identify the thoughts or images that produce their maladaptive behavior (VideoFile: CDMTv1-4). There will be 4 possible videos of different common situations the individual can select from to see the demonstration of this technique. The client can select as many of these AVI clips as they want, and repeat them as frequently as they desire though the provided AVI controls. These videos or animations will also demonstrate how to use the forms to collect the relevant data generated by the cognitive self-monitoring process.

5. Screen 4: After completing the demo video, the client will have an 1s additional set of 4 animations or videos to watch and record the data without the animations providing this par of the process. They will first receive the instructions provided in Screen 4. After they have entered their responses as to what they thought the negative and maladaptive cognitions were in the animation/video. Their responses will then be displayed against those that where inherently built into the scenario. The client will be able to assess the degree to which they were successful, and see what type of errors they missed. This will further enhance their training in this technique. The client will be encouraged to try all 4 tests animations/videos, and particularly if they do not show reasonably accurate results in their first try.

6. Screen 6: The client is asked to record their results on the Record Keeping Screen, which will be displayed in the lower portion of the demo. This Record Keeping Screen is a section of the Self-Report Module that will be implemented in many other modules. The Cognitive Self-Report Screen will be often used in conjunction with the record-keeping screen of the PhysioScan Module.

7. Screen 7: this screen will show a verity of self-report data forms. These forms will also be the forms printed out whereby the client will first record their data from homework exercises by hand and later input them into the computer.

8. Screen 8: These forms can also be customized to the individual problems. T In the Design Form screen, the client will be presented with a list of common ailments, symptoms, and complaints often associated with stress. These will include both physiological and psychological symptoms. When the client checks an appropriate box, an appropriate form of self-report will appear on the data collection form. Thus, if the person selects migraines or tension headaches, the data collection form will included appropriate measures to rate the frequency of the migraine, its intensity, and when they are most likely to occur. The rating scales used in this system are typically 10-point Likert scales ranging from mild or not at all to very painful and or very frequently. Once the form for the particular client is established, it can be completed immediately online whenever it appears as part of the protocol sequence. Alternatively, if the client uses the printed version, they can input their collected data the next time they logon. The form displayed is usually organized in the following way. At the outset, the data is collected as an initial baseline. Subsequently the form can be used to track the patient's ailments through various periods of the day. In addition, the client will always enter data immediately prior to and immediately after a training period. This helps to monitor progress and provide the program with information it can use to modify or change strategies if the current techniques are not successful. Finally, the client fills in the data at the end of training. When possible, the client should also record their data after 4, 6, 9, and 13 months as a follow-up. This is not only useful to determine the efficacy of the program, but also serves as a possible reminder that the client needs to resume training because they are not keeping up to their expected levels.

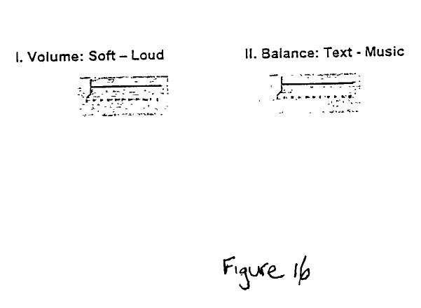

9. A typical cognitive-behavioral self-monitoring data collection form appears below, as it would be integrated into the Personal Record Keeping Form. FIG. 17 illustrates a typical personal record keeping form.

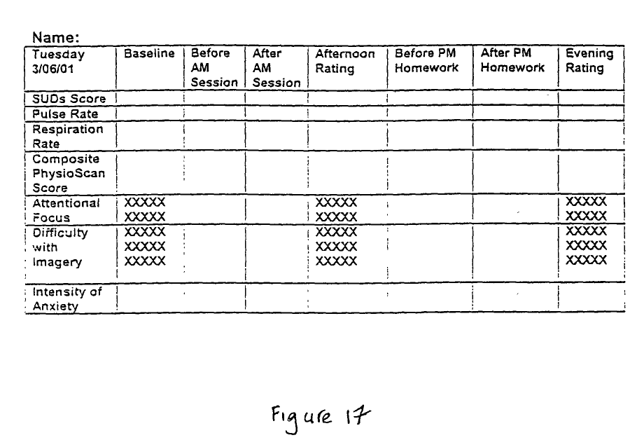

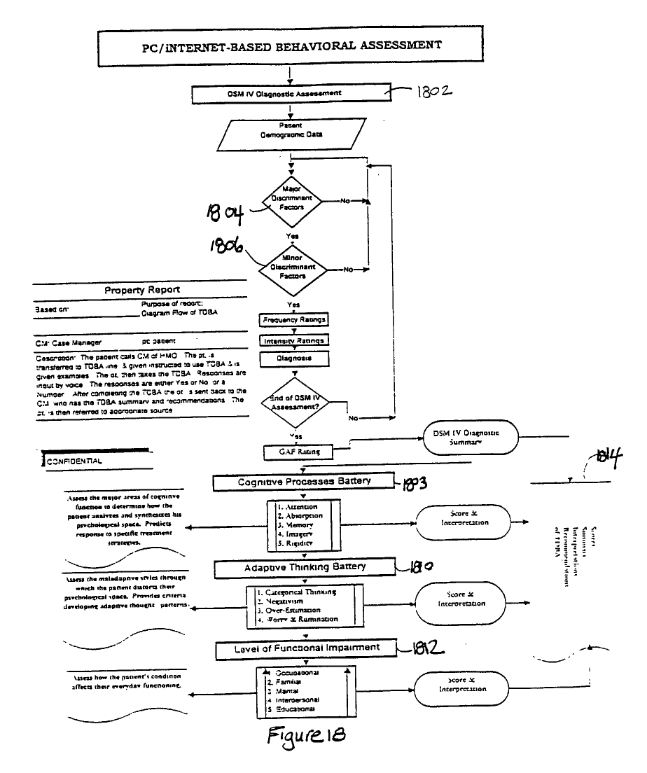

FIG. 18 illustrates an example of the present invention's method for PC or Internet based behavioral assessment. First, a DSM IV diagnostic assessment is performed (step 1802) and major and minor discriminant factors are identified (steps 1804 and 1806). Next, based on the DSM IV summary, a series of tests (cognitive process battery 1808, adaptive thinking battery 1810, and test for identifying level of functional impairment 1812) are performed, and the scores from these tests are used to provide clients with a behavioral assessment report along with recommendations.

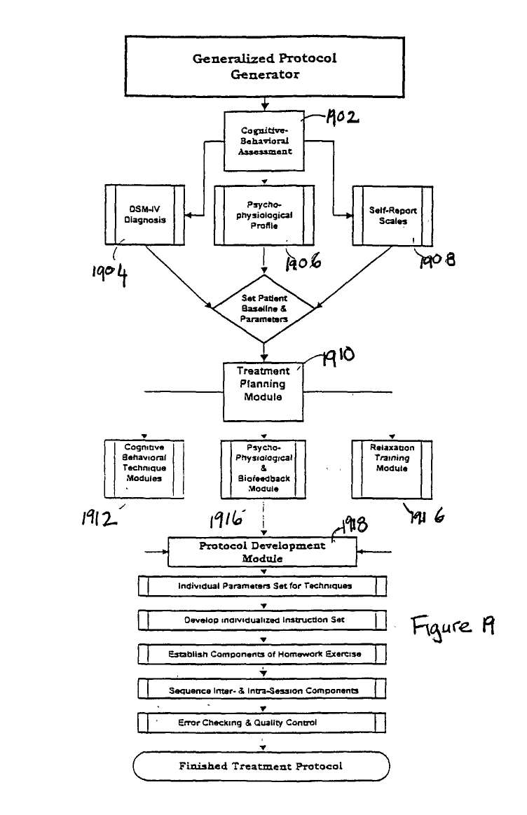

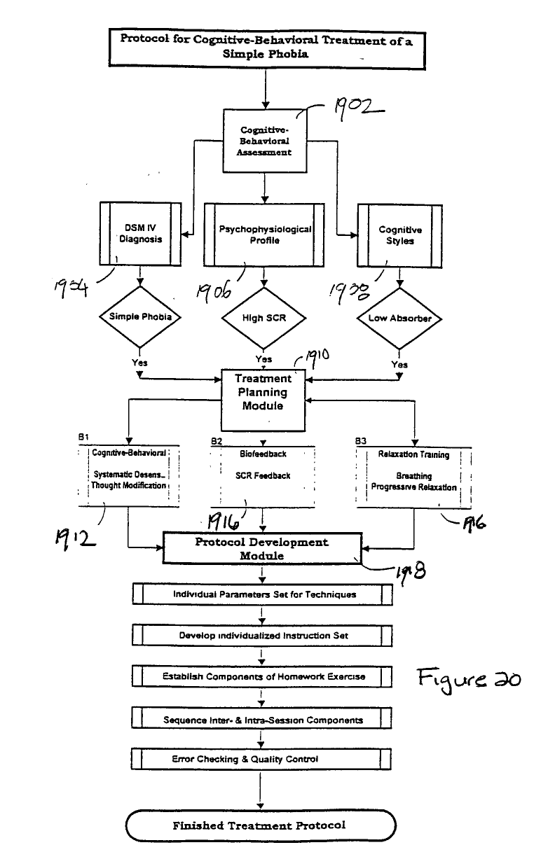

FIG. 19 illustrates the method associated with a generalized protocol generator of the present invention. Cognitive behavioral assessment 1902 is assessed using DSM-IV diagnosis 1904, the client's psycho-physiological profile 1906, and one or more self-reported scales 1908. Next, the client's/patient's baseline parameters are set. As a next step, the treatment planning module 1910, with the help of cognitive behavioral module 1912, psycho-physiological and biofeedback module 1914, relaxation module 1916 and protocol development module 1918, create an individualized module. FIG. 20 illustrates a specific example of a sample protocol for the treatment of a simple phobia.

### CONCLUSION

A system and method has been shown in the above embodiments for the effective implementation of a network-based implementation of an online psychological service. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific biofeedback hardware.

The above enhancements and described functional elements are implemented in various computing environments. For example, the present invention may be implemented on a conventional IBM PC or equivalent, multi-nodal system (e.g. LAN) or networking system (e.g. Internet, WWW, wireless web). All programming and data related thereto are stored in computer memory, static or dynamic, and may be retrieved by the user in any of: conventional computer storage, display (i.e. CRT) and/or hardcopy (i.e. printed) formats. The programming of the present invention may be implemented by one of skill in the art of database or web-based programming.

1. A modular system for providing customizable psychological services over a network, said system comprising:
one or more software instruction modules, each of said modules comprising any of, or a combination of, the following: a technique, a procedure, a test, or a skill;
a parameter matrix associated with each of said one or more software instruction modules, said parameter matrix comprising variables associated with each of said one or more software instruction modules;
one or more protocols, each of said one or more protocols dynamically formed by selecting sequencing one or more modules;
said one or more protocols customizable by modifying parameters in said parameter matrix,
and said customized one or more protocols providing psychological services over said network.

2. A modular system for providing customizable psychological services over a network, as per claim 1, wherein only a subset of said variables associated with said parameter matrix are customizable.

3. A modular system for providing customizable psychological services over a network, as per claim 1, wherein said one or more software instruction modules further comprise one or more routines, each of said routines providing for a specific level of service as a self-contained unit.

4. A modular system for providing customizable psychological services over a network, as per claim 1, wherein said network is any of the following: a local area network (LAN), a wide area network (WAN), the Internet, or a wireless network.

5. A modular system for providing customizable psychological services over a network, as per claim 1, wherein said system further comprises a virtual chat group that is accessed for information regarding said protocols and said modules.

6. A modular system for providing customizable psychological services over a network, as per claim 1, wherein said one or more protocols are selected from a set of standardized protocols.

7. A modular system for providing customizable psychological services over a network, as per claim 6, wherein said set of standardized protocols is stored in a server accessible over said network.

8. A modular system for providing customizable psychological services over a network, as per claim 1, wherein said system further comprises one or more links to professional resources for information regarding said modules and said protocols, said professional resources accessible over said network.

9. A modular system for providing customizable psychological services over a network, as per claim 1, wherein values of said variables comprising said parameter matrix are obtained from a profile that is client-specific.

10. A modular system for providing customizable psychological services over a network, as per claim 1, wherein said system is used to provide any of the following services: psychological assessment, relaxation, stress management, emotional self-regulation, therapeutic interventions, mental health maintenance, prevention of illness, or psychological information providers.

11. A modular system for providing customizable psychological services over a network, as per claim 1, wherein said one or more protocols include any of the following: a cognitive-behavioral protocol, prevention protocol, or performance optimization protocol.

12. A modularized system for providing customizable psychological services over a network, as per claim 1, wherein said one or more software instruction modules comprise any of the following:
generalized assessment module, physiological responses scanning module, breathing training module, attention and perception training module, single behavioral response module, sequential behavioral response training module, parallel behavioral response training module, autogenic training and meditation module, audio visual relaxation module, or systematic desensitization module.

13. A method for providing customizable psychological services over a network, said method
accessing a central service area associated with said network;
identifying one or more software instruction modules associated with any of, or a combination of, the following: a technique, a procedure, a test, or a skill;
modifying parameters and customizing said identified one or more software instruction modules;
selectively sequencing said one or more identified modules to form one or more protocols, and
providing customized psychological services using said one or more protocols.

14. A method for providing customizable psychological services over a network, as per claim 13, wherein said method further includes the step of accessing a chat group for information regarding customization of psychological services.

15. A method for providing customizable psychological services over a network, as per claim 13, wherein said method is implemented in conjunction with a website.

16. A method for providing customizable psychological services over a network, as per claim 15, wherein said website further includes one or more links to professional resources on the world wide web for accessing information regarding identification of said one or more modules or protocols.

17. A method for providing customizable psychological services over a network, as per claim 13, wherein said network is any of the following: a local area network (LAN), a wide area network (WAN), the Internet or a wireless network.

18. A method for providing customizable psychological services over a network, as per claim 13, wherein said one or more software instruction modules comprise any of the following: generalized assessment module, physiological responses scanning module, breathing training module, attention and perception training module, single behavioral response module, sequential behavioral response training module, parallel behavioral response training module, autogenic training and meditation module, audio visual relaxation module, or systematic desensitization module.

19. An article of manufacture comprising a computer usable medium having computer readable code embodied therein which provides for customizable psychological services, said medium comprising:
computer readable program code accessing a central service area in a network;
computer readable program code identifying one or more software instruction modules associated with any of, or a combination of, the following: a technique, a procedure, a test, or a skill;
computer readable code modifying parameters and customizing said identified one or more software instruction modules;
computer readable code sequencing said one or more identified modules to form one or more protocols, and
computer readable code providing customized psychological services using said one or more protocols.

20. An article of manufacture comprising a computer usable medium having computer readable code embodied therein which provides for customizable psychological services, as per claim 19, wherein said network is any of the following: a local area network (LAN), a wide area network (WAN), the Internet or a wireless network.
